(19) United States
(12) Patent Application Publication
(10) Pub. No.: US 2026/0163628 A1
(43) Pub. Date: Jun. 11, 2026

(54) RESOURCE CONFIGURATION AND ASSOCIATION FOR UE INITIATED BEAM REPORTING

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 19/388,949

(22) Filed: Nov. 13, 2025

Related U.S. Application Data
(60) Provisional application No. 63/729,648, filed on Dec. 9, 2024.
(60) Provisional application No. 63/747,777, filed on Jan. 21, 2025.
(60) Provisional application No. 63/750,016, filed on Jan. 27, 2025.
(60) Provisional application No. 63/760,502, filed on Feb. 19, 2025.
(60) Provisional application No. 63/770,778, filed on Mar. 12, 2025.
(60) Provisional application No. 63/772,232, filed on Mar. 14, 2025.
(60) Provisional application No. 63/777,486, filed on Mar. 25, 2025.
(60) Provisional application No. 63/794,930, filed on Apr. 25, 2025.

(51) Int. Cl. H04B 7/06; H04W 72/21

(52) U.S. Cl. CPC H04B 7/0626; H04W 72/21

(57) ABSTRACT

Methods and apparatuses for resource configuration and association for user equipment (UE)-initiated beam reporting. A method performed by a UE includes receiving N channel state information (CSI) report configurations. Each of the N CSI report configurations include a higher layer parameter ‘eventType’. The N CSI report configurations include a common configuration of one or more physical uplink control channel (PUCCH) resources. The method further includes determining a target CSI report configuration based on the N CSI report configurations, determining a UE-initiated report (UEIR) for the target CSI report configuration, and transmitting the UEIR.

### CROSS-REFERENCE TO RELATED AND CLAIM OF PRIORITY

The present application claims priority under 35 U.S.C. § 119 (e) to U.S. Provisional Patent Application No. 63/729,648 filed on Dec. 9, 2024; U.S. Provisional Patent Application No. 63/747,777 filed on Jan. 21, 2025; U.S. Provisional Patent Application No. 63/750,016 filed on Jan. 27, 2025; U.S. Provisional Patent Application No. 63/760,502 filed on Feb. 19, 2025; U.S. Provisional Patent Application No. 63/770,778 filed on Mar. 12, 2025; U.S. Provisional Patent Application No. 63/772,232 filed on Mar. 14, 2025; U.S. Provisional Patent Application No. 63/777,486 filed on Mar. 25, 2025; and U.S. Provisional Patent Application No. 63/794,930 filed on Apr. 25, 2025, which are hereby incorporated by reference in their entirety.

### TECHNICAL FIELD

The present disclosure relates generally to wireless communication systems and, more specifically, the present disclosure relates to methods and apparatuses for resource configuration and association for user equipment (UE)-initiated beam reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to resource configuration and association for UE-initiated beam reporting.

In one embodiment, a user equipment (UE) is provided. The UE includes a transceiver configured to receive N channel state information (CSI) report configurations. Each of the N CSI report configurations include a higher layer parameter ‘eventType’. The N CSI report configurations include a common configuration of one or more physical uplink control channel (PUCCH) resources. The UE further includes a processor operably coupled with the transceiver. The processor is configured to determine a target CSI report configuration based on the N CSI report configurations and determine a UE-initiated report (UEIR) for the target CSI report configuration. The transceiver is further configured to transmit the UEIR.

In another embodiment, a base station (BS) is provided. The BS includes a processor and a transceiver operably coupled with the processor. The transceiver is configured to transmit N CSI report configuration and receive a UEIR associated with a target CSI report configuration. The target CSI report configuration is based on the N CSI report configurations. Each of the N CSI report configurations include a higher layer parameter ‘eventType’. The N CSI report configurations include a common configuration of one or more PUCCH resources.

In yet another embodiment, a method performed by a UE is provided. The method includes receiving N CSI report configurations. Each of the N CSI report configurations include a higher layer parameter ‘eventType’. The N CSI report configurations include a common configuration of one or more PUCCH resources. The method further includes determining a target CSI report configuration based on the N CSI report configurations, determining a UEIR for the target CSI report configuration, and transmitting the UEIR.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example BS according to embodiments of the present disclosure;

FIG. 3 illustrates an example UE according to embodiments of the present disclosure;

FIGS. 4A and 4B illustrates an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIGS. 7A and 7B illustrate an example timeline for time window determination for event evaluations according to embodiments of the present disclosure; and

FIG. 8 illustrates an example method performed by a UE in a wireless communication system according to embodiments of the present disclosure.

### DETAILED DESCRIPTION

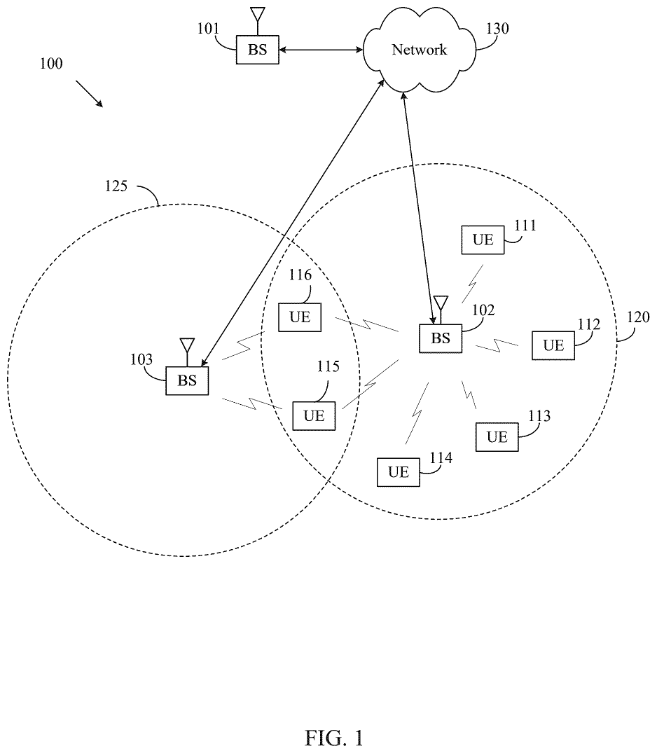

FIGS. 1-8, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR and 6GR communication systems.

In addition, in 5G/NR and 6GR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein [REF 1] 3GPP TS 38.211 v16.1.0, “NR; Physical channels and modulation;” [REF 2] 3GPP TS 38.212 v16.1.0, “NR; Multiplexing and Channel coding;” [REF 3] 3GPP TS 38.213 v16.1.0, “NR; Physical Layer Procedures for Control;” [REF 4] 3GPP TS 38.214 v16.1.0, “NR; Physical Layer Procedures for Data;” [REF 5] 3GPP TS 38.321 v16.1.0, “NR; Medium Access Control (MAC) protocol specification;” and [REF 6] 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a BS 101, a BS 102, and a BS 103. The BS 101 communicates with the BS 102 and the BS 103. The BS 101 also communicates with at least one network 130, such as the Internet, a proprietary Internet Protocol (IP) network, or other data network.

The BS 102 provides wireless broadband access to the network 130 for a first plurality of user equipments (UEs) within a coverage area 120 of the BS 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The BS 103 provides wireless broadband access to the network 130 for a second plurality of UEs within a coverage area 125 of the BS 103. The second plurality of UEs includes the UE 115 and the UE 116. In some embodiments, one or more of the BS s 101-103 may communicate with each other and with the UEs 111-116 using 6GR, 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a 6GR base station, a macrocell, a femtocell, a WiFi access point (AP), or other wirelessly enabled devices. Base stations may provide wireless access in accordance with one or more wireless communication protocols, e.g., 6GR, 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with BSs, such as the coverage areas 120 and 125, may have other shapes, including irregular shapes, depending upon the configuration of the BSs and variations in the radio environment associated with natural and man-made obstructions.

As described in more detail below, one or more of the UEs 111-116 include circuitry, programing, or a combination thereof for performing resource configuration and association for UE-initiated beam reporting. In certain embodiments, one or more of the BSs 101-103 include circuitry, programing, or a combination thereof to support resource configuration and association for UE-initiated beam reporting.

Although FIG. 1 illustrates one example of a wireless network, various changes may be made to FIG. 1. For example, the wireless network 100 could include any number of BSs and any number of UEs in any suitable arrangement. Also, the BS 101 could communicate directly with any number of UEs and provide those UEs with wireless broadband access to the network 130. Similarly, each BS 102-103 could communicate directly with the network 130 and provide UEs with direct wireless broadband access to the network 130. Further, the BSs 101, 102, and/or 103 could provide access to other or additional external networks, such as external telephone networks or other types of data networks.

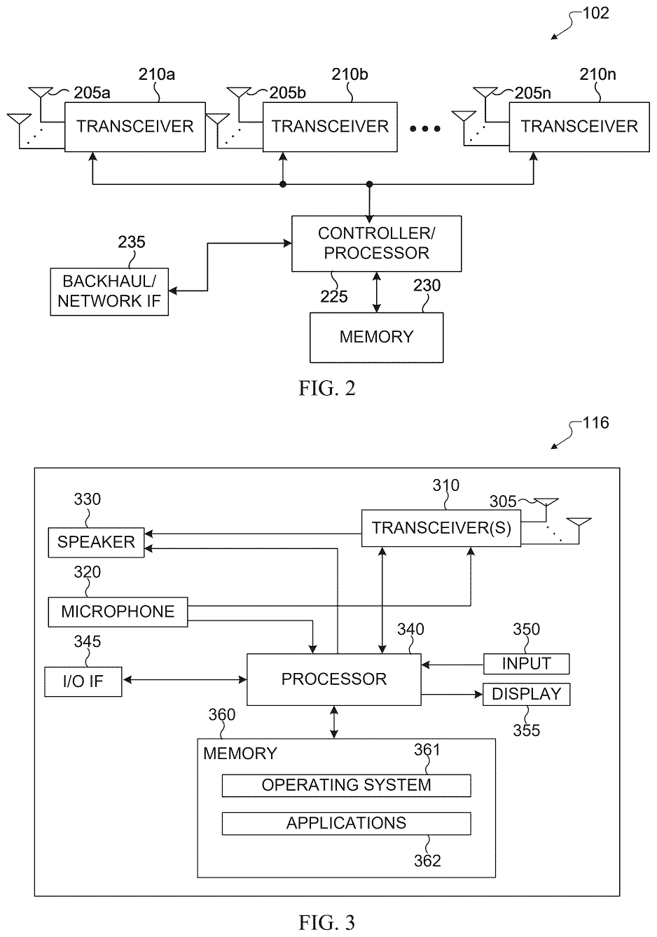

FIG. 2 illustrates an example BS 102 according to embodiments of the present disclosure. The embodiment of the BS 102 illustrated in FIG. 2 is for illustration only, and the BSs 101 and 103 of FIG. 1 could have the same or similar configuration. However, BSs come in a wide variety of configurations, and FIG. 2 does not limit the scope of this disclosure to any particular implementation of a BS.

As shown in FIG. 2, the BS 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the BS 102. For example, the controller/processor 225 could control the reception of uplink (UL) channels or signals and the transmission of downlink (DL) channels or signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the BS 102 by the controller/processor 225.

The controller/processor 225 is also capable of executing programs and other processes resident in the memory 230, such as supporting resource configuration and association for UE-initiated beam reporting. The controller/processor 225 can move data into or out of the memory 230 as required by an executing process.

The controller/processor 225 is also coupled to the backhaul or network interface 235. The backhaul or network interface 235 allows the BS 102 to communicate with other devices or systems over a backhaul connection or over a network. The interface 235 could support communications over any suitable wired or wireless connection(s). For example, when the BS 102 is implemented as part of a cellular communication system (such as one supporting 6GR, 5G/NR, LTE, or LTE-A), the interface 235 could allow the BS 102 to communicate with other BSs over a wired or wireless backhaul connection. When the BS 102 is implemented as an access point, the interface 235 could allow the BS 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of BS 102, various changes may be made to FIG. 2. For example, the BS 102 could include any number of each component shown in FIG. 2. Also, various components in FIG. 2 could be combined, further subdivided, or omitted and additional components could be added according to particular needs.

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a BS of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channels or signals and the transmission of UL channels or signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes that utilize resource configuration and association for UE-initiated beam reporting as described in embodiments of the present disclosure. The processor 340 can move data into or out of the memory 360 as required by an executing process. In some embodiments, the processor 340 is configured to execute the applications 362 based on the OS 361 or in response to signals received from BSs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

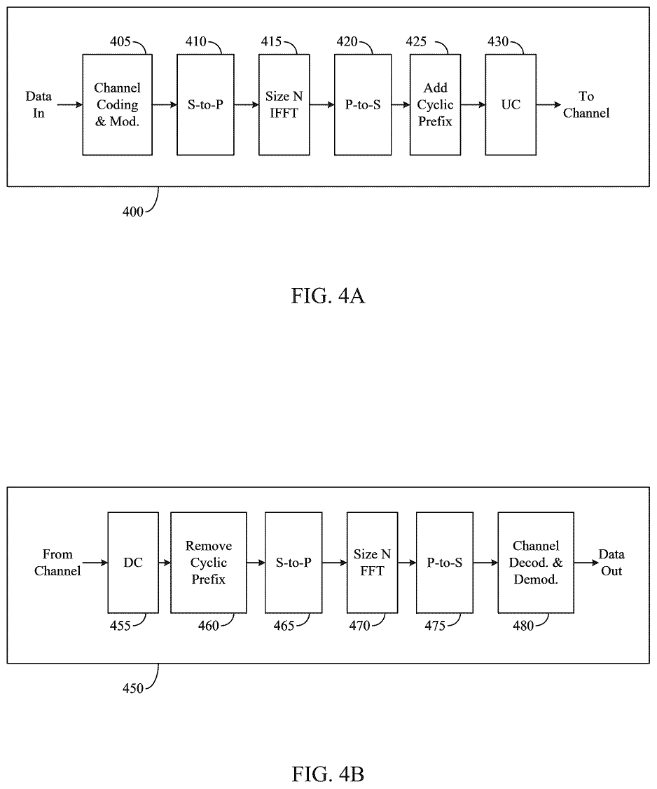

FIG. 4A and FIG. 4B illustrate an example of wireless transmit and receive paths 400 and 450, respectively, according to embodiments of the present disclosure. For example, a transmit path 400 may be described as being implemented in a BS (such as BS 102), while a receive path 450 may be described as being implemented in a UE (such as UE 116). However, it will be understood that the receive path 450 can be implemented in a BS and that the transmit path 400 can be implemented in a UE. In some embodiments, the transmit path 400 is configured to support resource configuration and association for UE-initiated beam reporting as described in embodiments of the present disclosure. In some embodiments, the receive path 450 is configured to support resource configuration and association for UE-initiated beam reporting as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the BS 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the BSs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to BSs 101-103 and may implement a receive path 450 for receiving in the downlink from BSs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

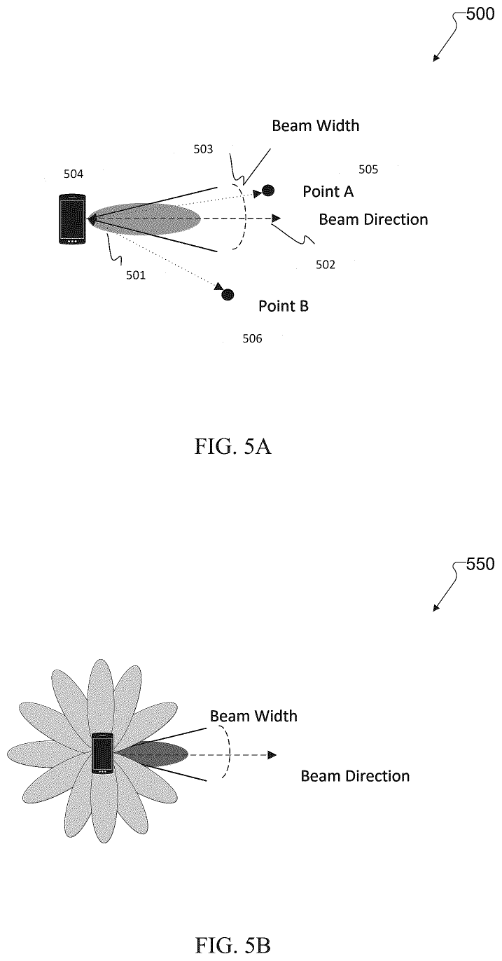

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by UE 116 of FIG. 3. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

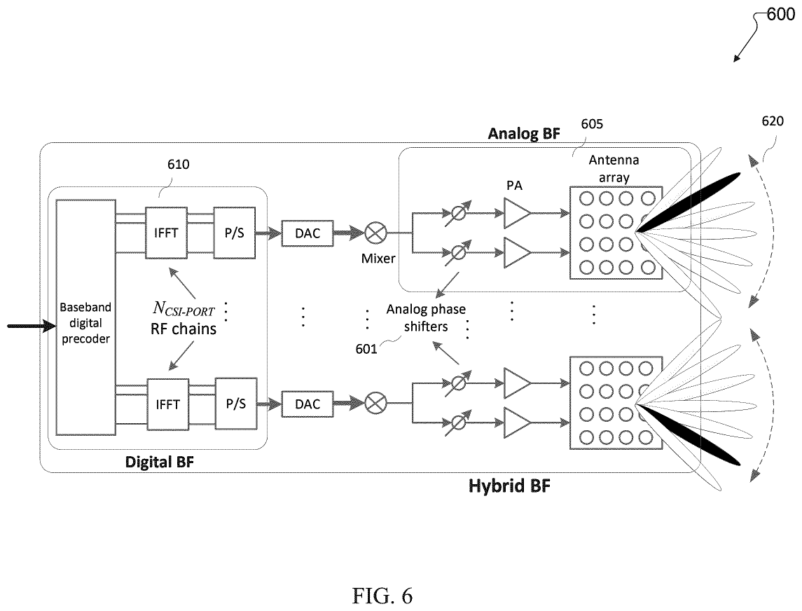

FIG. 6 illustrates an example of a transmitter structure 600 for beamforming according to embodiments of the present disclosure. In certain embodiments, one or more of BS 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 channel state information refence signal (CSI-RS) antenna ports which enable an eNB or a BS to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz. In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

In this disclosure, a beam is determined by either of;
A transmission configuration indication (TCI) state, that establishes a quasi-colocation (QCL) relationship between a source reference signal (e.g. synchronization signal block (SSB) and/or CSI-RS) and a target reference signal
A spatial relation information that establishes an association to a source reference signal, such as SSB or CSI-RS or sounding reference signal (SRS).

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

Embodiments of the present disclosure recognize that in (up to Rel.17) the NR specification, the most resource-efficient reporting mechanism for a content (e.g. beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB lacks knowledge on the DL channel condition—or, in other words, the UE knows the DL channel condition better. In this case, it is clearly beneficial if the UE can initiate its own aperiodic reporting for a content (e.g. beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from beam or CSI reports) and application scenarios.

Although UE-initiated/event-driven reporting can be beneficial, efficient designs are needed to ensure that the latency is reduced and, at the same time, error events can be minimized. Therefore, embodiments of the present disclosure recognize that there is a need for efficient designs for UE-initiated/event-driven reporting for a content that can offer good trade-off between latency and reliability, in particular, when the UE-initiated/event-driven beam management framework can include multiple report types (or report quantities), or/and multiple event types when a report type can be associated with an event (e.g, for beam report, the event can be beam failure, and for CSI, the event can be user throughput degradation or increasing retransmission rate).

The present disclosure provides various novel and detailed design examples on the UE-initiated/event-driven beam management framework including UE-initiated/event-driven beam reporting. To better support/enable the UE-initiated and the event-based beam operations, this disclosure presents example embodiments on means and/or procedures of transmitting the UE-initiated report(s) along with its indicator(s) via various uplink channels, and configuring and determining measurement RS resource(s) for the UE-initiated/event-driven beam operations. In addition, the present disclosure provides various resource allocation and association methods to enable the UE-initiated/event-driven beam reporting as well.

In the present disclosure, a UE detects (or determines) a need for transmitting a UE-initiated/UE-triggered report (or initiation/triggering) of a (report-)type (A), (B), or (C), where
(A) includes an initiator/trigger/pre-notification message
(B) includes a report/content (comprising one or multiple report quantities)
(C) includes both a trigger/pre-notification message and a (corresponding) report/content

The UE could send to the network (e.g., the network 130) the UE-initiated (UEI)/UE-triggered report of a (report-)type (A), (B) and/or (C) according to one or more of:
Fixed rule(s) in system specification(s): for example, the UE could send to the network a UEI report of a (report-)type (A), or a (report-)type (B), or a (report-)type (C), or a (report-)type (A) followed by a (report-)type (B).
Network's configuration(s)/indication(s), e.g., via higher layer RRC signaling(s)/parameter(s) and/or MAC CE command(s) and/or dynamic downlink control information (DCI) based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report of a (report-)type (A), ‘01’ indicating a UEI report of a (report-)type (B), ‘10’ indicating a UEI report of a (report-)type (C), and ‘11’ indicating a UEI report of a (report-)type (A) followed by a (report-)type (B).
UE's autonomous determination, which could be further sent to the network, e.g., via/in part of a beam/CSI report or UE's capability signaling(s).

The report is to facilitate/enable efficient/timely/fast/reliable communication over the link/channel between a target entity (e.g. NW/gNB (e.g., the network 130/the BS 102) or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ,Jᵢ)}, where Iᵢ is an beam (source RS) indicator (e.g. channel quality indicator (CQI) report interval (CRI), SSB resource indicator (SSBRI)) and Jᵢ is a beam metric (e.g. L1-reference signal received power (RSRP), L1-signal-to-interference-plus-noise ratio (SINR)).
In one example, the content includes CSI-related quantity/quantities. For example, at least one of: rank indicator (RI), precoding matrix indicator (PMI), channel quality indicator (CQI), CQI report interval (CRI), layer index (LI).
In one example, the content includes TDCP-related quantity/quantities. For example, an indicator about the Doppler profile (e.g. Doppler spread or Doppler shift, relative Doppler spreads, or relative Doppler shifts), or an indicator about the auto-correlation profiles (e.g. (auto-) correlation values corresponding to a few dominant lags/delays).
In one example, the content includes other (e.g. non-beam, non-CSI, non-TDCP) quantity/quantities.
   In one example, quantity/quantities comprises a selector/indicator indicating selection of one (or >1) of either
      beam (TCI state) TCI states (e.g. DL TCI state, UL TCI state, or unified (joint) DL/UL TCI state), or
      panel(s) (e.g. UE panels for DL reception or/and UL transmission), or
      antenna (e) (e.g. UE antennae for DL reception or/and UL transmission), or
      antenna port(s) (e.g. UE antenna ports for DL reception or/and UL transmission).
   In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g. this switching is for DL reception or/and UL transmission).
In one example, the content includes beam-related quantity/quantities (according to one or more examples described herein) and at least one other quantity/quantities (according to one or more examples described herein).
In one example, the content includes CSI-related quantity/quantities (according to one or more examples described herein) and at least one other quantity/quantities (according to one or more examples described herein).
In one example, the content includes TDCP-related quantity/quantities (according to one or more examples described herein) and at least one other quantity/quantities (according to one or more examples described herein).
In one example, the content includes beam-related quantity/quantities (according to one or more examples described herein) and CSI-related quantity/quantities (according to one or more examples described herein).
In one example, the content includes beam-related quantity/quantities (according to one or more examples described herein) and TDCP-related quantity/quantities (according to one or more examples described herein).
In one example, the content includes TDCP-related quantity/quantities (according to one or more examples described herein) and CSI-related quantity/quantities (according to one or more examples described herein).

In one example, the report is targeting a physical layer (L1) communication (e.g. L1 DL/UL, or LI SL), i.e, such reporting is to enable fast/reliable DL/UL or SL transmission/reception.

In one example, the link/channel between the target entity and the UE is a Uu interface (i.e. DL, UL).

In one example, the link/channel between the target entity and the UE is a sidelink (SL), or a device-to-device (D2D) or PC5 interface.

In one example, such reporting can be non-event-based or autonomous, the UE can initiate/trigger the report autonomously (i.e. without being associated with any event) or unconditionally/freely. For example, the UE can be configured with a triggering time window (or multiple UL slots), and the UE can trigger the report during this window.

In one example, such reporting can be event-based, i.e., the UE (e.g., the UE 116) can initiate/trigger the report only when it detects an event associated with the report, where the event can be of a (event-)type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g. beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 1 (for joint) and Table 2/Table 3 (for separate). In these examples, the event-types and the report-types are separate (explicit). However, they can also be joint, as shown in Table 4. A few examples of the autonomous UE-initiated report are shown in Table 5.

TABLE 1
event-based UE-initiated report

| | Report | | |
|---|---|---|---|
| Event type | Type | Trigger/pre-notification message | Content |
| 0: beam | (A) | Yes (e.g. beam-related event) | No |
| | (B) | No | Yes |
| | (C) | Yes (e.g. beam-related event) | Yes |
| 1: CSI | (A) | Yes (e.g. CSI-related event) | No |
| | (B) | No | Yes |
| | (C) | Yes (e.g. CSI-related event) | Yes |
| 2: TDCP | (A) | Yes (e.g. TDCP-related event) | No |
| | (B) | No | Yes |
| | (C) | Yes (e.g. TDCP-related event) | Yes |
| 3: non-CSI/beam/ | (A) | Yes (e.g. non-CSI-related event) | No |
| TDCP | (B) | No | Yes |
| | (C) | Yes (e.g. non-CSI-related event) | Yes |
| 4. other (content- | (A) | Yes (no need for content) | No |
| free/less events) | | | |

TABLE 2
event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 3
event-based UE-initiated report

| Report-type | Trigger/pre-notification message | Content |
|---|---|---|
| (A) | Yes | No |
| (B) | No | Yes |
| (C) | Yes | Yes |

TABLE 4
event-based UE-initiated report
Report

| Type | Trigger/pre-notification message | Content |
|---|---|---|
| 0 | Yes (e.g. beam-related event), content-specific or | No |
| | event-specific | |
| 1 | No | Beam |
| 2 | Yes (e.g. beam-related event) | Beam |
| 3 | Yes (e.g. CSI-related event) | No |
| 4 | No | CSI |
| 5 | Yes (e.g. CSI-related event) | CSI |
| 6 | Yes (e.g. TDCP-related event) | No |
| 7 | No | TDCP |
| 8 | Yes (e.g. TDCP-related event) | TDCP |
| 9 | Yes (e.g. non-CSI-related event) | No |
| 10 | No | Non-CSI |
| 11 | Yes (e.g. non-CSI-related event) | Non-CSI |

TABLE 5
non-event-based or autonomous UE-initiated report
Report

| Type | Trigger/pre-notification message | Content |
|---|---|---|
| 0 | Yes (content-agnostic/transparent) | No |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one example, when there is no content associated with a pre-notification (PN) message/trigger, i.e., the report-type is (A), the trigger/pre-notification message could simply provide a ‘hint/alarm/cue’ to the target entity (or purpose of the PN message/trigger as specified herein in the present disclosure) according to at least one of the following examples.
For example, the hint (or purpose of the PN message/trigger as specified herein in the present disclosure) is about the communication link/channel. For example, it can imply a need for a new or updated report (e.g. beam or CSI or TDCP). In this case, it is up to NW whether to configure a report for the content (separately).
For another example, the hint (or purpose of the PN message/trigger as specified herein in the present disclosure) is about an RS transmission. For example, it can imply a need for an aperiodic or semi-persistent RS (e.g. CSI-RS, SRS) transmission. The RS transmission can be from the target entity, or from the UE.
For another example, the hint (or purpose of the PN message/trigger as specified herein in the present disclosure) is about a selection/switch. For example, it can imply a need for switching from current A to another A, where A is one of current panel(s), TRP(s)/RRH(s), resource sets, antenna groups, antenna port groups.
For another example, the hint (or purpose of the PN message/trigger as specified herein in the present disclosure) is about beam/CSI parameters. For example, the parameter can be codebook type (e.g. from Type I to Type II or vice versa), or rank restriction (e.g. from high rank to low rank or vice versa).
For another example, the hint (or purpose of the PN message/trigger as specified herein in the present disclosure) is about RS parameters. For example, the parameter can be related to a AP RS trigger, or RS periodicity, or number of SRS ports (panel switch, 1 panel to 2 panel or vice versa) or number of RS resources.
For another example, the hint (or purpose of the PN message/trigger as specified herein in the present disclosure) is about transmission scheme, which can be one of PMI-based, diversity (CDD, cycling, SFBC), reciprocity (NCB, or non-PMI-feedback), or based on partial CSI (e.g. CRI-il or CRI-il-CQI or LI-CRI-il or LI-CRI-il-CQI), or based on single TRP to multi-TRP switch (or vice versa).
For another example, the hint (or purpose of the PN message/trigger as specified herein in the present disclosure) is about transmission parameters, e.g. MCS, or number of CWs.
For another example, when there is no pre-notification message/trigger associated with a content, i.e., the report-type is (B), the content can be transmitted using UL resource(s) configured (e.g. configured-grant physical uplink shared channel (PUSCH)), or reserved for the UE-initiated report, or via a RACH procedure.
For another example, the pre-notification (PN) message/trigger is to initiate or request or notify to the network (or the hint/purpose of the PN message/trigger as specified herein in the present disclosure is about) a transmission of a (beam) report/content—e.g., associated to the PN message/trigger, which could comprise one or more report quantities as specified/described herein in the present disclosure.

In the present disclosure, the UE could determine one or more purposes of the PN message/trigger and send the corresponding PN message(s)/trigger(s) to the network according to one or more of:
Fixed rule(s) in system specification(s): for example, the PN message is used to initiate or request or notify to the network (or the purpose of the PN message is about) a transmission of a (beam) report/content, which could comprise one or more indicators/triggers and/or report quantities as specified/described herein in the present disclosure.
Network's configuration(s)/indication(s), e.g., via higher layer RRC signaling(s)/parameter(s) and/or MAC CE command(s) and/or dynamic DCI based L1 signaling(s), based on/according to a corresponding UE's capability signaling: for example, the UE could receive from the network, e.g., via higher layer RRC signaling(s)/parameter(s) and/or MAC CE command(s) and/or dynamic DCI based L1 signaling(s), one or more indicators indicating one or more of the purposes of the PN message/trigger as specified herein in the present disclosure; for another example, the UE could be first higher layer RRC configured/provided by the network a list/set/pool of purposes of PN/trigger according to those specified herein in the present disclosure; the UE could then receive from the network a MAC CE/DCI to activate/indicate one or more purposes of the PN/trigger from the configured list/set/pool.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and/or the corresponding content(s) according to one or more of:
Fixed rule(s) in system specification(s): for example, the UE could send to the network a UEI report comprising only a PN message, or comprising only a content according to those specified herein in the present disclosure, or comprising both a PN message and a corresponding content.
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report comprising only a PN message, ‘01’ indicating a UEI report comprising only a content according to those specified herein in the present disclosure, ‘10’/‘11’ indicating a UEI report comprising both a PN message and a corresponding content.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-)type (A) or (report-)type (C) as specified herein in the present disclosure, and/or the (corresponding) content—e.g., of (report-)type (B) or (report-)type (C) as specified herein in the present disclosure, the UE could send to the network a pre-notification (PN) message/trigger and the content(s) a corresponding via/in same report/reporting instance/transmission/transmission occasion (e.g., via/in a same set of uplink resources including physical uplink control channel(s) (PUCCH(s)), PUSCH(s), MAC CE(s), PRACH(s) and etc.) or different reports/reporting instances/transmissions/transmission occasions (e.g., via/in different sets of uplink resources including PUCCH(s), PUSCH(s), MAC CE(s), PRACH(s) and etc.) according to one or more of:
Fixed rule(s) in system specification(s): for example, the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), or the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a one-bit indicator with ‘0’ (or ‘1’) indicating that the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), and ‘1’ (or ‘0’) indicating that the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
UE's autonomous determination, which could be further sent to the network, e.g., via/in part of a beam/CSI report or UE's capability signaling(s).

The indicator(s)/trigger(s) described herein in the present disclosure could correspond to (or could be in part of) the trigger/pre-notification (PN) message in a (report-)type (A) based report or a (report-)type (C) based report, or could correspond to (or could be in part of) the (corresponding) content in a (report-)type (B) based report or a (report-)type (C) based report. Furthermore, the signaling medium/container for reporting a UE-initiated (UEI) report comprising at least the indicator(s)/trigger(s) or the report quantities or the pre-notification message/trigger or the corresponding content(s) as specified herein in the present disclosure (or equivalently, the trigger/pre-notification message in a (report-)type (A) based report or a (report-)type (C) based report, or part of the (corresponding) content in a (report-)type (B) based report or a (report-)type (C) based report) could be PUCCH, PUSCH, PRACH, MAC CE, uplink control information (UCI) and etc.

As specified in Rel-17, a unified TCI framework could indicate/include N≥1 DL TCI states and/or M≥1 UL TCI states, wherein the indicated TCI state could be at least one of:
PA DEL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a physical downlink control channel (PDCCH) or a physical downlink shared channel (PDSCH). As described in the 3GPP Rel-17,
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH
   For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and dedicated PUCCH resources.

A UE could receive from the network a first (unified) TCI state(s) activation MAC CE command, used to map up to 8 TCI states and/or pairs of TCI states, with each pair comprising of one TCI state for DL channels/signals and/or one TCI state for UL channels/signals, to the codepoints of the DCI field ‘Transmission Configuration Indication’ for one or for a set of CCs/DL BWPs, and/or a second (unified) TCI state(s) activation MAC CE command, used to map up to 8 sets of TCI states, wherein each set could be comprised of up to two (e.g., none, one or two) TCI states for DL and UL signals/channels, and/or up to two (e.g., none, one or two) TCI state(s) for DL channels/signals and/or up to two (e.g., none, one or two) TCI state(s) for UL channels/signals to the codepoints of the DCI field “Transmission Configuration Indication” for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for all DL and/or UL BWPs in the indicated CCs. If the first/second MAC CE activation command maps TCI-State(s) and/or TCI-UL-State(s) to only one TCI codepoint, the UE shall apply the indicated TCI-State(s) and/or TCI-UL-State(s) to one or to a set of CCs/DL BWPs, and if applicable, to one or to a set of CCs/UL BWPs once the indicated mapping for the one single TCI codepoint is applied. That is, e.g., when/if the UE is provided/configured with dl-OrJointTCI-StateList and/or ul-TCI-StateList and/or is having one or two indicated TCI states and/or is having first and/or second indicated TCI states, an activated TCI codepoint in the second MAC CE activation command could be composed/comprised of one of:
Case 1: a first TCI state for DL channel(s)/signal(s)
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 5: a first TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 9: a pair of a first TCI state for DL channel(s)/signal(s) and a first TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 16: a first TCI state for DL channel(s)/signal(s) and UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

Furthermore, when/if the UE is configured by higher layer parameter PDCCH-Config that contains two values of coresetPoolIndex (e.g., 0 and 1) in ControlResourceSet, the first/second (unified) TCI state(s) activation command specified in the present as herein disclosure could also incorporate/provide/indicate/include/contain a value of coresetPoolIndex (e.g., 0 or 1). For this case, the TCI state(s)/TCI codepoint(s) activated by/in the first/second (unified) TCI state(s) activation command could be specific to the same coresetPoolIndex value (i.e., 0 or 1) provided/indicated therein.

In one example, when/if the UE is not provided/configured with two values of coresetPoolIndex (e.g., 0 and 1) in PDCCH-Config and/or ControlResourceSet, and/or when/if the UE is provided/configured by higher layer parameter PDCCH-Config that contains a single value of coresetPoolIndex (e.g., 0) in ControlResourceSet, the UE may or may not expect, or may or may not be expected to receive a third (unified) TCI state(s) activation MAC CE command, wherein all of the TCI codepoint(s) activated by/in the third (unified) TCI state(s) activation MAC CE command could be comprised of or mapped to or could correspond to one of:
Case 19: first TCI state(s) for DL channels/signals, and/or first TCI state(s) for UL channels/signals, and/or pair(s) of TCI states with each pair comprising of a first TCI state for DL channels/signals and a first TCI state for UL channels/signals
Case 20: second TCI state(s) for DL channels/signals, and/or second TCI state(s) for UL channels/signals, and/or pair(s) of TCI states with each pair comprising of a second TCI state for DL channels/signals and a second TCI state for UL channels/signals
Case 21: first TCI state(s) for both DL and UL channels/signals
Case 22: second TCI state(s) for both DL and UL channels/signals

That is, all of the TCI codepoint(s) activated by/in a third (unified) TCI state(s) activation command could be comprised of or mapped to either first joint/DL/UL TCI state(s)/pair(s) of first DL and UL TCI states or second joint/DL/UL TCI state(s)/pair(s) of second DL and UL TCI states.

In another example, when/if the UE is not provided/configured with two values of coresetPoolIndex (e.g., 0 and 1) in PDCCH-Config and/or ControlResourceSet, and/or when/if the UE is provided/configured by higher layer parameter PDCCH-Config that contains a single value of coresetPoolIndex (e.g., 0) in ControlResourceSet, the UE may or may not expect, or may or may not be expected to receive a fourth (unified) TCI state(s) activation MAC CE command as specified herein in the present disclosure with (1) at least one TCI codepoint activated therein composing/comprising of a first TCI state for DL and/or UL channel(s)/signal(s) or a pair of a first TCI state for DL channel(s)/signal(s) and a first TCI state for UL channel(s)/signal(s), and a second TCI state for DL and/or UL channel(s)/signal(s) or a pair of a second TCI state for DL channel(s)/signal(s) and a second TCI state for UL channel(s)/signal(s), and/or (2) at least one TCI codepoint activated therein composing/comprising of at least first TCI state(s) as specified herein in the present disclosure and another TCI codepoint activated therein composing/comprising of at least second TCI state(s) as specified herein in the present disclosure. That is, for this case/design example, the UE may or may not expect, or may or may not be expected to receive a fourth (unified) TCI state(s) activation MAC CE command as specified herein in the present disclosure with (1) at least one TCI codepoint activated therein composing/comprising of one of:
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s),
   and/or (2) at least one TCI codepoint activated therein composing/comprising of one of:
Case 1: a first TCI state for DL channel(s)/signal(s)
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 5: a first TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 9: a pair of a first TCI state for DL channel(s)/signal(s) and a first TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 16: a first TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s),
   and another TCI codepoint activated therein composing/comprising of one of:
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

In a (single-DCI based) multi-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a set of one or more (e.g., N>1) TCI states/pairs of TCI states, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

For PDCCH reception or PDCCH candidate monitoring in a (single-DCI based) multi-TRP system, a UE could be configured/provided/indicated by the network via higher layer RRC signaling/parameter and/or MAC CE command and/or dynamic DCI based LI signaling—e.g., in higher layer RRC signaling/parameter ControlResourceSet that configures a CORESET-a first indicator to indicate which one or more of the set of TCI states/pairs of TCI states indicated, e.g., by a TCI codepoint, in a beam indication DCI or MAC CE as specified herein in the present disclosure, to use/apply for receiving/monitoring the PDCCH(s)/PDCCH candidate(s) in the corresponding CORESET. For instance, for N=2 (i.e., a set of two TCI states/pairs of TCI states are indicated), the first indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving/monitoring the PDCCH(s)/PDCCH candidate(s)—e.g., first and second PDCCH candidates—in the corresponding CORESET(s), and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for receiving/monitoring the PDCCH(s)/PDCCH candidate(s)—e.g., first and second PDCCH candidates—in the corresponding CORESET(s), wherein the first and second PDCCH candidates could be received in search space sets that are higher layer linked via SearchSpaceLinking and/or the first and second PDCCH candidates carry the same/identical DCI payload. Furthermore, throughout the present disclosure, the first TCI state(s) or the second TCI state(s)—specified herein in the present disclosure-could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the first indicator could also be referred to as or could correspond to a higher layer parameter applyIndicatedTCIState configured/provided in PDCCH-Config/ControlResourceSet, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PDCCH reception(s).

For PDSCH reception in a (single-DCI based) multi-TRP system, a UE could be configured/provided/indicated by the network via higher layer RRC signaling/parameter and/or MAC CE command and/or dynamic DCI based L1 signaling—e.g., in a DL DCI (e.g., DCI format 1_0/1_1/1_2) that schedules the PDSCH-a second indicator to indicate which one or more of the set of TCI states/pairs of TCI states indicated, e.g., by a TCI codepoint, in a beam indication DCI or MAC CE as specified herein in the present disclosure, to use/apply for receiving the PDSCH(s). For instance, for N=2 (i.e., a set of two TCI states/pairs of TCI states are indicated), the second indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, wherein the first and second PDSCHs could correspond to two PDSCH transmission occasions or repetition in space, time and/or frequency.

Furthermore, throughout the present disclosure, the first TCI state(s) or the second TCI state(s)—specified herein in the present disclosure-could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the second indicator could also be referred to as or could correspond to a DCI indicator ‘TCI selection’ field in DCI format 1_1/1_2 (present when a higher layer parameter tciSelectionPresentInDCI is configured/present and/or set to ‘enabled’), which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PDSCH reception(s)

That is, for PDSCH reception in a (single-DCI based) multi-TRP system, when a UE is configured with dl-OrJointTCI-StateList and is having two indicated TCI-states, if the UE does not report its capability indicating support of “two default beams for S-DCI based MTRP” in frequency range 2 and when the offset between the reception of the scheduling/activation DCI format 1_0/1_1/1_2 and the scheduled or activated PDSCH reception is less than timeDurationForQCL in frequency range 2, the UE shall apply the first indicated TCI-State to the scheduled or activated PDSCH reception. When a UE is configured with dl-OrJointTCI-StateList and is having two indicated TCI-states:
Regardless of the offset between the reception of the scheduling DCI format 1_0/1_1/1_2 and the scheduled/activated PDSCH reception, if the UE is in frequency range 1, or the UE reports its capability indicating support of “two default beams for S-DCI based MTRP” in frequency range 2, or
If the UE does not report its capability indicating support of “two default beams for S-DCI based MTRP” in frequency range 2 and if the scheduling offset between the reception of the scheduling DCI format 1_0/1_1/1_2 and the scheduled/activated PDSCH reception is equal to or larger than time DurationForQCL
The UE can be configured by higher layer parameter applyIndicatedTCIState to indicate whether the first, the second, or both of the indicated TCI-state(s) is/are applied to PDSCH reception scheduled or activated by DCI format 1_0. The UE can be configured with applyIndicatedTCIState with value both only when the UE is configured with cjtSchemePDSCH and the UE reports its capability indicating support of two joint TCI states for PDSCH-CJT or the UE is configured with sfnSchemePdsch. In that case, the UE shall apply both indicated TCI-states to PDSCH reception scheduled or activated by DCI format 1_0 on a search space other than Type0/0A/2 CSS on CORESET #0.
If the UE is not configured with applyIndicatedTCIState, the first indicated TCI-state is applied to PDSCH reception scheduled or activated by DCI format 1_0.
When the UE is configured with tciSelection-PresentInDCI jointly for both DCI formats 1_1 and 1_2 in the same DL BWP, and when the UE receives a DCI format 1_1/1_2 that schedules or activates PDSCH reception, the UE shall determine the indicated joint/DL TCI state(s) for the PDSCH reception according to the following:
If the DCI format 1_1/1_2 indicates codepoint “00” for the TCI selection field (or equivalently, the second indicator as specified herein in the present disclosure), the UE shall apply the first one of two indicated joint/DL TCI states to all PDSCH DM-RS port(s) of corresponding PDSCH transmission occasions(s) scheduled or activated by the DCI format 1_1/1_2.
If the DCI format 1_1/1_2 indicates codepoint “01” for the TCI selection field (or equivalently, the second indicator as specified herein in the present disclosure), the UE shall apply the second one of two indicated joint/DL TCI states to all PDSCH DM-RS port(s) of corresponding PDSCH transmission occasion(s) scheduled or activated by the DCI format 1_1/1_2.
If the DCI format 1_1/1_2 indicates codepoint “10” for the TCI selection field (or equivalently, the second indicator as specified herein in the present disclosure), the UE shall apply both indicated joint/DL TCI states to the PDSCH reception scheduled or activated by the DCI format 1_1/1_2.
If the UE is not configured with tciSelection-PresentInDCI and when the UE receives a DCI format 1_1/1_2 that schedules/activates PDSCH reception, the UE shall apply both indicated TCI-States to the scheduled or activated PDSCH reception.

For PUCCH transmission in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter PUCCH-Config that configures PUCCH(s)/PUCCH resource(s)—a third indicator to indicate which one or more of the set of TCI states/pairs of TCI states indicated, e.g., by a TCI codepoint, in a beam indication DCI or MAC CE as specified herein in the present disclosure, to use/apply for transmitting the PUCCH(s)/PUCCH resource(s). For instance, for N=2 (i.e., a set of two TCI states/pairs of TCI states are indicated), the third indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the PUCCH(s)/PUCCH resource(s)—e.g., first PUCCH/PUCCH resource and second PUCCH/PUCCH resource, and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for transmitting the PUCCH(s)/PUCCH resource(s)—e.g., first PUCCH/PUCCH resource and second PUCCH/PUCCH resource, wherein the first and second PUCCHs/PUCCH resources could correspond to two PUCCH transmission occasions or repetitions in space, time and/or frequency.

Furthermore, throughout the present disclosure, the first TCI state(s) or the second TCI state(s)—specified herein in the present disclosure-could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the third indicator could also be referred to as or could correspond to a higher layer parameter applyIndicatedTCIState configured/provided in higher layer parameter(s) that configures/provides a PUCCH resource/resource group, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PUCCH transmission(s).

For PUSCH transmission in a (single-DCI based) multi-TRP system, a UE could be configured/provided/indicated by the network via higher layer RRC signaling/parameter and/or MAC CE command and/or dynamic DCI based L1 signaling—e.g., in an UL DCI (e.g., DCI format 0_0/0_1/0_2) that schedules the PUSCH-a fourth indicator to indicate which one or more of the set of TCI states/pairs of TCI states indicated, e.g., by a TCI codepoint, in a beam indication DCI or MAC CE as specified herein in the present disclosure, to use/apply for transmitting the PUSCH(s). For instance, for N=2 (i.e., a set of two TCI states/pairs of TCI states are indicated), the fourth indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, wherein the first and second PUSCHs could correspond to two PUSCH transmission occasions or repetition in space, time and/or frequency. \

Furthermore, throughout the present disclosure, the first TCI state(s) or the second TCI state(s)—specified herein in the present disclosure-could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the fourth indicator could also be referred to as or could correspond to a DCI indicator ‘SRS resource set’ field in DCI format 0_1/0_2, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PUSCH transmission(s).

In a (multi-DCI based) multi-TRP system, a UE could be indicated/provided/configured by the network, e.g., in PDCCH-Config, two values (i.e., 0 and 1) of CORESET pool index (denoted by CORESETPoolIndex), wherein each CORESET could be configured with a value of CORESETPoolIndex. Furthermore, a UE could be indicated/provided/configured by the network, e.g., via a beam indication MAC CE or a DCI (e.g., via one or more TCI codepoints of one or more TCI fields in the corresponding DCI format 1_1/1_2 with or without DL assignment) associated to a CORESET pool index value (e.g., 0 or 1), one or more TCI states/pairs of TCI states for the same (or different) CORESET pool index value, wherein a TCI state could be a joint DL and UL TCI state or a separate DL TCI state provided by TCI-State/DLorJointTCI-State or a separate UL TCI state provided by TCI-State/UL-TCIState indicated for channels/signals such as PDCCH, PDSCH, PUCCH and PUSCH associated to the same (or different) CORESET pool index value, and a pair of TCI states could include/contain a separate DL TCI state provided by TCI-State/DLorJointTCI-State or a separate UL TCI State provided by TCI-State/UL-TCIState indicated for channels/signals such as PDCCH, PDSCH, PUCCH and PUSCH associated to the same (or different) CORESET pool index value, under the unified TCI framework.

Throughout the present disclosure, setting a first indicator for PDCCH reception(s) as specified herein in the present disclosure as ‘00’ is equivalent to setting the first indicator for PDCCH reception(s) as specified herein in the present disclosure as ‘first’, and/or setting a first indicator for PDCCH reception(s) as specified herein in the present disclosure as ‘01’ is equivalent to setting the first indicator for PDCCH reception(s) as specified herein in the present disclosure as ‘second’, and/or setting a first indicator for PDCCH reception(s) as specified herein in the present disclosure as ‘10’ (or ‘11’) is equivalent to setting the first indicator for PDCCH reception(s) as specified herein in the present disclosure as ‘both’, and/or setting a first indicator for PDCCH reception(s) as specified herein in the present disclosure as ‘11’ (or ‘10’) is equivalent to setting the first indicator for PDCCH reception(s) as specified herein in the present disclosure as ‘none’.

Throughout the present disclosure, setting a second indicator for PDSCH reception(s) as specified herein in the present disclosure as ‘00’ is equivalent to setting the second indicator for PDSCH reception(s) as specified herein in the present disclosure as ‘first’, and/or setting a second indicator for PDSCH reception(s) as specified herein in the present disclosure as ‘01’ is equivalent to setting the second indicator for PDSCH reception(s) as specified herein in the present disclosure as ‘second’, and/or setting a second indicator for PDSCH reception(s) as specified herein in the present disclosure as ‘10’ (or ‘11’) is equivalent to setting the second indicator for PDSCH reception(s) as specified herein in the present disclosure as ‘both’, and/or setting a second indicator for PDSCH reception(s) as specified herein in the present disclosure as ‘11’ (or ‘10’) is equivalent to setting the second indicator for PDSCH reception(s) as specified herein in the present disclosure as ‘none’.

Throughout the present disclosure, setting a third indicator for PUCCH transmission(s) as specified herein in the present disclosure as ‘00’ is equivalent to setting the third indicator for PUCCH transmission(s) as specified herein in the present disclosure as ‘first’, and/or setting a third indicator for PUCCH transmission(s) as specified herein in the present disclosure as ‘01’ is equivalent to setting the third indicator for PUCCH transmission(s) as specified herein in the present disclosure as ‘second’, and/or setting a third indicator for PUCCH transmission(s) as specified herein in the present disclosure as ‘10’ (or ‘11’) is equivalent to setting the third indicator for PUCCH transmission(s) as specified herein in the present disclosure as ‘both’, and/or setting a third indicator for PUCCH transmission(s) as specified herein in the present disclosure as ‘11’ (or ‘10’) is equivalent to setting the third indicator for PUCCH transmission(s) as specified herein in the present disclosure as ‘none’.

Throughout the present disclosure, setting a fourth indicator for PUSCH transmission(s) as specified herein in the present disclosure as ‘00’ is equivalent to setting the fourth indicator for PUSCH transmission(s) as specified herein in the present disclosure as ‘first’, and/or setting a fourth indicator for PUSCH transmission(s) as specified herein in the present disclosure as ‘01’ is equivalent to setting the fourth indicator for PUSCH transmission(s) as specified herein in the present disclosure as ‘second’, and/or setting a fourth indicator for PUSCH transmission(s) as specified herein in the present disclosure as ‘10’ (or ‘11’) is equivalent to setting the fourth indicator for PUSCH transmission(s) as specified herein in the present disclosure as ‘both’, and/or setting a fourth indicator for PUSCH transmission(s) as specified herein in the present disclosure as ‘11’ (or ‘10’) is equivalent to setting the fourth indicator for PUSCH transmission(s) as specified herein in the present disclosure as ‘none’.

The RS(s) or RS resource(s) or RS resource index(es) of/for a current serving beam-denoted by current serving beam RS(s) or RS resource(s) or RS resource index(es)—could be identified or determined according to or based on one or more network's responses (NWRs), if applicable (i.e., the current serving beam RS(s) or RS resource(s) or RS resource index(es) could be associated or corresponding or linked or mapped to the NWR(s) if applicable) according to one or more of:
(implicit determination example-1): One or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS. For this design example, the indicated TCI state could be regarded/referred to as a NWR.
(implicit determination example-2): One or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s). For this design example, the indicated TCI state could be regarded/referred to as a NWR.
(explicit configuration example-1): a set s̅₀ of (periodic) CSI-RS resource configuration indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the present disclosure. The serving beam(s) set 5% of (periodic) CSI-RS resource configuration indexes could be provided in higher layer parameter(s) CSI-ReportConfig, CSI-ResourceConfig, nzp-CSI-RS-ResourceSet and/or higher layer parameter(s) UEI-ReportConfig, UEI-ResourceConfig and/or etc. dedicated/configured for the UEI reporting as specified herein in the present disclosure. For this design example, the set s̅₀ provided by currentServBeamRSList could be regarded/referred to as a NWR.
(explicit configuration example-2): a set s̅₀ of SS/PBCH block indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the present disclosure. The serving beam(s) set so of SS/PBCH block indexes could be provided in higher layer parameter(s) CSI-ReportConfig, CSI-ResourceConfig, CSI-SSB-ResourceSet, and/or higher layer parameter(s) UEI-ReportConfig, UEI-ResourceConfig and/or etc. dedicated/configured for the UEI reporting as specified herein in the present disclosure. For this design example, the set s̅₀ provided by currentServBeamRSList could be regarded/referred to as a NWR.

In one example, when/if the one or more RSs/RS resources/RS resource indexes provided in/by the indicated TCI state (e.g., of QCL-TypeD) correspond to CSI-RS(s) for beam management (e.g., CSI-RS(s) configured with repetition or with repetition set to ‘on’), the UE could follow those specified in the implicit determination example-1 in the present disclosure to determine or identify the current serving beam RS(s)/RS resource(s)/RS resource index(es). In another example, when/if the one or more RSs/RS resources/RS resource indexes provided in/by the indicated TCI state (e.g., of QCL-TypeD) correspond to CSI-RS(s) for tracking or tracking reference signal(s)—e.g., CSI-RS(s) configured with trs-Info, the UE may not follow those specified in the implicit determination example-1 in the present disclosure to determine or identify the current serving beam RS(s)/RS resource(s)/RS resource index(es), but instead, the UE could expect to be provided or configured or indicated by the network a/the set s̅₀ of (periodic) CSI-RS resource configuration indexes by currentServBeamRSList (e.g., via higher layer RRC signalling(s)/parameter(s) and/or MAC CE command(s) and/or dynamic DCI based LI signaling(s)) for monitoring/assessing the radio link and/or beam qualities for the current serving beam(s) according to those specified herein in the explicit configuration example-1 in the present disclosure. Furthermore, the UE could assess or evaluate the radio link/beam quality(s), e.g., by measuring L1-RSRP(s)/L1-SINR(s), of a current serving beam based on or according to one or more of:
The UE could assess or evaluate the radio link/beam quality(s), e.g., by measuring L1-RSRP(s)/LI-SINR(s), of all the RS(s) or RS resource(s) or RS resource index(es) determined (e.g., following those specified/described in the implicit determination example-1 and/or the implicit determination example-2 in the present disclosure) and/or configured (e.g., following those specified/described in the explicit configuration example-1 and/or the explicit configuration example-2 in the present disclosure) for the current serving beam(s) in the UEI/event-driven beam reporting.
The UE could assess or evaluate the radio link/beam quality(s), e.g., by measuring L1-RSRP(s)/LI-SINR(s), of one or more of the RS(s) or RS resource(s) or RS resource index(es) determined (e.g., following those specified/described in the implicit determination example-1 and/or the implicit determination example-2 in the present disclosure) and/or configured (e.g., following those specified/described in the explicit configuration example-1 and/or the explicit configuration example-2 in the present disclosure) for the current serving beam(s) in the UEI/event-driven beam reporting according to (or that has the same RS(s) or RS resource(s) or RS resource index(es) as to)
   one or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
   one or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

Candidate RS(s) or RS resource(s) or RS resource index(es)—denoted by candidate candidate/new beam RS(s) or RS resource(s) or RS resource index(es)—for determining the RS(s) or RS resource(s) or RS resource index(es) for actual measurement of/for a candidate/new beam—denoted by actual candidate/new beam RS(s) or RS resource(s) or RS resource index(es)—could be identified or determined according to or based on one or more NWRs, if applicable (i.e., the (candidate/actual) candidate/new beam RS(s) or RS resource(s) or RS resource index(es) could be associated or corresponding or linked or mapped to the NWR(s) if applicable) according to one or more of:
(explicit configuration example-A): a set s̅₁ of (periodic) CSI-RS resource configuration indexes by Candidate BeamRSList (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the present disclosure. The candidate/new beam(s) set s̅₁ of (periodic) CSI-RS resource configuration indexes could be provided in higher layer parameter(s) CSI-ReportConfig, CSI-ResourceConfig, nzp-CSI-RS-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure. For this design example, the set s̅₁ provided by Candidate BeamRSList could be regarded/referred to as a NWR.
(explicit configuration example-B): a set s̅₁ of SS/PBCH block indexes by CandidateBeamRSList (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the present disclosure. The candidate/new beam(s) set s̅₁ of SS/PBCH block indexes could be provided in higher layer parameter(s) CSI-ReportConfig, CSI-ResourceConfig, CSI-SSB-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure. For this design example, the set s̅₁ provided by CandidateBeamRSList could be regarded/referred to as a NWR.
(implicit determination example-A): One or more RSs or RS resources or RS resource indexes provided in/by one or more TCI states activated by/in a TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS. For this design example, the one or more activated TCI states could be regarded/referred to as NWR(s).
(implicit determination example-B): One or more first RSs or RS resources or RS resource indexes quasi-co-located (QCL'ed) with, e.g., of QCL-TypeD, one or more second RSs or RS resources or RS resource indexes provided in/by one or more TCI states activated by/in the TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State; in this case, the one or more first RSs or RS resources or RS resource indexes could be or could serve as the QCL root/source RS(s) for the second RS(s)/RS resource(s)/RS resource index(es) provided in/by one or more of the activated joint/DL TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s). For this design example, the one or more activated TCI states could be regarded/referred to as NWR(s).
(implicit determination example-C): One or more RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS. For this design example, the one or more configured/provided TCI states could be regarded/referred to as NWR(s).
(implicit determination example-D): One or more first RSs or RS resources or RS resource indexes quasi-co-located (QCL'ed) with, e.g., of QCL-TypeD, one or more second RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by one or more of the joint/DL TCI state(s) in the list of TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s). For this design example, the one or more configured/provided TCI states could be regarded/referred to as NWR(s).

In one example, when/if the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for beam management (e.g., CSI-RS(s) configured with repetition or with repetition set to ‘on’), the UE could follow those specified in the implicit determination example-A/C in the present disclosure to determine or identify the candidate/actual candidate/new beam RS(s)/RS resource(s)/RS resource index(es). In another example, when/if the one or more RSs/RS resources/RS resource indexes provided in/by one or more TCI states (e.g., of QCL-TypeD) activated by/in a TCI state(s) activation/deactivation MAC CE command and/or one or more TCI states (e.g., of QCL-TypeD) provided/configured in a higher layer RRC configured list of TCI state(s) correspond to CSI-RS(s) for tracking or tracking reference signal(s)—e.g., CSI-RS(s) configured with trs-Info, the UE may not follow those specified in the implicit determination example-A/C in the present disclosure to determine or identify the candidate/actual candidate/new beam RS(s)/RS resource(s)/RS resource index(es), but instead, the UE could expect to be provided or configured or indicated by the network a/the set s̅₁ of (periodic) CSI-RS resource configuration indexes by CandidateBeamRSList (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the explicit configuration example-A in the present disclosure.

When/if an activated TCI state is a joint/DL TCI state, a UE could determine or identify RS(s) or RS resource(s) or RS resource index(es) of/for the activated TCI state—denoted by activation beam RS(s) or RS resource(s) or RS resource index(es)—could be identified or determined according to or based on one or more NWRs, if applicable (i.e., the activation beam RS(s) or RS resource(s) or RS resource index(es) could be associated or corresponding or linked or mapped to the NWR(s) if applicable) according to one or more of:
(implicit determination example-i): One or more RSs or RS resources or RS resource indexes provided in/by the activated TCI state, wherein the activated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS. For this design example, the activated TCI state could be regarded/referred to as a NWR.
(implicit determination example-ii): One or more first RSs or RS resources or RS resource indexes quasi-co-located (QCL'ed) with second RS(s)/RS resource(s)/RS resource index(es) provided in/by the activated TCI state, e.g., of QCL-TypeD, wherein the activated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by the activated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s). For this design example, the activated TCI state could be regarded/referred to as a NWR.
(explicit configuration example-i): a set s̅₂ of (periodic) CSI-RS resource configuration indexes by activationBeamRSList (e.g., via higher layer RRC signalling(s)/parameter(s) and/or MAC CE command(s) and/or dynamic DCI based L1 signaling(s)) for monitoring/assessing the radio link and/or beam qualities for the activation beam(s) according to those specified herein in the present disclosure. The activation beam(s) set s̅₂ of (periodic) CSI-RS resource configuration indexes could be provided in higher layer parameter(s) CSI-ReportConfig, CSI-ResourceConfig, nzp-CSI-RS-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure. For this design example, the set s̅₂ provided by activationBeamRSList could be regarded/referred to as a NWR.
(explicit configuration example-ii): a set s̅₂ of SS/PBCH block indexes by activationBeamRSList (e.g., via higher layer RRC signalling(s)/parameter(s) and/or MAC CE command(s) and/or dynamic DCI based L1 signaling(s)) for monitoring/assessing the radio link and/or beam qualities for the activation beam(s) according to those specified herein in the present disclosure. The activation beam(s) set s̅₂ of SS/PBCH block indexes could be provided in higher layer parameter(s) CSI-ReportConfig, CSI-ResourceConfig, CSI-SSB-ResourceSet associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure. For this design example, the set s̅₂ provided by activationBeamRSList could be regarded/referred to as a NWR.

In one example, when/if the one or more RSs/RS resources/RS resource indexes provided in/by the activated TCI state (e.g., of QCL-TypeD) correspond to CSI-RS(s) for beam management (e.g., CSI-RS(s) configured with repetition or with repetition set to ‘on’), the UE could follow those specified in the implicit determination example-i in the present disclosure to determine or identify the activation beam RS(s)/RS resource(s)/RS resource index(es). In another example, when/if the one or more RSs/RS resources/RS resource indexes provided in/by the activated TCI state (e.g., of QCL-TypeD) correspond to CSI-RS(s) for tracking or tracking reference signal(s)—e.g., CSI-RS(s) configured with trs-Info, the UE may not follow those specified in the implicit determination example-i in the present disclosure to determine or identify the activation beam RS(s)/RS resource(s)/RS resource index(es), but instead, the UE could expect to be provided or configured or indicated by the network a/the set s̅₂ of (periodic) CSI-RS resource configuration indexes by activationBeamRSList (e.g., via higher layer RRC signalling(s)/parameter(s) and/or MAC CE command(s) and/or dynamic DCI based L1 signaling(s)) for monitoring/assessing the radio link and/or beam qualities for the activation beam(s) according to those specified herein in the explicit configuration example-i in the present disclosure. Furthermore, the UE could assess or evaluate the radio link/beam quality(s), e.g., by measuring LI-RSRP(s)/L1-SINR(s), of an activation beam/TCI state based on or according to one or more of:
The UE could assess or evaluate the radio link/beam quality(s), e.g., by measuring L1-RSRP(s)/L1-SINR(s), of all the RS(s) or RS resource(s) or RS resource index(es) determined (e.g., following those specified/described in the implicit determination example-i and/or the implicit determination example-ii in the present disclosure) and/or configured (e.g., following those specified/described in the explicit configuration example-i and/or the explicit configuration example-ii in the present disclosure) for the activation beam(s) in the UEI/event-driven beam reporting.
The UE could assess or evaluate the radio link/beam quality(s), e.g., by measuring L1-RSRP(s)/L1-SINR(s), of one or more of the RS(s) or RS resource(s) or RS resource index(es) determined (e.g., following those specified/described in the implicit determination example-i and/or the implicit determination example-ii in the present disclosure) and/or configured (e.g., following those specified/described in the explicit configuration example-i and/or the explicit configuration example-ii in the present disclosure) for the activation beam(s) in the UEI/event-driven beam reporting according to (or that has the same RS(s) or RS resource(s) or RS resource index(es) as to)
   one or more RSs or RS resources or RS resource indexes provided in/by an activated TCI state, wherein the activated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
   one or more first RSs or RS resources or RS resource indexes quasi-co-located (QCL'ed) with second RS(s)/RS resource(s)/RS resource index(es) provided in/by an activated TCI state, e.g., of QCL-TypeD, wherein the activated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an activated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

Throughout the present disclosure, a CSI-RS or a CSI-RS resource or a CSI-RS resource configuration could correspond to or could be referred to as a CSI-RS for beam management (e.g., a CSI-RS configured with repetition or with repetition set to ‘on’), a CSI-RS for tracking or tracking reference signal (TRS)—e.g., a CSI-RS configured with trs-Info, a CSI-RS configured without repetition or with repetition set to ‘off’, and etc. Throughout the present disclosure, according to or following those specified or defined herein in the present disclosure, an indicated TCI state, an activation TCI state or a provided/configured TCI state could be regarded/referred to as a NWR, or a NWR could be in form of an indicated TCI state, an activation TCI state or a provided/configured TCI state as specified/defined herein in the present disclosure. Furthermore, according to or following those specified or defined herein in the present disclosure, a UE could determine or identify or derive measurement RS(s) or RS resource(s)—e.g., the current serving beam RS(s) or RS resource(s) or RS resource index(es) and/or the (candidate/actual) candidate/new beam RS(s) or RS resource(s) or RS resource index(es) and/or the activation beam RS(s) or RS resource(s) or RS resource index(es) as specified/defined herein in the present disclosure—for evaluating, assessing, detecting, declaring or determining the event(s) and/or event instance(s) as specified/defined herein in the present disclosure from or based on or according to one or more NWRs.

A UE could determine or identify an instance of a first event (or an Event-1 instance) according to or based on or corresponding to: the UE could determine or identify at least one (same) candidate/new beam or candidate/new beam RS/RS resource that has a beam quality/metric (e.g., a measured L1-RSRP/L1-SINR) a threshold value greater than or equal to the beam quality(s)/metric(s)—e.g., measured L1-RSRP(s)/L1-SINR(s)—of one or more current serving beams or one or more current serving beam RS(s)/RS resource(s) as specified/defined herein in the present disclosure, wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a second event (or an Event-2 instance) according to or based on or corresponding to: the UE could determine or identify that the beam quality(s)/metric(s)—e.g., measured L1-RSRP(s)/L1-SINR(s)—of one or more current serving beams or one or more current serving beam RS(s)/RS resource(s) as specified/defined herein in the present disclosure is below or less than or equal to a threshold, wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a third event (or an Event-3 instance) according to or based on or corresponding to: the UE could determine or identify at least one (same) candidate/new beam or candidate/new beam RS/RS resource that has a beam quality/metric (e.g., a measured L1-RSRP/L1-SINR) a first threshold value greater than or equal to the beam quality(s)/metric(s)—e.g., measured LI-RSRP(s)/L1-SINR(s)—of one or more activated beams/TCI states (or one or more NWRs in general) or one or more activation beam RSs/RS resources as specified/defined herein in the present disclosure; furthermore, e.g., when/if the NWR(s) corresponds to or is in form of one or more activated beams/TCI states, the UE could determine or identify the one or more activated beams/TCI states as or corresponding to the activated beam/TCI state among all the activated beams/TCI states in the (unified) TCI state(s) activation/deactivation MAC CE command that has the m-th lowest/highest measured beam quality/metric such as LI-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, or equivalently, the one or more activation beam RSs or RS resources could have the m-th lowest/highest measured beam quality/metric such as LI-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure. The UE could determine or identify the value of m according to or based on: (i) a fixed value/rule in system specification(s) and/or per RRC (re-)configuration—e.g., the value of m cannot be 1 or the m-th cannot be the first (i.e., the (1-st) lowest/highest) or last (i.e., the (M-th) lowest/highest when/if the number of activated TCI state(s)/TCI codepoint(s) in the MAC CE command is M), (ii) network's configuration(s)/indication(s), e.g. via higher layer RRC signaling(s)/parameter(s) and/or MAC CE command(s) and/or dynamic DCI based L1 signaling(s) based on or according to a corresponding UE's capability or capability signaling—in this case, the UE may not expect the value of m to be configured or provided or indicated as 1 or the m-th to be configured or provided or indicated as the first (i.e., the (1-st) lowest/highest) or last (i.e., the (M-th) lowest/highest when/if the number of activated TCI state(s)/TCI codepoint(s) in the MAC CE command is M), and/or (iii) UE's autonomous determination or selection, which could be further sent or transmitted to the network via/by various UL channels/signals e.g. in/by part of a CSI/beam report and/or a UE's capability signaling—in this case, the value of m may not be 1 or the m-th may not be the first (i.e., the (1-st) lowest/highest) or last (i.e., the (M-th) lowest/highest when/if the number of activated TCI state(s)/TCI codepoint(s) in the MAC CE command is M). Additionally, the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a fourth event (or an Event-4 instance) according to or based on or corresponding to: the UE could determine or identify at least one (same) candidate/new beam or candidate/new beam RS/RS resource that has a beam quality/metric (e.g., a measured L1-RSRP/L1-SINR) greater than or equal to a threshold, wherein the UE could determine or identify the threshold value according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a fifth event (or an Event-5 instance) according to or based on or corresponding to: (1) the UE could determine or identify that the beam quality(s)/metric(s)—e.g., measured L1-RSRP(s)/L1-SINR(s)—of one or more current serving beams or one or more current serving beam RS(s)/RS resource(s) as specified/defined herein in the present disclosure is below or less than or equal to a first threshold, and (2) at least one (same) candidate/new beam or candidate/new beam RS/RS resource that has a beam quality/metric (e.g., a measured L1-RSRP/L1-SINR) a second threshold value greater than or equal to the beam quality(s)/metric(s)—e.g., measured L1-RSRP(s)/L1-SINR(s)—of one or more current serving beams or one or more current serving beam RS(s)/RS resource(s) as specified/defined herein in the present disclosure, wherein the UE could determine or identify the first and/or second threshold value(s) according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a sixth event (or an Event-6 instance) according to or based on or corresponding to: (1) the UE could determine or identify that the beam quality(s)/metric(s)—e.g., measured L1-RSRP(s)/L1-SINR(s)—of one or more current serving beams or one or more current serving beam RS(s)/RS resource(s) as specified/defined herein in the present disclosure is below or less than or equal to a first threshold, and (2) at least one (same) candidate/new beam or candidate/new beam RS/RS resource that has a beam quality/metric (e.g., a measured LI-RSRP/L1-SINR) greater than or equal to a second threshold, wherein the UE could determine or identify the first and/or second threshold value(s) according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

A UE could determine or identify an instance of a seventh event (or an Event-7 instance) according to or based on or corresponding to: (1) the UE could determine or identify that the beam quality(s)/metric(s)—e.g., measured L1-RSRP(s)/L1-SINR(s)—of one or more current serving beams or one or more current serving beam RS(s)/RS resource(s) as specified/defined herein in the present disclosure is below or less than or equal to a first threshold, (2) at least one (same) candidate/new beam or candidate/new beam RS/RS resource that has a beam quality/metric (e.g., a measured LI-RSRP/L1-SINR) a second threshold value greater than or equal to the beam quality(s)/metric(s)—e.g., measured L1-RSRP(s)/L1-SINR(s)—of one or more current serving beams or one or more current serving beam RS(s)/RS resource(s) as specified/defined herein in the present disclosure, and (3) at least one (same) candidate/new beam or candidate/new beam RS/RS resource that has a beam quality/metric (e.g., a measured L1-RSRP/L1-SINR) greater than or equal to a third threshold, wherein the UE could determine or identify the first, second and/or third threshold value(s) according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, and the at least one (same) candidate/new beam or candidate/new beam RS/RS resource determined or identified in (2) could be identical to or same as the at least one (same) candidate/new beam or candidate/new beam RS/RS resource determined or identified in (3).

A UE could be provided or configured or indicated by the network, e.g., via/by/in higher layer RRC signaling(s)/parameter(s) including CSI-ReportConfig and/or UEI-ReportConfig that provides or configures necessary information and/or setting(s) for the UE-initiated/event-driven beam operations including beam(s) reporting, beam(s) switching/update, etc. as specified/defined herein in the present disclosure and/or MAC CE command(s) and/or dynamic DCI based L1 signaling(s) according to or based on corresponding UE's capability(s) or capability signaling(s), one or more indicators/parameters to enable one or more of the Event-1, Event-2, Event-3, Event-4, Event-5, Event-6 and Event-7 as specified/defined herein in the present disclosure. For instance, the UE could be provided or configured with a higher layer parameter eventType set to:
‘event-1’ to enable the Event-1
‘event-2’ to enable the Event-2
‘event-3’ to enable the Event-3
‘event-4’ to enable the Event-4
‘event-5’ to enable the Event-5
‘event-6’ to enable the Event-6
‘event-7’ to enable the Event-7
‘event-x-y’ to enable both the Event-x and Event-y, wherein x={1, . . . , 7}, y={1, . . . , 7}, and x≠y ‘event-x-y-z’ to enable the Event-x, Event-y and Event-z, wherein x={1, . . . , 7}, y={1, . . . , 7}, z={1, . . . , 7}, and x≠y≠z.

The corresponding UE's capability(s) or capability signaling(s) could comprise one or more of the following components:
° ‘event-1’—to indicate their support of Event-1
‘event-2’—to indicate their support of Event-2
‘event-3’—to indicate their support of Event-3
‘event-4’—to indicate their support of Event-4
‘event-5’—to indicate their support of Event-5
‘event-6’—to indicate their support of Event-6
‘event-7’—to indicate their support of Event-7
‘event-x-y’—to indicate their support of Event-x and Event-y, wherein x={1, . . . , 7}, y={1, . . . , 7}, and x≠y ‘event-x-y-z’ to—to indicate their support of Event-x, Event-y and Event-z, wherein x={1, . . . , 7}, y={1, . . . , 7}, z={1, . . . , 7}, and x≠y≠Z.

According to or following those specified/defined herein in the present disclosure,
when/if an Event-x (wherein x={1, . . . , 7}) is enabled, (higher layer(s) of) a UE could determine, detect or declare the Event-x when/if (higher layer(s) of) the UE has determined or identified that the number of instance(s) of the x-th event (or equivalently, the number of the Event-x instance(s)) is greater than or equal to numberOfEventInstances>1 (higher layer configured) within a time window having a length/duration of time WindowDuration (higher layer configured);
when/if an Event-x and an Event-y (wherein x={1, . . . , 7}, y={1, . . . , 7}, and x≠y) are enabled, (higher layer(s)) of a UE could determine, detect or declare both of the Event-x and Event-y when/if (higher layer(s) of) the UE has determined or identified that (1):
   the number of instance(s) of the x-th event (or equivalently, the number of the Event-x instance(s)) is greater than or equal to numberOfEventxInstances≥1 (higher layer configured) within a first time window having a length/duration of timeWindow1Duration (higher layer configured), and
   the number of instance(s) of the y-th event (or equivalently, the number of the Event-y instance(s)) is greater than or equal to numberOfEventyInstances≥1 (higher layer configured) within a second time window having a length/duration of timeWindow2Duration (higher layer configured),
   wherein the first symbol/slot/etc. of the first time window and the first symbol/slot/etc. of the second time window are expected to be later in time than the first symbol/slot/etc. of an overall time window having a length/duration of time WindowDuration (higher layer configured), and the last symbol/slot/etc. of the first time window and the last symbol/slot/etc. of the second time window are expected to be earlier in time than the last symbol/slot/etc. of the overall time window; or (2): the number of instance(s) of the x-th event (or equivalently, the number of the Event-x instance(s)) is greater than or equal to numberOfEventxInstances>1 (higher layer configured) and the number of instance(s) of the y-th event (or equivalently, the number of the Event-y instance(s)) is greater than or equal to numberOfEventyInstances≥1 (higher layer configured) within a time window having a length/duration of time WindowDuration (higher layer configured); in this case, when/if the determination, detection or declaration of each of the Event-x and Event-y (e.g., Event-1, Event-4, and etc.) requires at least one new beam or new beam RS/RS resource to be determined or identified, the same/identical new beam(s) or new beam RS(s)/RS resource(s) could be expected to be determined/identified when determining, detecting or declaring the Event-x and Event-y.
when/if an Event-x, an Event-y and an Event-z (wherein x={1, . . . , 7}, y={1, . . . , 7}, z={1, . . . , 7}, and x≠y≠z) are enabled, (higher layer(s)) of a UE could determine, detect or declare both of the Event-x, Event-y and Event-z when/if (higher layer(s) of) the UE has determined or identified that (1):
   the number of instance(s) of the x-th event (or equivalently, the number of the Event-x instance(s)) is greater than or equal to numberOfEventxInstances≥1 (higher layer configured) within a first time window having a length/duration of timeWindow1Duration (higher layer configured), and
   number of instance(s) of the y-th event (or equivalently, the number of the Event-y instance(s)) is greater than or equal to numberOfEventyInstances≥1 (higher layer configured) within a second time window having a length/duration of timeWindow2Duration (higher layer configured), and
   number of instance(s) of the z-th event (or equivalently, the number of the Event-z instance(s)) is greater than or equal to numberOfEventzInstances≥1 (higher layer configured) within a third time window having a length/duration of timeWindow3Duration (higher layer configured),
wherein the first symbol/slot/etc. of the first time window, the first symbol/slot/etc. of the second time window and the first symbol/slot/etc. of the third time window are expected to be later in time than the first symbol/slot/etc. of an overall time window having a length/duration of time WindowDuration (higher layer configured), and the last symbol/slot/etc. of the first time window, the last symbol/slot/etc. of the second time window and the last symbol/slot/etc. of the third time window are expected to be earlier in time than the last symbol/slot/etc. of the overall time window; or (2): the number of instance(s) of the x-th event (or equivalently, the number of the Event-x instance(s)) is greater than or equal to numberOfEventxInstances≥1 (higher layer configured), the number of instance(s) of the y-th event (or equivalently, the number of the Event-y instance(s)) is greater than or equal to numberOfEventyInstances≥1 (higher layer configured) and the number of instance(s) of the z-th event (or equivalently, the number of the Event-z instance(s)) is greater than or equal to numberOfEventzInstances≥1 (higher layer configured) within a time window having a length/duration of time WindowDuration (higher layer configured); in this case, when/if the determination, detection or declaration of each of the Event-x, Event-y and Event-z (e.g., Event-1, Event-4, and etc.) requires at least one new beam or new beam RS/RS resource to be determined or identified, the same/identical new beam(s) or new beam RS(s)/RS resource(s) could be expected to be determined/identified when determining, detecting or declaring the Event-x, Event-y and Event-z.

As specified/defined in later part(s)/section(s) of the present disclosure, a UE could determine or identify the first and/or last symbol(s)/slot(s)/etc. of a time window for evaluating and/or assessing instance(s) of the event(s) and/or to detect, declare and/or determine the event(s) according to or following those specified herein in the present disclosure with a reference to or with respect to or according to transmission or transmission occasion of a PUCCH of a/the first UL channel as in Step-1 for Mode A, Mode B and/or Mode C as specified/defined herein in the present disclosure.

The RS(s) or RS resource(s) or RS resource (configuration) index(es) of/for a current serving beam—denoted by current serving beam RS(s) or RS resource(s) or RS resource index(es)—for event(s), e.g., Event-1 and/or Event-2 as specified/defined herein in the present disclosure, evaluation(s) and/or determination(s) could be identified or determined according to or based on one or more NWRs, if applicable (i.e., the current serving beam RS(s) or RS resource(s) or RS resource index(es) could be associated or corresponding or linked or mapped to the NWR(s) if applicable) according to one or more of:
Scheme-1: One or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.
Scheme-2: One or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.

For Scheme-1 and/or Scheme-2, the indicated TCI state could be regarded/referred to as a NWR, or a NWR could correspond to or could be in form of the indicated TCI state.

Candidate/new beam RS(s) or RS resource(s) or RS resource (configuration) index(es)—denoted by candidate/new beam RS(s) or RS resource(s) or RS resource (configuration) index(es)—for event(s), e.g., Event-1 and/or Event-3 as specified/defined herein in the present disclosure, evaluation(s) and/or determination(s) could be identified or determined according to a set of SS/PBCH block indexes provided by CSI-SSB-ResourceSet or a set of NZP CSI-RS resources provided by NZP-CSI-RS-ResourceSet (e.g., configured with ‘repetition’ or ‘repetition’ set to ‘enabled’ or ‘on’), wherein the candidate/new beam(s) set of SS/PBCH block indexes (CSI-SSB-ResourceSet) and/or NZP CSI-RS resources (NZP-CSI-RS-ResourceSet, e.g., configured with ‘repetition’ or ‘repetition’ set to ‘enabled’ or ‘on’) could be regarded/referred to as NWR(s) as well (or a NWR could be in form of configuration of the set of candidate/new beam RS(s)/RS resource(s)) and provided in or associated with higher layer parameter(s) CSI-ReportConfig, CSI-ResourceConfig associated/specific to a CSI reporting setting/configuration provided by CSI-ReportConfig and/or higher layer parameter(s) UEI-ReportConfig, UEI-ResourceConfig and/or etc. associated/specific to a UEI CSI reporting setting/configuration provided by UEI-ReportConfig dedicated/configured for the UEI reporting as specified herein in the present disclosure.

For evaluating, assessing or determining a given event (e.g., Event-1 as defined/specified herein in the present disclosure) and/or when/if a given event, e.g., Event-1 as defined/specified herein in the present disclosure, is enabled or provided or configured, when/if a UE is provided or configured a set of SS/PBCH block indexes provided by CSI-SSB-ResourceSet as the candidate/new beam(s) set of RS(s) or RS resource(s) or RS resource configuration(s) according to or following those specified herein in the present disclosure, the UE could determine or identify the current serving beam RS(s) as SSB(s) according to or following those specified or defined in Scheme-2. Otherwise, i.e., when/if a UE is provided or configured a set of NZP CSI-RS resources provided by NZP-CSI-RS-ResourceSet (e.g., configured with ‘repetition’ or ‘repetition’ set to ‘enabled’ or ‘on’) as the candidate/new beam(s) set of RS(s) or RS resource(s) or RS resource configuration(s), the UE could determine or identify the current serving beam RS(s) as NZP CSI-RS(s) or NZP CSI-RS resource(s) according to or following those specified or defined in Scheme-1.

For evaluating, assessing or determining a given event (e.g., Event-2 as defined/specified herein in the present disclosure) and/or when/if a given event, e.g., Event-2 as defined/specified herein in the present disclosure, is enabled or provided or configured,
In one example, when/if another or other event(s)—i.e., separate or different from the given event (e.g., Event-2), e.g., Event-1 and/or Event-3 as defined/specified herein in the present disclosure, is also or simultaneously (e.g., in a same CSI reporting setting or configuration provided by CSI-ReportConfig and/or UEI-ReportConfig provided/configured for the UEI beam reporting as specified/defined herein in the present disclosure that provides or configures or enables the given event e.g. Event-2) enabled or provided or configured, and/or when/if a UE is provided or configured a set of SS/PBCH block indexes provided by CSI-SSB-ResourceSet as the candidate/new beam(s) set of RS(s) or RS resource(s) or RS resource configuration(s) according to or following those specified herein in the present disclosure—e.g., for evaluating, assessing or determining the another or other event(s), e.g., Event-1 and/or Event-3, the UE could determine or identify the current serving beam RS(s) as SSB(s) for evaluating, assessing or determining the given event, e.g., Event-2, according to or following those specified or defined in Scheme-2. Otherwise, i.e., when/if a UE is provided or configured a set of NZP CSI-RS resources provided by NZP-CSI-RS-ResourceSet (e.g., configured with ‘repetition’ or ‘repetition’ set to ‘enabled’ or ‘on’) as the candidate/new beam(s) set of RS(s) or RS resource(s) or RS resource configuration(s)—e.g., for evaluating, assessing or determining the another or other event(s), e.g., Event-1 and/or Event-3, the UE could determine or identify the current serving beam RS(s) as NZP CSI-RS(s) or NZP CSI-RS resource(s) for evaluating, assessing or determining the given event, e.g., Event-2, according to or following those specified or defined in Scheme-1.
In another example, when/if another or other event(s)—i.e., separate or different from the given event (e.g., Event-2), e.g., Event-1 and/or Event-3 as defined/specified herein in the present disclosure, is not enabled or provided or configured or is disabled or absent (e.g., in a same CSI reporting setting or configuration provided by CSI-ReportConfig and/or UEI-ReportConfig provided/configured for the UEI beam reporting as specified/defined herein in the present disclosure that provides or configures or enables the given event e.g. Event-2), and/or
   for example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStype’ set to ‘on’ or ‘enabled’ or ‘true’ or ‘SSB’, the UE could determine or identify the current serving beam RS(s) as SSB(s) for evaluating, assessing or determining the given event, e.g., Event-2, according to or following those specified or defined in Scheme-2
   for another example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStypeCSIRS’ set to ‘off’ or ‘disabled’ or ‘false’, and/or when/if the higher layer parameter ‘currentBeamRStypeCSIRS’ is not provided or configured or present or is absent via/by/in/from the higher layer parameter(s)/signaling(s) CSI-ReportConfig and/or UEI-ReportConfig that provides or configures necessary information and/or setting(s) for the UEI beam reporting as specified/defined herein in the present disclosure, the UE could determine or identify the current serving beam RS(s) as SSB(s) for evaluating, assessing or determining the given event, e.g., Event-2, according to or following those specified or defined in Scheme-2
   for another example, when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStype’ set to ‘on’ or ‘enabled’ or ‘true’ or ‘CSI-RS’, the UE could determine or identify the current serving beam RS(s) as CSI-RS(s) for evaluating, assessing or determining the given event, e.g., Event-2, according to or following those specified or defined in Scheme-1
   when/if the UE is provided or configured by the network, e.g., via higher layer RRC signaling(s)/parameter(s)—e.g., via/by/in the higher layer parameter(s)/signaling(s) CSI-ReportConfig and/or UEI-ReportConfig that provides or configures necessary information and/or setting(s) for the UEI beam reporting as specified/defined herein in the present disclosure, a higher layer parameter ‘currentBeamRStypeSSB’ set to ‘off’ or ‘disabled’ or ‘false’, and/or when/if the higher layer parameter ‘currentBeamRStypeSSB’ is not provided or configured or present or is absent via/by/in/from the higher layer parameter(s)/signaling(s) CSI-ReportConfig and/or UEI-ReportConfig that provides or configures necessary information and/or setting(s) for the UEI beam reporting as specified/defined herein in the present disclosure, the UE could determine or identify the current serving beam RS(s) as CSI-RS(s) for evaluating, assessing or determining the given event, e.g., Event-2, according to or following those specified or defined in Scheme-1
In another example, the UE could be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a higher layer parameter ‘currentBeamRStype’; when/if the higher layer parameter ‘currentBeamRStype’ is set to ‘on’ or ‘enabled’ or ‘true’ or ‘SSB’, the UE could determine or identify the current serving beam RS(s) as SSB(s) for evaluating, assessing or determining the given event, e.g., Event-2, according to or following those specified or defined in Scheme-2, and/or when/if the higher layer parameter ‘currentBeamRStype’ is set to ‘on’ or ‘enabled’ or ‘true’ or ‘CSI-RS’, the UE could determine or identify the current serving beam RS(s) as CSI-RS(s) for evaluating, assessing or determining the given event, e.g., Event-2, according to or following those specified or defined in Scheme-1. For this design example, the UE may not be configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, any set(s) of candidate/new RS index(es)—e.g., SSB index(es) or periodic CSI-RS resource configuration index(es)—for event(s) or event instance(s) evaluation(s) and/or beam measurement/reporting.
In another example, when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of SSB index(es) as the candidate/new beam(s) set of RS index(es) for event(s) or event instance(s) evaluation(s) and/or beam measurement/reporting, the UE could determine or identify the current serving beam RS(s) as SSB(s) for evaluating, assessing or determining the given event, e.g., Event-2, according to or following those specified or defined in Scheme-2, and/or when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of NZP CSI-RS resource or resource configuration index(es) as the candidate/new beam(s) set of RS index(es) for event(s) or event instance(s) evaluation(s) and/or beam measurement/reporting, the UE could determine or identify the current serving beam RS(s) as CSI-RS(s) for evaluating, assessing or determining the given event, e.g., Event-2, according to or following those specified or defined in Scheme-1. For this design example, (i) the aforementioned higher layer parameter ‘currentBeamRStype’ could be absent or may not be provided, present or configured in the corresponding higher layer RRC signaling(s)/parameter(s), or (ii) the aforementioned higher layer parameter ‘currentBeamRStype’ could be provided, present or configured via/in/by the corresponding higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting but set to ‘off’ or ‘disabled’ or ‘false’.

Furthermore, for evaluating, assessing or determining a given event (e.g., Event-2 as defined/specified herein in the present disclosure) and/or when/if a given event, e.g., Event-2 as defined/specified herein in the present disclosure, is enabled or provided or configured,
In another example, when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, the higher layer parameter ‘currentBeamRStype’ and set to ‘on’ or ‘enabled’ or ‘true’ or ‘SSB’ or ‘CSI-RS’, the UE could determine or identify whether the current serving beam RS(s) is SSB(s) or CSI-RS(s) for evaluating, assessing or determining the given event, e.g., Event-2, according to or based on the higher layer parameter ‘currentBeamRStype’ following those specified or defined herein in the present disclosure, regardless whether or not the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, candidate/new beam RS index(es)—e.g. in a resource set—for event(s) or event instance(s) evaluation(s) and/or beam measurement/reporting
In another example, when/if the UE is configured or provided by the network, via higher layer RRC signaling(s)/parameter(s)—e.g., in/by/via CSI-ReportConfig, CSI-ResourceConfig, UEI-ReportConfig and/or UEI-ResourceConfig that provide(s) or configure(s) necessary information/setting(s) for the UE-initiated/event-driven beam reporting, a set of candidate/new beam RS index(es)—e.g. a set of SSB index(es) or a set of periodic CSI-RS resource configuration index(es)—for event(s) or event instance(s) evaluation(s) and/or beam measurement/reporting, the UE could determine or identify whether the current serving beam RS(s) is SSB(s) or CSI-RS(s) for evaluating, assessing or determining the given event, e.g., Event-2, according to or based on whether the configured or provided candidate/new beam RS index(es) in the set is SSB index(es) or CSI-RS resource/resource configuration index(es) following those specified or defined herein in the present disclosure (e.g., those specified or defined in Scheme-1 and/or Scheme-2 in the present disclosure), regardless whether or not the aforementioned higher layer parameter ‘currentBeamRStype’ is present or provided or configured in the corresponding higher layer RRC signaling(s)/parameter(s), and/or regardless of the value(s) of the aforementioned higher layer parameter ‘currentBeamRStype’, if present/configured/provided.

For a NWR in the form of an activated TCI state—e.g., a joint/DL TCI state, a UE could determine or identify RS(s) or RS resource(s) or RS resource index(es) of/for the activated TCI state (or in general, the NWR)—denoted by activation beam RS(s) or RS resource(s) or RS resource index(es) e.g., associated or corresponding or linked or mapped to the NWR in general if applicable—for event(s), e.g., Event-3 as specified/defined herein in the present disclosure, evaluation(s) and/or determination(s) according to one or more of:
Scheme-A: One or more RSs or RS resources or RS resource indexes provided in/by the activated TCI state, wherein the activated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.
Scheme-B: One or more first RSs or RS resources or RS resource indexes quasi-co-located (QCL'ed) with second RS(s)/RS resource(s)/RS resource index(es) provided in/by the activated TCI state, e.g., of QCL-TypeD, wherein the activated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by the activated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es), wherein the CSI-RS(s) or CSI-RS resource(s) or CSI-RS resource configuration(s) here could be provided or configured in a (first) NZP CSI-RS resource set configured with ‘repetition’ or ‘repetition’ set to ‘enabled’ or ‘on’, and/or in a (second) NZP CSI-RS resource set configured with ‘trs-Info’ or ‘trs-Info’ set to ‘enabled’ or ‘on’ or ‘true’.

For Scheme-A and/or Scheme-B, the activated TCI state could be regarded/referred to as a NWR, or a NWR could correspond to or could be in form of the activated TCI state.

For evaluating, assessing or determining a given event (e.g., Event-3 as defined/specified herein in the present disclosure) and/or when/if a given event, e.g., Event-3 as defined/specified herein in the present disclosure, is enabled or provided or configured, when/if a UE is provided or configured a set of SS/PBCH block indexes provided by CSI-SSB-ResourceSet as the candidate/new beam(s) set of RS(s) or RS resource(s) or RS resource configuration(s) according to or following those specified herein in the present disclosure, the UE could determine or identify the activation beam RS(s) as SSB(s) according to or following those specified or defined in Scheme-B. Otherwise, i.e., when/if a UE is provided or configured a set of NZP CSI-RS resources provided by NZP-CSI-RS-ResourceSet (e.g., configured with ‘repetition’ or ‘repetition’ set to ‘enabled’ or ‘on’) as the candidate/new beam(s) set of RS(s) or RS resource(s) or RS resource configuration(s), the UE could determine or identify the activation beam RS(s) as NZP CSI-RS(s) or NZP CSI-RS resource(s) according to or following those specified or defined in Scheme-A.

Furthermore, in one example, for evaluating, assessing or determining given event(s)—e.g., Event-1 and/or Event-2 as defined/specified herein in the present disclosure—and/or when/if given event(s), e.g., Event-1 and/or Event-2 as defined/specified herein in the present disclosure, is/are enabled or provided or configured, when/if only one NZP CSI-RS resource configured or provided in a NZP CSI-RS resource set provided by NZP-CSI-RS-ResourceSet configured with ‘trs-Info’ or ‘trs-Info’ set to ‘enabled’ or ‘on’ or ‘true’ is in the indicated (joint/DL) TCI state (e.g., corresponding to the QCL RS)—or associated or linked or corresponding or mapped to a NWR in general (if applicable), the UE could determine or identify the current serving beam RS(s)/RS resource(s)/RS resource configuration index(es) for evaluating, assessing or determining the given event(s), e.g., Event-1 and/or Event-2,
as a SSB as specified or defined in Scheme-2 according to or following those specified or defined herein in the present disclosure—for example, when/if the Scheme-2 is enabled by the network such that the candidate/new beam RS(s)/RS resource(s)/RS resource configuration(s) is configured or provided as SSB(s); for another example, when/if the Scheme-2 is enabled by the network such that the higher layer parameter e.g. currentBeamRStype is set to ‘SSB’;
as a NZP CSI-RS as specified or defined in Scheme-1 according to or following those specified or defined herein in the present disclosure such that the NZP CSI-RS resource could be configured or provided in a (different) NZP CSI-RS resource set provided by NZP-CSI-RS-ResourceSet configured with ‘repetition’ or ‘repetition’ set to ‘on’ or ‘enabled’—for example, when/if the Scheme-1 is enabled by the network such that the candidate/new beam RS(s)/RS resource(s)/RS resource configuration(s) is configured or provided as NZP CSI-RS(s) or NZP CSI-RS resource(s) provided or configured in NZP CSI-RS resource set(s) configured with ‘repetition’ or ‘repetition’ set to ‘on’ or ‘enabled’; for another example, when/if the Scheme-1 is enabled by the network such that the higher layer parameter e.g. currentBeamRStype is set to ‘CSI-RS’.

In another example, for evaluating, assessing or determining a given event—e.g., Event-3 as defined/specified herein in the present disclosure—and/or when/if a given event, e.g., Event-3 as defined/specified herein in the present disclosure, is enabled or provided or configured, when/if only one NZP CSI-RS resource configured or provided in a NZP CSI-RS resource set provided by NZP-CSI-RS-ResourceSet configured with ‘trs-Info’ or ‘trs-Info’ set to ‘enabled’ or ‘on’ or ‘true’ is in an activated (joint/DL) TCI state (e.g., corresponding to the QCL RS)—or associated or linked or corresponding or mapped to a NWR in general (if applicable), the UE could determine or identify the activation beam RS(s)/RS resource(s)/RS resource configuration index(es) for evaluating, assessing or determining the given event, e.g., Event-3,
as a SSB as specified or defined in Scheme-B according to or following those specified or defined herein in the present disclosure—for example, when/if the Scheme-B is enabled by the network such that the candidate/new beam RS(s)/RS resource(s)/RS resource configuration(s) is configured or provided as SSB(s); for another example, when/if the Scheme-B is enabled by the network such that the higher layer parameter e.g. currentBeamRStype is set to ‘SSB’;
as a NZP CSI-RS as specified or defined in Scheme-A according to or following those specified or defined herein in the present disclosure such that the NZP CSI-RS resource could be configured or provided in a (different) NZP CSI-RS resource set provided by NZP-CSI-RS-ResourceSet configured with ‘repetition’ or ‘repetition’ set to ‘on’ or ‘enabled’—for example, when/if the Scheme-A is enabled by the network such that the candidate/new beam RS(s)/RS resource(s)/RS resource configuration(s) is configured or provided as NZP CSI-RS(s) or NZP CSI-RS resource(s) provided or configured in NZP CSI-RS resource set(s) configured with ‘repetition’ or ‘repetition’ set to ‘on’ or ‘enabled’; for another example, when/if the Scheme-A is enabled by the network (e.g., the network 130) such that the higher layer parameter e.g. currentBeamRStype is set to ‘CSI-RS’.

In one operation mode (Mode A), upon detection and/or declaration of one or more of the events (e.g., the fourth event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-) type (B) or (report-)type (C) as specified herein in the present disclosure, and/or upon detection and/or declaration of one or more of the events (e.g., the first event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. The PN message/trigger could indicate a potential transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network (e.g., the network 130), e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms, etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to Ims, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: after the UE has transmitted the PN message/trigger, the UE (e.g., the UE 116) could expect to receive from the network a (downlink/uplink) DCI in response to the PN message/trigger, within a time window starting from the first or last symbol/slot/etc. of the transmission of the PN message/trigger. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window (in symbol, slot, ms, etc.). In addition, the UE could indicate to the network, e.g., in form of a UE's capability via a UE's capability signaling, whether or not the UE could expect to receive from the network the (downlink/uplink) DCI in response to the PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined herein, whether or not the UE could expect to receive from the network the (downlink/uplink) DCI in response to the PN message/trigger. The (downlink/uplink) DCI in response to the PN message/trigger could comprise one or more of the following components:
   Component-1: a one-bit indicator with ‘1’ (or ‘0’) indicating acknowledgement (ACK) for the PN message/trigger and ‘0’ (or ‘1’) indicating non-ACK (NACK) for the PN message/trigger
   Component-2: a time gap/duration (e.g., in number of symbols/slots/etc.)
   Component-3: a priority order or value for the PN message/trigger and/or the UEI report content(s)/quantity(s) associated/specific to the PN message/trigger as defined/specified herein in the present disclosure
   Component-4: a time offset (e.g., in number of symbols/slots/etc.)
   Component-5: resource allocation and/or indication for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including configured grant (CG) PUSCH of Type1 and/or Type2, dynamically granted/scheduled by the network for sending the UEI report content(s)/quantity(s) including DG PUSCH); the resource allocation and/or indication for the second UL channel could comprise or correspond/refer to one or more of the following components, and/or could be determined according to one or more of the following components:
      Component-5a: one or more resource IDs/indexes (e.g., PUCCH resource IDs/indexes, PUCCH resource set IDs/indexes, etc.), wherein a resource could correspond to a time-domain resource and/or a frequency-domain resource comprising or corresponding to one or more of: a transmission occasion (TO), a slot, a symbol, a physical resource block (PRB), a PUCCH resource, a PUSCH resource, a PRACH preamble and/or etc., wherein bitwidth k of a resource ID/index could be determined or calculated or computed with respect to a number of resources (denoted by K) in a resource set such that k=[log₂K] or k=[log₂K]. The resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. The resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the UEI report content(s)/quantity(s) in/via the second UL channel.
      Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. The resource set could be
   associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the UEI report content(s)/quantity(s) in/via the second UL channel.
      Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-5f: one or more CSI reporting configuration/setting IDs/indexes, wherein a CSI reporting setting/configuration is provided by CSI-ReportConfig.
      Component-5g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource allocation and/or indication for the second UL channel could correspond to the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-5h: a starting symbol/slot/etc, for the second UL channel
      Component-5i: an ending symbol/slot/etc, for the second UL channel
      Component-5j: a time duration/length (e.g., in form/terms/number of symbols/slot/etc.), within which the resources could be allocated/indicated for the second UL channel
      Component-5k: a number of resources allocated/indicated for the second UL channel
      Component-5l: an uplink (scheduling) grant, e.g., for PUSCH(s)

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.
Component-6: indication of resource(s) not used/available/applicable for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource(s) not used/available/applicable for the second UL channel could be in form of one or more of the following components, and/or the resource(s) not used/available/applicable for the second UL channel could be determined according to one or more of the components:
   Component-6a: one or more resource IDs/indexes (e.g., PUCCH resource IDs/indexes, PUCCH resource set IDs/indexes, etc.)—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=[log₂K] or k= [log₂K]. The resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
   Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. The resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the UEI report content(s)/quantity(s) in/via the second UL channel.
   Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. The resource set could be
   associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the UEI report content(s)/quantity(s) in/via the second UL channel.
   Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
   Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
   Component-6f: one or more CSI reporting configuration/setting IDs/indexes—for the resource(s) not used/applicable/available for the second UL channel, wherein a CSI reporting setting/configuration is provided by CSI-ReportConfig.
   Component-6g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
   Component-6h: a starting symbol/slot/etc, for the resource(s) not used/applicable/available for the second UL channel
   Component-6i: an ending symbol/slot/etc, for resource(s) not used/applicable/available for the second UL channel
   Component-6j: a time duration/length (e.g., in form/terms/number of symbols/slot/etc.), within which the resources may not be used/applicable/available for the second UL channel
   Component-6k: a number of resources not used/available/applicable for the second UL channel
   Component-6l: an uplink (scheduling) grant, e.g., for PUSCH(s), such that the scheduled/granted resource(s) may not be used/available/applicable for the second UL channel

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the UEI report content(s)/quantity(s) via/in the second UL channel.
Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.

One or more of the components including Component-1-Component-7 as defined/specified herein in the present disclosure could correspond to or could be realized, specified or implemented as/by one or more new DCI fields in the corresponding (downlink/uplink) DCI format; optionally, one or more of the components including Component-1-Component-7 as defined/specified herein in the present disclosure could correspond to or could be repurposed by one or more bits of one or more existing DCI fields in the corresponding (downlink/uplink) DCI format. Furthermore, the UE could indicate to the network, e.g., in form of a UE's capability via a UE's capability signaling, which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined herein, which one or more of the components including Component-1-Component-7 as defined/specified herein in the present disclosure the UE could support or expect.
Step-3: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH). In this step, the UE could expect to receive the (downlink/uplink) DCI in response to the transmission of the PN message/trigger comprising one or more of the components including Component-1-Component-7 as defined/specified herein in the present disclosure according to network's configuration(s) and/or indication(s) based on the corresponding UE's capability or capability signaling following those specified/described herein in the present disclosure. For example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. In this case, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission could indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type 1 and/or Type2) for sending the UEI report content(s)/quantity(s) via/in the second UL channel.

The (downlink/uplink) DCI (in Step-2) in response to the transmission of the PN message/trigger in Step-1 could be in various DCI formats including (uplink) DCI format(s) including DCI format(s) 0_0, 0_1, 0_2 and/or 0_3, (downlink) DCI format(s) including DCI format(s) 1_0, 1_1, 1_2 and/or 1_3, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the PN message/trigger transmission in Step-1 via/in the first UL channel:
The group common DCI format could comprise or indicate or provide one or more sets of components (e.g., one or more of Component-1-Component-7 as defined/specified herein in the present disclosure) with each set of components dedicated or specific or associated or corresponding to a PN message/trigger or a transmission of a PN message/trigger or a configuration of PN message/trigger or an order/index of a (transmission of) PN message/trigger, and therefore, a UE among a group of UEs; optionally or alternatively, each set of components provided, comprised or provided in the group common DCI could be dedicated or specific or associated or corresponding to identification (ID) information related to a UE including a cell-radio network temporary identifier (C-RNTI), a UE ID/index, and/or etc.
A UE could transmit or send a PN message/trigger in Step-1; upon detection or reception of the group common DCI in Step-2, the UE could identify or determine the set of components (e.g., one or more of Component-1-Component-7 as defined or specified herein in the present disclosure) provided/indicated in the group common DCI format that are associated or specific or dedicated to the PN message/trigger in Step-1 and/or any other identification information related to the UE. The UE could then identify or determine the resource(s) based on the identified or determined set of components following those specified herein in the present disclosure to use for transmitting or sending the second UL channel carrying or conveying the UEI report content(s)/quantity(s) associated/specific to the PN message/trigger transmitted or sent in Step-1 via/in the first UL channel.

In one operation mode (Mode B), upon detection and/or declaration of one or more of the events (e.g., the fourth event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-) type (B) or (report-)type (C) as specified herein in the present disclosure, and/or upon detection and/or declaration of one or more of the events (e.g., the first event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. The PN message/trigger could indicate a potential transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms, etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to Ims, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2); the UE could determine or identify the resource(s) for the second UL channel according to one or more of:
   In one example, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based LI signaling(s), according to or based on a corresponding UE's capability or capability signaling, wherein the candidate values could correspond to slot/symbol/etc. indexes.
   In another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel, regardless of whether or not a (downlink/uplink) DCI format in response to the PN message/trigger is received, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type 1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based LI signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

In one operation mode (Mode C), upon detection and/or declaration of one or more of the events (e.g., the fourth event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-) type (B) or (report-)type (C) as specified herein in the present disclosure, and/or upon detection and/or declaration of one or more of the events (e.g., the first event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-)type (A) or (report-)type (C) as specified herein in the present disclosure, and/or the (corresponding) UEI report content(s) or report quantity(s)—e.g., of (report-)type (B) or (report-)type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. The PN message/trigger could indicate a potential transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to 1 ms, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: after the UE has transmitted the PN message/trigger, the UE could expect to receive from the network a (downlink/uplink) DCI in response to the PN message/trigger, within a time window starting from the first or last symbol/slot/etc. of the transmission of the PN message/trigger. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window. In addition, the UE could indicate to the network, e.g., in form of a UE's capability via a UE's capability signaling, whether or not the UE could expect to receive from the network the (downlink/uplink) DCI in response to the PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined herein, whether or not the UE could expect to receive from the network the (downlink/uplink) DCI in response to the PN message/trigger. The (downlink/uplink) DCI in response to the PN message/trigger could comprise one or more of the following components:
   Component-1: a one-bit indicator with ‘1’ (or ‘0’) indicating acknowledgement (ACK) for the PN message/trigger and ‘0’ (or ‘1’) indicating non-ACK (NACK) for the PN message/trigger
   Component-2: a time gap/duration (e.g., in number of symbols/slots/etc.)
   Component-3: a priority order or value for the PN message/trigger and/or the UEI report content(s)/quantity(s) associated/specific to the PN message/trigger as defined/specified herein in the present disclosure
   Component-4: a time offset (e.g., in number of symbols/slots/etc.)
   Component-5: resource allocation and/or indication for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource allocation and/or indication for the second UL channel could comprise or correspond/refer to one or more of the following components, and/or could be determined according to one or more of the following components:
      Component-5a: one or more resource IDs/indexes, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=[log₂K] or k=[log₂K]. The resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based LI signaling(s), according to or based on a corresponding UE's capability or capability signaling.
      Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. The resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network (e.g., the network 130), e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the UEI report content(s)/quantity(s) in/via the second UL channel.
      Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. The resource set could be
   associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the UEI report content(s)/quantity(s) in/via the second UL channel.
      Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-5f: one or more CSI reporting configuration/setting IDs/indexes, wherein a CSI reporting setting/configuration is provided by CSI-ReportConfig.
      Component-5g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource allocation and/or indication for the second UL channel could correspond to the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-5h: a starting symbol/slot/etc, for the second UL channel
      Component-5i: an ending symbol/slot/etc, for the second UL channel
      Component-5j: a time duration/length (e.g., in form/terms/number of symbols/slot/etc.), within which the resources could be allocated/indicated for the second UL channel
      Component-5k: a number of resources allocated/indicated for the second UL channel
      Component-5l: an uplink (scheduling) grant, e.g., for PUSCH(s)

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.
Component-6: indication of resource(s) not used/available/applicable for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource(s) not used/available/applicable for the second UL channel could be in form of one or more of the following components, and/or the resource(s) not used/available/applicable for the second UL channel could be determined according to one or more of the components:
   Component-6a: one or more resource IDs/indexes—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=[log₂K] or k=[log₂K]. The resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based LI signaling(s), according to or based on a corresponding UE's capability or capability signaling.
   Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. The resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the UEI report content(s)/quantity(s) in/via the second UL channel.
   Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. The resource set could be
   associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the UEI report content(s)/quantity(s) in/via the second UL channel.
   Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
   Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
   Component-6f: one or more CSI reporting configuration/setting IDs/indexes—for the resource(s) not used/applicable/available for the second UL channel, wherein a CSI reporting setting/configuration is provided by CSI-ReportConfig.
   Component-6g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
   Component-6h: a starting symbol/slot/etc, for the resource(s) not used/applicable/available for the second UL channel
   Component-6i: an ending symbol/slot/etc, for resource(s) not used/applicable/available for the second UL channel
   Component-6j: a time duration/length (e.g., in form/terms/number of symbols/slot/etc.), within which the resources may not be used/applicable/available for the second UL channel
   Component-6k: a number of resources not used/available/applicable for the second UL channel
   Component-6l: an uplink (scheduling) grant, e.g., for PUSCH(s), such that the scheduled/granted resource(s) may not be used/available/applicable for the second UL channel

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the UEI report content(s)/quantity(s) via/in the second UL channel.
Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.

One or more of the components including Component-1-Component-7 as defined/specified herein in the present disclosure could correspond to or could be realized, specified or implemented as/by one or more new DCI fields in the corresponding (downlink/uplink) DCI format; optionally, one or more of the components including Component-1-Component-7 as defined/specified herein in the present disclosure could correspond to or could be repurposed by one or more bits of one or more existing DCI fields in the corresponding (downlink/uplink) DCI format. Furthermore, the UE (e.g., the UE 116) could indicate to the network, e.g., in form of a UE's capability via a UE's capability signaling, which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined herein, which one or more of the components including Component-1-Component-7 as defined/specified herein in the present disclosure the UE could support or expect.
Step-3: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the UE could determine or identify the resource(s) for the second UL channel according to one or more of:
   In one example, when/if the UE does not report to the network the capability signaling that they could support Step-2 as specified/described herein in the present disclosure, and/or when/if the UE reports to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based LI signaling(s) based on or according to the corresponding UE's capability or capability signaling, that Step-2 as specified/described herein in the present disclosure may not be enabled and/or the UE may not expect to receive from the network the (downlink/uplink) DCI format in response to the transmission of the PN message/trigger in Step-1, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type 1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based LI signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based LI signaling(s), according to or based on a corresponding UE's capability or capability signaling, wherein the candidate values could correspond to slot/symbol/etc. indexes.
   In another example, when/if the UE reports to the network the capability signaling that they could support Step-2 as specified/described herein in the present disclosure, and/or when/if the UE does not report to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2 as specified/described herein in the present disclosure could be enabled and/or the UE could expect to receive from the network the (downlink/uplink) DCI format in response to the transmission of the PN message/trigger in Step-1, and/or when/if after the UE has transmitted or sent the PN message/trigger via the first UL channel in Step-1 but does not receive the (downlink/uplink) DCI in response to the PN message/trigger as specified or discussed in Step-2 a first time period/window/duration (e.g., denoted by t1 in terms/form/number of symbols/slots/etc.) after the first or last symbol/slot/etc. of the transmission of the PN message/trigger, and/or when/if after the UE has transmitted or sent the (same) PN message/trigger max_PN times/instances—each separated by a time gap-within a second time period/window/duration (e.g., denoted by t2 in terms/form/number of symbols/slots/etc.) but does not receive the (downlink/uplink) DCI in response to the last transmission time/instance of the (same) PN message/trigger, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a third time period/window/duration (e.g., denoted by t3 in terms/form/number of symbols/slots/etc.) after the first or last symbol/slot/etc. of the transmission of the PN message/trigger. The value(s) of the max_PN, the time gap, the first, second and/or third time period(s)/window(s)/duration(s) t1, t2 and/or t3 could be determined according to: (i) fixed value(s) in system specification(s) and/or per RRC configuration, e.g., t1, t2, t3=0 symbol/slot/etc., t1, t2, t3=1 symbol/slot/etc., t1, t2, t3=2 symbols/slots/etc., (ii) network's configuration(s) and/or indication(s), e.g., via higher layer RRC signaling(s)/parameter(s) and/or MAC CE command(s) and/or dynamic DCI based LI signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the first, second and/or third time period(s)/window(s)/duration(s) t1, t2 and/or t3 (e.g., in form/terms/number of slots/symbols/etc.): for example, the value(s) of t1, t2 and/or t3 could be or could correspond to random value(s) within a value range [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value(s) and the value range including value(s) of min_value and/or max_value could correspond to slot/symbol/etc. index(es); for another example, the value(s) of t1, t2 and/or t3 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, the UE could expect to receive the (downlink/uplink) DCI in response to the transmission of the PN message/trigger comprising one or more of the components including Component-1-Component-7 as defined/specified herein in the present disclosure according to network's configuration(s) and/or indication(s) based on the corresponding UE's capability or capability signaling following those specified/described herein in the present disclosure.
      For example, the UE could expect to receive the (downlink/uplink) DCI in response to the transmission of the PN message/trigger comprising one or more of the components including Component-1, Component-2, Component-3 and/or Component-4 and/or Component-7 (i.e., except Component-5 and Component-6) according to network's configuration(s) and/or indication(s) based on the corresponding UE's capability or capability signaling following those specified/described herein in the present disclosure, and/or the UE could expect to receive the (downlink/uplink) DCI in response to the transmission of the PN message/trigger comprising one or more of the components including Component-1-Component-7 according to network's configuration(s) and/or indication(s) based on the corresponding UE's capability or capability signaling following those specified/described herein in the present disclosure but only receives the (downlink/uplink) DCI in response to the transmission of the PN message/trigger comprising one or more of the components including Component-1 (e.g., an ACK for the PN message/trigger), Component-2, Component-3 and/or Component-4 and/or Component-7 (i.e., except Component-5 and Component-6). For this design example, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t2 in terms/form/number of symbols/slots/etc.) after the first or last symbol/slot/etc. of the transmission of the PN message/trigger and/or after the first or last symbol/slot/etc. of the reception of the (downlink/uplink) DCI format in response to the transmission of the PN message/trigger. The value(s) of the time period/window/duration t2 could be determined according to: (i) fixed value(s) in system specification(s) and/or per RRC configuration, e.g., t2=0 symbol/slot/etc., t2=1 symbol/slot/etc., t2=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For instance, for (ii), the value(s) of t2 could be determined according to the time gap/duration provided/indicated in Component-2 and/or the time offset provided/indicated in Component-4 as/in part of the (downlink/uplink) DCI format in response to the PN message/trigger; for (iii), i.e., for the UE to autonomously determine or select the value(s) of the time period/window/duration t2 (e.g., in form/terms/number of slots/symbols/etc.): for example, the value(s) of t2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. For this design example, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission does not indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. For this design example, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission could indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a potential transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, when/if the (downlink/uplink) DCI in response to the PN message/trigger is received p1 (in number of slots/symbols/etc.) earlier in time than the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type 1 and/or Type2 a time period/window/duration (e.g., denoted by t1 in terms/form/number of symbols/slots/etc.) after the first or last symbol/slot/etc. of the transmission of the PN message/trigger, and/or when/if the earliest available UL resource(s) determined or identified according to or based on the received (downlink/uplink) DCI following those specified herein in the present disclosure (e.g., according to or based on one or more of the Component-1-Component-7) is p2 (in number of slots/symbols/etc.) earlier in time than the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger, the UE could determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the UEI report content(s)/quantity(s) associated/specific to the PN message/trigger sent/transmitted in/via the first UL channel (in Step-1) on or over the determined or identified resource(s) for the second UL channel. The value(s) of p1, p2, t1 and/or the time period/window/duration as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, when/if the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger is q1 (in number of slots/symbols/etc.) earlier in time than the reception of the (downlink/uplink) DCI in response to the PN message/trigger, and/or when/if the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger is q2 (in number of slots/symbols/etc.) earlier in time than the earliest available UL resource(s) determined or identified according to or based on the received (downlink/uplink) DCI following those specified herein in the present disclosure (e.g., according to or based on one or more of the Component-1-Component-7), the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes. Furthermore, the value(s) of q1, q2 and/or the time period/window/duration as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, regardless of how/when the periodic/semi-persistent PUCCH resource(s) and/or the PUSCH resource(s) such as CG PUSCH of Type 1 and/or Type2 is (pre-) configured by the network for transmitting or sending the UEI report content(s)/quantity(s) as defined or specified herein in the present disclosure, the UE could determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the UEI report content(s)/quantity(s) associated/specific to the PN message/trigger sent/transmitted in/via the first UL channel (in Step-1) on or over the determined or identified resource(s) for the second UL channel.
      For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type 1 and/or Type2) for sending the UEI report content(s)/quantity(s) via/in the second UL channel, regardless of whether or not a (downlink/uplink) DCI format in response to the PN message/trigger is received, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
      For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type 1 and/or Type2) for sending the UEI report content(s)/quantity(s) via/in the second UL channel and/or the UE receives a (downlink/uplink) DCI in response to the PN message/trigger comprising at least an ACK (e.g., in Component-1) for the transmission of the PN message/trigger, regardless of whether or not the (downlink/uplink) DCI format in response to the PN message/trigger comprises or provides or indicates component(s)—e.g., Component-5 and/or Component-6 as defined/specified herein in the present disclosure—that provides or comprises or indicates resource allocation and/or indication for the second UL channel to carry or convey the UEI report content(s)/quantity(s) associated/specific to the PN message/trigger, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger and/or after the first or last symbol/slot/etc. of the reception of the (downlink/uplink) DCI format in response to the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network (e.g., the network 130) via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

The (downlink/uplink) DCI (in Step-2) in response to the transmission of the PN message/trigger in Step-1 could be in various DCI formats including (uplink) DCI format(s) including DCI format(s) 0_0, 0_1 and/or 0_2, (downlink) DCI format(s) including DCI format(s) 1_0, 1_1 and/or 1_2, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the PN message/trigger transmission in Step-1 via/in the first UL channel:
The group common DCI format could comprise or indicate or provide one or more sets of components (e.g., one or more of Component-1-Component-7 as defined/specified herein in the present disclosure) with each set of components dedicated or specific or associated or corresponding to a PN message/trigger or a transmission of a PN message/trigger or a configuration of PN message/trigger or an order/index of a (transmission of) PN message/trigger, and therefore, a UE among a group of UEs; optionally or alternatively, each set of components provided, comprised or provided in the group common DCI could be dedicated or specific or associated or corresponding to identification (ID) information related to a UE including a C-RNTI, a UE ID/index, and/or etc.
A UE could transmit or send a PN message/trigger in Step-1; upon detection or reception of the group common DCI in Step-2, the UE could identify or determine the set of components (e.g., one or more of Component-1-Component-7 as defined or specified herein in the present disclosure) provided/indicated in the group common DCI format that are associated or specific or dedicated to the PN message/trigger in Step-1 and/or any other identification information related to the UE. The UE could then identify or determine the resource(s) based on the identified or determined set of components following those specified herein in the present disclosure to use for transmitting or sending the second UL channel carrying or conveying the UEI report content(s)/quantity(s) associated/specific to the PN message/trigger transmitted or sent in Step-1 via/in the first UL channel.

Supporting Mode A (and/or Mode B and/or Mode C) and therefore the corresponding operations could be a basic UE feature such that when/if a UE supports the UE-initiated/event-driven beam reporting/management (or for a UE supporting the UE-initiated/event-driven beam reporting/management), the UE could or would need to support at least Mode A (and/or Mode B and/or Mode C) and therefore the corresponding operations. Supporting Mode B (and/or Mode A and/or Mode C) and therefore the corresponding operations could be optional for a UE supporting the UE-initiated/event-driven beam reporting/management; in this case, the UE could indicate to the network in their capability signaling(s) one or more of:
Support of Mode A and therefore the corresponding operations
Support of Mode B and therefore the corresponding operations
Support of Mode C and therefore the corresponding operations

That is, a UE's capability or capability signaling could comprise one or more components each indicating support of:
{Mode A}
{Mode B}
{Mode C}
{Mode A, Mode B}
{Mode A, Mode C}
{Mode B, Mode C}

According to or following those specified herein in the present disclosure,
For Event-1 as specified/defined herein in the present disclosure, when/if (higher layer(s) of) a UE has determined or identified that a first Event-1 instance is associated/specific to a new/candidate beam RS/RS resource such that the UE could determine or identify that the candidate/new beam RS/RS resource has a beam quality/metric (e.g., a measured L1-RSRP/L1-SINR) a threshold value greater than or equal to the beam quality(s)/metric(s)—e.g., measured L1-RSRP(s)/L1-SINR(s)—of the current serving beam RS/RS resource as specified/defined herein in the present disclosure, and (higher layer(s) of) the UE has determined or identified that a second Event-1 instance is associated/specific to the (same) new/candidate beam RS/RS resource such that the UE could determine or identify that the candidate/new beam RS/RS resource has a beam quality/metric (e.g., a measured L1-RSRP/L1-SINR) the threshold value greater than or equal to the beam quality(s)/metric(s)—e.g., measured L1-RSRP(s)/L1-SINR(s)—of the current serving beam RS/RS resource, the first and second Event-1 instances could be associated/specific to the (same) new/candidate beam RS/RS resource.
For Event-2 as specified/defined herein in the present disclosure, when/if (higher layer(s) of) a UE has determined or identified that a first Event-2 instance is associated/specific to the current serving beam RS/RS resource such that the UE could determine or identify that the current beam RS/RS resource has a beam quality/metric (e.g., a measured L1-RSRP/L1-SINR) lower than or equal to a threshold value, and (higher layer(s) of) the UE has determined or identified that a second Event-2 instance is associated/specific to the current serving beam RS/RS resource such that the UE could determine or identify that the current beam RS/RS resource has a beam quality/metric (e.g., a measured L1-RSRP/L1-SINR) lower than or equal to a threshold value, the first and second Event-2 instances could be associated/specific to the current beam RS/RS resource.
For Event-3 as specified/defined herein in the present disclosure, (higher layer(s) of) a UE could determine or identify that a first Event-3 instance is associated/specific to a new/candidate beam RS/RS resource such that the UE could determine or identify that the candidate/new beam RS/RS resource has a beam quality/metric (e.g., a measured L1-RSRP/L1-SINR) a threshold value greater than or equal to the beam quality(s)/metric(s)—e.g., measured L1-RSRP(s)/L1-SINR(s)—of a first activated beam/TCI state or a first activation beam RS/RS resource as specified/defined herein in the present disclosure; furthermore, the UE could determine or identify the first activated beam/TCI state as or corresponding to the activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, or equivalently, the first activation beam RS or RS resource could have the m-th lowest/highest measured beam quality/metric such as LI-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure, wherein the UE could determine or identify the value of m according to or following those specified herein in the present disclosure, and (higher layer(s) of) the UE could determine or identify that a second Event-3 instance is associated/specific to the new/candidate beam RS/RS resource such that the UE could determine or identify that the candidate/new beam RS/RS resource has a beam quality/metric (e.g., a measured LI-RSRP/L1-SINR) a threshold value greater than or equal to the beam quality(s)/metric(s)—e.g., measured L1-RSRP(s)/L1-SINR(s)—of a second activated beam/TCI state or a second activation beam RS/RS resource as specified/defined herein in the present disclosure; furthermore, the UE could determine or identify the second activated beam/TCI state as or corresponding to the activated beam/TCI state among the activated beams/TCI states in the (unified) TCI state(s) activation/deactivation MAC CE command that has the m-th lowest/highest measured beam quality/metric such as LI-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, or equivalently, the second activation beam RS or RS resource could have the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure, wherein the UE could determine or identify the value of m according to or following those specified herein in the present disclosure. In this case, the UE could determine or identify the first activation beam RS/RS resource (and therefore, the corresponding first activated beam/TCI state and the measurement result(s) including beam quality(s)/metric(s) such as L1-RSRP(s)/L1-SINR(s)) and the second activation beam RS/RS resource (and therefore, the corresponding second activated beam/TCI state and the measurement result(s) including beam quality(s)/metric(s) such as L1-RSRP(s)/L1-SINR(s)) from two separate MOs according to or following those specified herein in the present disclosure.
   When/if the first activation beam RS/RS resource (and the corresponding first activated beam/TCI state) is the same as or identical to the second activation beam RS/RS resource (and the corresponding second activated beam/TCI state), the UE could determine or identify or it could be said that the first and second Event-3 instances could be associated/specific to (a pair of) the (same) new/candidate beam RS/RS resource and the (same) activation beam RS/RS resource (or equivalently, the (same) activated beam/TCI state).
   When/if the first activation beam RS/RS resource (and the corresponding first activated beam/TCI state) is different or separate from the second activation beam RS/RS resource (and the corresponding second activated beam/TCI state), the UE could determine or identify or it could be said that the first and second Event-3 instances could be associated/specific (only) to the (same) new/candidate beam RS/RS resource.
For Event-4 as specified/defined herein in the present disclosure, when/if (higher layer(s) of) a UE has determined or identified that a first Event-4 instance is associated/specific to a new/candidate beam RS/RS resource such that the UE could determine or identify that the candidate/new beam RS/RS resource has a beam quality/metric (e.g., a measured L1-RSRP/L1-SINR) greater than or equal to a threshold value, and (higher layer(s) of) the UE has determined or identified that a second Event-2 instance is associated/specific to the (same) new/candidate beam RS/RS resource such that the UE could determine or identify that the candidate/new beam RS/RS resource has a beam quality/metric (e.g., a measured L1-RSRP/L1-SINR) greater than or equal to the threshold value, the first and second Event-4 instances could be
   associated/specific to the (same) new/candidate beam RS/RS resource.
For Event-5 as specified/defined herein in the present disclosure, when/if (higher layer(s) of) a UE has determined or identified that a first Event-5 instance is associated/specific to the current serving beam RS/RS resource and a new/candidate beam RS/RS resource such that the UE could determine or identify that (1) a beam quality/metric—e.g., a measured L1-RSRP/L1-SINR—of the current serving beam RS/RS resource is below or less than or equal to a first threshold, and (2) a candidate/new beam RS/RS resource that has a beam quality/metric (e.g., a measured L1-RSRP/L1-SINR) a second threshold value greater than or equal to the beam quality/metric—e.g., the measured L1-RSRP/L1-SINR—of the current serving beam RS/RS resource, and (higher layer(s) of) the UE has determined or identified that a second Event-5 instance is associated/specific to the current serving beam RS/RS resource and the (same) new/candidate beam RS/RS resource such that the UE could determine or identify that (1) a beam quality/metric—e.g., a measured L1-RSRP/L1-SINR—of the current serving beam RS/RS resource is below or less than or equal to the first threshold, and (2) the candidate/new beam RS/RS resource that has a beam quality/metric (e.g., a measured L1-RSRP/L1-SINR) the second threshold value greater than or equal to the beam quality/metric—e.g., the measured L1-RSRP/L1-SINR—of the current serving beam RS/RS resource, the first and second Event-5 instances could be associated/specific to the current serving beam RS/RS resource and the (same) new/candidate beam RS/RS resource.
For Event-6 as specified/defined herein in the present disclosure, when/if (higher layer(s) of) a UE has determined or identified that a first Event-6 instance is associated/specific to the current serving beam RS/RS resource and a new/candidate beam RS/RS resource such that the UE could determine or identify that (1) a beam quality/metric—e.g., a measured L1-RSRP/L1-SINR—of the current serving beam RS/RS resource is below or less than or equal to a first threshold, and (2) a candidate/new beam RS/RS resource that has a beam quality/metric (e.g., a measured LI-RSRP/L1-SINR) greater than or equal to a second threshold, and (higher layer(s) of) the UE has determined or identified that a second Event-6 instance is associated/specific to the current serving beam RS/RS resource and the (same) new/candidate beam RS/RS resource such that the UE could determine or identify that (1) a beam quality/metric—e.g., a measured LI-RSRP/L1-SINR—of the current serving beam RS/RS resource is below or less than or equal to the first threshold, and (2) the candidate/new beam RS/RS resource that has a beam quality/metric (e.g., a measured L1-RSRP/L1-SINR) greater than or equal to the second threshold, the first and second Event-6 instances could be associated/specific to the current serving beam RS/RS resource and the (same) new/candidate beam RS/RS resource.
For Event-7 as specified/defined herein in the present disclosure, when/if (higher layer(s) of) a UE has determined or identified that a first Event-7 instance is associated/specific to the current serving beam RS/RS resource and a new/candidate beam RS/RS resource such that the UE could determine or identify that (1) a beam quality/metric—e.g., a measured L1-RSRP/L1-SINR—of the current serving beam RS/RS resource is below or less than or equal to a first threshold, (2) a candidate/new beam RS/RS resource that has a beam quality/metric (e.g., a measured L1-RSRP/L1-SINR) a second threshold value greater than or equal to the beam quality/metric—e.g., the measured L1-RSRP/L1-SINR—of the current serving beam RS/RS resource, and (3) the (same) candidate/new beam RS/RS resource that has a beam quality/metric (e.g., a measured L1-RSRP/L1-SINR) greater than or equal to a third threshold, and (higher layer(s) of) the UE has determined or identified that a second Event-7 instance is associated/specific to the current serving beam RS/RS resource and the (same) new/candidate beam RS/RS resource such that the UE could determine or identify that (1) a beam quality/metric—e.g., a measured L1-RSRP/L1-SINR—of the current serving beam RS/RS resource is below or less than or equal to the first threshold, (2) the candidate/new beam RS/RS resource that has a beam quality/metric (e.g., a measured L1-RSRP/L1-SINR) the second threshold value greater than or equal to the beam quality/metric—e.g., the measured L1-RSRP/L1-SINR—of the current serving beam RS/RS resource, and (3) the (same) candidate/new beam RS/RS resource that has a beam quality/metric (e.g., a measured L1-RSRP/L1-SINR) greater than or equal to the third threshold, the first and second Event-7 instances could be associated/specific to the current serving beam RS/RS resource and the (same) new/candidate beam RS/RS resource.

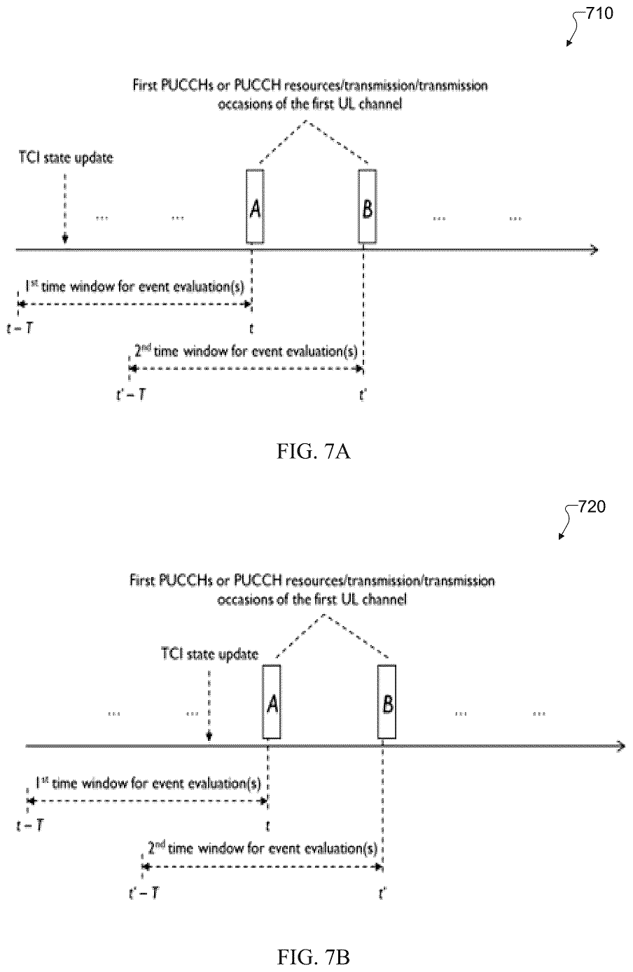

FIGS. 7A and 7B illustrate an example timeline 710 and 720 for time window determination for event evaluations according to embodiments of the present disclosure. For example, timeline 710 and 720 can be followed by the UE 116 of FIG. 3. This example is for illustration only and other embodiments can be used without departing from the scope of the present disclosure.

With reference to FIG. 7A, the TCI state update within the first time window PUCCH A is not transmitted. No TCI state update within the second time window, PUCCH B can be transmitted, if event conditions are satisfied. With reference to FIG. 7B, TCI state update within the first and second time windows, both PUCCH A and PUCCH B are not transmitted.

In one example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t-T (e.g., in form of a slot or a symbol, i.e., slot or symbol t-T or the (t-T)-th slot or symbol) and ending at time t is greater than or equal to a value/number M (e.g., higher layer configured) wherein:
Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure,
   and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based LI signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE (e.g., the UE 116) does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1 within the time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.
The current serving beam RS(s)/RS resource(s) as specified/defined herein in the present disclosure does not change within the time window
   For Scheme-1 specified/defined herein in the present disclosure wherein CSI-RS(s) is the current serving beam RS(s)/RS resource(s), (i) the UE does not receive a TCI state update within the time window, and/or (ii) the UE receives a TCI state update within the time window but the (QCL source) RS(s)/RS resource(s)—e.g., CSI-RS(s)—indicated in/by the TCI state does not change (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE does not receive a TCI state update within the time window, and/or (ii) the UE receives a TCI state update within the time window but the SSB(s) QCL'ed with (e.g., of QCL-TypeD) the CSI-RS(s) indicated in/by the TCI state does not change (in this case, the (QCL source) RS(s)/RS resource(s) of CSI-RS(s) indicated in/by the TCI state may or may not change)
The activation beam RS(s)/RS resource(s) as specified/defined herein in the present disclosure does not change within the time window
   For Scheme-A specified/defined herein in the present disclosure wherein CSI-RS(s) is the activation beam RS(s)/RS resource(s), (i) the UE does not receive an update to/of the corresponding activated TCI state within the time window, and/or (ii) the UE receives an update to/of the corresponding activated TCI state within the time window but the (QCL source) RS(s)/RS resource(s)—e.g., CSI-RS(s)—indicated in/by the activated TCI state does not change (in this case, the SSB(s) QCL'ed with (e.g., of QCL-TypeD) the CSI-RS(s) indicated in/by the activated TCI state may or may not change),
   For Scheme-B specified/defined herein in the present disclosure wherein SSB(s) is the activation beam RS(s)/RS resource(s), (i) the UE does not receive an update to/of the corresponding activated TCI state within the time window, and/or (ii) the UE receives an update to/of the corresponding activated TCI state within the time window but the SSB(s) QCL'ed with (e.g., of QCL-TypeD) the CSI-RS(s) indicated in/by the activated TCI state does not change (in this case, the (QCL source) RS(s)/RS resource(s) of CSI-RS(s) indicated in/by the activated TCI state may or may not change)
The beam failure detection (BFD) RS(s)/RS resource(s) for BFR does not change or the UE does not receive any (re-)configuration e.g. via RRC and/or update e.g. via MAC CE to/of the BFD RS(s)/RS resource(s)—e.g., in BFD RS (resource) set(s) q0, q00 and/or q01—for BFR within the time window
The candidate beam detection (CBD)/new beam identification (NBI) RS(s)/RS resource(s) for BFR does not change or the UE does not receive any (re-)configuration e.g. via RRC and/or update e.g. via MAC CE to/of the CBD/NBI RS(s)/RS resource(s)—e.g., in CBD/NBI RS (resource) set(s) q1, q10 and/or q11—for BFR within the time window
A/the new beam RS index q_new identified/determined from CBD/NBI RS (resource) set(s) q1, q10 and/or q11 for BFR does not change within the time window
The UE does not receive any of the NWR(s) and/or any form(s) of the NWR(s) as specified/defined throughout the present disclosure.

After the determination or identification or declaration of an/the event according to the time window, the UE could transmit or trigger or initiate a transmission of the PN message/trigger over/on/via/in the PUCCH resource or transmission or transmission occasion of the first UL channel at time t. The time duration or length of the time window is T or T−1 or T+1 symbol(s)/slot(s), which could be higher layer configured/provided by the network according to or based on a corresponding UE's capability or capability signaling. One conceptual example of the described design example/procedure herein is presented in FIG. 7. The aforementioned signal(s), channel(s), signaling(s), indication(s), configuration(s), command(s) and/or etc. that the UE receives or does not receive could also be regarded/referred to as NWR(s) in the present disclosure.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t-T (e.g., in form of a slot or a symbol, i.e., slot or symbol t-T or the (t-T)-th slot or symbol) and ending at time t-T′ (e.g., in form of a slot or a symbol, i.e., slot or symbol t-T′ or the (t-T′)-th slot or symbol) is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure,
   and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step−1
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.
The current serving beam RS(s)/RS resource(s) as specified/defined herein in the present disclosure does not change within the time window
   For Scheme-1 specified/defined herein in the present disclosure wherein CSI-RS(s) is the current serving beam RS(s)/RS resource(s), (i) the UE does not receive a TCI state update within the time window, and/or (ii) the UE receives a TCI state update within the time window but the (QCL source) RS(s)/RS resource(s)—e.g., CSI-RS(s)—indicated in/by the TCI state does not change (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE does not receive a TCI state update within the time window, and/or (ii) the UE receives a TCI state update within the time window but the SSB(s) QCL'ed with (e.g., of QCL-TypeD) the CSI-RS(s) indicated in/by the TCI state does not change (in this case, the (QCL source) RS(s)/RS resource(s) of CSI-RS(s) indicated in/by the TCI state may or may not change)
The activation beam RS(s)/RS resource(s) as specified/defined herein in the present disclosure does not change within the time window
   For Scheme-A specified/defined herein in the present disclosure wherein CSI-RS(s) is the activation beam RS(s)/RS resource(s), (i) the UE does not receive an update to/of the corresponding activated TCI state within the time window, and/or (ii) the UE receives an update to/of the corresponding activated TCI state within the time window but the (QCL source) RS(s)/RS resource(s)—e.g., CSI-RS(s)—indicated in/by the activated TCI state does not change (in this case, the SSB(s) QCL'ed with (e.g., of QCL-TypeD) the CSI-RS(s) indicated in/by the activated TCI state may or may not change),
   For Scheme-B specified/defined herein in the present disclosure wherein SSB(s) is the activation beam RS(s)/RS resource(s), (i) the UE does not receive an update to/of the corresponding activated TCI state within the time window, and/or (ii) the UE receives an update to/of the corresponding activated TCI state within the time window but the SSB(s) QCL'ed with (e.g., of QCL-TypeD) the CSI-RS(s) indicated in/by the activated TCI state does not change (in this case, the (QCL source) RS(s)/RS resource(s) of CSI-RS(s) indicated in/by the activated TCI state may or may not change)
The beam failure detection (BFD) RS(s)/RS resource(s) for BFR does not change or the UE does not receive any (re-)configuration e.g. via RRC and/or update e.g. via MAC CE to/of the BFD RS(s)/RS resource(s)—e.g., in BFD RS (resource) set(s) q0, q00 and/or q01—for BFR within the time window
The candidate beam detection (CBD)/new beam identification (NBI) RS(s)/RS resource(s) for BFR does not change or the UE does not receive any (re-)configuration e.g. via RRC and/or update e.g. via MAC CE to/of the CBD/NBI RS(s)/RS resource(s)—e.g., in CBD/NBI RS (resource) set(s) q1, q10 and/or q11—for BFR within the time window
A/the new beam RS index q_new identified/determined from CBD/NBI RS (resource) set(s) q1, q10 and/or q11 for BFR does not change within the time window
The UE does not receive any of the NWR(s) and/or any form(s) of the NWR(s) as specified/defined throughout the present disclosure within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, T′ could be less than or equal to T, and the time duration or length of the time window is (T−T′) or (T−T′−1) or (T+T′ +1) symbol(s)/slot(s), which could be higher layer configured/provided by the network according to or based on a corresponding UE's capability or capability signaling. And, the UE could determine or identify the time gap or duration or offset of T′ or (T′−1) or (T′+1) symbol(s)/slot(s) according to or based on (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling. The aforementioned signal(s), channel(s), signaling(s), indication(s), configuration(s), command(s) and/or etc. that the UE receives or does not receive could also be regarded/referred to as NWR(s) in the present disclosure.

In one example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t-T (e.g., in form of a slot or a symbol, i.e., slot or symbol t-T or the (t-T)-th slot or symbol) and ending at time t is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure,
   and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1 within the time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.
The current serving beam RS(s)/RS resource(s) as specified/defined herein in the present disclosure does not change within the time window
   For Scheme-1 specified/defined herein in the present disclosure wherein CSI-RS(s) is the current serving beam RS(s)/RS resource(s), (i) the UE does not receive a TCI state update within the time window, and/or (ii) the UE receives a TCI state update within the time window but the (QCL source) RS(s)/RS resource(s)—e.g., CSI-RS(s)—indicated in/by the TCI state does not change (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE does not receive a TCI state update within the time window, and/or (ii) the UE receives a TCI state update within the time window but the SSB(s) QCL'ed with (e.g., of QCL-TypeD) the CSI-RS(s) indicated in/by the TCI state does not change (in this case, the (QCL source) RS(s)/RS resource(s) of CSI-RS(s) indicated in/by the TCI state may or may not change)
The activation beam RS(s)/RS resource(s) as specified/defined herein in the present disclosure does not change within the time window
   For Scheme-A specified/defined herein in the present disclosure wherein CSI-RS(s) is the activation beam RS(s)/RS resource(s), (i) the UE does not receive an update to/of the corresponding activated TCI state within the time window, and/or (ii) the UE receives an update to/of the corresponding activated TCI state within the time window but the (QCL source) RS(s)/RS resource(s)—e.g., CSI-RS(s)—indicated in/by the activated TCI state does not change (in this case, the SSB(s) QCL'ed with (e.g., of QCL-TypeD) the CSI-RS(s) indicated in/by the activated TCI state may or may not change),
   For Scheme-B specified/defined herein in the present disclosure wherein SSB(s) is the activation beam RS(s)/RS resource(s), (i) the UE does not receive an update to/of the corresponding activated TCI state within the time window, and/or (ii) the UE receives an update to/of the corresponding activated TCI state within the time window but the SSB(s) QCL'ed with (e.g., of QCL-TypeD) the CSI-RS(s) indicated in/by the activated TCI state does not change (in this case, the (QCL source) RS(s)/RS resource(s) of CSI-RS(s) indicated in/by the activated TCI state may or may not change)
The beam failure detection (BFD) RS(s)/RS resource(s) for BFR does not change or the UE does not receive any (re-)configuration e.g. via RRC and/or update e.g. via MAC CE to/of the BFD RS(s)/RS resource(s)—e.g., in BFD RS (resource) set(s) q0, q00 and/or q01—for BFR within the time window
The candidate beam detection (CBD)/new beam identification (NBI) RS(s)/RS resource(s) for BFR does not change or the UE does not receive any (re-)configuration e.g. via RRC and/or update e.g. via MAC CE to/of the CBD/NBI RS(s)/RS resource(s)—e.g., in CBD/NBI RS (resource) set(s) q1, q10 and/or q11—for BFR within the time window
A/the new beam RS index q_new identified/determined from CBD/NBI RS (resource) set(s) q1, q10 and/or q11 for BFR does not change within the time window
The UE does not receive any of the NWR(s) and/or any form(s) of the NWR(s) as specified/defined throughout the present disclosure within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. The time duration or length of the time window is T or T−1 or T+1 symbol(s)/slot(s), which could be higher layer configured/provided by the network according to or based on a corresponding UE's capability or capability signaling. The aforementioned signal(s), channel(s), signaling(s), indication(s), configuration(s), command(s) and/or etc. that the UE receives or does not receive could also be regarded/referred to as NWR(s) in the present disclosure.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t−T′ (e.g., in form of a slot or a symbol, i.e., slot or symbol t−T′ or the (t−T′)-th slot or symbol) is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure,
   and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1
The UE does not receive reconfiguration/update/addition/removal/release (e.g., via/by/in upper layer(s) and/or RRC signaling(s) and/or MAC CE command(s) and/or dynamic DCI based LI signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.
The current serving beam RS(s)/RS resource(s) as specified/defined herein in the present disclosure does not change within the time window
   For Scheme-1 specified/defined herein in the present disclosure wherein CSI-RS(s) is the current serving beam RS(s)/RS resource(s), (i) the UE does not receive a TCI state update within the time window, and/or (ii) the UE receives a TCI state update within the time window but the (QCL source) RS(s)/RS resource(s)—e.g., CSI-RS(s)—indicated in/by the TCI state does not change (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE does not receive a TCI state update within the time window, and/or (ii) the UE receives a TCI state update within the time window but the SSB(s) QCL'ed with (e.g., of QCL-TypeD) the CSI-RS(s) indicated in/by the TCI state does not change (in this case, the (QCL source) RS(s)/RS resource(s) of CSI-RS(s) indicated in/by the TCI state may or may not change)
The activation beam RS(s)/RS resource(s) as specified/defined herein in the present disclosure does not change within the time window
   For Scheme-A specified/defined herein in the present disclosure wherein CSI-RS(s) is the activation beam RS(s)/RS resource(s), (i) the UE does not receive an update to/of the corresponding activated TCI state within the time window, and/or (ii) the UE receives an update to/of the corresponding activated TCI state within the time window but the (QCL source) RS(s)/RS resource(s)—e.g., CSI-RS(s)—indicated in/by the activated TCI state does not change (in this case, the SSB(s) QCL'ed with (e.g., of QCL-TypeD) the CSI-RS(s) indicated in/by the activated TCI state may or may not change),
   For Scheme-B specified/defined herein in the present disclosure wherein SSB(s) is the activation beam RS(s)/RS resource(s), (i) the UE does not receive an update to/of the corresponding activated TCI state within the time window, and/or (ii) the UE receives an update to/of the corresponding activated TCI state within the time window but the SSB(s) QCL'ed with (e.g., of QCL-TypeD) the CSI-RS(s) indicated in/by the activated TCI state does not change (in this case, the (QCL source) RS(s)/RS resource(s) of CSI-RS(s) indicated in/by the activated TCI state may or may not change)
The beam failure detection (BFD) RS(s)/RS resource(s) for BFR does not change or the UE does not receive any (re-)configuration e.g. via RRC and/or update e.g. via MAC CE to/of the BFD RS(s)/RS resource(s)—e.g., in BFD RS (resource) set(s) q0, q00 and/or q01—for BFR within the time window
The candidate beam detection (CBD)/new beam identification (NBI) RS(s)/RS resource(s) for BFR does not change or the UE does not receive any (re-)configuration e.g. via RRC and/or update e.g. via MAC CE to/of the CBD/NBI RS(s)/RS resource(s)—e.g., in CBD/NBI RS (resource) set(s) q1, q10 and/or q11—for BFR within the time window
A/the new beam RS index q_new identified/determined from CBD/NBI RS (resource) set(s) q1, q10 and/or q11 for BFR does not change within the time window
The UE does not receive any of the NWR(s) and/or any form(s) of the NWR(s) as specified/defined throughout the present disclosure within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. Here, T′ could be less than or equal to T, and the time duration or length of the time window is (T−T′) or (T−T′−1) or (T+T′ +1) symbol(s)/slot(s), which could be higher layer configured/provided by the network according to or based on a corresponding UE's capability or capability signaling. And, the UE could determine or identify the time gap or duration or offset of T′ or (T′−1) or (T′+1) symbol(s)/slot(s) according to or based on (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling. The aforementioned signal(s), channel(s), signaling(s), indication(s), configuration(s), command(s) and/or etc. that the UE receives or does not receive could also be regarded/referred to as NWR(s) in the present disclosure.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel ist, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure,
   and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1 within the time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.
The current serving beam RS(s)/RS resource(s) as specified/defined herein in the present disclosure does not change within the time window
   For Scheme-1 specified/defined herein in the present disclosure wherein CSI-RS(s) is the current serving beam RS(s)/RS resource(s), (i) the UE does not receive a TCI state update within the time window, and/or (ii) the UE receives a TCI state update within the time window but the (QCL source) RS(s)/RS resource(s)—e.g., CSI-RS(s)—indicated in/by the TCI state does not change (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE does not receive a TCI state update within the time window, and/or (ii) the UE receives a TCI state update within the time window but the SSB(s) QCL'ed with (e.g., of QCL-TypeD) the CSI-RS(s) indicated in/by the TCI state does not change (in this case, the (QCL source) RS(s)/RS resource(s) of CSI-RS(s) indicated in/by the TCI state may or may not change)
The activation beam RS(s)/RS resource(s) as specified/defined herein in the present disclosure does not change within the time window
   For Scheme-A specified/defined herein in the present disclosure wherein CSI-RS(s) is the activation beam RS(s)/RS resource(s), (i) the UE does not receive an update to/of the corresponding activated TCI state within the time window, and/or (ii) the UE receives an update to/of the corresponding activated TCI state within the time window but the (QCL source) RS(s)/RS resource(s)—e.g., CSI-RS(s)—indicated in/by the activated TCI state does not change (in this case, the SSB(s) QCL'ed with (e.g., of QCL-TypeD) the CSI-RS(s) indicated in/by the activated TCI state may or may not change),
   For Scheme-B specified/defined herein in the present disclosure wherein SSB(s) is the activation beam RS(s)/RS resource(s), (i) the UE does not receive an update to/of the corresponding activated TCI state within the time window, and/or (ii) the UE receives an update to/of the corresponding activated TCI state within the time window but the SSB(s) QCL'ed with (e.g., of QCL-TypeD) the CSI-RS(s) indicated in/by the activated TCI state does not change (in this case, the (QCL source) RS(s)/RS resource(s) of CSI-RS(s) indicated in/by the activated TCI state may or may not change)
The beam failure detection (BFD) RS(s)/RS resource(s) for BFR does not change or the UE does not receive any (re-)configuration e.g. via RRC and/or update e.g. via MAC CE to/of the BFD RS(s)/RS resource(s)—e.g., in BFD RS (resource) set(s) q0, q00 and/or q01—for BFR within the time window
The candidate beam detection (CBD)/new beam identification (NBI) RS(s)/RS resource(s) for BFR does not change or the UE does not receive any (re-)configuration e.g. via RRC and/or update e.g. via MAC CE to/of the CBD/NBI RS(s)/RS resource(s)—e.g., in CBD/NBI RS (resource) set(s) q1, q10 and/or q11—for BFR within the time window
A/the new beam RS index q_new identified/determined from CBD/NBIRS (resource) set(s) q1, q10 and/or q11 for BFR does not change within the time window
The UE does not receive any of the NWR(s) and/or any form(s) of the NWR(s) as specified/defined throughout the present disclosure within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. The time duration or length of the time window is T or T−1 or T+1 symbol(s)/slot(s), which could be higher layer configured/provided by the network according to or based on a corresponding UE's capability or capability signaling. Furthermore, the reference beam RS or RS resource could be derived from an activated TCI state with the Q-th best beam quality e.g. L1-RSRP among the TCI state(s) activated by/in a (unified) TCI state(s) activation/deactivation MAC CE, wherein the value Q could be higher layer configured by the network according to or based on a corresponding UE's capability or capability signaling.
In one scheme (Scheme-A): the reference beam RS or RS resource could correspond to the (QCL) RS/RS resource in the RS resource set provided or indicated in the activated TCI state (with the Q-th best beam quality)
In another scheme (Scheme-B): the reference beam RS or RS resource could correspond to the SSB which is QCL'ed with the (QCL) RS/RS resource in the RS resource set provided or indicated in the activated TCI state (with the Q-th best beam quality)

The UE could determine or identity which scheme (i.e., Scheme-A or Scheme-B) according to or based on:
Scheme-A when/if the configured new beam RS(s) or RS resource(s) has the same RS type (e.g., a CSI-RS including a TRS—e.g., a CSI-RS in a CSI-RS resource set configured with ‘trs-info’ and/or a CSI-RS in a CSI-RS resource set configured with repetition (e.g., set to ‘on’)—as the (QCL) RS/RS resource in the RS resource set provided or indicated in the activated TCI state (with the Q-th best beam quality), Scheme-B when/if the configured new beam RS(s) or RS resource(s) has the same type (i.e., a SSB) as the SSB which is QCL'ed with the (QCL) RS/RS resource in the RS resource set provided or indicated in the activated TCI state (with the Q-th best beam quality)
Network's configuration(s)/indication(s), e.g., via higher layer RRC signaling(s)/parameter(s) based on or according to a corresponding UE's capability or capability signaling, of Scheme-A or Scheme-B

The aforementioned signal(s), channel(s), signaling(s), indication(s), configuration(s), command(s) and/or etc. that the UE receives or does not receive could also be regarded/referred to as NWR(s) in the present disclosure.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T (e.g., in form of a slot or a symbol, i.e., slot or symbol t−T or the (t−T)-th slot or symbol) and ending at time t−T′ (e.g., in form of a slot or a symbol, i.e., slot or symbol t−T′ or the (t−T′)-th slot or symbol) is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure,
   and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window
The current serving beam RS(s)/RS resource(s) as specified/defined herein in the present disclosure does not change within the time window
   For Scheme-1 specified/defined herein in the present disclosure wherein CSI-RS(s) is the current serving beam RS(s)/RS resource(s), (i) the UE does not receive a TCI state update within the time window, and/or (ii) the UE receives a TCI state update within the time window but the (QCL source) RS(s)/RS resource(s)—e.g., CSI-RS(s)—indicated in/by the TCI state does not change (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE does not receive a TCI state update within the time window, and/or (ii) the UE receives a TCI state update within the time window but the SSB(s) QCL'ed with (e.g., of QCL-TypeD) the CSI-RS(s) indicated in/by the TCI state does not change (in this case, the (QCL source) RS(s)/RS resource(s) of CSI-RS(s) indicated in/by the TCI state may or may not change)
The activation beam RS(s)/RS resource(s) as specified/defined herein in the present disclosure does not change within the time window
   For Scheme-A specified/defined herein in the present disclosure wherein CSI-RS(s) is the activation beam RS(s)/RS resource(s), (i) the UE does not receive an update to/of the corresponding activated TCI state within the time window, and/or (ii) the UE receives an update to/of the corresponding activated TCI state within the time window but the (QCL source) RS(s)/RS resource(s)—e.g., CSI-RS(s)—indicated in/by the activated TCI state does not change (in this case, the SSB(s) QCL'ed with (e.g., of QCL-TypeD) the CSI-RS(s) indicated in/by the activated TCI state may or may not change),
   For Scheme-B specified/defined herein in the present disclosure wherein SSB(s) is the activation beam RS(s)/RS resource(s), (i) the UE does not receive an update to/of the corresponding activated TCI state within the time window, and/or (ii) the UE receives an update to/of the corresponding activated TCI state within the time window but the SSB(s) QCL'ed with (e.g., of QCL-TypeD) the CSI-RS(s) indicated in/by the activated TCI state does not change (in this case, the (QCL source) RS(s)/RS resource(s) of CSI-RS(s) indicated in/by the activated TCI state may or may not change)
The beam failure detection (BFD) RS(s)/RS resource(s) for BFR does not change or the UE does not receive any (re-)configuration e.g. via RRC and/or update e.g. via MAC CE to/of the BFD RS(s)/RS resource(s)—e.g., in BFD RS (resource) set(s) q0, q00 and/or q01—for BFR within the time window
The candidate beam detection (CBD)/new beam identification (NBI) RS(s)/RS resource(s) for BFR does not change or the UE does not receive any (re-)configuration e.g. via RRC and/or update e.g. via MAC CE to/of the CBD/NBI RS(s)/RS resource(s)—e.g., in CBD/NBI RS (resource) set(s) q1, q10 and/or q11—for BFR within the time window
The UE does not receive any of the NWR(s) and/or any form(s) of the NWR(s) as specified/defined throughout the present disclosure within the time window.

A/the new beam RS index q_new identified/determined from CBD/NBI RS (resource) set(s) q1, q10 and/or q11 for BFR does not change within the time window the UE could transmit or trigger or initiate a transmission of the PN message/trigger over/on/via/in the PUCCH resource or transmission or transmission occasion of the first UL channel. Here, T′ could be less than or equal to T, and the time duration or length of the time window is (T−T′) or (T−T′−1) or (T+T′+1) symbol(s)/slot(s), which could be higher layer configured/provided by the network (e.g., the network 130) according to or based on a corresponding UE's capability or capability signaling. And, the UE could determine or identify the time gap or duration or offset of T′ or (T′−1) or (T′+1) symbol(s)/slot(s) according to or based on (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling. Furthermore, the reference beam RS or RS resource could be derived from an activated TCI state with the Q-th best beam quality e.g. L1-RSRP among the TCI state(s) activated by/in a (unified) TCI state(s) activation/deactivation MAC CE, wherein the value Q could be higher layer configured by the network according to or based on a corresponding UE's capability or capability signaling.
In one scheme (Scheme-A): the reference beam RS or RS resource could correspond to the (QCL) RS/RS resource in the RS resource set provided or indicated in the activated TCI state (with the Q-th best beam quality)
In another scheme (Scheme-B): the reference beam RS or RS resource could correspond to the SSB which is QCL'ed with the (QCL) RS/RS resource in the RS resource set provided or indicated in the activated TCI state (with the Q-th best beam quality)

The UE could determine or identity which scheme (i.e., Scheme-A or Scheme-B) according to or based on:
Scheme-A when/if the configured new beam RS(s) or RS resource(s) has the same RS type (e.g., a CSI-RS including a TRS—e.g., a CSI-RS in a CSI-RS resource set configured with ‘trs-info’ and/or a CSI-RS in a CSI-RS resource set configured with repetition (e.g., set to ‘on’)—as the (QCL) RS/RS resource in the RS resource set provided or indicated in the activated TCI state (with the Q-th best beam quality), Scheme-B when/if the configured new beam RS(s) or RS resource(s) has the same type (i.e., a SSB) as the SSB which is QCL'ed with the (QCL) RS/RS resource in the RS resource set provided or indicated in the activated TCI state (with the Q-th best beam quality)
Network's configuration(s)/indication(s), e.g., via higher layer RRC signaling(s)/parameter(s) based on or according to a corresponding UE's capability or capability signaling, of Scheme-A or Scheme-B

The aforementioned signal(s), channel(s), signaling(s), indication(s), configuration(s), command(s) and/or etc. that the UE receives or does not receive could also be regarded/referred to as NWR(s) in the present disclosure.

In another example, for Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could determine or identify or declare an/the event when/if the number/counting of event instance(s) within a time window starting from time t−T−T_proc (e.g., in form of a slot or a symbol, i.e., slot or symbol t−T−T_proc or the (t−T−T_proc)-th slot or symbol) and ending at time t−T_proc is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure,
   and/or when/if one or more of the following conditions are achieved or satisfied:
The UE does not receive a TCI state update within the time window
The UE receives a TCI state update within the time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window
The UE does not receive a (unified) TCI state(s) activation/deactivation MAC CE within the time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window, wherein the UE could determine or identify the value of m according to or following those specified herein in the present disclosure
The UE does not receive any form/format of a beam failure recover response (BFRR) within the time window
The UE or higher layer(s) of the UE does not start (or starts) a prohibit timer as defined/specified herein in the present disclosure within the time window, and/or the prohibit timer expires (or does not expire) within the time window
For Mode-A/Mode-B, the UE does not receive a DCI in Step-2 in response to the transmission of the PN message/trigger in Step-1 within the time window

The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time window
The UE does not receive triggering of aperiodic or semi-persistent CSI measurement and/or reporting (e.g., via a CSI request field in a triggering DCI) within the time window
The UE does not receive activation of semi-persistent CSI measurement and/or reporting (e.g., via SP CSI measurement and/or reporting activation MAC CE(s)) within the time window.
The current serving beam RS(s)/RS resource(s) as specified/defined herein in the present disclosure does not change within the time window
   For Scheme-1 specified/defined herein in the present disclosure wherein CSI-RS(s) is the current serving beam RS(s)/RS resource(s), (i) the UE does not receive a TCI state update within the time window, and/or (ii) the UE receives a TCI state update within the time window but the (QCL source) RS(s)/RS resource(s)—e.g., CSI-RS(s)—indicated in/by the TCI state does not change (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE does not receive a TCI state update within the time window, and/or (ii) the UE receives a TCI state update within the time window but the SSB(s) QCL'ed with (e.g., of QCL-TypeD) the CSI-RS(s) indicated in/by the TCI state does not change (in this case, the (QCL source) RS(s)/RS resource(s) of CSI-RS(s) indicated in/by the TCI state may or may not change)
The activation beam RS(s)/RS resource(s) as specified/defined herein in the present disclosure does not change within the time window
   For Scheme-A specified/defined herein in the present disclosure wherein CSI-RS(s) is the activation beam RS(s)/RS resource(s), (i) the UE does not receive an update to/of the corresponding activated TCI state within the time window, and/or (ii) the UE receives an update to/of the corresponding activated TCI state within the time window but the (QCL source) RS(s)/RS resource(s)—e.g., CSI-RS(s)—indicated in/by the activated TCI state does not change (in this case, the SSB(s) QCL'ed with (e.g., of QCL-TypeD) the CSI-RS(s) indicated in/by the activated TCI state may or may not change),
   For Scheme-B specified/defined herein in the present disclosure wherein SSB(s) is the activation beam RS(s)/RS resource(s), (i) the UE does not receive an update to/of the corresponding activated TCI state within the time window, and/or (ii) the UE receives an update to/of the corresponding activated TCI state within the time window but the SSB(s) QCL'ed with (e.g., of QCL-TypeD) the CSI-RS(s) indicated in/by the activated TCI state does not change (in this case, the (QCL source) RS(s)/RS resource(s) of CSI-RS(s) indicated in/by the activated TCI state may or may not change)
The beam failure detection (BFD) RS(s)/RS resource(s) for BFR does not change or the UE does not receive any (re-)configuration e.g. via RRC and/or update e.g. via MAC CE to/of the BFD RS(s)/RS resource(s)—e.g., in BFD RS (resource) set(s) q0, q00 and/or q01—for BFR within the time window
The candidate beam detection (CBD)/new beam identification (NBI) RS(s)/RS resource(s) for BFR does not change or the UE does not receive any (re-)configuration e.g. via RRC and/or update e.g. via MAC CE to/of the CBD/NBI RS(s)/RS resource(s)—e.g., in CBD/NBI RS (resource) set(s) q1, q10 and/or q11—for BFR within the time window
A/the new beam RS index q_new identified/determined from CBD/NBI RS (resource) set(s) q1, q10 and/or q11 for BFR does not change within the time window
The UE does not receive any of the NWR(s) and/or any form(s) of the NWR(s) as specified/defined throughout the present disclosure within the time window.

After the determination or identification or declaration of an/the event according to the time window, the UE could transmit or trigger or initiate a transmission of the PN message/trigger over/on/via/in the PUCCH resource or transmission or transmission occasion of the first UL channel at time t. The time duration or length of the time window is T or T−1 or T+1 symbol(s)/slot(s), which could be higher layer configured/provided by the network according to or based on a corresponding UE's capability or capability signaling. Here, T_proc could be in slot, symbol, etc., which could represent processing time of PUCCH transmission(s) of the first UL channel including UCI bit(s) preparation and etc. The UE could determine or identify value(s) of T_proc according to or based on one or more of: (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based LI signaling(s) according to or based on or subject to a corresponding UE's capability or capability signaling, and/or (3) a corresponding UE's capability or capability signaling. When/if the UE could not determine or identify or declare an/the event within a first time window starting from time t−T−T_proc and ending at time t−T_proc according to or following those specified herein in the present disclosure: for example, when/if the UE could not identify or determine, within the first time window starting from time t−T−T_proc and ending at time t−T_proc, any candidate/new beam RS(s) or RS resource(s) that satisfies or achieves the event condition(s)—e.g., to satisfy the event condition(s) for a candidate/new beam RS or RS resource, the number/counting of event instance(s) within the first time window should be greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure,
   and/or when/if one or more of the following conditions are achieved or satisfied:
The UE does not receive a TCI state update within the first time window
The UE receives a TCI state update within the first time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the first time window
The UE does not receive a (unified) TCI state(s) activation/deactivation MAC CE within the first time window
The UE (e.g., the UE 116) does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the first time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the first time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the first time window, wherein the UE could determine or identify the value of m according to or following those specified herein in the present disclosure
The UE does not receive any form/format of a beam failure recover response (BFRR) within the first time window
The UE or higher layer(s) of the UE does not start (or starts) a prohibit timer as defined/specified herein in the present disclosure within the first time window, and/or the prohibit timer expires (or does not expire) within the first time window
For Mode-A/Mode-B, the UE does not receive a DCI in Step-2 in response to the transmission of the PN message/trigger in Step-1 within the first time window
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the first time window
The UE does not receive triggering of aperiodic or semi-persistent CSI measurement and/or reporting (e.g., via a CSI request field in a triggering DCI) within the first time window
The UE does not receive activation of semi-persistent CSI measurement and/or reporting (e.g., via SP CSI measurement and/or reporting activation MAC CE(s)) within the first time window;
The current serving beam RS(s)/RS resource(s) as specified/defined herein in the present disclosure does not change within the first time window
   For Scheme-1 specified/defined herein in the present disclosure wherein CSI-RS(s) is the current serving beam RS(s)/RS resource(s), (i) the UE does not receive a TCI state update within the first time window, and/or (ii) the UE receives a TCI state update within the first time window but the (QCL source) RS(s)/RS resource(s)—e.g., CSI-RS(s)—indicated in/by the TCI state does not change (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE does not receive a TCI state update within the first time window, and/or (ii) the UE receives a TCI state update within the first time window but the SSB(s) QCL'ed with (e.g., of QCL-TypeD) the CSI-RS(s) indicated in/by the TCI state does not change (in this case, the (QCL source) RS(s)/RS resource(s) of CSI-RS(s) indicated in/by the TCI state may or may not change)
The activation beam RS(s)/RS resource(s) as specified/defined herein in the present disclosure does not change within the first time window
   For Scheme-A specified/defined herein in the present disclosure wherein CSI-RS(s) is the activation beam RS(s)/RS resource(s), (i) the UE does not receive an update to/of the corresponding activated TCI state within the first time window, and/or (ii) the UE receives an update to/of the corresponding activated TCI state within the first time window but the (QCL source) RS(s)/RS resource(s)—e.g., CSI-RS(s)—indicated in/by the activated TCI state does not change (in this case, the SSB(s) QCL'ed with (e.g., of QCL-TypeD) the CSI-RS(s) indicated in/by the activated TCI state may or may not change),
   For Scheme-B specified/defined herein in the present disclosure wherein SSB(s) is the activation beam RS(s)/RS resource(s), (i) the UE does not receive an update to/of the corresponding activated TCI state within the first time window, and/or (ii) the UE receives an update to/of the corresponding activated TCI state within the first time window but the SSB(s) QCL'ed with (e.g., of QCL-TypeD) the CSI-RS(s) indicated in/by the activated TCI state does not change (in this case, the (QCL source) RS(s)/RS resource(s) of CSI-RS(s) indicated in/by the activated TCI state may or may not change)
The beam failure detection (BFD) RS(s)/RS resource(s) for BFR does not change or the UE does not receive any (re-)configuration e.g. via RRC and/or update e.g. via MAC CE to/of the BFD RS(s)/RS resource(s)—e.g., in BFD RS (resource) set(s) q0, q00 and/or q01—for BFR within the first time window
The candidate beam detection (CBD)/new beam identification (NBI) RS(s)/RS resource(s) for BFR does not change or the UE does not receive any (re-)configuration e.g. via RRC and/or update e.g. via MAC CE to/of the CBD/NBI RS(s)/RS resource(s)—e.g., in CBD/NBI RS (resource) set(s) q1, q10 and/or q11—for BFR within the first time window
A/the new beam RS index q_new identified/determined from CBD/NBI RS (resource) set(s) q1, q10 and/or q11 for BFR does not change within the first time window;
   and for another example, when/if one or more of the following conditions are achieved or satisfied:
The UE receives a TCI state update within the first time window
The UE receives a TCI state update within the first time window, and the (measured) current beam RS/RS resource associated/specific to or determined/identified based on or according to the TCI state update or updated TCI state according to or following those specified herein in the present disclosure is updated/changed in contrast to or different from the previous one
The UE receives reconfiguration/update/addition/removal/release (e.g., via/by/in upper layer(s) and/or RRC signaling(s) and/or MAC CE command(s) and/or dynamic DCI based LI signaling(s)) of the (measured) current beam RS/RS resource associated/specific to or determined/identified based on or according to the indicated TCI state according to or following those specified herein in the present disclosure within the first time window
The UE receives a (unified) TCI state(s) activation/deactivation MAC CE within the first time window
The UE receives a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the first time window
The UE receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the first time window, wherein the UE could determine or identify the value of m according to or following those specified herein in the present disclosure
The UE receives a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the first time window, wherein the UE could determine or identify the value of m according to or following those specified herein in the present disclosure
The UE receives a beam failure recover response (BFRR) within the first time window
The UE or higher layer(s) of the UE starts (or does not start) a prohibit timer as defined/specified herein in the present disclosure within the first time window, and/or the prohibit timer does not expire (or expires) within the first time window
For Mode-A/Mode-B, the UE receives a DCI in Step-2 in response to the transmission of the PN message/trigger in Step-1 within the first time window
The UE receives reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the first time window
The UE receives triggering of aperiodic or semi-persistent CSI measurement and/or reporting (e.g., via a CSI request field in a triggering DCI) within the first time window
The UE receives activation of semi-persistent CSI measurement and/or reporting (e.g., via SP CSI measurement and/or reporting activation MAC CE(s)) within the first time window,
The current serving beam RS(s)/RS resource(s) as specified/defined herein in the present disclosure changes within the first time window
   For Scheme-1 specified/defined herein in the present disclosure wherein CSI-RS(s) is the current serving beam RS(s)/RS resource(s), (i) the UE receives a TCI state update within the first time window, and/or (ii) the UE receives a TCI state update within the time window and the (QCL source) RS(s)/RS resource(s)—e.g., CSI-RS(s)—indicated in/by the TCI state changes (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE receives a TCI state update within the first time window, and/or (ii) the UE receives a TCI state update within the first time window and the SSB(s) QCL'ed with (e.g., of QCL-TypeD) the CSI-RS(s) indicated in/by the TCI state changes (in this case, the (QCL source) RS(s)/RS resource(s) of CSI-RS(s) indicated in/by the TCI state may or may not change)
The activation beam RS(s)/RS resource(s) as specified/defined herein in the present disclosure changes within the first time window
   For Scheme-A specified/defined herein in the present disclosure wherein CSI-RS(s) is the activation beam RS(s)/RS resource(s), (i) the UE receives an update to/of the corresponding activated TCI state within the first time window, and/or (ii) the UE receives an update to/of the corresponding activated TCI state within the first time window and the (QCL source) RS(s)/RS resource(s)—e.g., CSI-RS(s)—indicated in/by the activated TCI state changes (in this case, the SSB(s) QCL'ed with (e.g., of QCL-TypeD) the CSI-RS(s) indicated in/by the activated TCI state may nor may not change),
   For Scheme-B specified/defined herein in the present disclosure wherein SSB(s) is the activation beam RS(s)/RS resource(s), (i) the UE receives an update to/of the corresponding activated TCI state within the first time window, and/or (ii) the UE receives an update to/of the corresponding activated TCI state within the first time window and the SSB(s) QCL'ed with (e.g., of QCL-TypeD) the CSI-RS(s) indicated in/by the activated TCI state changes (in this case, the (QCL source) RS(s)/RS resource(s) of CSI-RS(s) indicated in/by the activated TCI state may or may not change)
The beam failure detection (BFD) RS(s)/RS resource(s) for BFR changes or the UE receives (re-)configuration(s) e.g. via RRC and/or update(s) e.g. via MAC CE to/of the BFD RS(s)/RS resource(s)—e.g., in BFD RS (resource) set(s) q0, q00 and/or q01—for BFR within the first time window
The candidate beam detection (CBD)/new beam identification (NBI) RS(s)/RS resource(s) for BFR changes or the UE receives (re-)configuration(s) e.g. via RRC and/or update(s) e.g. via MAC CE to/of the CBD/NBI RS(s)/RS resource(s)—e.g., in CBD/NBI RS (resource) set(s) q1, q10 and/or q11—for BFR within the first time window
A/the new beam RS index q_new identified/determined from CBD/NBI RS (resource) set(s) q1, q10 and/or q11 for BFR changes within the first time window
The UE does not receive any of the NWR(s) and/or any form(s) of the NWR(s) as specified/defined throughout the present disclosure within the first time window,
   the UE could determine or identify or declare an/the event when/if the number/counting of event instance(s) within a second time window starting from time t−T−T_proc-t_offset (e.g., in form of a slot or a symbol, i.e., slot or symbol t−T−T_proc-t_offset or the (t−T−T_proc-t_offset)-th slot or symbol) and ending at time t−T_proc-t_offset is greater than or equal to a value/number M (e.g., higher layer configured) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure,
   and/or when/if one or more of the following conditions are achieved or satisfied:
The UE does not receive a TCI state update within the second time window
The UE receives a TCI state update within the second time window, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the second time window
The UE does not receive a (unified) TCI state(s) activation/deactivation MAC CE within the second time window
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the second time window
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the second time window, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the second time window, wherein the UE could determine or identify the value of m according to or following those specified herein in the present disclosure
The UE does not receive any form/format of a beam failure recover response (BFRR) within the second time window
The UE or higher layer(s) of the UE does not start (or starts) a prohibit timer as defined/specified herein in the present disclosure within the second time window, and/or the prohibit timer expires (or does not expire) within the second time window
For Mode-A/Mode-B, the UE does not receive a DCI in Step-2 in response to the transmission of the PN message/trigger in Step-1 within the second time window
The UE does not receive reconfiguration/update/addition/removal/release (e.g., via/by/in upper layer(s) and/or RRC signaling(s) and/or MAC CE command(s) and/or dynamic DCI based LI signaling(s)) of new beam RS(s) or RS resource(s) within the second time window
The UE does not receive triggering of aperiodic or semi-persistent CSI measurement and/or reporting (e.g., via a CSI request field in a triggering DCI) within the second time window
The UE does not receive activation of semi-persistent CSI measurement and/or reporting (e.g., via SP CSI measurement and/or reporting activation MAC CE(s)) within the second time window.
The current serving beam RS(s)/RS resource(s) as specified/defined herein in the present disclosure does not change within the second time window
   For Scheme-1 specified/defined herein in the present disclosure wherein CSI-RS(s) is the current serving beam RS(s)/RS resource(s), (i) the UE does not receive a TCI state update within the second time window, and/or (ii) the UE receives a TCI state update within the second time window but the (QCL source) RS(s)/RS resource(s)—e.g., CSI-RS(s)—indicated in/by the TCI state does not change (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE does not receive a TCI state update within the second time window, and/or (ii) the UE receives a TCI state update within the second time window but the SSB(s) QCL'ed with (e.g., of QCL-TypeD) the CSI-RS(s) indicated in/by the TCI state does not change (in this case, the (QCL source) RS(s)/RS resource(s) of CSI-RS(s) indicated in/by the TCI state may or may not change)
The activation beam RS(s)/RS resource(s) as specified/defined herein in the present disclosure does not change within the second time window
   For Scheme-A specified/defined herein in the present disclosure wherein CSI-RS(s) is the activation beam RS(s)/RS resource(s), (i) the UE does not receive an update to/of the corresponding activated TCI state within the second time window, and/or (ii) the UE receives an update to/of the corresponding activated TCI state within the second time window but the (QCL source) RS(s)/RS resource(s)—e.g., CSI-RS(s)—indicated in/by the activated TCI state does not change (in this case, the SSB(s) QCL'ed with (e.g., of QCL-TypeD) the CSI-RS(s) indicated in/by the activated TCI state may or may not change),
   For Scheme-B specified/defined herein in the present disclosure wherein SSB(s) is the activation beam RS(s)/RS resource(s), (i) the UE does not receive an update to/of the corresponding activated TCI state within the second time window, and/or (ii) the UE receives an update to/of the corresponding activated TCI state within the second time window but the SSB(s) QCL'ed with (e.g., of QCL-TypeD) the CSI-RS(s) indicated in/by the activated TCI state does not change (in this case, the (QCL source) RS(s)/RS resource(s) of CSI-RS(s) indicated in/by the activated TCI state may or may not change)
The beam failure detection (BFD) RS(s)/RS resource(s) for BFR does not change or the UE does not receive any (re-)configuration e.g. via RRC and/or update e.g. via MAC CE to/of the BFD RS(s)/RS resource(s)—e.g., in BFD RS (resource) set(s) q0, q00 and/or q01—for BFR within the second time window
The candidate beam detection (CBD)/new beam identification (NBI) RS(s)/RS resource(s) for BFR does not change or the UE does not receive any (re-)configuration e.g. via RRC and/or update e.g. via MAC CE to/of the CBD/NBI RS(s)/RS resource(s)—e.g., in CBD/NBI RS (resource) set(s) q1, q10 and/or q11—for BFR within the second time window
A/the new beam RS index q_new identified/determined from CBD/NBI RS (resource) set(s) q1, q10 and/or q11 for BFR does not change within the second time window
The UE does not receive any of the NWR(s) and/or any form(s) of the NWR(s) as specified/defined throughout the present disclosure within the second time window.

After the determination or identification or declaration of an/the event according to the second time window, the UE could transmit or trigger or initiate a transmission of the PN message/trigger over/on/via/in the PUCCH resource or transmission or transmission occasion of the first UL channel at time t. The UE could determine or identify value(s) of t_offset (e.g., in form/terms of symbol(s)/slot(s)/etc.) according to or based on: (1) fixed rule(s)/value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based LI signaling(s) according to or based on or subject to a corresponding UE's capability or capability signaling, and/or (3) a corresponding UE's capability or capability signaling. For example, candidate value(s) of t_offset could be {1, 2, . . . ,10, 20, 40, . . . } slot(s)/symbol(s)/ms/etc. For another example, t_offset could correspond to one or more of:
Periodicity of the PUCCH resource(s)/transmission(s)/transmission occasion(s) of the first UL channel, e.g., denoted by T_pucch
0 or T_pucch or a value (e.g., in form/terms of number of symbol(s)/slot(s)/ms/etc.) in the range of [0, T_pucch] based on or according to higher layer's configuration(s), wherein T_pucch represents the periodicity of the PUCCH resource(s)/transmission(s)/transmission occasion(s) of the first UL channel
Periodicity of an event evaluation or event evaluation instance for determining an event instance according to or following those specified herein in the present disclosure
Periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure
min {periodicity of a first MO, periodicity of a second MO}
max {periodicity of a first MO, periodicity of a second MO}
max {x ms, min {periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling

The first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). According to or following those specified herein in the present disclosure:
When/if the UE could determine or identify or declare an/the event within a k-th time window starting from time t−T−T_proc-kxt_offset and ending at time t−T_proc-kxt_offset according to or following those specified herein in the present disclosure, the UE could transmit or trigger or initiate a transmission of the PN message/trigger over/on/via/in the PUCCH resource or transmission or transmission occasion of the first UL channel at time t, and/or.
When/if the UE could determine or identify or declare an/the event within a k-th time window starting from time t−T−T_proc-kxt_offset and ending at time t−T_proc-kxt_offset according to or following those specified herein in the present disclosure, the UE may not check or evaluate or assess whether the UE could determine or identify or declare an/the event within a (k+1)-th or (k−1)-th time window starting from time t−T−T_proc-(k+1)×t_offset and ending at time t−T_proc-(k+1)×t_offset according to or following those specified herein in the present disclosure, and/or
When/if the UE could not determine or identify or declare an/the event within a k-th time window starting from time t−T−T_proc-kxt_offset and ending at time t−T_proc-kxt_offset according to or following those specified herein in the present disclosure, the UE could further check or evaluate or assess whether the UE could determine or identify or declare an/the event within a (k+1)-th or (k−1)-th time window starting from time t−T−T_proc-(k+1)×t_offset and ending at time t−T_proc-(k+1)×t_offset according to or following those specified herein in the present disclosure.

In this case, k∈{0, . . . , Kmax}, wherein the UE could determine or identify vaue(s) of k and/or Kmax according to or based on: 1) fixed value(s) in system specification(s) and/or per RRC (re-)configuration, (2) network's configuration(s) and/or indication(s) via/by higher layer RRC signaling(s)/parameter(s) and/or MAC CE command(s) and/or dynamic DCI based L1 signaling(s) according to or based on or subject to a corresponding UE's capability or capability signaling, and/or (3) a corresponding UE's capability or capability signaling.
In one example, the starting time t−T−T_proc-(Kmax+1)×t_offset of the Kmax-th time window could be no earlier than t−2×T−T_proc, and/or the ending time t−T_proc-(Kmax+1)×t_offset of the Kmax-th time window could be no earlier than t−T−T_proc.
In another example, the ending time t−T_proc-(Kmax+1)×t_offset of the Kmax-th time window could be no earlier than t−T_pucch-T_proc, wherein T_pucch (e.g., in form/terms of symbol(s)/slot(s)/etc.) represents the periodicity of/for the PUCCH resource(s).

The (second) time window(s) here can also be referred to as sliding time window(s) with a time offset t_offset. The aforementioned signal(s), channel(s), signaling(s), indication(s), configuration(s), command(s) and/or etc. that the UE receives or does not receive could also be regarded/referred to as NWR(s) in the present disclosure.

In another example, when/if a UE has determined or identified or declared an event instance wherein:
for Event-1, the event instance could be associated/specific to at least one (same) new/candidate beam RS/RS resource according to or following those specified herein in the present disclosure
for Event-2, the event instance could be associated/specific to the current beam RS/RS resource according to or following those specified herein in the present disclosure
for Event-3, the event instance could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure,
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure
(higher layer(s) of) the UE could start a time window/timer;
according to or following those specified herein in the present disclosure, when/if (higher layer(s) of) the UE has determined or identified the aforementioned event instance before end of the time window and/or within the time window (e.g., before the last symbol/slot/etc. of the time window, wherein duration/length of the time window could be higher layer configured) and/or before the timer expires, (higher layer(s) of) the UE could increment an event instance count/counting for or of or specific to the new beam RS or RS resource by one;
before end of the time window and/or within the time window (e.g., before the last symbol/slot/etc. of the time window, wherein duration/length of the time window could be higher layer configured) and/or before the timer expires, when/if (higher layer(s) of) the UE has determined or identified that the number of the event instance(s) and/or the event instance count(s)/counting(s) is greater than or equal to maxCount (e.g., higher layer configured), (higher layer(s) of) the UE could determine or identify or declare a potential/candidate event occurrence.

For Mode-A, Mode-B and/or Mode-C as specified/defined herein in the present disclosure, for or with respect to or regarding or with a reference to a PUCCH resource or transmission or transmission occasion at time t (e.g., in form of a slot or a symbol, i.e., slot or symbol t or the t-th slot or symbol) of the first UL channel—e.g., the first (or last) symbol/slot/etc. of transmitting the PUCCH resource or the PUCCH transmission or the PUCCH transmission occasion of the first UL channel is t, the UE could first determine or identify a time duration starting from time t−T_du-T_proc (e.g., in form of a slot or a symbol, i.e., slot or symbol t−T_du-T_proc or the (t−T_du-T_proc)-th slot or symbol) and ending at time t−T_proc—e.g., the time duration here could be associated/specific/corresponding to the PUCCH resource or transmission or transmission occasion at time t. The UE (e.g., higher layer(s) of the UE) could determine or identify or declare an/the event when/if (higher layer(s) of) the UE could determine or identify or declare at least one potential/candidate event occurrence (or one or more potential/candidate event occurrences) according to or following those specified or described herein in the present disclosure within the aforementioned time duration associated/specific/corresponding to the PUCCH resource or transmission or transmission occasion at time t—for instance, the start of the time window(s)/timer(s) used to determine or identify or declare the at least one (or the one or more) potential/candidate event occurrence(s) could be after or no earlier than the start of the time duration; and/or
the end of the time window(s) used to determine or identify or declare the at least one (or the one or more) potential/candidate event occurrence(s) could be before or no later than the end of the time duration, or the timer(s) used to determine or identify or declare the at least one (or the one or more) potential/candidate event occurrence(s) may not expire or may not be expired before or no later than the end of the time duration; and/or
the time window(s) used to determine or identify or declare the at least one (or the one or more) potential/candidate event occurrence(s) could be within the time duration
   and/or when/if one or more of the following conditions are achieved or satisfied:
The UE does not receive a TCI state update within the time duration
The UE receives a TCI state update within the time duration, and the (measured) current beam RS/RS resource associated/specific to or determined/identified based on or according to the TCI state update or updated TCI state according to or following those specified herein in the present disclosure is not updated/changed in contrast to or different from the previous one
The UE does not receive reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time duration
The UE does not receive a (unified) TCI state(s) activation/deactivation MAC CE within the time duration
The UE does not receive a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time duration
The UE does not receive a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time duration, wherein the UE could determine or identify the value of m according to or following those specified herein in the present disclosure
The UE does not receive a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time duration, wherein the UE could determine or identify the value of m according to or following those specified herein in the present disclosure
The UE does not receive any form/format of a beam failure recover response (BFRR) within the time duration
The UE or higher layer(s) of the UE does not start (or starts) a prohibit timer as defined/specified herein in the present disclosure within the time duration, and/or the prohibit timer expires (or does not expire) within the time duration
For Mode-A/Mode-B, the UE does not receive a DCI in Step-2 in response to the transmission of the PN message/trigger in Step-1 within the time duration
The UE does not receive reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s) within the time duration
The UE does not receive triggering of aperiodic or semi-persistent CSI measurement and/or reporting (e.g., via a CSI request field in a triggering DCI) within the time duration
The UE does not receive activation of semi-persistent CSI measurement and/or reporting (e.g., via SP CSI measurement and/or reporting activation MAC CE(s)) within the time duration.
The current serving beam RS(s)/RS resource(s) as specified/defined herein in the present disclosure does not change within the time duration
   For Scheme-1 specified/defined herein in the present disclosure wherein CSI-RS(s) is the current serving beam RS(s)/RS resource(s), (i) the UE does not receive a TCI state update within the time duration, and/or (ii) the UE receives a TCI state update within the time duration but the (QCL source) RS(s)/RS resource(s)—e.g., CSI-RS(s)—indicated in/by the TCI state does not change (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE does not receive a TCI state update within the time duration, and/or (ii) the UE receives a TCI state update within the time duration but the SSB(s) QCL'ed with (e.g., of QCL-TypeD) the CSI-RS(s) indicated in/by the TCI state does not change (in this case, the (QCL source) RS(s)/RS resource(s) of CSI-RS(s) indicated in/by the TCI state may or may not change)
The activation beam RS(s)/RS resource(s) as specified/defined herein in the present disclosure does not change within the time duration
   For Scheme-A specified/defined herein in the present disclosure wherein CSI-RS(s) is the activation beam RS(s)/RS resource(s), (i) the UE does not receive an update to/of the corresponding activated TCI state within the time duration, and/or (ii) the UE receives an update to/of the corresponding activated TCI state within the time duration but the (QCL source) RS(s)/RS resource(s)—e.g., CSI-RS(s)—indicated in/by the activated TCI state does not change (in this case, the SSB(s) QCL'ed with (e.g., of QCL-TypeD) the CSI-RS(s) indicated in/by the activated TCI state may or may not change),
   For Scheme-B specified/defined herein in the present disclosure wherein SSB(s) is the activation beam RS(s)/RS resource(s), (i) the UE does not receive an update to/of the corresponding activated TCI state within the time duration, and/or (ii) the UE receives an update to/of the corresponding activated TCI state within the time duration but the SSB(s) QCL'ed with (e.g., of QCL-TypeD) the CSI-RS(s) indicated in/by the activated TCI state does not change (in this case, the (QCL source) RS(s)/RS resource(s) of CSI-RS(s) indicated in/by the activated TCI state may or may not change)
The beam failure detection (BFD) RS(s)/RS resource(s) for BFR does not change or the UE does not receive any (re-)configuration e.g. via RRC and/or update e.g. via MAC CE to/of the BFD RS(s)/RS resource(s)—e.g., in BFD RS (resource) set(s) q0, q00 and/or q01—for BFR within the time duration
The candidate beam detection (CBD)/new beam identification (NBI) RS(s)/RS resource(s) for BFR does not change or the UE does not receive any (re-)configuration e.g. via RRC and/or update e.g. via MAC CE to/of the CBD/NBI RS(s)/RS resource(s)—e.g., in CBD/NBI RS (resource) set(s) q1, q10 and/or q11—for BFR within the time duration
A/the new beam RS index q_new identified/determined from CBD/NBI RS (resource) set(s) q1, q10 and/or q11 for BFR does not change within the time duration
The UE does not receive any of the NWR(s) and/or any form(s) of the NWR(s) as specified/defined throughout the present disclosure within the time duration.

After the determination or identification or declaration of an/the event according to the time duration, the UE could transmit or trigger or initiate a transmission of the PN message/trigger over/on/via/in the PUCCH resource or transmission or transmission occasion of the first UL channel at time t. The UE could determine or identify value(s) of the time duration and/or T_du according to or following: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, (iii) a corresponding UE's capability or capability signaling, and/or (iv) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
For example, T_du could correspond to or higher layer configured as T_pucch, wherein T_pucch represents the periodicity of the PUCCH resource(s)/transmission(s)/transmission occasion(s) of the first UL channel.
For another example, T_du could correspond to or higher layer configured as 0 or T_pucch or a value (e.g., in form/terms of number of symbol(s)/slot(s)/ms/etc.) in the range of [0, T_pucch], wherein T_pucch represents the periodicity of the PUCCH resource(s)/transmission(s)/transmission occasion(s) of the first UL channel.
For another example, T_du could correspond to or higher layer configured as the periodicity of an event evaluation or event evaluation instance for determining an event instance according to or following those specified herein in the present disclosure
For another example, T_du could correspond to or higher layer configured as the periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure
For another example, T_du could correspond to or higher layer configured as min {periodicity of a first MO, periodicity of a second MO}
For another example, T_du could correspond to or higher layer configured as max {periodicity of a first MO, periodicity of a second MO}
For another example, T_du could correspond to or higher layer configured as max {x ms, min {periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling

The first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). Furthermore, according to or following those specified herein in the present disclosure, i.e., for the operation(s) in Mode-A, Mode-B and/or Mode-C as specified/defined herein in the present disclosure, the UE could send or transmit to the network beam report(s)—e.g., via/in/by the (CG/DG) PUSCH resource(s) of the second UL channel-associated/specific to the transmission or triggering or initiation of the transmission of the PN message/trigger over/on/via/in the PUCCH resource or transmission or transmission occasion of the first UL channel at time t. In this case, the UE could determine or identify report content(s)/quantity(s) including at least SSBRI(s)/CRI(s) and/or L1-RSRP(s)/L1-SINR(s) of the beam report(s) based on or according to at least the new/candidate beam RS(s)/RS resource(s) associated or specific or corresponding to the potential/candidate event occurrence(s) determined or identified or declared by (higher layer(s) of) the UE within the time duration specific/corresponding/associated to the PUCCH resource or transmission or transmission occasion of the first UL channel at time t. For this design example, the time window(s) associated/specific to the event instance(s) wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure,
   could correspond to or could be sliding time window(s) as specified/defined herein in the present disclosure. The aforementioned signal(s), channel(s), signaling(s), indication(s), configuration(s), command(s) and/or etc. that the UE receives or does not receive could also be regarded/referred to as NWR(s) in the present disclosure.

Throughout the present disclosure, when/if (higher layer(s) of) the UE starts a time window/timer of or for or specific to a new/candidate beam RS/RS resource for determining or identifying or declaring event instance(s) according to or following those specified herein in the present disclosure,
In one example, before the end of the time window or before the timer expires, (higher layer(s) of) the UE may not start another time window/timer of or for or specific to a/the same new/candidate beam RS/RS resource for determining or identifying or declaring event instance(s) according to or following those specified herein in the present disclosure; i.e., (higher layer(s) of) the UE may start another time window/timer of or for or specific to a/the same new/candidate beam RS/RS resource for determining or identifying or declaring event instance(s) according to or following those specified herein in the present disclosure no earlier than the end of the time window or the expiration of the timer.
In another example, after (higher layer(s)) of the UE has started the time window/timer, (higher layer(s) of) the UE could start a prohibit timer specific/corresponding/associated to the time window/timer. In this case, when/if the prohibit timer is running, (higher layer(s) of) the UE may not start another time window/timer of or for or specific to a/the same new/candidate beam RS/RS resource for determining or identifying or declaring event instance(s) according to or following those specified herein in the present disclosure; i.e., (higher layer(s) of) the UE may not start another time window/timer of or for or specific to a/the same new/candidate beam RS/RS resource for determining or identifying or declaring event instance(s) according to or following those specified herein in the present disclosure before the expiration of the prohibit timer. The UE could determine or identify value(s)/duration(s)/length(s) of the prohibit timer (e.g., in slot(s)/symbol(s)/ms/etc.) based on or according to: (i) fixed value(s) in system specification(s) and/or per RRC (re-)configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, (iii) a corresponding UE's capability or capability signaling, and/or (iv) UE's autonomous determination/selection, which could be further sent to the network (e.g., the network 130) via various UL channels/signals including PUCCH(s), PUSCH(s), PRACH(s), and/or etc., e.g., in part of a CSI/beam report and/or UE's capability signaling(s).

Throughout the present disclosure, a time duration, a time window, a time offset, a time gap and/or etc. could be equivalent such that they can be used in an exchangeable manner.

Throughout the present disclosure, any time duration, time length, time window, time gap or time offset could be in form/terms of (number of) slot(s)/symbol(s) or milli-second, i.e., ms. Furthermore, throughout the present disclosure, within a time window/duration as specified/defined herein in the present disclosure, (higher layer(s) of) the UE could reset the counting of event instance(s), e.g., to zero, when/if one or more of the following conditions are achieved or satisfied:
The UE receives a TCI state update within the time window/duration
The UE receives a TCI state update within the time window/duration, and the (measured) current beam RS/RS resource associated/specific to or determined/identified based on or according to the TCI state update or updated TCI state according to or following those specified herein in the present disclosure is updated/changed in contrast to or different from the previous one
The UE receives reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure within the time window/duration
The UE receives a (unified) TCI state(s) activation/deactivation MAC CE within the time window/duration
The UE receives a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure within the time window/duration
The UE receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure within the time window/duration, wherein the UE could determine or identify the value of m according to or following those specified herein in the present disclosure
The UE receives a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure within the time window/duration, wherein the UE could determine or identify the value of m according to or following those specified herein in the present disclosure
The UE receives a beam failure recover response (BFRR) within the time window/duration
The UE or higher layer(s) of the UE starts (or does not start) a prohibit timer as defined/specified herein in the present disclosure within the time window/duration, and/or the prohibit timer does not expire (or expires) within the time window/duration
For Mode-A/Mode-B, the UE receives a DCI in Step-2 in response to the transmission of the PN message/trigger in Step-1 within the time window/duration
The UE receives reconfiguration/update/addition/removal/release (e.g., via/by/in upper layer(s) and/or RRC signaling(s) and/or MAC CE command(s) and/or dynamic DCI based LI signaling(s)) of new beam RS(s) or RS resource(s) within the time window/duration
The UE receives triggering of aperiodic or semi-persistent CSI measurement and/or reporting (e.g., via a CSI request field in a triggering DCI) within the time window/duration
The UE receives activation of semi-persistent CSI measurement and/or reporting (e.g., via SP CSI measurement and/or reporting activation MAC CE(s)) within the time window/duration,
The current serving beam RS(s)/RS resource(s) as specified/defined herein in the present disclosure changes within the time window/duration
   For Scheme-1 specified/defined herein in the present disclosure wherein CSI-RS(s) is the current serving beam RS(s)/RS resource(s), (i) the UE receives a TCI state update within the time window/duration, and/or (ii) the UE receives a TCI state update within the time window/duration and the (QCL source) RS(s)/RS resource(s)—e.g., CSI-RS(s)—indicated in/by the TCI state changes (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), (i) the UE receives a TCI state update within the time window/duration, and/or (ii) the UE receives a TCI state update within the time window/duration and the SSB(s) QCL'ed with (e.g., of QCL-TypeD) the CSI-RS(s) indicated in/by the TCI state changes (in this case, the (QCL source) RS(s)/RS resource(s) of CSI-RS(s) indicated in/by the TCI state may or may not change)
The activation beam RS(s)/RS resource(s) as specified/defined herein in the present disclosure changes within the time window/duration
   For Scheme-A specified/defined herein in the present disclosure wherein CSI-RS(s) is the activation beam RS(s)/RS resource(s), (i) the UE receives an update to/of the corresponding activated TCI state within the time window/duration, and/or (ii) the UE receives an update to/of the corresponding activated TCI state within the time window/duration and the (QCL source) RS(s)/RS resource(s)—e.g., CSI-RS(s)—indicated in/by the activated TCI state changes (in this case, the SSB(s) QCL'ed with (e.g., of QCL-TypeD) the CSI-RS(s) indicated in/by the activated TCI state may nor may not change),
   For Scheme-B specified/defined herein in the present disclosure wherein SSB(s) is the activation beam RS(s)/RS resource(s), (i) the UE receives an update to/of the corresponding activated TCI state within the time window/duration, and/or (ii) the UE receives an update to/of the corresponding activated TCI state within the time window/duration and the SSB(s) QCL'ed with (e.g., of QCL-TypeD) the CSI-RS(s) indicated in/by the activated TCI state changes (in this case, the (QCL source) RS(s)/RS resource(s) of CSI-RS(s) indicated in/by the activated TCI state may or may not change)
The beam failure detection (BFD) RS(s)/RS resource(s) for BFR changes or the UE receives (re-)configuration(s) e.g. via RRC and/or update(s) e.g. via MAC CE to/of the BFD RS(s)/RS resource(s)—e.g., in BFD RS (resource) set(s) q0, q00 and/or q01—for BFR within the time window/duration
The candidate beam detection (CBD)/new beam identification (NBI) RS(s)/RS resource(s) for BFR changes or the UE receives (re-)configuration(s) e.g. via RRC and/or update(s) e.g. via MAC CE to/of the CBD/NBI RS(s)/RS resource(s)—e.g., in CBD/NBI RS (resource) set(s) q1, q10 and/or q11—for BFR within the time window/duration
A/the new beam RS index q_new identified/determined from CBD/NBI RS (resource) set(s) q1, q10 and/or q11 for BFR changes within the time window/duration
The UE receives from the network a NWR (in any form(s)) as specified/defined throughout the present disclosure within the time window/duration,
   wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure.
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure.

The aforementioned signal(s), channel(s), signaling(s), indication(s), configuration(s), command(s) and/or etc. that the UE receives or does not receive could also be regarded/referred to as NWR(s) in the present disclosure.

For the described or specified design examples in the present disclosure, the UE could perform or conduct or carry out or do the aforementioned determination or identification or declaration of an/the event, and/or instance(s) of the aforementioned determination or identification or declaration of an/the event could be:
for each periodic PUCCH resource or transmission or transmission occasion of the first UL channel
based on or according to (i) fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling
with a periodicity, wherein
   periodicity could be the same as the periodicity of the PUCCH resource(s)/transmission(s)/transmission occasion(s) of the first UL channel
   the periodicity could be a fixed value in system specification(s) and/or per RRC (re-)configuration
   the periodicity could be determined by the UE and subject to a corresponding UE's capability/capability signaling
   the periodicity could be based on or according to network's configuration(s)/indication(s) via higher layer RRC signaling(s)/parameter(s) and/or MAC CE command(s) and/or dynamic DCI based L1 signaling(s) according to or based on a corresponding UE's capability or capability signaling
with a (minimum) time gap/offset between two adjacent or neighboring instances of determination or identification or declaration of an/the event, wherein
   the (minimum) time gap/offset could be the same as the periodicity of the PUCCH resource(s)/transmission(s)/transmission occasion(s) of the first UL channel
   the (minimum) time gap/offset could be a fixed value in system specification(s) and/or per RRC (re-)configuration
   the (minimum) time gap/offset could be determined by the UE and subject to a corresponding UE's capability/capability signaling
   the (minimum) time gap/offset could be based on or according to network's configuration(s)/indication(s) via higher layer RRC signaling(s)/parameter(s) and/or MAC CE command(s) and/or dynamic DCI based LI signaling(s) according to or based on a corresponding UE's capability or capability signaling

For the described or specified design examples in the present disclosure, within the time window, when/if the UE
receives a TCI state update
receives a TCI state update, and the (measured) current beam RS/RS resource associated/specific to or determined/identified based on or according to the TCI state update or updated TCI state according to or following those specified herein in the present disclosure is updated/changed in contrast to or different from the previous one
receives reconfiguration/update/addition/removal/release (e.g., via/by/in upper layer(s) and/or RRC signaling(s) and/or MAC CE command(s) and/or dynamic DCI based L1 signaling(s)) of the (measured) current beam RS/RS resource associated/specific to or determined/identified based on or according to the indicated TCI state according to or following those specified herein in the present disclosure
receives a (unified) TCI state(s) activation/deactivation MAC CE
receives a (unified) TCI state(s) activation/deactivation MAC CE that activates or updates the activation beam RS(s)/RS resource(s), and therefore, the corresponding activated beam(s)/TCI state(s), used for determining or identifying the Event-3 and Event-3 instance(s) according to or following those specified herein in the present disclosure
receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command according to or following those specified herein in the present disclosure, wherein the UE could determine or identify the value of m according to or following those specified herein in the present disclosure
receives a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as LI-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure, wherein the UE could determine or identify the value of m according to or following those specified herein in the present disclosure
receives a beam failure recover response (BFRR)
starts (or does not start) a prohibit timer as defined/specified herein in the present disclosure, and/or the prohibit timer does not expire (or expires)
for Mode-A/Mode-B, receives a DCI in Step-2 in response to the transmission of the PN message/trigger in Step-1
receives reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s)
receives triggering of aperiodic or semi-persistent CSI measurement and/or reporting (e.g., via a CSI request field in a triggering DCI)
receives activation of semi-persistent CSI measurement and/or reporting (e.g., via SP CSI measurement and/or reporting activation MAC CE(s))
receives a change/update to/of the current serving beam RS(s)/RS resource(s) as specified/defined herein in the present disclosure
   For Scheme-1 specified/defined herein in the present disclosure wherein CSI-RS(s) is the current serving beam RS(s)/RS resource(s), the UE receives (i) a TCI state update, and/or (ii) a TCI state update with a change/update to/of the (QCL source) RS(s)/RS resource(s)—e.g., CSI-RS(s)—indicated in/by the TCI state (in this case, the SSB(s) QCL'ed with (e.g., of QCL-TypeD) the CSI-RS(s) indicated in/by the TCI state may or may not change),
   For Scheme-2 specified/defined herein in the present disclosure wherein SSB(s) is the current serving beam RS(s)/RS resource(s), the UE receives (i) a TCI state update, and/or (ii) a TCI state update with a change/update to/of the SSB(s) QCL'ed with (e.g., of QCL-TypeD) the CSI-RS(s) indicated in/by the TCI state (in this case, the (QCL source) RS(s)/RS resource(s) of CSI-RS(s) indicated in/by the TCI state may or may not change)
receives a change/update to/of the activation beam RS(s)/RS resource(s) as specified/defined herein in the present disclosure changes
   For Scheme-A specified/defined herein in the present disclosure wherein CSI-RS(s) is the activation beam RS(s)/RS resource(s), the UE receives (i) an update to/of the corresponding activated TCI state, and/or (ii) an update to/of the corresponding activated TCI state with a change/update to/of the (QCL source) RS(s)/RS resource(s)—e.g., CSI-RS(s)—indicated in/by the activated TCI state (in this case, the SSB(s) QCL'ed with (e.g., of QCL-TypeD) the CSI-RS(s) indicated in/by the activated TCI state may nor may not change),
   For Scheme-B specified/defined herein in the present disclosure wherein SSB(s) is the activation beam RS(s)/RS resource(s), the UE receives (i) an update to/of the corresponding activated TCI state, and/or (ii) an update to/of the corresponding activated TCI state with a change/update to/of the SSB(s) QCL'ed with (e.g., of QCL-TypeD) the CSI-RS(s) indicated in/by the activated TCI state (in this case, the (QCL source) RS(s)/RS resource(s) of CSI-RS(s) indicated in/by the activated TCI state may or may not change)
receives (re-)configuration(s) e.g. via RRC and/or update(s) e.g. via MAC CE and/or change(s) to/of the beam failure detection (BFD) RS(s)/RS resource(s)—e.g., in BFD RS (resource) set(s) q0, q00 and/or q01—for BFR
receives (re-)configuration(s) e.g. via RRC and/or update(s) e.g. via MAC CE and/or change(s) to/of the candidate beam detection (CBD)/new beam identification (NBI) RS(s)/RS resource(s)—e.g., in CBD/NBI RS (resource) set(s) q1, q10 and/or q11—for BFR
receives a change/update to/of a/the new beam RS index q_new identified/determined from CBD/NBI RS (resource) set(s) q1, q10 and/or q11 for BFR
receives an NWR (in any form(s)) as specified/defined throughout the present disclosure
   the UE could reset the number/counting of the event instance(s) determined or identified or declared
within the corresponding time window
before the reception of the TCI state update
before the reception of the (unified) TCI state(s) activation/deactivation MAC CE
for Mode-A/Mode-B, before the reception of the DCI in Step-2 in response to the transmission of the PN message/trigger in Step-1
before the reception of the reconfiguration of new beam RS(s) or RS resource(s)
before the reception of the triggering of aperiodic or semi-persistent CSI measurement and/or reporting (e.g., via a CSI request field in a triggering DCI)
before the reception of the activation of semi-persistent CSI measurement and/or reporting (e.g., via SP CSI measurement and/or reporting activation MAC CE(s))
   to zero, wherein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure.
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure.

The aforementioned signal(s), channel(s), signaling(s), indication(s), configuration(s), command(s) and/or etc. that the UE receives or does not receive could also be regarded/referred to as NWR(s) in the present disclosure.

In one example, for one or more RSs or RS resources each corresponding to one or more of: (1) a (same) new/candidate beam RS/RS resource (e.g., for Event-1 or Event-3 or Event-4 or Event-5 or Event-6 or Event-7), (2) the current beam RS/RS resource (e.g., for Event-2 or Event-5 or Event-6 or Event-7), (3) (a pair of) a (same) new/candidate beam RS/RS resource and a (same) activation beam RS/RS resource (or equivalently, a (same) activated beam/TCI state)—e.g., for Event-3, the MAC entity of/for a UE (e.g., the UE 116) could or shall for each Serving Cell configured/enabled for UE-initiated/event-driven beam reporting according to those specified herein in the present disclosure:
1> to initiate or trigger a UEI/event-driven beam reporting based on or according to detection or declaration or determination of an event (e.g., Event-1, Event-2, Event-3, Event-4, Event-5, Event-6 and/or Event-7 in the present disclosure), e.g., to transmit or trigger or initiate a transmission of the PN message/trigger over/on/via/in the PUCCH resource or PUCCH transmission or PUCCH transmission occasion of the first UL channel in Mode A and/or Mode B and/or Mode C at time t:
   2> if an indication for an event instance (e.g., an Event-1 instance or an Event-2 instance or an Event-3 instance or an Event-4 instance or an Event-5 instance or an Event-6 instance or an Event-7 instance)) associated/specific to the one or more RSs or RS resources determined or identified according to or following those specified herein in the present disclosure has been received from lower layers:
      3> start or restart an EventInstanceDetectionTimer (higher layer configured for the event-when/if applicable), e.g., associated/specific to the one or more RSs or RS resources;
      3> increment an EventInstanceCounter (higher layer configured for the event-when/if applicable), e.g., associated/specific to the one or more RSs or RS resources by 1;
      3> if EventInstanceCounter>=EventInstanceMaxCount (higher layer configured for the event-when/if applicable), identify or determine or detect or declare a first potential/candidate event occurrence, e.g., associated/specific to the one or more RSs or RS resources, according to or following those specified herein in the present disclosure:
         4> if the identification or determination or detection or declaration of the first potential/candidate event occurrence is within a time duration starting from time t−T_du-T_proc (e.g., in form of a slot or a symbol, i.e., slot or symbol t−T_du-T_proc or the (t−T_du-T_proc)-th slot or symbol) and ending at time t−T_proc—e.g., the time duration here could be associated/specific/corresponding to the PUCCH resource or transmission or transmission occasion of the first UL channel in Mode-A and/or Mode-B and/or Mode-C at time t, wherein T_du, T_proc and/or etc. could be determine or identified according to or following those specified herein in the present disclosure, and/or
         4> if there is no other potential/candidate event occurrence(s), e.g., associated/specific to the same one or more RSs or RS resources, identified or determined within the aforementioned time window starting from time t−T_du-T_proc (e.g., in form of a slot or a symbol, i.e., slot or symbol t−T_du-T_proc or the (t−T_du-T_proc)-th slot or symbol) and ending at time t−T_proc and later in time than the identification or determination or detection of the first potential/candidate event occurrence
         5> trigger or initiate a transmission of the PN message/trigger over/on/via/in the PUCCH resource or PUCCH transmission or PUCCH transmission occasion of the first UL channel at time t according to or based on (identification, determination, detection or declaration of) at least the first potential/candidate event occurrence, wherein the report content(s)/quantity(s) in the UEI beam report(s) could be determined or identified according to or based on (identification, determination, detection or declaration of) at least the first potential/candidate event occurrence (hence, the one or more RSs or RS resources associated/specific to the first potential/candidate event occurrence);
   2> if one or more of the following conditions are satisfied or achieved:
      the EventInstance DetectionTimer, e.g., associated/specific to the one or more RSs or RS resources, expires
      the UE receives a TCI state update
      the UE receives a (unified) TCI state(s) activation/deactivation MAC CE
      the UE receives a (unified) TCI state(s) activation/deactivation MAC CE that activates or updates the activation beam RS(s)/RS resource(s), and therefore, the corresponding activated beam(s)/TCI state(s), used for determining or identifying the first candidate/potential event occurrence according to or following those specified herein in the present disclosure
      the UE receives a (unified) TCI state(s) activation/deactivation MAC CE that activates or updates at least one activation beam RS/RS resource that has the m-th lowest/highest measured beam quality/metric such as L1-RSRP(s)/L1-SINR(s) among the activation beam RSs or RS resources corresponding, specific or associated to the activated beams/TCI states in the (unified) TCI state(s) activation/deactivation MAC CE command used for determining or identifying the first candidate/potential event occurrence according to or following those specified herein in the present disclosure, wherein the UE could determine or identify the value of m according to or following those specified herein in the present disclosure
      the UE receives a (unified) TCI state(s) activation/deactivation MAC CE that activates or updates at least one activated beam/TCI state among the activated beams/TCI states in the (unified) TCI state(s) activation/deactivation MAC CE command that has the m-th lowest/highest measured beam quality/metric such as L1-RSRP(s)/L1-SINR(s)—e.g., obtained by measuring, assessing or evaluating activation beam RS(s)/RS resource(s) associated/specific to the activated beam(s)/TCI state(s) according to or following those specified herein in the present disclosure-used for determining or identifying the first candidate/potential event occurrence, wherein the UE could determine or identify the value of m according to or following those specified herein in the present disclosure
      the UE receives a beam failure recover response (BFRR)
      for Mode-A/Mode-B, the UE receives a DCI in Step-2 in response to the transmission of the PN message/trigger in Step-1
      the UE receives reconfiguration/update/addition/removal/release (e.g., via/by/in upper layer(s) and/or RRC signaling(s) and/or MAC CE command(s) and/or dynamic DCI based L1 signaling(s)) of new beam RS(s) or RS resource(s)
      the UE receives reconfiguration/update/addition/removal/release (e.g., via/by/in upper layer(s) and/or RRC signaling(s) and/or MAC CE command(s) and/or dynamic DCI based L1 signaling(s)) of the one or more RSs or RS resources
      the UE receives triggering of aperiodic or semi-persistent CSI measurement and/or reporting (e.g., via a CSI request field in a triggering DCI)
      the UE receives activation of semi-persistent CSI measurement and/or reporting (e.g., via SP CSI measurement and/or reporting activation MAC CE(s))
      the current serving beam RS(s)/RS resource(s) as specified/defined herein in the present disclosure changes
      For Scheme-1 specified/defined herein in the present disclosure wherein CSI-RS(s) is the current serving beam RS(s)/RS resource(s), (i) the UE receives a TCI state update, and/or (ii) the UE receives a TCI state update and the (QCL source) RS(s)/RS resource(s)—e.g., CSI-RS(s)—indicated in/by the TCI state changes (in this case, the SSB(s) QCL'ed with (e.g., of QCL-TypeD) the CSI-RS(s) indicated in/by the TCI state may or may not change),
      For Scheme-2 specified/defined herein in the present disclosure wherein SSB(s) is the current serving beam RS(s)/RS resource(s), (i) the UE receives a TCI state update, and/or (ii) the UE receives a TCI state update and the SSB(s) QCL'ed with (e.g., of QCL-TypeD) the CSI-RS(s) indicated in/by the TCI state changes (in this case, the (QCL source) RS(s)/RS resource(s) of CSI-RS(s) indicated in/by the TCI state may or may not change)
      the activation beam RS(s)/RS resource(s) as specified/defined herein in the present disclosure changes
      For Scheme-A specified/defined herein in the present disclosure wherein CSI-RS(s) is the activation beam RS(s)/RS resource(s), (i) the UE receives an update to/of the corresponding activated TCI state, and/or (ii) the UE receives an update to/of the corresponding activated TCI state and the (QCL source) RS(s)/RS resource(s)—e.g., CSI-RS(s)—indicated in/by the activated TCI state changes (in this case, the SSB(s) QCL'ed with (e.g., of QCL-TypeD) the CSI-RS(s) indicated in/by the activated TCI state may nor may not change),
      For Scheme-B specified/defined herein in the present disclosure wherein SSB(s) is the activation beam RS(s)/RS resource(s), (i) the UE receives an update to/of the corresponding activated TCI state, and/or (ii) the UE receives an update to/of the corresponding activated TCI state and the SSB(s) QCL'ed with (e.g., of QCL-TypeD) the CSI-RS(s) indicated in/by the activated TCI state changes (in this case, the (QCL source) RS(s)/RS resource(s) of CSI-RS(s) indicated in/by the activated TCI state may or may not change)
      the beam failure detection (BFD) RS(s)/RS resource(s) for BFR changes or the UE receives (re-)configuration(s) e.g. via RRC and/or update(s) e.g. via MAC CE to/of the BFD RS(s)/RS resource(s)—e.g., in BFD RS (resource) set(s) q0, q00 and/or q01—for BFR
      the candidate beam detection (CBD)/new beam identification (NBI) RS(s)/RS resource(s) for BFR changes or the UE receives (re-)configuration(s) e.g. via RRC and/or update(s) e.g. via MAC CE to/of the CBD/NBI RS(s)/RS resource(s)—e.g., in CBD/NBI RS (resource) set(s) q1, q10 and/or q11—for BFR
      a/the new beam RS index q_new identified/determined from CBD/NBI RS (resource) set(s) q1, q10 and/or q11 for BFR changes
      The UE receives from the network a NWR (in any form(s)) as specified/defined throughout the present disclosure 3> set EventInstanceCounter, e.g., associated/specific to the one or more RSs or RS resources, to 0.

The one or more RSs or RS resources could belong to or could be a subset of or one(s) of the RS(s) or RS resource(s) configured, provided, determined or identified for event evaluation(s) according to or following those specified/described herein in the present disclosure, wherein one or more of or each of the RS(s) or RS resource(s) configured, provided, determined or identified for event evaluation(s) could correspond to one or more of:

the current beam RS/RS resource
new/candidate beam RS(s)/RS resource(s) in the corresponding resource set
activation beam RS(s)/RS resource(s) in the corresponding activated TCI state(s), e.g., provided/indicated in a (unified) TCI state(s) activation/deactivation MAC CE
Pair(s) of new/candidate beam RS(s)/RS resource(s) in the corresponding resource set and activation beam RS(s)/RS resource(s) in the corresponding activated TCI state(s), e.g., provided/indicated in a (unified) TCI state(s) activation/deactivation MAC CE

According to or following those specified herein in the present disclosure, a UE or higher layer(s) of the UE could trigger or initiate a transmission of the PN message/trigger over/on/via/in the PUCCH resource or PUCCH transmission or PUCCH transmission occasion of the first UL channel in Mode A and/or Mode B and/or Mode C according to or based on (identification, determination, detection or declaration of) one or more potential/candidate event occurrences, wherein each of the one or more potential/candidate event occurrences could be associated/specific to different/separate (sets of) RSs or RS resources. In this case, the corresponding UEI/event-driven beam report(s)—e.g., carried or conveyed or transmitted or sent via PUSCH resource(s) of the second UL channel in Mode A and/or Mode B and/or Mode C associated/specific to the transmission of the PN message/trigger over/on/via/in the PUCCH resource or PUCCH transmission or PUCCH transmission occasion of the first UL channel in Mode A and/or Mode B and/or Mode C-could comprise or include or contain report content(s)/quantity(s) including resource indicator(s) such as SSBRI(s)/CRI(s) and beam metric(s) such as L1-RSRP(s)/L1-SINR(s) determined or identified according to or based on (identification, determination, detection or declaration of) the one or more potential/candidate event occurrences (hence, the RS(s) or RS resource(s) associated/specific to the potential/candidate event occurrence(s)).

A UE or higher layer(s) of a UE could start a prohibit timer (duration, length and/or etc. of the prohibit timer and/or how/when the prohibit timer would expire could be higher layer configured)
after the last symbol/slot/etc. of transmitting a PN message/trigger on/over/in a PUCCH resource or a PUCCH transmission/transmission occasion of the first UL channel of Mode A and/or Mode B and/or Mode C, and/or
after the last symbol/slot/etc. of receiving the UL grant DCI in Step-2 of Mode A and/or Mode C, and/or
after the last symbol/slot/etc. of when the UL grant DCI received in Step-2 of Mode A and/or Mode C has become applicable, and/or
after the last symbol/slot/etc. of transmitting a beam report on/over/in (DG and/or CG e.g. Type1 CG) PUSCH resource(s) of the second UL channel of Mode A and/or Mode B and/or Mode C.

When a prohibit timer is running, the UE or higher layer(s) of the UE may not transmit any PN message(s)/trigger(s)/notification(s) on/over/in a PUCCH resource or a PUCCH transmission/transmission occasion of the first UL channel (e.g., in Mode A, Mode B and/or Mode C). That is, only when there is no prohibit timer running, the UE or higher layer(s) of the UE could transmit a PN message/trigger on/over/in a PUCCH resource or a PUCCH transmission/transmission occasion of the first UL channel (e.g., in Mode A, Mode B and/or Mode C). In addition, when/if a prohibit timer is running, and/or when/if the duration, length and/or etc. of the prohibit timer is less/smaller (or larger/greater) than or equal to a threshold,
in one example, the UE or higher layer(s) of the UE could continue performing or conducting the event evaluation(s) including counting of the event instance(s) according to or following those specified herein in the present disclosure; in this case,
   for example, when/if the UE or higher layer(s) of the UE starts the prohibit timer, the UE or higher layer(s) of the UE may not reset the number/counting of the event instance(s), e.g., to zero, and could continue/keep incrementing the number/counting of the (same) event instance(s) counted before the prohibit timer starts according to or following those specified herein in the present disclosure;
   for another example, when/if the UE or higher layer(s) of the UE starts the prohibit timer, the UE or higher layer(s) of the UE could or may reset the number/counting of the event instance(s), e.g., to zero;
   for another example, when/if or after the prohibit timer expires, the UE or higher layer(s) of the UE could or may reset the number/counting of the event instance(s), e.g., to zero;
in another example, the UE or higher layer(s) of the UE could stop performing or conducting the event evaluation(s) including counting of the event instance(s) according to or following those specified herein in the present disclosure; in this case,
   for example, when/if the UE or higher layer(s) of the UE starts the prohibit timer, the UE or higher layer(s) of the UE could or may reset the number/counting of the event instance(s), e.g., to zero;
   for another example, when/if the UE or higher layer(s) of the UE starts the prohibit timer, the UE or higher layer(s) of the UE may not reset the number/counting of the event instance(s), e.g., to zero, and when/if or after the prohibit timer expires, the UE or higher layer(s) of the UE could continue/keep incrementing the number/counting of the (same) event instance(s) counted before the prohibit timer starts according to or following those specified herein in the present disclosure

The UE could determine or identify value of the threshold according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For instance, the UE could determine or identify value of the threshold as multiple (e.g., n times with n=1, 2, . . . ) of a time period/duration/gap, wherein the time period/duration/gap could correspond to:
periodicity of the PUCCH resource(s)/transmission(s)/transmission occasion(s) of the first UL channel, e.g., denoted by T_pucch
0 or T_pucch or a value (e.g., in form/terms of number of symbol(s)/slot(s)/ms/etc.) in the range of [0, T_pucch] based on or according to higher layer's configuration(s), wherein T_pucch represents the periodicity of the PUCCH resource(s)/transmission(s)/transmission occasion(s) of the first UL channel
the time duration T_du as specified/defined herein in the present disclosure
the time offset t_offset as specified/defined herein in the present disclosure
the time window T as specified/defined herein in the present disclosure
the processing time T_proc as specified/defined herein in the present disclosure
periodicity of an event evaluation or event evaluation instance for determining an event instance according to or following those specified herein in the present disclosure
periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure
min {periodicity of a first MO, periodicity of a second MO}
max {periodicity of a first MO, periodicity of a second MO}
max {x ms, min {periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling

The first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). Otherwise, e.g., when/if a prohibit timer is running, and/or when/if the duration, length and/or etc. of the prohibit timer is larger/greater (or less/smaller) than or equal to the threshold specified herein in the present disclosure,
the UE or higher layer(s) of the UE could stop performing or conducting the event evaluation(s) including counting of the event instance(s) according to or following those specified herein in the present disclosure, and/or
when/if the UE or higher layer(s) of the UE starts the prohibit timer, the UE or higher layer(s) of the UE could or may reset the number/counting of the event instance(s), e.g., to zero, and/or
when/if or after the prohibit timer expires, the UE or higher layer(s) of the UE could or may reset the number/counting of the event instance(s), e.g., to zero, and/or
when/if or after the prohibit timer expires, the UE or higher layer(s) of the UE may not continue/keep incrementing the number/counting of the (same) event instance(s) counted before the prohibit timer starts according to or following those specified herein in the present disclosure.

Regarding the event instance(s) specified/discussed herein:
for Event-1, the event instance(s) could be associated/specific to at least one (same) new/candidate beam RS/RS resource according to or following those specified herein in the present disclosure
for Event-2, the event instance(s) could be associated/specific to the current beam RS/RS resource according to or following those specified herein in the present disclosure
for Event-3, the event instance(s) could be
   associated/specific to at least (one (same) pair of) a (same) new/candidate beam RS/RS resource and a (same) activation beam RS/RS resource (or equivalently, the (same) activated beam/TCI state) according to or following those specified herein in the present disclosure, or
   associated/specific (only) to at least one (same) new/candidate beam RS/RS resource according to or following those specified herein in the present disclosure.
for Event-4, the event instance(s) could be associated/specific to at least one (same) new/candidate beam RS/RS resource according to or following those specified herein in the present disclosure
for Event-5, the event instance(s) could be associated/specific to the current serving beam RS/RS resource and at least one (same) new/candidate beam RS/RS resource according to or following those specified herein in the present disclosure
for Event-6, the event instance(s) could be associated/specific to the current serving beam RS/RS resource and at least one (same) new/candidate beam RS/RS resource according to or following those specified herein in the present disclosure
for Event-7, the event instance(s) could be associated/specific to the current serving beam RS/RS resource and at least one (same) new/candidate beam RS/RS resource according to or following those specified herein in the present disclosure.

In addition, UE could determine or identify the value of n according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The aforementioned signal(s), channel(s), signaling(s), indication(s), configuration(s), command(s) and/or etc. that the UE receives or does not receive could also be regarded/referred to as NWR(s) in the present disclosure.

According to or following those specified herein in the present disclosure, when/if a UE or higher layer(s) of a UE has determined or detected or declared an event and there is no prohibit timer running, the UE could transmit a PN message/trigger on/over/in/by a first PUCCH resource or a first PUCCH transmission/transmission occasion (of the first UL channel) at time t, wherein the UE could determine or identify association(s)/linkage(s)/correspondence(s)—e.g., in terms of their timing relations-between the determination or detection or declaration of the event and the first PUCCH resource or first PUCCH transmission or first PUCCH transmission occasion at time t according to or following those specified herein in the present disclosure. When/if a UE or higher layer(s) of a UE has determined or detected or declared an event, and determined or identified a first PUCCH resource or a first PUCCH transmission or a first PUCCH transmission occasion (of the first UL channel) at time t associated/specific to the determination or detection or declaration of the event, and when/if there is a prohibit timer running,
the UE may not transmit a PN message/trigger on/over/in/by the first PUCCH resource or first PUCCH transmission/transmission occasion of the first UL channel at time t based on the determination, detection or declaration of the event according to or following those specified herein in the present disclosure, and/or
the UE could determine or identify a second PUCCH resource or a second PUCCH transmission or a second PUCCH transmission occasion (of the first UL channel) at time t′ to transmit a PN message/trigger based on the determination, detection or declaration of the event according to or following those specified herein in the present disclosure, wherein the second PUCCH resource or the second PUCCH transmission/transmission occasion could be the first available or valid PUCCH resource or PUCCH transmission/transmission occasion of the first UL channel after the first PUCCH resource or transmission or transmission occasion—at least the prohibit timer is not running at time t′ or the prohibit timer has expired before the time t′.

Furthermore, delta_t=t′-t could be smaller/less (or larger/greater) than or equal to a threshold. The UE could determine or identify value of the threshold according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based LI signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. For instance, the UE could determine or identify value of the threshold as multiple (e.g., n′ times with n′=1, 2, . . . ) of a time period/duration/gap, wherein the time period/duration/gap could correspond to:
periodicity of the PUCCH resource(s)/transmission(s)/transmission occasion(s) of the first UL channel, e.g., denoted by T_pucch
0 or T_pucch or a value (e.g., in form/terms of number of symbol(s)/slot(s)/ms/etc.) in the range of [0, T_pucch] based on or according to higher layer's configuration(s), wherein T_pucch represents the periodicity of the PUCCH resource(s)/transmission(s)/transmission occasion(s) of the first UL channel
the time duration T_du as specified/defined herein in the present disclosure
the time offset t_offset as specified/defined herein in the present disclosure
the time window T as specified/defined herein in the present disclosure
the processing time T_proc as specified/defined herein in the present disclosure
periodicity of an event evaluation or event evaluation instance for determining an event instance according to or following those specified herein in the present disclosure
periodicity of a measurement occasion (MO), wherein the MO could correspond to current serving beam RS(s)/RS resource(s), candidate/new beam RS(s)/RS resource(s), or activation beam RS(s)/RS resource(s) according to or following those specified herein in the present disclosure
min {periodicity of a first MO, periodicity of a second MO}
max {periodicity of a first MO, periodicity of a second MO}
max {x ms, min {periodicity of a first MO, periodicity of a second MO}, wherein the UE could determine or identify the value of x according to or based on: a fixed value in system specification(s) and/or per RRC (re-)configuration, e.g., x=1, 2, 3, 4, 5, 6, 8, 10, 20, . . . , (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling

The first (or second) MO could correspond to current serving beam RS(s)/RS resource(s), candidate/new beam RS(s)/RS resource(s), or activation beam RS(s)/RS resource(s) according to or following those specified herein in the present disclosure, and the first MO and the second MO could correspond to different RS(s)/RS resource(s) for event evaluation(s). For instance, the first MO could correspond to current beam RS(s)/RS resource(s) while the second MO could correspond to candidate/new beam RS(s)/RS resource(s). In addition, the UE could determine or identify the value of n′ according to or based on: (i) a fixed value in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

Alternatively, when/if a UE or higher layer(s) of a UE has determined or detected or declared an event, and determined or identified a first PUCCH resource or a first PUCCH transmission or a first PUCCH transmission occasion (of the first UL channel) at time t associated/specific to the determination or detection or declaration of the event, and when/if there is a prohibit timer running,
the UE may not transmit a PN message/trigger on/over/in/by the first PUCCH resource or first PUCCH transmission/transmission occasion of the first UL channel at time t based on the determination, detection or declaration of the event according to or following those specified herein in the present disclosure, and/or
the UE could determine or identify a second PUCCH resource or a second PUCCH transmission or a second PUCCH transmission occasion (of the first UL channel) at time t′, wherein the second PUCCH resource or the second PUCCH transmission/transmission occasion could be the first available or valid PUCCH resource or PUCCH transmission/transmission occasion of the first UL channel after the first PUCCH resource or transmission or transmission occasion—at least the prohibit timer is not running at time t′ or the prohibit timer has expired before the time t′. When/if delta_t=t′−t is greater/larger (or less/smaller) than or equal to the threshold specified herein in the present disclosure, the UE may not transmit a PN message/trigger on/over/in/by the second PUCCH resource or second PUCCH transmission/transmission occasion of the first UL channel at time t′ based on the determination, detection or declaration of the event according to or following those specified herein in the present disclosure, and/or
the UE may not transmit any PN message(s)/trigger(s) on/over/in/by any PUCCH resource(s) or any PUCCH transmission(s)/transmission occasion(s) of the first UL channel based on the determination, detection or declaration of the event according to or following those specified herein in the present disclosure.

According to or following those specified herein in the present disclosure, a UE could perform or conduct event(s) evaluation(s) and/or event instance(s) evaluation(s) in MAC/L2/L3/upper layer(s) and/or PHY/L1/lower layer(s). The UE could determine or identify MAC/L2/L3/upper layer(s) and/or PHY/L1/lower layer(s) to evaluate the event(s) or the event instance(s) according to or following those specified herein in the present disclosure according to or based on: fixed rule(s) in system specification(s) and/or per RRC (re-) configuration, (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
In one example, when/if Mode A (or Mode C) is enabled, the UE could perform or conduct event(s) evaluation(s) and/or event instance(s) evaluation(s) in MAC/L2/L3/upper layer(s); otherwise, i.e., when/if Mode B (or Mode C) is enabled, the UE could perform or conduct event(s) evaluation(s) and/or event instance(s) evaluation(s) in PHY/L1/lower layer(s).
In another example, when/if a (dedicated) SR (e.g., the corresponding SR configuration is associated with a SR ID or SR configuration ID) is used as the first UL channel, the UE could perform or conduct event(s) evaluation(s) and/or event instance(s) evaluation(s) in MAC/L2/L3/upper layer(s); otherwise, e.g., when/if a UCI (e.g., having a PUCCH resource configuration not associated with a SR ID or SR configuration ID) is used as the first UL channel, the UE could perform or conduct event(s) evaluation(s) and/or event instance(s) evaluation(s) in PHY/L1/lower layer(s).

Supporting evaluation(s) of event(s)/event instance(s) in MAC/L2/L3/upper layer(s) (and/or in PHY/L1/lower layer(s)) could be a basic UE feature such that when/if a UE supports the UE-initiated/event-driven beam reporting/management (or for a UE supporting the UE-initiated/event-driven beam reporting/management), the UE could or would need to support at least evaluation(s) of event(s)/event instance(s) in MAC/L2/L3/upper layer(s) (and/or in PHY/LI/lower layer(s)). Supporting evaluation(s) of event(s)/event instance(s) in PHY/L1/lower layer(s) (and/or in MAC/L2/L3/upper layer(s)) could be optional for a UE supporting the UE-initiated/event-driven beam reporting/management; in this case, the UE could indicate to the network in their capability signaling(s) one or more of:
Support of event(s)/event instance(s) evaluation(s) in MAC/L2/L3/upper layer(s)
Support of event(s)/event instance(s) evaluation(s) in PHY/L1/lower layer(s)

That is, a UE's capability or capability signaling could comprise one or more components each indicating support of:
{event(s)/event instance(s) evaluation(s) in MAC/L2/L3/upper layer(s)}
{event(s)/event instance(s) evaluation(s) in PHY/L1/lower layer(s)}
{event(s)/event instance(s) evaluation(s) in MAC/L2/L3/upper layer(s), event(s)/event instance(s) evaluation(s) in PHY/L1/lower layer(s)}

Throughout the present disclosure, the aforementioned signal(s), channel(s), signaling(s), indication(s), configuration(s), command(s) and/or etc. that the UE receives or does not receive for evaluating, assessing, detecting, declaring or determining the event(s) and/or event evaluation(s) and/or triggering or initiating the UE-initiated/event-driven beam reporting (e.g., triggering or initiating transmission(s) of the PN message/trigger via/in/by the PUCCH(s)/PUCCH resource(s) of the first UL channel as in Step-1 for Mode A, Mode B and/or Mode C according to or following those specified herein in the present disclosure) could also be regarded/referred to as NWR(s) in the present disclosure.

According to or following those specified/described herein in the present disclosure, e.g., for Mode-A, Mode-B and/or Mode-C as specified/defined herein in the present disclosure (i.e., when/if one or more of them are configured/provided/enabled), a PUCCH resource or transmission or transmission occasion or a PUCCH resource configuration of the first UL channel in Mode A, Mode B and/or Mode C could be associated to a CSI report setting/configuration provided for the UE-initiated/event-driven beam reporting. For instance, the CSI report setting/configuration could be provided by higher layer parameter(s) CSI-ReportConfig and/or UEI-ReportConfig configured for the UE-initiated/event-driven beam reporting—e.g., a higher layer parameter denoted by ueInitiatedBeamReporting could be provided/configured and/or set to ‘enabled’ in the CSI-ReportConfig and/or UEI-ReportConfig, and/or higher layer parameter reportQuantity in the CSI-ReportConfig and/or UEI-ReportConfig could be set to a particular value, e.g., ‘none’, to enable the UE-initiated/event-driven beam reporting. A UE could determine or identify that a PUCCH resource/resource configuration of the first UL channel could be associated/specific/mapped/linked/corresponding to a CSI report setting/configuration configured or provided for the UE-initiated/event-driven beam reporting according to one or more of:
In one example, the higher layer parameter(s)/signaling(s) that provides or configures the PUCCH resource/resource configuration of the first UL channel such as PUCCH-Config, PUCCH-ResourceSet, PUCCH-Resource, PUCCH-ResourceCommon and/or etc. could provide or configure or comprise or include or contain information related to the CSI report setting/configuration—e.g., reportConfigId of the CSI-ReportConfig/UEI-ReportConfig as specified/defined herein in the present disclosure that provides or configures the CSI report setting/configuration.
In another example, the CSI-ReportConfig/UEI-ReportConfig that provides or configures the CSI report setting/configuration for the UE-initiated/event-driven beam reporting as specified/defined herein in the present disclosure could provide or configure or comprise or include or contain information related to the PUCCH resource/resource configuration of the first UL channel—e.g., ID or index of the higher layer parameter(s) PUCCH-Config, PUCCH-ResourceSet, PUCCH-Resource, PUCCH-ResourceCommon and/or etc. that provides or configures the PUCCH resource/resource configuration of the first UL channel.
In another example, the higher layer parameter(s)/signaling(s) that provides or configures the PUCCH resource/resource configuration of the first UL channel such as PUCCH-Config, PUCCH-ResourceSet, PUCCH-Resource, PUCCH-ResourceCommon and/or etc. could provide or configure or comprise or include or contain a first entity ID, and the CSI-ReportConfig/UEI-ReportConfig that provides or configures the CSI report setting/configuration for the UE-initiated/event-driven beam reporting as specified/defined herein in the present disclosure could provide or configure or comprise or include or contain a second entity ID. For this design example, the first entity ID and the second entity ID could have the same/identical value(s)—e.g., the first and second entity IDs could be in form of one-bit indicators, and both of them could correspond to ‘1’s or ‘0’s.
In another example, higher layer parameter(s)/signaling(s) that provides or configures necessary information and/or setting for the UE-initiated/event-driven beam reporting could provide or configure or comprise or include or contain first information related to one or more CSI report settings/configurations provided or configured for the UE-initiated/event-driven beam reporting as specified/defined herein in the present disclosure, and second information related to one or more PUCCH resources/resource configurations of the first UL channel as specified/defined herein in the present disclosure, wherein the UE could determine or identify association(s)/mapping(s)/linkage(s) between the first and second information according to one or more of:
   For example, the first information could correspond to a set of one or more reportConfigId's each corresponding to a CSI-ReportConfig and/or UEI-ReportConfig that provides or configures a CSI report setting/configuration for the UE-initiated/event-driven beam reporting as specified/defined herein in the present disclosure, and the second information could correspond to a set of one or more PUCCH resource/resource configuration IDs/indexes each corresponding to a PUCCH-Config, PUCCH-ResourceSet, PUCCH-Resource, PUCCH-ResourceCommon and/or etc. that provides or configures the PUCCH resource/resource configuration of the first UL channel. For this design example, the reportConfigId (and therefore, the corresponding CSI report setting/configuration) of the first entry in the set of one or more reportConfigId's could be associated/specific/corresponding/linked to the PUCCH resource/resource configuration ID/index (and therefore, the corresponding PUCCH resource/resource configuration of the first UL channel) of the first entry in the set of one or more PUCCH resource/resource configuration IDs/indexes as specified/defined herein in the present disclosure, the reportConfigId (and therefore, the corresponding CSI report setting/configuration) of the second entry in the set of one or more reportConfigId's could be associated/specific/corresponding/linked to the PUCCH resource/resource configuration ID/index (and therefore, the corresponding PUCCH resource/resource configuration of the first UL channel) of the second entry in the set of one or more PUCCH resource/resource configuration IDs/indexes as specified/defined herein in the present disclosure, and so on, and the reportConfigId (and therefore, the corresponding CSI report setting/configuration) of the last entry in the set of one or more reportConfigId's could be associated/specific/corresponding/linked to the PUCCH resource/resource configuration ID/index (and therefore, the corresponding PUCCH resource/resource configuration of the first UL channel) of the last entry in the set of one or more PUCCH resource/resource configuration IDs/indexes as specified/defined herein in the present disclosure.
   For another example, the first information could correspond to a set of one or more reportConfigId's each corresponding to a CSI-ReportConfig and/or UEI-ReportConfig that provides or configures a CSI report setting/configuration for the UE-initiated/event-driven beam reporting as specified/defined herein in the present disclosure, and the second information could correspond to a set of one or more PUCCH resource/resource configuration IDs/indexes each corresponding to a PUCCH-Config, PUCCH-ResourceSet, PUCCH-Resource, PUCCH-ResourceCommon and/or etc. that provides or configures the PUCCH resource/resource configuration of the first UL channel. For this design example, the lowest (or highest) value of the reportConfigId (and therefore, the corresponding CSI report setting/configuration) in the set of one or more reportConfigId's could be associated/specific/corresponding/linked to the lowest (or highest) value of the PUCCH resource/resource configuration ID/index (and therefore, the corresponding PUCCH resource/resource configuration of the first UL channel) in the set of one or more PUCCH resource/resource configuration IDs/indexes as specified/defined herein in the present disclosure, the second lowest (or second highest) value of the reportConfigId (and therefore, the corresponding CSI report setting/configuration) in the set of one or more reportConfigId's could be associated/specific/corresponding/linked to the second lowest (or second highest) value of the PUCCH resource/resource configuration ID/index (and therefore, the corresponding PUCCH resource/resource configuration of the first UL channel) in the set of one or more PUCCH resource/resource configuration IDs/indexes as specified/defined herein in the present disclosure, and so on, and the highest (or lowest) value of the reportConfigId (and therefore, the corresponding CSI report setting/configuration) in the set of one or more reportConfigId's could be associated/specific/corresponding/linked to the highest (or lowest) value of the PUCCH resource/resource configuration ID/index (and therefore, the corresponding PUCCH resource/resource configuration of the first UL channel) in the set of one or more PUCCH resource/resource configuration IDs/indexes as specified/defined herein in the present disclosure.
   For another example, the first information could correspond to a set of one or more reportConfigId's each corresponding to a CSI-ReportConfig and/or UEI-ReportConfig that provides or configures a CSI report setting/configuration for the UE-initiated/event-driven beam reporting as specified/defined herein in the present disclosure, and the second information could correspond to a set of one or more PUCCH resource/resource configuration IDs/indexes each corresponding to a PUCCH-Config, PUCCH-ResourceSet, PUCCH-Resource, PUCCH-ResourceCommon and/or etc. that provides or configures the PUCCH resource/resource configuration of the first UL channel. For this design example, the higher layer parameter(s)/signaling(s) that provides or configures necessary information and/or setting for the UE-initiated/event-driven beam reporting could also provide or configure or comprise or include or contain a bitmap with each entry/bit position of the bitmap associated, corresponding, specific or linked to a reportConfigId in the set of one or more reportConfigId's and a PUCCH resource/resource configuration ID/index in the set of one or more PUCCH resource/resource configuration IDs/indexes. In this case, when/if an entry/bit position of the bitmap is set to ‘1’ (or ‘0’), the reportConfigId (and therefore, the corresponding CSI report setting/configuration) in the set of one or more reportConfigId's associated/corresponding/specific/linked to the entry/bit position could be associated/specific/corresponding/linked to the PUCCH resource/resource configuration ID/index (and therefore, the corresponding PUCCH resource/resource configuration of the first UL channel) in the set of one or more PUCCH resource/resource configuration IDs/indexes as specified/defined herein in the present disclosure associated/corresponding/linked to the entry/bit position.

According to or following those specified/described herein in the present disclosure, e.g., for Mode-A, Mode-B and/or Mode-C as specified/defined herein in the present disclosure (i.e., when/if one or more of them are configured/provided/enabled) and/or for DG and/or Type 1/2 CG PUSCH(s), a PUSCH resource or transmission or transmission occasion or a PUSCH resource configuration of the second UL channel in Mode A, Mode B and/or Mode C could be associated to a CSI report setting/configuration provided for the UE-initiated/event-driven beam reporting. For instance, the CSI report setting/configuration could be provided by higher layer parameter(s) CSI-ReportConfig and/or UEI-ReportConfig configured for the UE-initiated/event-driven beam reporting—e.g., a higher layer parameter denoted by ueInitiatedBeamReporting could be provided/configured and/or set to ‘enabled’ in the CSI-ReportConfig and/or UEI-ReportConfig, and/or higher layer parameter reportQuantity in the CSI-ReportConfig and/or UEI-ReportConfig could be set to a particular value, e.g., ‘none’, to enable the UE-initiated/event-driven beam reporting. A UE could determine or identify that a PUSCH resource/resource configuration of the second UL channel could be associated/specific/mapped/linked/corresponding to a CSI report setting/configuration configured or provided for the UE-initiated/event-driven beam reporting according to one or more of:
In one example, the higher layer parameter(s)/signaling(s) that provides or configures the PUSCH resource/resource configuration of the second UL channel such as PUSCH-Config, UCI-OnPUSCH, PUSCH-ConfigCommon, ConfiguredGrantConfig, SPS-Config, CG-UCI-OnPUSCH and/or etc. could provide or configure or comprise or include or contain information related to the CSI report setting/configuration—e.g., reportConfigId of the CSI-ReportConfig/UEI-ReportConfig as specified/defined herein in the present disclosure that provides or configures the CSI report setting/configuration.
In another example, the CSI-ReportConfig/UEI-ReportConfig that provides or configures the CSI report setting/configuration for the UE-initiated/event-driven beam reporting as specified/defined herein in the present disclosure could provide or configure or comprise or include or contain information related to the PUSCH resource/resource configuration of the second UL channel—e.g., ID or index of the higher layer parameter(s) PUSCH-Config, UCI-OnPUSCH, PUSCH-ConfigCommon, ConfiguredGrantConfig, SPS-Config, CG-UCI-OnPUSCH and/or etc. that provides or configures the PUSCH resource/resource configuration of the second UL channel.
In another example, the higher layer parameter(s)/signaling(s) that provides or configures the PUSCH resource/resource configuration of the second UL channel such as PUSCH-Config, UCI-OnPUSCH, PUSCH-ConfigCommon, ConfiguredGrantConfig, SPS-Config, CG-UCI-OnPUSCH and/or etc. could provide or configure or comprise or include or contain a first entity ID, and the CSI-ReportConfig/UEI-ReportConfig that provides or configures the CSI report setting/configuration for the UE-initiated/event-driven beam reporting as specified/defined herein in the present disclosure could provide or configure or comprise or include or contain a second entity ID. For this design example, the first entity ID and the second entity ID could have the same/identical value(s)—e.g., the first and second entity IDs could be in form of one-bit indicators, and both of them could correspond to ‘1’s or ‘0’s.
In another example, higher layer parameter(s)/signaling(s) that provides or configures necessary information and/or setting for the UE-initiated/event-driven beam reporting could provide or configure or comprise or include or contain first information related to one or more CSI report settings/configurations provided or configured for the UE-initiated/event-driven beam reporting as specified/defined herein in the present disclosure, and second information related to one or more PUSCH resources/resource configurations of the second UL channel as specified/defined herein in the present disclosure, wherein the UE could determine or identify association(s)/mapping(s)/linkage(s) between the first and second information according to one or more of:
   For example, the first information could correspond to a set of one or more reportConfigId's each corresponding to a CSI-ReportConfig and/or UEI-ReportConfig that provides or configures a CSI report setting/configuration for the UE-initiated/event-driven beam reporting as specified/defined herein in the present disclosure, and the second information could correspond to a set of one or more PUSCH resource/resource configuration IDs/indexes each corresponding to a PUSCH-Config, UCI-OnPUSCH, PUSCH-ConfigCommon, ConfiguredGrantConfig, SPS-Config, CG-UCI-OnPUSCH and/or etc. that provides or configures the PUSCH resource/resource configuration of the second UL channel. For this design example, the reportConfigId (and therefore, the corresponding CSI report setting/configuration) of the first entry in the set of one or more reportConfigId's could be associated/specific/corresponding/linked to the PUSCH resource/resource configuration ID/index (and therefore, the corresponding PUSCH resource/resource configuration of the second UL channel) of the first entry in the set of one or more PUSCH resource/resource configuration IDs/indexes as specified/defined herein in the present disclosure, the reportConfigId (and therefore, the corresponding CSI report setting/configuration) of the second entry in the set of one or more reportConfigId's could be associated/specific/corresponding/linked to the PUSCH resource/resource configuration ID/index (and therefore, the corresponding PUSCH resource/resource configuration of the second UL channel) of the second entry in the set of one or more PUSCH resource/resource configuration IDs/indexes as specified/defined herein in the present disclosure, and so on, and the reportConfigId (and therefore, the corresponding CSI report setting/configuration) of the last entry in the set of one or more reportConfigId's could be associated/specific/corresponding/linked to the PUSCH resource/resource configuration ID/index (and therefore, the corresponding PUSCH resource/resource configuration of the second UL channel) of the last entry in the set of one or more PUSCH resource/resource configuration IDs/indexes as specified/defined herein in the present disclosure.
   For another example, the first information could correspond to a set of one or more reportConfigId's each corresponding to a CSI-ReportConfig and/or UEI-ReportConfig that provides or configures a CSI report setting/configuration for the UE-initiated/event-driven beam reporting as specified/defined herein in the present disclosure, and the second information could correspond to a set of one or more PUSCH resource/resource configuration IDs/indexes each corresponding to a PUSCH-Config, UCI-OnPUSCH, PUSCH-ConfigCommon, ConfiguredGrantConfig, SPS-Config, CG-UCI-OnPUSCH and/or etc. that provides or configures the PUSCH resource/resource configuration of the second UL channel. For this design example, the lowest (or highest) value of the reportConfigId (and therefore, the corresponding CSI report setting/configuration) in the set of one or more reportConfigId's could be associated/specific/corresponding/linked to the lowest (or highest) value of the PUSCH resource/resource configuration ID/index (and therefore, the corresponding PUSCH resource/resource configuration of the second UL channel) in the set of one or more PUSCH resource/resource configuration IDs/indexes as specified/defined herein in the present disclosure, the second lowest (or second highest) value of the reportConfigId (and therefore, the corresponding CSI report setting/configuration) in the set of one or more reportConfigId's could be associated/specific/corresponding/linked to the second lowest (or second highest) value of the PUSCH resource/resource configuration ID/index (and therefore, the corresponding PUSCH resource/resource configuration of the second UL channel) in the set of one or more PUSCH resource/resource configuration IDs/indexes as specified/defined herein in the present disclosure, and so on, and the highest (or lowest) value of the reportConfigId (and therefore, the corresponding CSI report setting/configuration) in the set of one or more reportConfigId's could be associated/specific/corresponding/linked to the highest (or lowest) value of the PUSCH resource/resource configuration ID/index (and therefore, the corresponding PUSCH resource/resource configuration of the second UL channel) in the set of one or more PUSCH resource/resource configuration IDs/indexes as specified/defined herein in the present disclosure.
   For another example, the first information could correspond to a set of one or more reportConfigId's each corresponding to a CSI-ReportConfig and/or UEI-ReportConfig that provides or configures a CSI report setting/configuration for the UE-initiated/event-driven beam reporting as specified/defined herein in the present disclosure, and the second information could correspond to a set of one or more PUSCH resource/resource configuration IDs/indexes each corresponding to a PUSCH-Config, UCI-OnPUSCH, PUSCH-ConfigCommon, ConfiguredGrantConfig, SPS-Config, CG-UCI-OnPUSCH and/or etc. that provides or configures the PUSCH resource/resource configuration of the second UL channel. For this design example, the higher layer parameter(s)/signaling(s) that provides or configures necessary information and/or setting for the UE-initiated/event-driven beam reporting could also provide or configure or comprise or include or contain a bitmap with each entry/bit position of the bitmap associated, corresponding, specific or linked to a reportConfigId in the set of one or more reportConfigId's and a PUSCH resource/resource configuration ID/index in the set of one or more PUSCH resource/resource configuration IDs/indexes. In this case, when/if an entry/bit position of the bitmap is set to ‘1’ (or ‘0’), the reportConfigId (and therefore, the corresponding CSI report setting/configuration) in the set of one or more reportConfigId's associated/corresponding/specific/linked to the entry/bit position could be associated/specific/corresponding/linked to the PUSCH resource/resource configuration ID/index (and therefore, the corresponding PUSCH resource/resource configuration of the second UL channel) in the set of one or more PUSCH resource/resource configuration IDs/indexes as specified/defined herein in the present disclosure associated/corresponding/linked to the entry/bit position.

According to or following those specified/described herein in the present disclosure, e.g., for Mode-A, Mode-B and/or Mode-C as specified/defined herein in the present disclosure (i.e., when/if one or more of them are configured/provided/enabled), a PUCCH resource or transmission or transmission occasion or a PUCCH resource configuration of the first UL channel could be associated to a PUSCH resource or transmission or transmission occasion or a PUSCH resource configuration (e.g., DG and/or Type1/2 CG PUSCH(s)) of the second UL channel in Mode A, Mode B and/or Mode C. A UE could determine or identify that a PUCCH resource/resource configuration of the first UL channel could be associated/specific/mapped/linked/corresponding to a PUSCH resource/resource configuration of the second UL channel according to one or more of:
In one example, the higher layer parameter(s)/signaling(s) that provides or configures the PUCCH resource/resource configuration of the first UL channel such as PUCCH-Config, PUCCH-ResourceSet, PUCCH-Resource, PUCCH-ResourceCommon and/or etc. could provide or configure or comprise or include or contain information related to the PUSCH resource/resource configuration of the second UL channel—e.g., ID or index of the higher layer parameter(s) PUSCH-Config, UCI-OnPUSCH, PUSCH-ConfigCommon, ConfiguredGrantConfig, SPS-Config, CG-UCI-OnPUSCH and/or etc. that provides or configures the PUSCH resource/resource configuration of the second UL channel.
In another example, the higher layer parameter(s)/signaling(s) that provides or configures the PUSCH resource/resource configuration of the second UL channel such as PUSCH-Config, UCI-OnPUSCH, PUSCH-ConfigCommon, ConfiguredGrantConfig, SPS-Config, CG-UCI-OnPUSCH and/or etc. could provide or configure or comprise or include or contain information related to the PUCCH resource/resource configuration of the first UL channel—e.g., ID or index of the higher layer parameter(s) PUCCH-Config, PUCCH-ResourceSet, PUCCH-Resource, PUCCH-ResourceCommon and/or etc. that provides or configures the PUCCH resource/resource configuration of the first UL channel.
In another example, the higher layer parameter(s)/signaling(s) that provides or configures the PUCCH resource/resource configuration of the first UL channel such as PUCCH-Config, PUCCH-ResourceSet, PUCCH-Resource, PUCCH-ResourceCommon and/or etc. could provide or configure or comprise or include or contain a first entity ID, and the higher layer parameter(s)/signaling(s) that provides or configures the PUSCH resource/resource configuration of the second UL channel such as PUSCH-Config, UCI-OnPUSCH, PUSCH-ConfigCommon, ConfiguredGrantConfig, SPS-Config, CG-UCI-OnPUSCH and/or etc. could provide or configure or comprise or include or contain a second entity ID. For this design example, the first entity ID and the second entity ID could have the same/identical value(s)—e.g., the first and second entity IDs could be in form of one-bit indicators, and both of them could correspond to ‘1’s or ‘0’s.
In another example, higher layer parameter(s)/signaling(s) that provides or configures necessary information and/or setting for the UE-initiated/event-driven beam reporting could provide or configure or comprise or include or contain first information related to one or more PUCCH resources/resource configurations of the first UL channel as specified/defined herein in the present disclosure, and second information related to one or more PUSCH resources/resource configurations of the second UL channel as specified/defined herein in the present disclosure, wherein the UE could determine or identify association(s)/mapping(s)/linkage(s) between the first and second information according to one or more of:
   For example, the first information could correspond to a set of one or more PUCCH resource/resource configuration IDs/indexes each corresponding to a PUCCH-Config, PUCCH-ResourceSet, PUCCH-Resource, PUCCH-ResourceCommon and/or etc. that provides or configures the PUCCH resource/resource configuration of the first UL channel, and the second information could correspond to a set of one or more PUSCH resource/resource configuration IDs/indexes each corresponding to a PUSCH-Config, UCI-OnPUSCH, PUSCH-ConfigCommon, ConfiguredGrantConfig, SPS-Config, CG-UCI-OnPUSCH and/or etc. that provides or configures the PUSCH resource/resource configuration of the second UL channel. For this design example, the PUCCH resource/resource configuration ID/index (and therefore, the corresponding PUCCH resource/resource configuration of the first UL channel) of the first entry in the set of one or more PUCCH resource/resource configuration IDs/indexes as specified/defined herein in the present disclosure could be associated/specific/corresponding/linked to the PUSCH resource/resource configuration ID/index (and therefore, the corresponding PUSCH resource/resource configuration of the second UL channel) of the first entry in the set of one or more PUSCH resource/resource configuration IDs/indexes as specified/defined herein in the present disclosure, the PUCCH resource/resource configuration ID/index (and therefore, the corresponding PUCCH resource/resource configuration of the first UL channel) of the second entry in the set of one or more PUCCH resource/resource configuration IDs/indexes as specified/defined herein in the present disclosure could be associated/specific/corresponding/linked to the PUSCH resource/resource configuration ID/index (and therefore, the corresponding PUSCH resource/resource configuration of the second UL channel) of the second entry in the set of one or more PUSCH resource/resource configuration IDs/indexes as specified/defined herein in the present disclosure, and so on, and the PUCCH resource/resource configuration ID/index (and therefore, the corresponding PUCCH resource/resource configuration of the first UL channel) of the last entry in the set of one or more PUCCH resource/resource configuration IDs/indexes as specified/defined herein the present in disclosure could be associated/specific/corresponding/linked to the PUSCH resource/resource configuration ID/index (and therefore, the corresponding PUSCH resource/resource configuration of the second UL channel) of the last entry in the set of one or more PUSCH resource/resource configuration IDs/indexes as specified/defined herein in the present disclosure.
   For another example, the first information could correspond to a set of one or more PUCCH resource/resource configuration IDs/indexes each corresponding to a PUCCH-Config, PUCCH-ResourceSet, PUCCH-Resource, PUCCH-ResourceCommon and/or etc. that provides or configures the PUCCH resource/resource configuration of the first UL channel, and the second information could correspond to a set of one or more PUSCH resource/resource configuration IDs/indexes each corresponding to a PUSCH-Config, UCI-OnPUSCH, PUSCH-ConfigCommon, ConfiguredGrantConfig, SPS-Config, CG-UCI-OnPUSCH and/or etc. that provides or configures the PUSCH resource/resource configuration of the second UL channel. For this design example, the lowest (or highest) value of the PUCCH resource/resource configuration ID/index (and therefore, the corresponding PUCCH resource/resource configuration of the first UL channel) in the set of one or more PUCCH resource/resource configuration IDs/indexes as specified/defined herein in the present disclosure could be associated/specific/corresponding/linked to the lowest (or highest) value of the PUSCH resource/resource configuration ID/index (and therefore, the corresponding PUSCH resource/resource configuration of the second UL channel) in the set of one or more PUSCH resource/resource configuration IDs/indexes as specified/defined herein in the present disclosure, the second lowest (or second highest) value of PUCCH resource/resource configuration ID/index (and therefore, the corresponding PUCCH resource/resource configuration of the first UL channel) in the set of one or more PUCCH resource/resource configuration IDs/indexes as specified/defined herein in the present disclosure could be associated/specific/corresponding/linked to the second lowest (or second highest) value of the PUSCH resource/resource configuration ID/index (and therefore, the corresponding PUSCH resource/resource configuration of the second UL channel) in the set of one or more PUSCH resource/resource configuration IDs/indexes as specified/defined herein in the present disclosure, and so on, and the highest (or lowest) value of the PUCCH resource/resource configuration ID/index (and therefore, the corresponding PUCCH resource/resource configuration of the first UL channel) in the set of one or more PUCCH resource/resource configuration IDs/indexes as specified/defined herein in the present disclosure could be associated/specific/corresponding/linked to the highest (or lowest) value of the PUSCH resource/resource configuration ID/index (and therefore, the corresponding PUSCH resource/resource configuration of the second UL channel) in the set of one or more PUSCH resource/resource configuration IDs/indexes as specified/defined herein in the present disclosure.
   For another example, the first information could correspond to a set of one or more PUCCH resource/resource configuration IDs/indexes each corresponding to a PUCCH-Config, PUCCH-ResourceSet, PUCCH-Resource, PUCCH-ResourceCommon and/or etc. that provides or configures the PUCCH resource/resource configuration of the first UL channel, and the second information could correspond to a set of one or more PUSCH resource/resource configuration IDs/indexes each corresponding a to PUSCH-Config, UCI-OnPUSCH, PUSCH-ConfigCommon, ConfiguredGrantConfig, SPS-Config, CG-UCI-OnPUSCH and/or etc. that provides or configures the PUSCH resource/resource configuration of the second UL channel. For this design example, the higher layer parameter(s)/signaling(s) that provides or configures necessary information and/or setting for the UE-initiated/event-driven beam reporting could also provide or configure or comprise or include or contain a bitmap with each entry/bit position of the bitmap associated, corresponding, specific or linked to a PUCCH resource/resource configuration ID/index in the set of one or more PUCCH resource/resource configuration IDs/indexes and a PUSCH resource/resource configuration ID/index in the set of one or more PUSCH resource/resource configuration IDs/indexes. In this case, when/if an entry/bit position of the bitmap is set to ‘1’ (or ‘0’), the PUCCH resource/resource configuration ID/index (and therefore, the corresponding PUCCH resource/resource configuration of the first UL channel) in the set of one or more PUCCH resource/resource configuration IDs/indexes as specified/defined herein in the present disclosure associated/corresponding/specific/linked to the entry/bit position could be associated/specific/corresponding/linked to the PUSCH resource/resource configuration ID/index (and therefore, the corresponding PUSCH resource/resource configuration of the second UL channel) in the set of one or more PUSCH resource/resource configuration IDs/indexes as specified/defined herein in the present disclosure associated/corresponding/linked to the entry/bit position.

According to or following those specified/described herein in the present disclosure, e.g., for Mode-A, Mode-B and/or Mode-C as specified/defined herein in the present disclosure (i.e., when/if one or more of them are configured/provided/enabled), a PUCCH resource or transmission or transmission occasion or a PUCCH resource configuration of the first UL channel in Mode A, Mode B and/or Mode C could be associated to a set of M (M≥1 or M>1) CSI report settings/configurations provided for the UE-initiated/event-driven beam reporting. For instance, each of the M CSI report settings/configurations could be provided by higher layer parameter(s) CSI-ReportConfig and/or UEI-ReportConfig configured for the UE-initiated/event-driven beam reporting—e.g., for a given CSI report setting/configuration (i.e., out of all the M CSI report settings/configuration in the set) provided/configured by a CSI-ReportConfig/UEI-ReportConfig, higher layer parameter denoted by ueInitiatedBeamReporting could be provided/configured and/or set to ‘enabled’ in the CSI-ReportConfig and/or UEI-ReportConfig that provides or configures the CSI report setting/configuration, and/or higher layer parameter reportQuantity in the CSI-ReportConfig and/or UEI-ReportConfig could be set to a particular value, e.g., ‘none’, to enable the UE-initiated/event-driven beam reporting for the corresponding CSI report setting/configuration. A UE could determine or identify that a PUCCH resource/resource configuration of the first UL channel could be associated/specific/mapped/linked/corresponding to the set of M CSI report settings/configurations configured or provided for the UE-initiated/event-driven beam reporting according to one or more of:
In one example, the higher layer parameter(s)/signaling(s) that provides or configures the PUCCH resource/resource configuration of the first UL channel such as PUCCH-Config, PUCCH-ResourceSet, PUCCH-Resource, PUCCH-ResourceCommon and/or etc. could provide or configure or comprise or include or contain information related to the set of M CSI report settings/configurations—e.g., M reportConfigId's of M CSI-ReportConfig's/UEI-ReportConfig's as specified/defined herein in the present disclosure each providing or configuring a CSI report setting/configuration in the set of M CSI report settings/configurations.
In another example, higher layer parameter(s)/signaling(s) CSI-ReportConfig(s)/UEI-ReportConfig(s) that provides or configures each of the M CSI report settings/configurations in the corresponding set for the UE-initiated/event-driven beam reporting as specified/defined herein in the present disclosure could provide or configure or comprise or include or contain information related to the PUCCH resource/resource configuration of the first UL channel—e.g., (a same) ID or index of the higher layer parameter(s) PUCCH-Config, PUCCH-ResourceSet, PUCCH-Resource, PUCCH-ResourceCommon and/or etc. that provides or configures the PUCCH resource/resource configuration of the first UL channel.
In another example, the higher layer parameter(s)/signaling(s) that provides or configures the PUCCH resource/resource configuration of the first UL channel such as PUCCH-Config, PUCCH-ResourceSet, PUCCH-Resource, PUCCH-ResourceCommon and/or etc. could provide or configure or comprise or include or contain a first entity ID, and higher layer parameter(s)/signaling(s) CSI-ReportConfig(s)/UEI-ReportConfig(s) that provides or configures each of the M CSI report settings/configurations in the corresponding set for the UE-initiated/event-driven beam reporting as specified/defined herein in the present disclosure could provide or configure or comprise or include or contain a (same) second entity ID. For this design example, the first entity ID and the second entity ID(s) could have the same/identical value(s)—e.g., the first and second entity IDs could be in form of one-bit indicators, and both of them could correspond to ‘1’s or ‘0’s.
In another example, higher layer parameter(s)/signaling(s) that provides or configures necessary information and/or setting for the UE-initiated/event-driven beam reporting could provide or configure or comprise or include or contain first information related to one or more CSI report settings/configurations provided or configured for the UE-initiated/event-driven beam reporting as specified/defined herein in the present disclosure, and second information related to one or more PUCCH resources/resource configurations of the first UL channel as specified/defined herein in the present disclosure, wherein the UE could determine or identify association(s)/mapping(s)/linkage(s) between the first and second information according to one or more of:
   For example, the first information could correspond to N≥1 sets of reportConfigId's with each set comprising one or more (i.e., M) reportConfigId's each corresponding to a CSI-ReportConfig and/or UEI-ReportConfig that provides or configures a CSI report setting/configuration for the UE-initiated/event-driven beam reporting as specified/defined herein in the present disclosure, and the second information could correspond to a set of one or more (i.e., N) PUCCH resource/resource configuration IDs/indexes each corresponding to a PUCCH-Config, PUCCH-ResourceSet, PUCCH-Resource, PUCCH-ResourceCommon and/or etc. that provides or configures the PUCCH resource/resource configuration of the first UL channel. For this design example, the M reportConfigId's (and therefore, the corresponding M CSI report settings/configurations) in the first set of reportConfigId's (e.g., the 1st set among all the N sets in ordinal position(s), the set with the lowest/highest set ID/index among all the N sets, and/or etc.) could be associated/specific/corresponding/linked to the PUCCH resource/resource configuration ID/index (and therefore, the corresponding PUCCH resource/resource configuration of the first UL channel) of the first entry in the set of N PUCCH resource/resource configuration IDs/indexes as specified/defined herein in the present disclosure, the M reportConfigId's (and therefore, the corresponding M CSI report settings/configurations) in the second set of reportConfigId's (e.g., the 2nd set among all the N sets in ordinal position(s), the set with the second lowest/highest set ID/index among all the N sets, and/or etc.) could be associated/specific/corresponding/linked to the PUCCH resource/resource configuration ID/index (and therefore, the corresponding PUCCH resource/resource configuration of the first UL channel) of the second entry in the set of N PUCCH resource/resource configuration IDs/indexes as specified/defined herein in the present disclosure, and so on, and the M reportConfigId's (and therefore, the corresponding M CSI report settings/configurations) in the last set of reportConfigId's (e.g., the N-th set among all the N sets in ordinal position(s), the set with the highest/lowest set ID/index among all the N sets, and/or etc.) could be associated/specific/corresponding/linked to the PUCCH resource/resource configuration ID/index (and therefore, the corresponding PUCCH resource/resource configuration of the first UL channel) of the last entry in the set of N PUCCH resource/resource configuration IDs/indexes as specified/defined herein in the present disclosure.
   For another example, the first information could correspond to N≥1 sets of reportConfigId's with each set comprising one or more (i.e., M) reportConfigId's each corresponding to a CSI-ReportConfig and/or UEI-ReportConfig that provides or configures a CSI report setting/configuration for the UE-initiated/event-driven beam reporting as specified/defined herein in the present disclosure, and the second information could correspond to a set of one or more (i.e., N) PUCCH resource/resource configuration IDs/indexes each corresponding to a PUCCH-Config, PUCCH-ResourceSet, PUCCH-Resource, PUCCH-ResourceCommon and/or etc. that provides or configures the PUCCH resource/resource configuration of the first UL channel. For this design example, each of the N PUCCH resource/resource configuration IDs/indexes in the corresponding set (and therefore, the corresponding PUCCH resource/resource configuration of the first UL channel) could correspond to or could be associated or linked or mapped or specific to a bitmap with each entry/bit position of the bitmap associated, corresponding, specific or linked to a set of M reportConfigId's (and therefore, the corresponding M CSI report settings/configurations); for instance, the first entry/bit position of the bitmap could correspond to or could be associated/specific/linked/mapped to the first set (e.g., the 1st set among all the N sets in ordinal position(s), the set with the lowest/highest set ID/index among all the N sets, and/or etc.) of M reportConfigId's (and therefore, the corresponding M CSI report settings/configurations), the second entry/bit position of the bitmap could correspond to or could be associated/specific/linked/mapped to the second set (e.g., the 2nd set among all the N sets in ordinal position(s), the set with the second lowest/highest set ID/index among all the N sets, and/or etc.) of M reportConfigId's (and therefore, the corresponding M CSI report settings/configurations), and so on, and the last entry/bit position of the bitmap could correspond to or could be associated/specific/linked/mapped to the last set (e.g., the N-th set among all the N sets in ordinal position(s), the set with the highest/lowest set ID/index among all the N sets, and/or etc.) of M reportConfigId's (and therefore, the corresponding M CSI report settings/configurations). In this case, for a PUCCH resource/resource configuration ID/index in the corresponding set (and therefore, the corresponding PUCCH resource/resource configuration of the first UL channel), when/if an entry/bit position of the bitmap associated/specific/corresponding/mapped to the PUCCH resource/resource configuration is set to ‘1’ (or ‘0’), the set of M reportConfigId's (and therefore, the corresponding CSI report settings/configurations) associated/corresponding/specific/linked to the entry/bit position could be associated/specific/corresponding/linked to the PUCCH resource/resource configuration ID/index (and therefore, the corresponding PUCCH resource/resource configuration of the first UL channel) in the set of N PUCCH resource/resource configuration IDs/indexes as specified/defined herein in the present disclosure. For this design example, the higher layer parameter(s)/signaling(s) that provides or configures necessary information and/or setting for the UE-initiated/event-driven beam reporting could provide or configure or comprise or include or contain the bitmap(s).

According to or following those specified/described herein in the present disclosure, e.g., for Mode-A, Mode-B and/or Mode-C as specified/defined herein in the present disclosure (i.e., when/if one or more of them are configured/provided/enabled) and/or for DG and/or Type1/2 CG PUSCH(s), a PUSCH resource or transmission or transmission occasion or a PUSCH resource configuration of the second UL channel in Mode A, Mode B and/or Mode C could be associated to a set of M (M≥1 or M>1) CSI report settings/configurations provided for the UE-initiated/event-driven beam reporting. For instance, each of the M CSI report settings/configurations could be provided by higher layer parameter(s) CSI-ReportConfig and/or UEI-ReportConfig configured for the UE-initiated/event-driven beam reporting—e.g., for a given CSI report setting/configuration (i.e., out of all the M CSI report settings/configuration in the set) provided/configured by a CSI-ReportConfig/UEI-ReportConfig, higher layer parameter denoted by ueInitiatedBeamReporting could be provided/configured and/or set to ‘enabled’ in the CSI-ReportConfig and/or UEI-ReportConfig that provides or configures the CSI report setting/configuration, and/or higher layer parameter reportQuantity in the CSI-ReportConfig and/or UEI-ReportConfig could be set to a particular value, e.g., ‘none’, to enable the UE-initiated/event-driven beam reporting for the corresponding CSI report setting/configuration. A UE could determine or identify that a PUSCH resource/resource configuration of the second UL channel could be associated/specific/mapped/linked/corresponding to the set of M CSI report settings/configurations configured or provided for the UE-initiated/event-driven beam reporting according to one or more of:
In one example, the higher layer parameter(s)/signaling(s) that provides or configures the PUSCH resource/resource configuration of the second UL channel such as PUSCH-Config, UL-OnPUSCH, PUSCH-ConfigCommon, ConfiguredGrantConfig, SPS-Config, CG-UCI-OnPUSCH and/or etc. could provide or configure or comprise or include or contain information related to the set of M CSI report settings/configurations—e.g., M reportConfigId's of M CSI-ReportConfig's/UEI-ReportConfig's as specified/defined herein in the present disclosure each providing or configuring a CSI report setting/configuration in the set of M CSI report settings/configurations.
In another example, higher layer parameter(s)/signaling(s) CSI-ReportConfig(s)/UEI-ReportConfig(s) that provides or configures each of the M CSI report settings/configurations in the corresponding set for the UE-initiated/event-driven beam reporting as specified/defined herein in the present disclosure could provide or configure or comprise or include or contain information related to the PUSCH resource/resource configuration of the second UL channel—e.g., (a same) ID or index of the higher layer parameter(s) PUSCH-Config, UCI-OnPUSCH, PUSCH-ConfigCommon, ConfiguredGrantConfig, SPS-Config, CG-UCI-OnPUSCH and/or etc. that provides or configures the PUSCH resource/resource configuration of the second UL channel.
In another example, the higher layer parameter(s)/signaling(s) that provides or configures the PUSCH resource/resource configuration of the second UL channel such as PUSCH-Config, UCI-OnPUSCH, PUSCH-ConfigCommon, ConfiguredGrantConfig, SPS-Config, CG-UCI-OnPUSCH and/or etc. could provide or configure or comprise or include or contain a first entity ID, and higher layer parameter(s)/signaling(s) CSI-ReportConfig(s)/UEI-ReportConfig(s) that provides or configures each of the M CSI report settings/configurations in the corresponding set for the UE-initiated/event-driven beam reporting as specified/defined herein in the present disclosure could provide or configure or comprise or include or contain a (same) second entity ID. For this design example, the first entity ID and the second entity ID(s) could have the same/identical value(s)—e.g., the first and second entity IDs could be in form of one-bit indicators, and both of them could correspond to ‘1’s or ‘0’s.
In another example, higher layer parameter(s)/signaling(s) that provides or configures necessary information and/or setting for the UE-initiated/event-driven beam reporting could provide or configure or comprise or include or contain first information related to one or more CSI report settings/configurations provided or configured for the UE-initiated/event-driven beam reporting as specified/defined herein in the present disclosure, and second information related to one or more PUSCH resources/resource configurations of the second UL channel as specified/defined herein in the present disclosure, wherein the UE could determine or identify association(s)/mapping(s)/linkage(s) between the first and second information according to one or more of:
   For example, the first information could correspond to N≥1 sets of reportConfigId's with each set comprising one or more (i.e., M) reportConfigId's each corresponding to a CSI-ReportConfig and/or UEI-ReportConfig that provides or configures a CSI report setting/configuration for the UE-initiated/event-driven beam reporting as specified/defined herein in the present disclosure, and the second information could correspond to a set of one or more (i.e., N) PUSCH resource/resource configuration IDs/indexes each corresponding to a PUSCH-Config, UCI-OnPUSCH, PUSCH-ConfigCommon, ConfiguredGrantConfig, SPS-Config, CG-UCI-OnPUSCH and/or etc. that provides or configures the PUSCH resource/resource configuration of the second UL channel. For this design example, the M reportConfigld's (and therefore, the corresponding M CSI report settings/configurations) in the first set of reportConfigId's (e.g., the 1st set among all the N sets in ordinal position(s), the set with the lowest/highest set ID/index among all the N sets, and/or etc.) could be associated/specific/corresponding/linked to the PUSCH resource/resource configuration ID/index (and therefore, the corresponding PUSCH resource/resource configuration of the second UL channel) of the first entry in the set of N PUSCH resource/resource configuration IDs/indexes as specified/defined herein in the present disclosure, the M reportConfigId's (and therefore, the corresponding M CSI report settings/configurations) in the second set of reportConfigId's (e.g., the 2nd set among all the N sets in ordinal position(s), the set with the second lowest/highest set ID/index among all the N sets, and/or etc.) could be associated/specific/corresponding/linked to the PUSCH resource/resource configuration ID/index (and therefore, the corresponding PUSCH resource/resource configuration of the second UL channel) of the second entry in the set of N PUSCH resource/resource configuration IDs/indexes as specified/defined herein in the present disclosure, and so on, and the M reportConfigId's (and therefore, the corresponding M CSI report settings/configurations) in the last set of reportConfigId's (e.g., the N-th set among all the N sets in ordinal position(s), the set with the highest/lowest set ID/index all among the N sets, and/or etc.) could be associated/specific/corresponding/linked to the PUSCH resource/resource configuration ID/index (and therefore, the corresponding PUSCH resource/resource configuration of the second UL channel) of the last entry in the set of N PUSCH resource/resource configuration IDs/indexes as specified/defined herein in the present disclosure.
   For another example, the first information could correspond to N≥1 sets of reportConfigId's with each set comprising one or more (i.e., M) reportConfigId's each corresponding to a CSI-ReportConfig and/or UEI-ReportConfig that provides or configures a CSI report setting/configuration for the UE-initiated/event-driven beam reporting as specified/defined herein in the present disclosure, and the second information could correspond to a set of one or more (i.e., N) PUSCH resource/resource configuration IDs/indexes each corresponding to a PUSCH-Config, UL-OnPUSCH, PUSCH-ConfigCommon, ConfiguredGrantConfig, SPS-Config, CG-UCI-OnPUSCH and/or etc. that provides or configures the PUSCH resource/resource configuration of the second UL channel. For this design example, each of the N PUSCH resource/resource configuration IDs/indexes in the corresponding set (and therefore, the corresponding PUSCH resource/resource configuration of the second UL channel) could correspond to or could be associated or linked or mapped or specific to a bitmap with each entry/bit position of the bitmap associated, corresponding, specific or linked to a set of M reportConfigId's (and therefore, the corresponding M CSI report settings/configurations); for instance, the first entry/bit position of the bitmap could correspond to or could be associated/specific/linked/mapped to the first set (e.g., the 1st set among all the N sets in ordinal position(s), the set with the lowest/highest set ID/index among all the N sets, and/or etc.) of M reportConfigId's (and therefore, the corresponding M CSI report settings/configurations), the second entry/bit position of the bitmap could correspond to or could be associated/specific/linked/mapped to the second set (e.g., the 2nd set among all the N sets in ordinal position(s), the set with the second lowest/highest set ID/index among all the N sets, and/or etc.) of M reportConfigId's (and therefore, the corresponding M CSI report settings/configurations), and so on, and the last entry/bit position of the bitmap could correspond to or could be associated/specific/linked/mapped to the last set (e.g., the N-th set among all the N sets in ordinal position(s), the set with the highest/lowest set ID/index among all the N sets, and/or etc.) of M reportConfigId's (and therefore, the corresponding M CSI report settings/configurations). In this case, for a PUSCH resource/resource configuration ID/index in the corresponding set (and therefore, the corresponding PUSCH resource/resource configuration of the second UL channel), when/if an entry/bit of the position bitmap associated/specific/corresponding/mapped to the PUSCH resource/resource configuration is set to ‘1’ (or ‘0’), the set of M reportConfigId's (and therefore, the corresponding CSI report settings/configurations) associated/corresponding/specific/linked to the entry/bit position could be associated/specific/corresponding/linked to the PUSCH resource/resource configuration ID/index (and therefore, the corresponding PUSCH resource/resource configuration of the second UL channel) in the set of N PUSCH resource/resource configuration IDs/indexes as specified/defined herein in the present disclosure. For this design example, the higher layer parameter(s)/signaling(s) that provides or configures necessary information and/or setting for the UE-initiated/event-driven beam reporting could provide or configure or comprise or include or contain the bitmap(s).

According to or following those specified/described herein in the present disclosure, e.g., for Mode-A, Mode-B and/or Mode-C as specified/defined herein in the present disclosure (i.e., when/if one or more of them are configured/provided/enabled), a PUCCH resource or transmission or transmission occasion or a PUCCH resource configuration of the first UL channel could be associated to a set of M (M≥1 or M>1) PUSCH resources or transmissions or transmission occasions or PUSCH resource configurations (e.g., DG and/or Type 1/2 CG PUSCH(s)) of the second UL channel in Mode A, Mode B and/or Mode C. A UE could determine or identify that a PUCCH resource/resource configuration of the first UL channel could be associated/specific/mapped/linked/corresponding to the set of M PUSCH resources/PUSCH resource configurations according to one or more of:
In one example, the higher layer parameter(s)/signaling(s) that provides or configures the PUCCH resource/resource configuration of the first UL channel such as PUCCH-Config, PUCCH-ResourceSet, PUCCH-Resource, PUCCH-ResourceCommon and/or etc. could provide or configure or comprise or include or contain information related to the set of M PUSCH resources/resource configurations—e.g., M IDs/indexes of the higher layer parameters PUSCH-Config(s), UCI-OnPUSCH(s), PUSCH-ConfigCommon(s), ConfiguredGrantConfig(s), SPS-Config(s), CG-UCI-OnPUSCH(s) and/or etc. that provide or configure the M PUSCH resources/resource configurations of the second UL channel in the set.
In another example, higher layer parameter(s)/signaling(s) PUSCH-Config(s), UCI-OnPUSCH(s), PUSCH-ConfigCommon(s), ConfiguredGrantConfig(s), SPS-Config(s), CG-UCI-OnPUSCH(s) and/or etc. that provides or configures each of the M PUSCH resources/resource configurations of the second UL channel in the corresponding set as specified/defined herein in the present disclosure could provide or configure or comprise or include or contain information related to the PUCCH resource/resource configuration of the first UL channel—e.g., (a same) ID or index of the higher layer parameter(s) PUCCH-Config, PUCCH-ResourceSet, PUCCH-Resource, PUCCH-ResourceCommon and/or etc. that provides or configures the PUCCH resource/resource configuration of the first UL channel.
In another example, the higher layer parameter(s)/signaling(s) that provides or configures the PUCCH resource/resource configuration of the first UL channel such as PUCCH-Config, PUCCH-ResourceSet, PUCCH-Resource, PUCCH-ResourceCommon and/or etc. could provide or configure or comprise or include or contain a first entity ID, and the higher layer parameter(s)/signaling(s) that provides or configures each of the M PUSCH resources/resource configurations of the second UL channel such as PUSCH-Config(s), UCI-OnPUSCH(s), PUSCH-ConfigCommon(s), ConfiguredGrantConfig(s), SPS-Config(s), CG-UCI-OnPUSCH(s) and/or etc. could provide or configure or comprise or include or contain a (same) second entity ID. For this design example, the first entity ID and the second entity ID(s) could have the same/identical value(s)—e.g., the first and second entity IDs could be in form of one-bit indicators, and both of them could correspond to ‘1’s or ‘0’s.
In another example, higher layer parameter(s)/signaling(s) that provides or configures necessary information and/or setting for the UE-initiated/event-driven beam reporting could provide or configure or comprise or include or contain first information related to one or more PUCCH resources/resource configurations of the first UL channel as specified/defined herein in the present disclosure, and second information related to one or more PUSCH resources/resource configurations of the second UL channel as specified/defined herein in the present disclosure, wherein the UE could determine or identify association(s)/mapping(s)/linkage(s) between the first and second information according to one or more of:
   For example, the first information could correspond to N≥1 sets of PUSCH resource/resource configuration IDs/indexes with each set comprising one or more (i.e., M) PUSCH resource/resource configuration IDs/indexes each corresponding to a PUSCH-Config, UCI-OnPUSCH, PUSCH-ConfigCommon, ConfiguredGrantConfig, SPS-Config, CG-UCI-OnPUSCH and/or etc. that provides or configures the PUSCH resource/resource configuration of the second UL channel, and the second information could correspond to a set of one or more (i.e., N) PUCCH resource/resource configuration IDs/indexes each corresponding to a PUCCH-Config, PUCCH-ResourceSet, PUCCH-Resource, PUCCH-ResourceCommon and/or etc. that provides or configures the PUCCH resource/resource configuration of the first UL channel. For this design example, the M PUSCH resource/resource configuration IDs/indexes (and therefore, the corresponding M PUSCH resources/resource configurations of the second UL channel) in the first set of PUSCH resource/resource configuration IDs/indexes (e.g., the 1st set among all the N sets in ordinal position(s), the set with the lowest/highest set ID/index among all the N sets, and/or etc.) could be associated/specific/corresponding/linked to the PUCCH resource/resource configuration ID/index (and therefore, the corresponding PUCCH resource/resource configuration of the first UL channel) of the first entry in the set of N PUCCH resource/resource configuration IDs/indexes as specified/defined herein in the present disclosure, the M PUSCH resource/resource configuration IDs/indexes (and therefore, the corresponding M PUSCH resources/resource configurations of the second UL channel) in the second set of PUSCH resource/resource configuration IDs/indexes (e.g., the 2nd set among all the N sets in ordinal position(s), the set with the second lowest/highest set ID/index among all the N sets, and/or etc.) could be associated/specific/corresponding/linked to the PUCCH resource/resource configuration ID/index (and therefore, the corresponding PUCCH resource/resource configuration of the first UL channel) of the second entry in the set of N PUCCH resource/resource configuration IDs/indexes as specified/defined herein in the present disclosure, and so on, and the M PUSCH resource/resource configuration IDs/indexes (and therefore, the corresponding M PUSCH resources/resource configurations of the second UL channel) in the last set of PUSCH resource/resource configuration IDs/indexes (e.g., the N-th set among all the N sets in ordinal position(s), the set with the highest/lowest set ID/index among all the N sets, and/or etc.) could be associated/specific/corresponding/linked to the PUCCH resource/resource configuration ID/index (and therefore, the corresponding PUCCH resource/resource configuration of the first UL channel) of the last entry in the set of N PUCCH resource/resource configuration IDs/indexes as specified/defined herein in the present disclosure.
   For another example, the first information could correspond to N≥1 sets of PUSCH resource/resource configuration IDs/indexes with each set comprising one or more (i.e., M) PUSCH resource/resource configuration IDs/indexes each corresponding to a PUSCH-Config, UCI-OnPUSCH, PUSCH-ConfigCommon, ConfiguredGrantConfig, SPS-Config, CG-UCI-OnPUSCH and/or etc. that provides or configures the PUSCH resource/resource configuration of the second UL channel, and the second information could correspond to a set of one or more (i.e., N) PUCCH resource/resource configuration IDs/indexes each corresponding to a PUCCH-Config, PUCCH-ResourceSet, PUCCH-Resource, PUCCH-ResourceCommon and/or etc. that provides or configures the PUCCH resource/resource configuration of the first UL channel. For this design example, each of the N PUCCH resource/resource configuration IDs/indexes in the corresponding set (and therefore, the corresponding PUCCH resource/resource configuration of the first UL channel) could correspond to or could be associated or linked or mapped or specific to a bitmap with each entry/bit position of the bitmap associated, corresponding, specific or linked to a set of M PUSCH resource/resource configuration ID/indexes (and therefore, the corresponding M PUSCH resources/resource configurations of the second UL channel); for instance, the first entry/bit position of the bitmap could correspond to or could be associated/specific/linked/mapped to the first set (e.g., the 1st set among all the N sets in ordinal position(s), the set with the lowest/highest set ID/index among all the N sets, and/or etc.) of M PUSCH resource/resource configuration IDs/indexes (and therefore, the corresponding M PUSCH resources/resource configurations of the second UL channel), the second entry/bit position of the bitmap could correspond to or could be associated/specific/linked/mapped to the second set (e.g., the 2nd set among all the N sets in ordinal position(s), the set with the second lowest/highest set ID/index among all the N sets, and/or etc.) of M PUSCH resource/resource configuration IDs/indexes (and therefore, the corresponding M PUSCH resources/resource configurations of the second UL channel), and so on, and the last entry/bit position of the bitmap could correspond to or could be associated/specific/linked/mapped to the last set (e.g., the N-th set among all the N sets in ordinal position(s), the set with the highest/lowest set ID/index among all the N sets, and/or etc.) of M PUSCH resource/resource configuration IDs/indexes (and therefore, the corresponding M PUSCH resources/resource configurations of the second UL channel). In this case, for a PUCCH resource/resource configuration ID/index in the corresponding set (and therefore, the corresponding PUCCH resource/resource configuration of the first UL channel), when/if an entry/bit position of the bitmap associated/specific/corresponding/mapped to the PUCCH resource/resource configuration is set to ‘1’ (or ‘0’), the set of M PUSCH resource/resource configuration IDs/indexes (and therefore, the corresponding PUSCH resources/resource configurations of the second UL channel) associated/corresponding/specific/linked to the entry/bit position could be associated/specific/corresponding/linked to the PUCCH resource/resource configuration ID/index (and therefore, the corresponding PUCCH resource/resource configuration of the first UL channel) in the set of N PUCCH resource/resource configuration IDs/indexes as specified/defined herein in the present disclosure. For this design example, the higher layer parameter(s)/signaling(s) that provides or configures necessary information and/or setting for the UE-initiated/event-driven beam reporting could provide or configure or comprise or include or contain the bitmap(s).

According to or following those specified/described herein in the present disclosure, e.g., for Mode-A, Mode-B and/or Mode-C as specified/defined herein in the present disclosure (i.e., when/if one or more of them are configured/provided/enabled), a set of M (M≥1 or M>1) PUCCH resources or transmissions or transmission occasions or PUCCH resource configurations of the first UL channel in Mode A, Mode B and/or Mode C could be associated to a CSI report setting/configuration provided for the UE-initiated/event-driven beam reporting. For instance, the CSI report setting/configuration could be provided by higher layer parameter(s) CSI-ReportConfig and/or UEI-ReportConfig configured for the UE-initiated/event-driven beam reporting—e.g., a higher layer parameter denoted by ueInitiatedBeamReporting could be provided/configured and/or set to ‘enabled’ in the CSI-ReportConfig and/or UEI-ReportConfig, and/or higher layer parameter reportQuantity in the CSI-ReportConfig and/or UEI-ReportConfig could be set to a particular value, e.g., ‘none’, to enable the UE-initiated/event-driven beam reporting. A UE could determine or identify that the CSI report setting/configuration configured or provided for the UE-initiated/event-driven beam reporting could be associated/specific/mapped/linked/corresponding to the set of M PUCCH resources/PUCCH resource configurations according to one or more of:
In one example, the CSI-ReportConfig/UEI-ReportConfig that provides or configures the CSI report setting/configuration for the UE-initiated/event-driven beam reporting as specified/defined herein in the present disclosure could provide or configure or comprise or include or contain information related to the set of M PUCCH resources/resource configurations—e.g., M IDs/indexes of the higher layer parameters PUCCH-Config(s), PUCCH-ResourceSet(s), PUCCH-Resource(s), PUCCH-ResourceCommon(s) and/or etc. that provide or configure the M PUCCH resources/resource configurations of the first UL channel in the set.
In another example, higher layer parameter(s)/signaling(s) PUCCH-Config(s), PUCCH-ResourceSet(s), PUCCH-Resource(s), PUCCH-ResourceCommon(s) and/or etc. that provides or configures each of the M PUCCH resources/resource configurations of the first UL channel in the corresponding set as specified/defined herein in the present disclosure could provide or configure or comprise or include or contain information related to the CSI report setting/configuration—e.g., reportConfigId of the CSI-ReportConfig/UEI-ReportConfig as specified/defined herein in the present disclosure that provides or configures the CSI report setting/configuration.
In another example, the higher layer parameter(s)/signaling(s) that provides or configures each of the M PUCCH resources/resource configurations of the first UL channel such as PUCCH-Config(s), PUCCH-ResourceSet(s), PUCCH-Resource(s), PUCCH-ResourceCommon(s) and/or etc. could provide or configure or comprise or include or contain a first entity ID, and the CSI-ReportConfig/UEI-ReportConfig that provides or configures the CSI report setting/configuration for the UE-initiated/event-driven beam reporting as specified/defined herein in the present disclosure could provide or configure or comprise or include or contain a second entity ID. For this design example, the first entity ID(s) and the second entity ID could have the same/identical value(s)—e.g., the first and second entity IDs could be in form of one-bit indicators, and both of them could correspond to ‘1’s or ‘0’s.
In another example, higher layer parameter(s)/signaling(s) that provides or configures necessary information and/or setting for the UE-initiated/event-driven beam reporting could provide or configure or comprise or include or contain first information related to one or more CSI report settings/configurations provided or configured for the UE-initiated/event-driven beam reporting as specified/defined herein in the present disclosure, and second information related to one or more PUCCH resources/resource configurations of the first UL channel as specified/defined herein in the present disclosure, wherein the UE could determine or identify association(s)/mapping(s)/linkage(s) between the first and second information according to one or more of:
   For example, the first information could correspond to a set of one or more (N) reportConfigId's each corresponding to a CSI-ReportConfig and/or UEI-ReportConfig that provides or configures a CSI report setting/configuration for the UE-initiated/event-driven beam reporting as specified/defined herein in the present disclosure, and the second information could correspond to N≥1 sets of PUCCH resource/resource configuration IDs/indexes with each set comprising one or more (i.e., M) PUCCH resource/resource configuration IDs/indexes each corresponding to a PUCCH-Config, PUCCH-ResourceSet, PUCCH-Resource, PUCCH-ResourceCommon and/or etc. that provides or configures the PUCCH resource/resource configuration of the first UL channel. For this design example, the M PUCCH resource/resource configuration IDs/indexes (and therefore, the corresponding M PUCCH resources/resource configurations of the first UL channel) in the first set of PUCCH resource/resource configuration IDs/indexes (e.g., the 1st set among all the N sets in ordinal position(s), the set with the lowest/highest set ID/index among all the N sets, and/or etc.) could be associated/specific/corresponding/linked to the reportConfigId (and therefore, the corresponding CSI report setting/configuration for the UE-initiated/event-driven beam reporting) of the first entry in the set of N reportConfigId's as specified/defined herein in the present disclosure, the M PUCCH resource/resource configuration IDs/indexes (and therefore, the corresponding M PUCCH resources/resource configurations of the first UL channel) in the second set of PUCCH resource/resource configuration IDs/indexes (e.g., the 2nd set among all the N sets in ordinal position(s), the set with the second lowest/highest set ID/index among all the N sets, and/or etc.) could be associated/specific/corresponding/linked to the reportConfigId (and therefore, the corresponding CSI report setting/configuration for the UE-initiated/event-driven beam reporting) of the second entry in the set of N reportConfigId's as specified/defined herein in the present disclosure, and so on, and the M PUCCH resource/resource configuration IDs/indexes (and therefore, the corresponding M PUCCH resources/resource configurations of the first UL channel) in the last set of PUCCH resource/resource configuration IDs/indexes (e.g., the N-th set among all the N sets in ordinal position(s), the set with the highest/lowest set ID/index among all the be N sets, and/or etc.) could associated/specific/corresponding/linked to the reportConfigId (and therefore, the corresponding CSI report setting/configuration for the UE-initiated/event-driven beam reporting) of the last entry in the set of N reportConfigId's as specified/defined herein in the present disclosure.
   For another example, the first information could correspond to a set of one or more (N) reportConfigId's each corresponding to a CSI-ReportConfig and/or UEI-ReportConfig that provides or configures a CSI report setting/configuration for the UE-initiated/event-driven beam reporting as specified/defined herein in the present disclosure, and the second information could correspond to N≥1 sets of PUCCH resource/resource configuration IDs/indexes with each set comprising one or more (i.e., M) PUCCH resource/resource configuration IDs/indexes each corresponding to a PUCCH-Config, PUCCH-ResourceSet, PUCCH-Resource, PUCCH-ResourceCommon and/or etc. that provides or configures the PUCCH resource/resource configuration of the first UL channel. For this design example, each of the N reportConfigId's in the corresponding set (and therefore, the corresponding CSI report setting/configuration configured or provided for the UE-initiated/event-driven beam reporting) could correspond to or could be associated or linked or mapped or specific to a bitmap with each entry/bit position of the bitmap associated, corresponding, specific or linked to a set of M PUCCH resource/resource configuration ID/indexes (and therefore, the corresponding M PUCCH resources/resource configurations of the first UL channel); for instance, the first entry/bit position of the bitmap could correspond to or could be associated/specific/linked/mapped to the first set (e.g., the 1st set among all the N sets in ordinal position(s), the set with the lowest/highest set ID/index among all the N sets, and/or etc.) of M PUCCH resource/resource configuration IDs/indexes (and therefore, the corresponding M PUCCH resources/resource configurations of the first UL channel), the second entry/bit position of the bitmap could correspond to or could be associated/specific/linked/mapped to the second set (e.g., the 2nd set among all the N sets in ordinal position(s), the set with the second lowest/highest set ID/index among all the N sets, and/or etc.) of M PUCCH resource/resource configuration IDs/indexes (and therefore, the corresponding M PUCCH resources/resource configurations of the first UL channel), and so on, and the last entry/bit position of the bitmap could correspond to or could be associated/specific/linked/mapped to the last set (e.g., the N-th set among all the N sets in ordinal position(s), the set with the highest/lowest set ID/index among all the N sets, and/or etc.) of M PUCCH resource/resource configuration IDs/indexes (and therefore, the corresponding M PUCCH resources/resource configurations of the first UL channel). In this case, for a reportConfigId in the corresponding set (and therefore, the corresponding CSI report configuration/setting provide or configured for the UE-initiated/event-driven beam reporting), when/if an entry/bit position of the bitmap associated/specific/corresponding/mapped to the CSI report setting/configuration is set to ‘1’ (or ‘0’), the set of M PUCCH resource/resource configuration IDs/indexes (and therefore, the corresponding PUCCH resources/resource configurations of the first UL channel) associated/corresponding/specific/linked to the entry/bit position could be associated/specific/corresponding/linked to the reportConfigId (and therefore, the corresponding CSI report configuration/setting for the UE-initiated/event-driven beam reporting) in the set of N reportConfigId's as specified/defined herein in the present disclosure. For this design example, the higher layer parameter(s)/signaling(s) that provides or configures necessary information and/or setting for the UE-initiated/event-driven beam reporting could provide or configure or comprise or include or contain the bitmap(s).

According to or following those specified/described herein in the present disclosure, e.g., for Mode-A, Mode-B and/or Mode-C as specified/defined herein in the present disclosure (i.e., when/if one or more of them are configured/provided/enabled) and/or for DG and/or Type 1/2 CG PUSCH(s), a set of M (M≥1 or M>1) PUSCH resources or transmissions or transmission occasions or PUSCH resource configurations of the second UL channel in Mode A, Mode B and/or Mode C could be associated to a CSI report setting/configuration provided for the UE-initiated/event-driven beam reporting. For instance, the CSI report setting/configuration could be provided by higher layer parameter(s) CSI-ReportConfig and/or UEI-ReportConfig configured for the UE-initiated/event-driven beam reporting—e.g., a higher layer parameter denoted by ueInitiatedBeamReporting could be provided/configured and/or set to ‘enabled’ in the CSI-ReportConfig and/or UEI-ReportConfig, and/or higher layer parameter reportQuantity in the CSI-ReportConfig and/or UEI-ReportConfig could be set to a particular value, e.g., ‘none’, to enable the UE-initiated/event-driven beam reporting. A UE could determine or identify that the CSI report setting/configuration configured or provided for the UE-initiated/event-driven beam reporting could be associated/specific/mapped/linked/corresponding to the set of M PUSCH resources/PUSCH resource configurations according to one or more of:
In one example, the CSI-ReportConfig/UEI-ReportConfig that provides or configures the CSI report setting/configuration for the UE-initiated/event-driven beam reporting as specified/defined herein in the present disclosure could provide or configure or comprise or include or contain information related to the set of M PUSCH resources/resource configurations—e.g., M IDs/indexes of the higher layer parameters PUSCH-Config(s), UCI-OnPUSCH(s), PUSCH-ConfigCommon(s), ConfiguredGrantConfig(s), SPS-Config(s), CG-UCI-OnPUSCH(s) and/or etc. that provide or configure the M PUSCH resources/resource configurations of the second UL channel in the set.
In another example, higher layer parameter(s)/signaling(s) PUSCH-Config(s), UCI-OnPUSCH(s), PUSCH-ConfigCommon(s), ConfiguredGrantConfig(s), SPS-Config(s), CG-UCI-OnPUSCH(s) and/or etc. that provides or configures each of the M PUSCH resources/resource configurations of the second UL channel in the corresponding set as specified/defined herein in the present disclosure could provide or configure or comprise or include or contain information related to the CSI report setting/configuration—e.g., reportConfigId of the CSI-ReportConfig/UEI-ReportConfig as specified/defined herein in the present disclosure that provides or configures the CSI report setting/configuration.
In another example, the higher layer parameter(s)/signaling(s) that provides or configures each of the M PUSCH resources/resource configurations of the second UL channel such as PUSCH-Config(s), UCI-OnPUSCH(s), PUSCH-ConfigCommon(s), ConfiguredGrantConfig(s), SPS-Config(s), CG-UCI-OnPUSCH(s) and/or etc. could provide or configure or comprise or include or contain a first entity ID, and the CSI-ReportConfig/UEI-ReportConfig that provides or configures the CSI report setting/configuration for the UE-initiated/event-driven beam reporting as specified/defined herein in the present disclosure could provide or configure or comprise or include or contain a second entity ID. For this design example, the first entity ID(s) and the second entity ID could have the same/identical value(s)—e.g., the first and second entity IDs could be in form of one-bit indicators, and both of them could correspond to ‘1’s or ‘0’s.
In another example, higher layer parameter(s)/signaling(s) that provides or configures necessary information and/or setting for the UE-initiated/event-driven beam reporting could provide or configure or comprise or include or contain first information related to one or more CSI report settings/configurations provided or configured for the UE-initiated/event-driven beam reporting as specified/defined herein in the present disclosure, and second information related to one or more PUSCH resources/resource configurations of the second UL channel as specified/defined herein in the present disclosure, wherein the UE could determine or identify association(s)/mapping(s)/linkage(s) between the first and second information according to one or more of:
   For example, the first information could correspond to a set of one or more (N) reportConfigId's each corresponding to a CSI-ReportConfig and/or UEI-ReportConfig that provides or configures a CSI report setting/configuration for the UE-initiated/event-driven beam reporting as specified/defined herein in the present disclosure, and the second information could correspond to N≥1 sets of PUSCH resource/resource configuration IDs/indexes with each set comprising one or more (i.e., M) PUSCH resource/resource configuration IDs/indexes each corresponding to a PUSCH-Config, UCI-OnPUSCH, PUSCH-ConfigCommon, ConfiguredGrantConfig, SPS-Config, CG-UCI-OnPUSCH and/or etc. that provides or configures the PUSCH resource/resource configuration of the second UL channel. For this design example, the M PUSCH resource/resource configuration IDs/indexes (and therefore, the corresponding M PUSCH resources/resource configurations of the second UL channel) in the first set of PUSCH resource/resource configuration IDs/indexes (e.g., the 1st set among all the N sets in ordinal position(s), the set with the lowest/highest set ID/index among all the N sets, and/or etc.) could be associated/specific/corresponding/linked to the reportConfigId (and therefore, the corresponding CSI report setting/configuration for the UE-initiated/event-driven beam reporting) of the first entry in the set of N reportConfigId's as specified/defined herein in the present disclosure, the M PUSCH resource/resource configuration IDs/indexes (and therefore, the corresponding M PUSCH resources/resource configurations of the second UL channel) in the second set of PUSCH resource/resource configuration IDs/indexes (e.g., the 2nd set among all the N sets in ordinal position(s), the set with the second lowest/highest set ID/index among all the N sets, and/or etc.) could be associated/specific/corresponding/linked to the reportConfigId (and therefore, the corresponding CSI report setting/configuration for the UE-initiated/event-driven beam reporting) of the second entry in the set of N reportConfigId's as specified/defined herein in the present disclosure, and so on, and the M PUSCH resource/resource configuration IDs/indexes (and therefore, the corresponding M PUSCH resources/resource configurations of the second UL channel) in the last set of PUSCH resource/resource configuration IDs/indexes (e.g., the N-th set among all the N sets in ordinal position(s), the set with the highest/lowest set ID/index among all the N sets, and/or etc.) could be associated/specific/corresponding/linked to the reportConfigId (and therefore, the corresponding CSI report setting/configuration for the UE-initiated/event-driven beam reporting) of the last entry in the set of N reportConfigId's as specified/defined herein in the present disclosure.
   For another example, the first information could correspond to a set of one or more (N) reportConfigId's each corresponding to a CSI-ReportConfig and/or UEI-ReportConfig that provides or configures a CSI report setting/configuration for the UE-initiated/event-driven beam reporting as specified/defined herein in the present disclosure, and the second information could correspond to N≥1 sets of PUSCH resource/resource configuration IDs/indexes with each set comprising one or more (i.e., M) PUSCH resource/resource configuration IDs/indexes each corresponding to a PUSCH-Config, UCI-OnPUSCH, PUSCH-ConfigCommon, ConfiguredGrantConfig, SPS-Config, CG-UCI-OnPUSCH and/or etc. that provides or configures the PUSCH resource/resource configuration of the second UL channel. For this design example, each of the N reportConfigId's in the corresponding set (and therefore, the corresponding CSI report setting/configuration configured or provided for the UE-initiated/event-driven beam reporting) could correspond to or could be associated or linked or mapped or specific to a bitmap with each entry/bit position of the bitmap associated, corresponding, specific or linked to a set of M PUSCH resource/resource configuration ID/indexes (and therefore, the corresponding M PUSCH resources/resource configurations of the second UL channel); for instance, the first entry/bit position of the bitmap could correspond to or could be associated/specific/linked/mapped to the first set (e.g., the 1st set among all the N sets in ordinal position(s), the set with the lowest/highest set ID/index among all the N sets, and/or etc.) of M PUSCH resource/resource configuration IDs/indexes (and therefore, the corresponding M PUSCH resources/resource configurations of the second UL channel), the second entry/bit position of the bitmap could correspond to or could be associated/specific/linked/mapped to the second set (e.g., the 2nd set among all the N sets in ordinal position(s), the set with the second lowest/highest set ID/index among all the N sets, and/or etc.) of M PUSCH resource/resource configuration IDs/indexes (and therefore, the corresponding M PUSCH resources/resource configurations of the second UL channel), and so on, and the last entry/bit position of the bitmap could correspond to or could be associated/specific/linked/mapped to the last set (e.g., the N-th set among all the N sets in ordinal position(s), the set with the highest/lowest set ID/index among all the N sets, and/or etc.) of M PUSCH resource/resource configuration IDs/indexes (and therefore, the corresponding M PUSCH resources/resource configurations of the second UL channel). In this case, for a reportConfigId in the corresponding set (and therefore, the corresponding CSI report configuration/setting provide or configured for the UE-initiated/event-driven beam reporting), when/if an entry/bit position of the bitmap associated/specific/corresponding/mapped to the CSI report setting/configuration is set to ‘1’ (or ‘0’), the set of M PUSCH resource/resource configuration IDs/indexes (and therefore, the corresponding PUSCH resources/resource configurations of the second UL channel) associated/corresponding/specific/linked to the entry/bit position could be associated/specific/corresponding/linked to the reportConfigId (and therefore, the corresponding CSI report configuration/setting for the UE-initiated/event-driven beam reporting) in the set of N reportConfigId's as specified/defined herein in the present disclosure. For this design example, the higher layer parameter(s)/signaling(s) that provides or configures necessary information and/or setting for the UE-initiated/event-driven beam reporting could provide or configure or comprise or include or contain the bitmap(s).

According to or following those specified/described herein in the present disclosure, e.g., for Mode-A, Mode-B and/or Mode-C as specified/defined herein in the present disclosure (i.e., when/if one or more of them are configured/provided/enabled), a PUSCH resource or transmission or transmission occasion or a PUSCH resource configuration (e.g., DG and/or Type 1/2 CG PUSCH(s)) of the second UL channel could be associated to a set of M (M≥1 or M>1) PUCCH resources or transmissions or transmission occasions or PUCCH resource configurations of the first UL channel in Mode A, Mode B and/or Mode C. A UE could determine or identify that a PUSCH resource/resource configuration of the second UL channel could be associated/specific/mapped/linked/corresponding to the set of M PUCCH resources/PUCCH resource configurations according to one or more of:
In one example, the higher layer parameter(s)/signaling(s) that provides or configures the PUSCH resource/resource configuration of the second UL channel such as PUSCH-Config, UCI-OnPUSCH, PUSCH-ConfigCommon, ConfiguredGrantConfig, SPS-Config, CG-UCI-OnPUSCH and/or etc. could provide or configure or comprise or include or contain information related to the set of M PUCCH resources/resource configurations—e.g., M IDs/indexes of the higher layer parameters PUCCH-Config(s), PUCCH-ResourceSet(s), PUCCH-Resource(s), PUCCH-ResourceCommon(s) and/or etc. that provide or configure the M PUCCH resources/resource configurations of the first UL channel in the set.
In another example, higher layer parameter(s)/signaling(s) PUCCH-Config(s), PUCCH-ResourceSet(s), PUCCH-Resource(s), PUCCH-ResourceCommon(s) and/or etc. that provides or configures each of the M PUCCH resources/resource configurations of the first UL channel in the corresponding set as specified/defined herein in the present disclosure could provide or configure or comprise or include or contain information related to the PUSCH resource/resource configuration of the second UL channel—e.g., (a same) ID or index of the higher layer parameter(s) PUSCH-Config, UCI-OnPUSCH, PUSCH-ConfigCommon, ConfiguredGrantConfig, SPS-Config, CG-UCI-OnPUSCH and/or etc. that provides or configures the PUSCH resource/resource configuration of the second UL channel.
In another example, the higher layer parameter(s)/signaling(s) that provides or configures each of the M PUCCH resources/resource configurations of the first UL channel such as PUCCH-Config(s), PUCCH-ResourceSet(s), PUCCH-Resource(s), PUCCH-ResourceCommon(s) and/or etc. could provide or configure or comprise or include or contain a first entity ID, and the higher layer parameter(s)/signaling(s) that provides or configures the PUSCH resource/resource configuration of the second UL channel such as PUSCH-Config, UCI-OnPUSCH, PUSCH-ConfigCommon, ConfiguredGrantConfig, SPS-Config, CG-UCI-OnPUSCH and/or etc. could provide or configure or comprise or include or contain a second entity ID. For this design example, the first entity ID(s) and the second entity ID could have the same/identical value(s)—e.g., the first and second entity IDs could be in form of one-bit indicators, and both of them could correspond to ‘1’s or ‘0’s.
In another example, higher layer parameter(s)/signaling(s) that provides or configures necessary information and/or setting for the UE-initiated/event-driven beam reporting could provide or configure or comprise or include or contain first information related to one or more PUSCH resources/resource configurations of the second UL channel as specified/defined herein in the present disclosure, and second information related to one or more PUCCH resources/resource configurations of the first UL channel as specified/defined herein in the present disclosure, wherein the UE could determine or identify association(s)/mapping(s)/linkage(s) between the first and second information according to one or more of:
   For example, the first information could correspond to a set of one or more (i.e., N) PUSCH resource/resource configuration IDs/indexes each corresponding to a PUSCH-Config, UCI-OnPUSCH, PUSCH-ConfigCommon, ConfiguredGrantConfig, SPS-Config, CG-UCI-OnPUSCH and/or etc. that provides or configures the PUSCH resource/resource configuration of the second UL channel, and the second information could correspond to N≥1 sets of PUCCH resource/resource configuration IDs/indexes with each set comprising one or more (i.e., M) PUCCH resource/resource configuration IDs/indexes each corresponding to a PUCCH-Config, PUCCH-ResourceSet, PUCCH-Resource, PUCCH-ResourceCommon and/or etc. that provides or configures the PUCCH resource/resource configuration of the first UL channel. For this design example, the M PUCCH resource/resource configuration IDs/indexes (and therefore, the corresponding M PUCCH resources/resource configurations of the first UL channel) in the first set of PUCCH resource/resource configuration IDs/indexes (e.g., the 1st set among all the N sets in ordinal position(s), the set with the lowest/highest set ID/index among all the N sets, and/or etc.) could be associated/specific/corresponding/linked to the PUSCH resource/resource configuration ID/index (and therefore, the corresponding PUSCH resource/resource configuration of the second UL channel) of the first entry in the set of N PUSCH resource/resource configuration IDs/indexes as specified/defined herein in the present disclosure, the M PUCCH resource/resource configuration IDs/indexes (and therefore, the corresponding M PUCCH resources/resource configurations of the first UL channel) in the second set of PUCCH resource/resource configuration IDs/indexes (e.g., the 2nd set among all the N sets in ordinal position(s), the set with the second lowest/highest set ID/index among all the N sets, and/or etc.) could be associated/specific/corresponding/linked to the PUSCH resource/resource configuration ID/index (and therefore, the corresponding PUSCH resource/resource configuration of the second UL channel) of the second entry in the set of N PUSCH resource/resource configuration IDs/indexes as specified/defined herein in the present disclosure, and so on, and the M PUCCH resource/resource configuration IDs/indexes (and therefore, the corresponding M PUCCH resources/resource configurations of the first UL channel) in the last set of PUCCH resource/resource configuration IDs/indexes (e.g., the N-th set among all the N sets in ordinal position(s), the set with the highest/lowest set ID/index among all the N sets, and/or etc.) could be associated/specific/corresponding/linked to the PUSCH resource/resource configuration ID/index (and therefore, the corresponding PUSCH resource/resource configuration of the second UL channel) of the last entry in the set of N PUSCH resource/resource configuration IDs/indexes as specified/defined herein in the present disclosure.
   For another example, the first information could correspond to a set of a set of one or more (i.e., N) PUSCH resource/resource configuration IDs/indexes each corresponding to a PUSCH-Config, UL-OnPUSCH, PUSCH-ConfigCommon, ConfiguredGrantConfig, SPS-Config, CG-UCI-OnPUSCH and/or etc. that provides or configures the PUSCH resource/resource configuration of the second UL channel, and the second information could correspond to N>1 sets of PUCCH resource/resource configuration IDs/indexes with each set comprising one or more (i.e., M) PUCCH resource/resource configuration IDs/indexes each corresponding to a PUCCH-Config, PUCCH-ResourceSet, PUCCH-Resource, PUCCH-ResourceCommon and/or etc. that provides or configures the PUCCH resource/resource configuration of the first UL channel. For this design example, each of the N PUSCH resource/resource configuration IDs/indexes in the corresponding set (and therefore, the corresponding PUSCH resource/resource configuration of the second UL channel) could correspond to or could be associated or linked or mapped or specific to a bitmap with each entry/bit position of the bitmap associated, corresponding, specific or linked to a set of M PUCCH resource/resource configuration ID/indexes (and therefore, the corresponding M PUCCH resources/resource configurations of the first UL channel); for instance, the first entry/bit position of the bitmap could correspond to or could be associated/specific/linked/mapped to the first set (e.g., the 1st set among all the N sets in ordinal position(s), the set with the lowest/highest set ID/index among all the N sets, and/or etc.) of M PUCCH resource/resource configuration IDs/indexes (and therefore, the corresponding M PUCCH resources/resource configurations of the first UL channel), the second entry/bit position of the bitmap could correspond to or could be associated/specific/linked/mapped to the second set (e.g., the 2nd set among all the N sets in ordinal position(s), the set with the second lowest/highest set ID/index among all the N sets, and/or etc.) of M PUCCH resource/resource configuration IDs/indexes (and therefore, the corresponding M PUCCH resources/resource configurations of the first UL channel), and so on, and the last entry/bit position of the bitmap could correspond to or could be associated/specific/linked/mapped to the last set (e.g., the N-th set among all the N sets in ordinal position(s), the set with the highest/lowest set ID/index among all the N sets, and/or etc.) of M PUCCH resource/resource configuration IDs/indexes (and therefore, the corresponding M PUCCH resources/resource configurations of the first UL channel). In this case, for a PUSCH resource/resource configuration ID/index in the corresponding set (and therefore, the corresponding PUSCH resource/resource configuration of the second UL channel), when/if an entry/bit position of the bitmap associated/specific/corresponding/mapped to the PUSCH resource/resource configuration is set to ‘1’ (or ‘0’), the set of M PUCCH resource/resource configuration IDs/indexes (and therefore, the corresponding PUCCH resources/resource configurations of the first UL channel) associated/corresponding/specific/linked to the entry/bit position could be associated/specific/corresponding/linked to the PUSCH resource/resource configuration ID/index (and therefore, the corresponding PUSCH resource/resource configuration of the second UL channel) in the set of N PUSCH resource/resource configuration IDs/indexes as specified/defined herein in the present disclosure. For this design example, the higher layer parameter(s)/signaling(s) that provides or configures necessary information and/or setting for the UE-initiated/event-driven beam reporting could provide or configure or comprise or include or contain the bitmap(s).

For Mode-A, Mode-B and/or Mode-C as specified/defined herein in the present disclosure, consider a single reporting instance/CSI-Report/CSI report to send or transmit beam report(s):
In one example, when/if the UE transmits or sends a PN message/trigger over/on/via/by/in a PUCCH resource or PUCCH resource configuration or PUCCH transmission/transmission occasion of the first UL channel, the UE could determine or identify a CSI report setting/configuration provided or configured for the UE-initiated/event-driven beam reporting associated or corresponding or specific or mapped to the PUCCH resource/resource configuration of the first UL channel according to or following those specified herein in the present disclosure. In this case, the UE could determine a beam report comprising at least one or more resource indicators (including SSBRI(s)/CRI(s)) and beam metrics (including L1-RSRP(s)/L1-SINR(s)) according to the determined/identified CSI report setting/configuration. The UE could then transmit or send, in a single reporting instance/CSI-Report/CSI report determined or identified according to or based on the determined/identified CSI report setting/configuration, the determined beam report.
   For example, the UE could transmit or send the beam report over/on/via/by/in a (DG or CG) PUSCH resource/transmission/transmission occasion of the second UL channel, wherein the (DG or CG) PUSCH resource/transmission/transmission occasion of the second UL channel could be associated or corresponding or specific or mapped to (1) the PUCCH resource or PUCCH resource configuration or PUCCH transmission/transmission occasion of the first UL channel and/or (2) the determined/identified CSI report setting/configuration according to or following those specified herein in the present disclosure.
   For another example, the UE could transmit or send the beam report over/on/via/by/in a set of one or more, e.g., M≥1 or M>1, (DG or CG) PUSCH resources/transmissions/transmission occasions of the second UL channel, wherein the set of one or more M (DG or CG) PUSCH resources/transmissions/transmission occasions of the second UL channel could be associated or corresponding or specific or mapped to (1) the PUCCH resource or PUCCH resource configuration or PUCCH transmission/transmission occasion of the first UL channel and/or (2) the determined/identified CSI report setting/configuration according to or following those specified herein in the present disclosure.
In another example, when/if the UE transmits or sends a PN message/trigger over/on/via/by/in a PUCCH resource or PUCCH resource configuration or PUCCH transmission/transmission occasion of the first UL channel, the UE could determine or identify a set of one or more (e.g., M≥1 or M>1) CSI report settings/configurations each provided or configured by a CSI-ReportConfig/UEI-ReportConfig for the UE-initiated/event-driven beam reporting associated or corresponding or specific or mapped to the PUCCH resource/resource configuration of the first UL channel according to or following those specified herein in the present disclosure. In this case, the UE could determine one or more (e.g., one) beam reports each comprising at least one or more resource indicators (including SSBRI(s)/CRI(s)) and beam metrics (including L1-RSRP(s)/L1-SINR(s)) according to one or more of the determined/identified M CSI report settings/configurations. The UE could then transmit or send, in a single reporting instance/CSI-Report/CSI report determined or identified according to or based on the one or more of the M determined/identified CSI report settings/configurations, the determined beam report(s), wherein the UE could determine or identify the one or more of the M determined/identified CSI report settings/configurations—from/among/out of all the M determined/identified CSI report settings/configurations-according to or based on:
   (i) fixed rule(s) in system specification(s) and/or per RRC configuration, e.g., the one or more of the M determined/identified CSI report settings/configurations could correspond to the first CSI report setting/configuration among the M CSI report settings/configurations (e.g., in terms/form of its ordinal position), the CSI report setting/configuration with the lowest/highest reportConfigId value among the M CSI report settings/configurations, the m-th CSI report setting/configuration among the M CSI report settings/configurations (e.g., in terms/form of its ordinal position), the CSI report setting/configuration with the m-th lowest/highest reportConfigId value among the M CSI report settings/configurations, all of the M CSI report settings/configurations and/or etc., wherein the UE could determine of identify the value of m according to or based on: (1) fixed value(s) in system specification(s) and/or per RRC configuration, (2) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (3) UE's autonomous determination or selection, which could be further sent to the network via/by/in various UL channels/signals including CSI/beam report and/or UE's capability signaling(s); and/or
   (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling; and/or
   (iii) UE's autonomous determination or selection, which could be further sent to the network via/by/in various UL channels/signals including CSI/beam report and/or UE's capability signaling(s).
Furthermore:
   For example, the UE could transmit or send the beam report(s) over/on/via/by/in a (DG or CG) PUSCH resource/transmission/transmission occasion of the second UL channel, wherein the (DG or CG) PUSCH resource/transmission/transmission occasion of the second UL channel could be associated or corresponding or specific or mapped to (1) the PUCCH resource or PUCCH resource configuration or PUCCH transmission/transmission occasion of the first UL channel and/or (2) the determined/identified M CSI report settings/configurations according to or following those specified herein in the present disclosure and/or (3) the one or more of the M determined/identified CSI report settings/configurations according to or following those specified herein in the present disclosure.
   For another example, the UE could transmit or send the beam report(s) over/on/via/by/in a set of one or more, e.g., M≥1 or M>1, (DG or CG) PUSCH resources/transmissions/transmission occasions of the second UL channel, wherein the set of one or more M (DG or CG) PUSCH resources/transmissions/transmission occasions of the second UL channel could be associated or corresponding or specific or mapped to (1) the PUCCH resource or PUCCH resource configuration or PUCCH transmission/transmission occasion of the first UL channel and/or (2) the determined/identified M CSI report settings/configurations according to or following those specified herein in the present disclosure and/or (3) the one or more of the M determined/identified CSI report settings/configurations according to or following those specified herein in the present disclosure.
   For another example, the UE could determine or identify a set of one or more, e.g., M≥1 or M>1, (DG or CG) PUSCH resources/transmissions/transmission occasions of the second UL channel associated or corresponding or specific or mapped to (1) the PUCCH resource or PUCCH resource configuration or PUCCH transmission/transmission occasion of the first UL channel and/or (2) the determined/identified M CSI report settings/configurations according to or following those specified herein in the present disclosure and/or (3) the one or more of the M determined/identified CSI report settings/configurations according to or following those specified herein in the present disclosure. For this design example, the UE could transmit or send the beam report(s) over/on/via/by/in one or more of the M (DG or CG) PUSCH resources/transmissions/transmission occasions of the second UL channel. The UE could determine or identify the one or more of the M (DG or CG) PUSCH resources/transmissions/transmission occasions of the second UL channel—from/among/out of all the M (DG or CG) PUSCH resources/transmissions/transmission occasions of the second UL channel-according to or based on:
      (i) fixed rule(s) in system specification(s) and/or per RRC configuration, e.g., the one or more of the M (DG or CG) PUSCH resources/transmissions/transmission occasions of the second UL channel could correspond to the first (DG or CG) PUSCH resource/transmission/transmission occasion of the second UL channel among the M (DG or CG) PUSCH resources/transmissions/transmission occasions of the second UL channel (e.g., in terms/form of its ordinal position), the (DG or CG) PUSCH resource/transmission/transmission occasion of the second UL channel with the lowest/highest (resource/resource configuration) ID/index among the M (DG or CG) PUSCH resources/transmissions/transmission occasions of the second UL channel, the m-th (DG or CG) PUSCH resource/transmission/transmission occasion of the second UL channel among the M (DG or CG) PUSCH resources/transmissions/transmission occasions of the second UL channel (e.g., in terms/form of its ordinal position), the (DG or CG) PUSCH resource/transmission/transmission occasion of the second UL channel with the m-th lowest/highest (resource/resource configuration) ID/index value among the M (DG or CG) PUSCH resources/transmissions/transmission occasions of the second UL channel, all of the M (DG or CG) PUSCH resources/transmissions/transmission occasions of the second UL channel and/or etc., wherein the UE could determine of identify the value of m according to or based on: (1) fixed value(s) in system specification(s) and/or per RRC configuration, (2) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (3) UE's autonomous determination or selection, which could be further sent to the network via/by/in various UL channels/signals including CSI/beam report and/or UE's capability signaling(s); and/or
      (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling; and/or
      (iii) UE's autonomous determination or selection, which could be further sent to the network via/by/in various UL channels/signals including CSI/beam report and/or UE's capability signaling(s).
In another example, when/if the UE transmits or sends a PN message/trigger over/on/via/by/in a PUCCH resource or PUCCH resource configuration or PUCCH transmission/transmission occasion of the first UL channel, the UE could determine or identify a set of one or more (e.g., M≥1 or M>1) CSI report settings/configurations each provided or configured by a CSI-ReportConfig/UEI-ReportConfig for the UE-initiated/event-driven beam reporting associated or corresponding or specific or mapped to the PUCCH resource/resource configuration of the first UL channel according to or following those specified herein in the present disclosure. In this case, the UE could determine one or more (e.g., M) beam reports each comprising at least one or more resource indicators (including SSBRI(s)/CRI(s)) and beam metrics (including L1-RSRP(s)/L1-SINR(s)) according to the determined/identified M CSI report settings/configurations. The UE could then transmit or send, in a single reporting instance/CSI-Report/CSI report determined or identified according to or based on one or more of the M determined/identified CSI report settings/configurations, the determined M beam report, wherein the UE could determine or identify the one or more of the M determined/identified CSI report settings/configurations—from/among/out of all the M determined/identified CSI report settings/configurations-according to or based on:
   (i) fixed rule(s) in system specification(s) and/or per RRC configuration, e.g., the one or more of the M determined/identified CSI report settings/configurations could correspond to the first CSI report setting/configuration among the M CSI report settings/configurations (e.g., in terms/form of its ordinal position), the CSI report setting/configuration with the lowest/highest reportConfigId value among the CSI report settings/configurations, the m-th CSI report setting/configuration among the M CSI report settings/configurations (e.g., in terms/form of its ordinal position), the CSI report setting/configuration with the m-th lowest/highest reportConfigId value among the M CSI report settings/configurations, all of the M CSI report settings/configurations and/or etc., wherein the UE could determine of identify the value of m according to or based on: (1) fixed value(s) in system specification(s) and/or per RRC configuration, (2) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (3) UE's autonomous determination or selection, which could be further sent to the network via/by/in various UL channels/signals including CSI/beam report and/or UE's capability signaling(s); and/or
   (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling; and/or
   (iii) UE's autonomous determination or selection, which could be further sent to the network via/by/in various UL channels/signals including CSI/beam report and/or UE's capability signaling(s).
Furthermore:
   For example, the UE could transmit or send the M beam reports over/on/via/by/in a (DG or CG) PUSCH resource/transmission/transmission occasion of the second UL channel, wherein the (DG or CG) PUSCH resource/transmission/transmission occasion of the second UL channel could be associated or corresponding or specific or mapped to (1) the PUCCH resource or PUCCH resource configuration or PUCCH transmission/transmission occasion of the first UL channel and/or (2) the determined/identified M CSI report settings/configurations according to or following those specified herein in the present disclosure and/or (3) the one or more of the M determined/identified CSI report settings/configurations according to or following those specified herein in the present disclosure.
   For another example, the UE could transmit or send the M beam reports over/on/via/by/in a set of one or more, e.g., M≥1 or M>1, (DG or CG) PUSCH resources/transmissions/transmission occasions of the second UL channel, wherein the set of one or more M (DG or CG) PUSCH resources/transmissions/transmission occasions of the second UL channel could be associated or corresponding or specific or mapped to (1) the PUCCH resource or PUCCH resource configuration or PUCCH transmission/transmission occasion of the first UL channel and/or (2) the determined/identified M CSI report settings/configurations according to or following those specified herein in the present disclosure and/or (3) the one or more of the M determined/identified CSI report settings/configurations according to or following those specified herein in the present disclosure.
   For another example, the UE could determine or identify a set of one or more, e.g., M≥1 or M>1, (DG or CG) PUSCH resources/transmissions/transmission occasions of the second UL channel associated or corresponding or specific or mapped to (1) the PUCCH resource or PUCCH resource configuration or PUCCH transmission/transmission occasion of the first UL channel and/or (2) the determined/identified M CSI report settings/configurations according to or following those specified herein in the present disclosure and/or (3) the one or more of the M determined/identified CSI report settings/configurations according to or following those specified herein in the present disclosure. For this design example, the UE could transmit or send the M beam reports over/on/via/by/in one or more of the M (DG or CG) PUSCH resources/transmissions/transmission occasions of the second UL channel. The UE could determine or identify the one or more of the M (DG or CG) PUSCH resources/transmissions/transmission occasions of the second UL channel—from/among/out of all the M (DG or CG) PUSCH resources/transmissions/transmission occasions of the second UL channel-according to or based on:
      (i) fixed rule(s) in system specification(s) and/or per RRC configuration, e.g., the one or more of the M (DG or CG) PUSCH resources/transmissions/transmission occasions of the second UL channel could correspond to the first (DG or CG) PUSCH resource/transmission/transmission occasion of the second UL channel among the M (DG or CG) PUSCH resources/transmissions/transmission occasions of the second UL channel (e.g., in terms/form of its ordinal position), the (DG or CG) PUSCH resource/transmission/transmission occasion of the second UL channel with the lowest/highest (resource/resource configuration) ID/index among the M (DG or CG) PUSCH resources/transmissions/transmission occasions of the second UL channel, the m-th (DG or CG) PUSCH resource/transmission/transmission occasion of the second UL channel among the M (DG or CG) PUSCH resources/transmissions/transmission occasions of the second UL channel (e.g., in terms/form of its ordinal position), the (DG or CG) PUSCH resource/transmission/transmission occasion of the second UL channel with the m-th lowest/highest (resource/resource configuration) ID/index value among the M (DG or CG) PUSCH resources/transmissions/transmission occasions of the second UL channel, all of the M (DG or CG) PUSCH resources/transmissions/transmission occasions of the second UL channel and/or etc., wherein the UE could determine of identify the value of m according to or based on: (1) fixed value(s) in system specification(s) and/or per RRC configuration, (2) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (3) UE's autonomous determination or selection, which could be further sent to the network via/by/in various UL channels/signals including CSI/beam report and/or UE's capability signaling(s); and/or
      (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling; and/or
      (iii) UE's autonomous determination or selection, which could be further sent to the network via/by/in various UL channels/signals including CSI/beam report and/or UE's capability signaling(s).

For Mode-A, Mode-B and/or Mode-C as specified/defined herein in the present disclosure, consider one or more (e.g., M≥1 or M>1) reporting instances/CSI-Reports/CSI reports to send or transmit beam report(s):
In another example, when/if the UE transmits or sends a PN message/trigger over/on/via/by/in a PUCCH resource or PUCCH resource configuration or PUCCH transmission/transmission occasion of the first UL channel, the UE could determine or identify a set of one or more (e.g., M≥1 or M>1) CSI report settings/configurations each provided or configured by a CSI-ReportConfig/UEI-ReportConfig for the UE-initiated/event-driven beam reporting associated or corresponding or specific or mapped to the PUCCH resource/resource configuration of the first UL channel according to or following those specified herein in the present disclosure. In this case, the UE could determine one or more (e.g., one) beam reports each comprising at least one or more resource indicators (including SSBRI(s)/CRI(s)) and beam metrics (including L1-RSRP(s)/L1-SINR(s)) according to one or more of the determined/identified M CSI report settings/configurations. The UE could then transmit or send, in one or more (e.g., M) reporting instances/CSI-Reports/CSI reports determined or identified according to or based on the one or more of the M determined/identified CSI report settings/configurations, the determined beam report(s), wherein the UE could determine or identify the one or more of the M determined/identified CSI report settings/configurations—from/among/out of all the M determined/identified CSI report settings/configurations-according to or based on:
   (i) fixed rule(s) in system specification(s) and/or per RRC configuration, e.g., the one or more of the M determined/identified CSI report settings/configurations could correspond to the first CSI report setting/configuration among the M CSI report settings/configurations (e.g., in terms/form of its ordinal position), the CSI report setting/configuration with the lowest/highest reportConfigId value among the M CSI report settings/configurations, the m-th CSI report setting/configuration among the M CSI report settings/configurations (e.g., in terms/form of its ordinal position), the CSI report setting/configuration with the m-th lowest/highest reportConfigId value among the M CSI report settings/configurations, all of the M CSI report settings/configurations and/or etc., wherein the UE could determine of identify the value of m according to or based on: (1) fixed value(s) in system specification(s) and/or per RRC configuration, (2) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (3) UE's autonomous determination or selection, which could be further sent to the network via/by/in various UL channels/signals including CSI/beam report and/or UE's capability signaling(s); and/or
   (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling; and/or
   (iii) UE's autonomous determination or selection, which could be further sent to the network via/by/in various UL channels/signals including CSI/beam report and/or UE's capability signaling(s).
Furthermore:
   For example, the UE could transmit or send the beam report(s) over/on/via/by/in a (DG or CG) PUSCH resource/transmission/transmission occasion of the second UL channel, wherein the (DG or CG) PUSCH resource/transmission/transmission occasion of the second UL channel could be associated or corresponding or specific or mapped to (1) the PUCCH resource or PUCCH resource configuration or PUCCH transmission/transmission occasion of the first UL channel and/or (2) the determined/identified M CSI report settings/configurations according to or following those specified herein in the present disclosure and/or (3) the one or more of the M determined/identified CSI report settings/configurations according to or following those specified herein in the present disclosure.
   For another example, the UE could transmit or send the beam report(s) over/on/via/by/in a set of one or more, e.g., M≥1 or M>1, (DG or CG) PUSCH resources/transmissions/transmission occasions of the second UL channel, wherein the set of one or more M (DG or CG) PUSCH resources/transmissions/transmission occasions of the second UL channel could be associated or corresponding or specific or mapped to (1) the PUCCH resource or PUCCH resource configuration or PUCCH transmission/transmission occasion of the first UL channel and/or (2) the determined/identified M CSI report settings/configurations according to or following those specified herein in the present disclosure and/or (3) the one or more of the M determined/identified CSI report settings/configurations according to or following those specified herein in the present disclosure.
   For another example, the UE could determine or identify a set of one or more, e.g., M≥1 or M>1, (DG or CG) PUSCH resources/transmissions/transmission occasions of the second UL channel associated or corresponding or specific or mapped to (1) the PUCCH resource or PUCCH resource configuration or PUCCH transmission/transmission occasion of the first UL channel and/or (2) the determined/identified M CSI report settings/configurations according to or following those specified herein in the present disclosure and/or (3) the one or more of the M determined/identified CSI report settings/configurations according to or following those specified herein in the present disclosure. For this design example, the UE could transmit or send the beam report(s) over/on/via/by/in one or more of the M (DG or CG) PUSCH resources/transmissions/transmission occasions of the second UL channel. The UE could determine or identify the one or more of the M (DG or CG) PUSCH resources/transmissions/transmission occasions of the second UL channel—from/among/out of all the M (DG or CG) PUSCH resources/transmissions/transmission occasions of the second UL channel-according to or based on:
      (i) fixed rule(s) in system specification(s) and/or per RRC configuration, e.g., the one or more of the M (DG or CG) PUSCH resources/transmissions/transmission occasions of the second UL channel could correspond to the first (DG or CG) PUSCH resource/transmission/transmission occasion of the second UL channel among the M (DG or CG) PUSCH resources/transmissions/transmission occasions of the second UL channel (e.g., in terms/form of its ordinal position), the (DG or CG) PUSCH resource/transmission/transmission occasion of the second UL channel with the lowest/highest (resource/resource configuration) ID/index among the M (DG or CG) PUSCH resources/transmissions/transmission occasions of the second UL channel, the m-th (DG or CG) PUSCH resource/transmission/transmission occasion of the second UL channel among the M (DG or CG) PUSCH resources/transmissions/transmission occasions of the second UL channel (e.g., in terms/form of its ordinal position), the (DG or CG) PUSCH resource/transmission/transmission occasion of the second UL channel with the m-th lowest/highest (resource/resource configuration) ID/index value among the M (DG or CG) PUSCH resources/transmissions/transmission occasions of the second UL channel, all of the M (DG or CG) PUSCH resources/transmissions/transmission occasions of the second UL channel and/or etc., wherein the UE could determine of identify the value of m according to or based on: (1) fixed value(s) in system specification(s) and/or per RRC configuration, (2) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (3) UE's autonomous determination or selection, which could be further sent to the network via/by/in various UL channels/signals including CSI/beam report and/or UE's capability signaling(s); and/or
      (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling; and/or
      (iii) UE's autonomous determination or selection, which could be further sent to the network via/by/in various UL channels/signals including CSI/beam report and/or UE's capability signaling(s).
In another example, when/if the UE transmits or sends a PN message/trigger over/on/via/by/in a PUCCH resource or PUCCH resource configuration or PUCCH transmission/transmission occasion of the first UL channel, the UE could determine or identify a set of one or more (e.g., M≥1 or M>1) CSI report settings/configurations each provided or configured by a CSI-ReportConfig/UEI-ReportConfig for the UE-initiated/event-driven beam reporting associated or corresponding or specific or mapped to the PUCCH resource/resource configuration of the first UL channel according to or following those specified herein in the present disclosure. In this case, the UE could determine one or more (e.g., M) beam reports each comprising at least one or more resource indicators (including SSBRI(s)/CRI(s)) and beam metrics (including L1-RSRP(s)/L1-SINR(s)) according to one or more of the determined/identified M CSI report settings/configurations. The UE could then transmit or send, in one or more (e.g., M) reporting instances/CSI-Reports/CSI reports determined or identified according to or based on the one or more of the M determined/identified CSI report settings/configurations, the determined M beam reports, wherein the UE could determine or identify the one or more of the M determined/identified CSI report settings/configurations—from/among/out of all the M determined/identified CSI report settings/configurations-according to or based on:
   (i) fixed rule(s) in system specification(s) and/or per RRC configuration, e.g., the one or more of the M determined/identified CSI report settings/configurations could correspond to the first CSI report setting/configuration among the M CSI report settings/configurations (e.g., in terms/form of its ordinal position), the CSI report setting/configuration with the lowest/highest reportConfigId value among the M CSI report settings/configurations, the m-th CSI report setting/configuration among the M CSI report settings/configurations (e.g., in terms/form of its ordinal position), the CSI report setting/configuration with the m-th lowest/highest reportConfigId value among the M CSI report settings/configurations, all of the M CSI report settings/configurations and/or etc., wherein the UE could determine of identify the value of m according to or based on: (1) fixed value(s) in system specification(s) and/or per RRC configuration, (2) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (3) UE's autonomous determination or selection, which could be further sent to the network via/by/in various UL channels/signals including CSI/beam report and/or UE's capability signaling(s); and/or
   (ii) network's configuration(s) and/or indication(s), e.g., via higher layer RRC signaling(s)/parameter(s) and/or MAC CE command(s) and/or dynamic DCI based LI signaling(s), according to or based on a corresponding UE's capability or capability signaling; and/or
   (iii) UE's autonomous determination or selection, which could be further sent to the network via/by/in various UL channels/signals including CSI/beam report and/or UE's capability signaling(s).
Furthermore:
   For example, the UE could transmit or send the M beam reports over/on/via/by/in a (DG or CG) PUSCH resource/transmission/transmission occasion of the second UL channel, wherein the (DG or CG) PUSCH resource/transmission/transmission occasion of the second UL channel could be associated or corresponding or specific or mapped to (1) the PUCCH resource or PUCCH resource configuration or PUCCH transmission/transmission occasion of the first UL channel and/or (2) the determined/identified M CSI report settings/configurations according to or following those specified herein in the present disclosure and/or (3) the one or more of the M determined/identified CSI report settings/configurations according to or following those specified herein in the present disclosure.
   For another example, the UE could transmit or send the M beam reports over/on/via/by/in a set of one or more, e.g., M≥1 or M>1, (DG or CG) PUSCH resources/transmissions/transmission occasions of the second UL channel, wherein the set of one or more M (DG or CG) PUSCH resources/transmissions/transmission occasions of the second UL channel could be associated or corresponding or specific or mapped to (1) the PUCCH resource or PUCCH resource configuration or PUCCH transmission/transmission occasion of the first UL channel and/or (2) the determined/identified M CSI report settings/configurations according to or following those specified herein in the present disclosure and/or (3) the one or more of the M determined/identified CSI report settings/configurations according to or following those specified herein in the present disclosure.
   For another example, the UE could determine or identify a set of one or more, e.g., M≥1 or M>1, (DG or CG) PUSCH resources/transmissions/transmission occasions of the second UL channel associated or corresponding or specific or mapped to (1) the PUCCH resource or PUCCH resource configuration or PUCCH transmission/transmission occasion of the first UL channel and/or (2) the determined/identified M CSI report settings/configurations according to or following those specified herein in the present disclosure and/or (3) the one or more of the M determined/identified CSI report settings/configurations according to or following those specified herein in the present disclosure. For this design example, the UE could transmit or send the M beam reports over/on/via/by/in one or more of the M (DG or CG) PUSCH resources/transmissions/transmission occasions of the second UL channel. The UE could determine or identify the one or more of the M (DG or CG) PUSCH resources/transmissions/transmission occasions of the second UL channel—from/among/out of all the M (DG or CG) PUSCH resources/transmissions/transmission occasions of the second UL channel-according to or based on:
      (i) fixed rule(s) in system specification(s) and/or per RRC configuration, e.g., the one or more of the M (DG or CG) PUSCH resources/transmissions/transmission occasions of the second UL channel could correspond to the first (DG or CG) PUSCH resource/transmission/transmission occasion of the second UL channel among the M (DG or CG) PUSCH resources/transmissions/transmission occasions of the second UL channel (e.g., in terms/form of its ordinal position), the (DG or CG) PUSCH resource/transmission/transmission occasion of the second UL channel with the lowest/highest (resource/resource configuration) ID/index among the M (DG or CG) PUSCH resources/transmissions/transmission occasions of the second UL channel, the m-th (DG or CG) PUSCH resource/transmission/transmission occasion of the second UL channel among the M (DG or CG) PUSCH resources/transmissions/transmission occasions of the second UL channel (e.g., in terms/form of its ordinal position), the (DG or CG) PUSCH resource/transmission/transmission occasion of the second UL channel with the m-th lowest/highest (resource/resource configuration) ID/index value among the M (DG or CG) PUSCH resources/transmissions/transmission occasions of the second UL channel, all of the M (DG or CG) PUSCH resources/transmissions/transmission occasions of the second UL channel and/or etc., wherein the UE could determine of identify the value of m according to or based on: (1) fixed value(s) in system specification(s) and/or per RRC configuration, (2) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (3) UE's autonomous determination or selection, which could be further sent to the network via/by/in various UL channels/signals including CSI/beam report and/or UE's capability signaling(s); and/or
      (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling; and/or
      (iii) UE's autonomous determination or selection, which could be further sent to the network via/by/in various UL channels/signals including CSI/beam report and/or UE's capability signaling(s).
In another example, when/if the UE transmits or sends a PN message/trigger over/on/via/by/in a PUCCH resource or PUCCH resource configuration or PUCCH transmission/transmission occasion of the first UL channel, the UE could determine or identify a set of one or more (e.g., M≥1 or M>1) CSI report settings/configurations each provided or configured by a CSI-ReportConfig/UEI-ReportConfig for the UE-initiated/event-driven beam reporting associated or corresponding or specific or mapped to the PUCCH resource/resource configuration of the first UL channel according to or following those specified herein in the present disclosure. In this case, the UE could determine one or more (e.g., M) beam reports each comprising at least one or more resource indicators (including SSBRI(s)/CRI(s)) and beam metrics (including L1-RSRP(s)/L1-SINR(s)) according to one or more of the determined/identified M CSI report settings/configurations. The UE could then transmit or send, in one or more (e.g., M) reporting instances/CSI-Reports/CSI reports determined or identified according to or based on the one or more of the M determined/identified CSI report settings/configurations, the determined M beam reports, wherein the UE could determine or identify the one or more of the M determined/identified CSI report settings/configurations—from/among/out of all the M determined/identified CSI report settings/configurations-according to or based on:
   (i) fixed rule(s) in system specification(s) and/or per RRC configuration, e.g., the one or more of the M determined/identified CSI report settings/configurations could correspond to the first CSI report setting/configuration among the M CSI report settings/configurations (e.g., in terms/form of its ordinal position), the CSI report setting/configuration with the lowest/highest reportConfigId value among the M CSI report settings/configurations, the m-th CSI report setting/configuration among the M CSI report settings/configurations (e.g., in terms/form of its ordinal position), the CSI report setting/configuration with the m-th lowest/highest reportConfigId value among the M CSI report settings/configurations, all of the M CSI report settings/configurations and/or etc., wherein the UE could determine of identify the value of m according to or based on: (1) fixed value(s) in system specification(s) and/or per RRC configuration, (2) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (3) UE's autonomous determination or selection, which could be further sent to the network via/by/in various UL channels/signals including CSI/beam report and/or UE's capability signaling(s); and/or
   (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling; and/or
   (iii) UE's autonomous determination or selection, which could be further sent to the network via/by/in various UL channels/signals including CSI/beam report and/or UE's capability signaling(s).
Furthermore:
   For example, the UE could transmit or send the M beam reports over/on/via/by/in a (DG or CG) PUSCH resource/transmission/transmission occasion of the second UL channel, wherein the (DG or CG) PUSCH resource/transmission/transmission occasion of the second UL channel could be associated or corresponding or specific or mapped to (1) the PUCCH resource or PUCCH resource configuration or PUCCH transmission/transmission occasion of the first UL channel and/or (2) the determined/identified M CSI report settings/configurations according to or following those specified herein in the present disclosure and/or (3) the one or more of the M determined/identified CSI report settings/configurations according to or following those specified herein in the present disclosure.
   For another example, the UE could transmit or send the M beam reports over/on/via/by/in a set of one or more, e.g., M≥1 or M>1, (DG or CG) PUSCH resources/transmissions/transmission occasions of the second UL channel, wherein the set of one or more M (DG or CG) PUSCH resources/transmissions/transmission occasions of the second UL channel could be associated or corresponding or specific or mapped to (1) the PUCCH resource or PUCCH resource configuration or PUCCH transmission/transmission occasion of the first UL channel and/or (2) the determined/identified M CSI report settings/configurations according to or following those specified herein in the present disclosure and/or (3) the one or more of the M determined/identified CSI report settings/configurations according to or following those specified herein in the present disclosure.
   For another example, the UE could determine or identify a set of one or more, e.g., M≥1 or M>1, (DG or CG) PUSCH resources/transmissions/transmission occasions of the second UL channel associated or corresponding or specific or mapped to (1) the PUCCH resource or PUCCH resource configuration or PUCCH transmission/transmission occasion of the first UL channel and/or (2) the determined/identified M CSI report settings/configurations according to or following those specified herein in the present disclosure and/or (3) the one or more of the M determined/identified CSI report settings/configurations according to or following those specified herein in the present disclosure. For this design example, the UE could transmit or send the M beam reports over/on/via/by/in one or more of the M (DG or CG) PUSCH resources/transmissions/transmission occasions of the second UL channel. The UE could determine or identify the one or more of the M (DG or CG) PUSCH resources/transmissions/transmission occasions of the second UL channel—from/among/out of all the M (DG or CG) PUSCH resources/transmissions/transmission occasions of the second UL channel-according to or based on:
      (i) fixed rule(s) in system specification(s) and/or per RRC configuration, e.g., the one or more of the M (DG or CG) PUSCH resources/transmissions/transmission occasions of the second UL channel could correspond to the first (DG or CG) PUSCH resource/transmission/transmission occasion of the second UL channel among the M (DG or CG) PUSCH resources/transmissions/transmission occasions of the second UL channel (e.g., in terms/form of its ordinal position), the (DG or CG) PUSCH resource/transmission/transmission occasion of the second UL channel with the lowest/highest (resource/resource configuration) ID/index among the M (DG or CG) PUSCH resources/transmissions/transmission occasions of the second UL channel, the m-th (DG or CG) PUSCH resource/transmission/transmission occasion of the second UL channel among the M (DG or CG) PUSCH resources/transmissions/transmission occasions of the second UL channel (e.g., in terms/form of its ordinal position), the (DG or CG) PUSCH resource/transmission/transmission occasion of the second UL channel with the m-th lowest/highest (resource/resource configuration) ID/index value among the M (DG or CG) PUSCH resources/transmissions/transmission occasions of the second UL channel, all of the M (DG or CG) PUSCH resources/transmissions/transmission occasions of the second UL channel and/or etc., wherein the UE could determine of identify the value of m according to or based on: (1) fixed value(s) in system specification(s) and/or per RRC configuration, (2) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (3) UE's autonomous determination or selection, which could be further sent to the network via/by/in various UL channels/signals including CSI/beam report and/or UE's capability signaling(s); and/or
      (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling; and/or
      (iii) UE's autonomous determination or selection, which could be further sent to the network via/by/in various UL channels/signals including CSI/beam report and/or UE's capability signaling(s).

For Mode A, Mode B and/or Mode C according to or following those specified/defined herein in the present disclosure, for a PUCCH resource or a PUCCH resource configuration or a PUCCH transmission/transmission occasion of the first UL channel as in Step-1—denoted by a first PUCCH here, a UE could determine or identify, e.g., based on or according to network's configuration(s) and/or indication(s) and/or signaling(s) e.g. via higher layer RRC signaling(s)/parameter(s) and/or MAC CE command(s) and/or dynamic DCI based L1 signaling(s) based on or subject/according to a corresponding UE's capability or capability signaling, association(s), mapping(s), linkage(s) or correspondence(s) between the first PUCCH and one or more CSI reporting settings each provided by a CSI-ReportConfig according to or following those specified herein in the present disclosure. In particular,
In one example, each of the one or more CSI reporting settings could be (dedicated) for the UE-initiated/event-driven beam reporting as specified/defined herein in the present disclosure. For example, each of the one or more CSI reporting settings could be provided by a higher layer parameter UEI-ReportConfig. For another example, the higher layer parameter(s) CSI-ReportConfig and/or UEI-ReportConfig and/or etc. that provides or configures each of the one or more CSI reporting settings could provide, configure, include, comprise or contain a higher layer parameter ueiBeamReporting, and/or the higher layer parameter ueiBeamReporting could be set to ‘enabled’.
In another example, the one or more CSI reporting settings may not be (dedicated) for the UE-initiated/event-driven beam reporting as specified/defined herein in the present disclosure. For instance, each of the one or more CSI reporting settings could be provided by a higher layer parameter CSI-ReportConfig, and the higher layer parameter CSI-ReportConfig that provides or configures each of the one or more CSI reporting settings (i) could provide, configure, include, comprise or contain a higher layer parameter ueiBeamReporting set to ‘disabled’, and (ii) may not provide, configure, include, comprise or contain the higher layer parameter ueiBeamReporting, and/or the higher layer parameter ueiBeamReport could be absent or is not present, provided, configured, included, comprised or contained in the higher layer parameter(s) CSI-ReportConfig(s).
In another example, the one or more CSI reporting settings could comprise one or more first CSI reporting settings (dedicated) for the UE-initiated/event-driven beam reporting as specified/defined herein in the present disclosure, and one or more second CSI reporting settings not (dedicated) for the UE-initiated/event-driven beam reporting as specified/defined herein in the present disclosure. In this design example,
   regarding the one or more first CSI reporting settings: for example, each of the one or more first CSI reporting settings could be provided by a higher layer parameter UEI-ReportConfig. For another example, the higher layer parameter(s) CSI-ReportConfig and/or UEI-ReportConfig and/or etc. that provides or configures each of the one or more first CSI reporting settings could provide, configure, include, comprise or contain a higher layer parameter ueiBeamReporting, and/or the higher layer parameter ueiBeamReporting could be set to ‘enabled’.
   regarding the one or more second CSI reporting settings: for instance, each of the one or more second CSI reporting settings could be provided by a higher layer parameter CSI-ReportConfig, and the higher layer parameter CSI-ReportConfig that provides or configures each of the one or more second CSI reporting settings (i) could provide, configure, include, comprise or contain a higher layer parameter ueiBeamReporting set to ‘disabled’, and (ii) may not provide, configure, include, comprise or contain the higher layer parameter ueiBeamReporting, and/or the higher layer parameter ueiBeamReport could be absent or is not present, provided, configured, included, comprised or contained in the higher layer parameter(s) CSI-ReportConfig(s).

According to or following those specified herein in the present disclosure, for Mode A, Mode B and/or Mode C, a UE could transmit or send to the network a PN message/trigger (or a first UEI report) as in Step-1 via/in/by/on a first PUCCH as specified/defined herein in the present disclosure; when/if the first PUCCH is associated, linked, mapped or corresponding to one or more first CSI reporting settings (dedicated) for the UE-initiated/event-driven beam reporting as specified/defined herein in the present disclosure and one or more second CSI reporting settings not (dedicated) for the UE-initiated/event-driven beam reporting as specified/defined herein in the present disclosure:
In one example, the UE could follow fixed rule(s) in system specification(s) to determine or identify which of the first CSI reporting setting(s) and the second CSI reporting setting(s) to use or apply for the beam reporting. For instance, when/if the UE has sent or transmitted a PN message/trigger via/by/in the first PUCCH as in Step-1 according to or following those specified herein in the present disclosure, and/or the UE could determine or identify PUSCH resource(s)—as in Step-3 of Mode A and/or Mode C and/or as in Step-2 of Mode B-associated, linked, mapped or corresponding to the first PUCCH for transmitting the corresponding UEI beam report(s) according to or following those specified/defined herein in the present disclosure, (1) the UE could use or apply the first CSI reporting setting(s) associated, linked, mapped or corresponding to the first PUCCH for transmitting the UEI beam report(s), or, (2) the UE could use or apply both the first CSI reporting setting(s) associated, linked, mapped or corresponding to the first PUCCH for transmitting the UEI beam report(s) and the second CSI reporting setting(s) associated, linked, mapped or corresponding to the first PUCCH for transmitting (legacy) aperiodic CSI/beam report(s)—i.e., other than the UEI beam report(s) as specified/defined herein in the present disclosure. When/if (i) the UE does not send or transmit any (valid) PN message(s)/trigger(s) via/by/in first PUCCH(s) as in Step-1 according to or following those specified herein in the present disclosure, and/or (ii) the UE has sent or transmitted a PN message/trigger via/by/in the first PUCCH as in Step-1 according to or following those specified herein in the present disclosure but the UE could not determine or identify PUSCH resource(s)—as in Step-3 of Mode A and/or Mode C and/or as in Step-2 of Mode B-linked, associated, mapped or corresponding to the first PUCCH for transmitting the corresponding UEI beam report(s) according to or following those specified/defined herein in the present disclosure, the UE could use or apply the second CSI reporting setting(s) associated, linked, mapped or corresponding to the first PUCCH for transmitting (legacy) aperiodic CSI/beam report(s)—i.e., other than the UEI beam report(s) as specified/defined herein in the present disclosure.
In another example, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, an indicator to indicate to the UE which of the first CSI reporting setting(s) and the second CSI reporting setting(s) to use or apply for the beam reporting. For example, the UE could be provided or configured in higher layer parameter(s) e.g. CSI-ReportConfig that provides or configures necessary information/setting(s) for the UE-initiated/event-driven beam reporting as specified/defined herein in the present disclosure a higher layer parameter reportConfigType; in this case, when/if reportConfigType is set to ‘first’, the UE could use or apply the first CSI reporting setting(s) associated, linked, mapped or corresponding to the first PUCCH for the beam reporting, when/if reportConfig Type is set to ‘second’, the UE could use or apply the second CSI reporting setting(s) associated, linked, mapped or corresponding to the first PUCCH for the beam reporting, and/or when/if reportConfig Type is set to ‘both’, the UE could use or apply both the first and second CSI reporting settings associated, linked, mapped or corresponding to the first PUCCH for the beam reporting. For another example, the UE could receive in a DCI (via a DCI field) a one-bit indicator; when/if the one-bit indicator is set to ‘0’ (or ‘1’), the UE could use or apply the first CSI reporting setting(s) associated, linked, mapped or corresponding to the first PUCCH for the beam reporting, and when/if the one-bit indicator is set to ‘1’ (or ‘0’), the UE could use or apply the second CSI reporting setting(s) associated, linked, mapped or corresponding to the first PUCCH for the beam reporting; for this design example, the DCI could correspond to the (downlink/uplink) DCI in Step-2 of Mode A and/or Mode C that provides the UL grant for the beam reporting, and the DCI field could be a new/dedicated DCI field or an existing DCI field e.g, the CSI request field by/via repurposing one or more codepoints of the existing DCI field. For another example, the UE could receive in a DCI (via a DCI field) a two-bit indicator; when/if the two-bit indicator is set to ‘00’ (or ‘01’ or ‘10’ or ‘11’), the UE could use or apply the first CSI reporting setting(s) associated, linked, mapped or corresponding to the first PUCCH for the beam reporting, when/if the two-bit indicator is set to ‘01’ (or ‘00’ or ‘10’ or ‘11’), the UE could use or apply the second CSI reporting setting(s) associated, linked, mapped or corresponding to the first PUCCH for the beam reporting, and/or when/if the two-bit indicator is set to ‘10’ (or ‘00’ or ‘01’ or ‘11’), the UE could use or apply both the first and second CSI reporting settings associated, linked, mapped or corresponding to the first PUCCH for the beam reporting; for this design example, the DCI could correspond to the (downlink/uplink) DCI in Step-2 of Mode A and/or Mode C that provides the UL grant for the beam reporting, and the DCI field could be a new/dedicated DCI field or an existing DCI field e.g, the CSI request field by/via repurposing one or more codepoints of the existing DCI field.
In another example, the PN message/trigger (or the first UEI report) sent or transmitted by the UE via/by/in the first PUCCH as in Step-1 could indicate to the network which of the first CSI reporting setting(s) and the second CSI reporting setting(s) the UE would/could use or apply for the beam reporting. For instance, the PN message/trigger (or the first UEI report) could be or could correspond to a one-bit indicator; when/if the one-bit indicator is set to ‘0’ (or ‘1’), the UE could indicate to the network that they would/could use or apply the first CSI reporting setting(s) associated, linked, mapped or corresponding to the first PUCCH for the beam reporting, and when/if the one-bit indicator is set to ‘1’ (or ‘0’), the UE could indicate to the network that they would/could use or apply the second CSI reporting setting(s) associated, linked, mapped or corresponding to the first PUCCH for the beam reporting. For another example, the PN message/trigger (or the first UEI report) could be or could correspond to a two-bit indicator; when/if the two-bit indicator is set to ‘00’ (or ‘01’ or ‘10’ or ‘11’), the UE could indicate to the network that they would/could use or apply the first CSI reporting setting(s) associated, linked, mapped or corresponding to the first PUCCH for the beam reporting, when/if the two-bit indicator is set to ‘01’ (or ‘00’ or ‘10’ or ‘11’), the UE could indicate to the network that they would/could use or apply the second CSI reporting setting(s) associated, linked, mapped or corresponding to the first PUCCH for the beam reporting, and/or when/if the two-bit indicator is set to ‘10’ (or ‘00’ or ‘01’ or ‘11’), the UE could indicate to the network that they would/could use or apply both the first and second CSI reporting settings associated, linked, mapped or corresponding to the first PUCCH for the beam reporting.

For Mode A and/or Mode C according to or following those specified/defined herein in the present disclosure, a UE could expect to receive from the network a (downlink/uplink) DCI as in Step-2 in response to the PN message/trigger (or the first UEI report) transmitted or sent via/in/on the first PUCCH as in Step-1, wherein the DCI could provide an UL grant for the corresponding beam reporting (as in Step-3 in Mode A and/or Mode C). In particular, the DCI could be with a non-zero CSI request field indicating a trigger state e.g. pointing to the index(es) of the entries in CSI-AperiodicTriggerStateList or the index(es) of the codepoint(s) in the aperiodic CSI trigger state subselection MAC CE, wherein the trigger state could be associated, linked, mapped or corresponding to one or more CSI reporting settings each provided by a CSI-ReportConfig according to or following those specified herein in the present disclosure. Specifically,
In one example, each of the one or more CSI reporting settings could be (dedicated) for the UE-initiated/event-driven beam reporting as specified/defined herein in the present disclosure. For example, each of the one or more CSI reporting settings could be provided by a higher layer parameter UEI-ReportConfig. For another example, the higher layer parameter(s) CSI-ReportConfig and/or UEI-ReportConfig and/or etc. that provides or configures each of the one or more CSI reporting settings could provide, configure, include, comprise or contain a higher layer parameter ueiBeamReporting, and/or the higher layer parameter ueiBeamReporting could be set to ‘enabled’.
In another example, the one or more CSI reporting settings may not be (dedicated) for the UE-initiated/event-driven beam reporting as specified/defined herein in the present disclosure. For instance, each of the one or more CSI reporting settings could be provided by a higher layer parameter CSI-ReportConfig, and the higher layer parameter CSI-ReportConfig that provides or configures each of the one or more CSI reporting settings (i) could provide, configure, include, comprise or contain a higher layer parameter ueiBeamReporting set to ‘disabled’, and (ii) may not provide, configure, include, comprise or contain the higher layer parameter ueiBeamReporting, and/or the higher layer parameter ueiBeamReport could be absent or is not present, provided, configured, included, comprised or contained in the higher layer parameter(s) CSI-ReportConfig(s).
In another example, the one or more CSI reporting settings could comprise one or more first CSI reporting settings (dedicated) for the UE-initiated/event-driven beam reporting as specified/defined herein in the present disclosure, and one or more second CSI reporting settings not (dedicated) for the UE-initiated/event-driven beam reporting as specified/defined herein in the present disclosure. In this design example,
   regarding the one or more first CSI reporting settings: for example, each of the one or more first CSI reporting settings could be provided by a higher layer parameter UEI-ReportConfig. For another example, the higher layer parameter(s) CSI-ReportConfig and/or UEI-ReportConfig and/or etc. that provides or configures each of the one or more first CSI reporting settings could provide, configure, include, comprise or contain a higher layer parameter ueiBeamReporting, and/or the higher layer parameter ueiBeamReporting could be set to ‘enabled’.
   regarding the one or more second CSI reporting settings: for instance, each of the one or more second CSI reporting settings could be provided by a higher layer parameter CSI-ReportConfig, and the higher layer parameter CSI-ReportConfig that provides or configures each of the one or more second CSI reporting settings (i) could provide, configure, include, comprise or contain a higher layer parameter ueiBeamReporting set to ‘disabled’, and (ii) may not provide, configure, include, comprise or contain the higher layer parameter ueiBeamReporting, and/or the higher layer parameter ueiBeamReport could be absent or is not present, provided, configured, included, comprised or contained in the higher layer parameter(s) CSI-ReportConfig(s).

According to or following those specified herein in the present disclosure, for Mode A and/or Mode C, a UE could transmit or send to the network a PN message/trigger (or a first UEI report) as in Step-1 via/in/by/on a first PUCCH as specified/defined herein in the present disclosure; furthermore, the UE could expect to receive from the network a (downlink/uplink) DCI as in Step-2 in response to the PN message/trigger (or the first UEI report) transmitted or sent via/in/on the first PUCCH as in Step-1, wherein the DCI could provide an UL grant for the corresponding beam reporting (as in Step-3 in Mode A and/or Mode C). In particular, the DCI could be with a non-zero CSI request field indicating a trigger state e.g. pointing to the index(es) of the entries in CSI-AperiodicTriggerStateList or the index(es) of the codepoint(s) in the aperiodic CSI trigger state subselection MAC CE, wherein the trigger state could be associated, linked, mapped or corresponding to one or more CSI reporting settings each provided by a CSI-ReportConfig according to or following those specified herein in the present disclosure. In particular, when/if an indicated trigger state is associated, linked, mapped or corresponding to one or more first CSI reporting settings (dedicated) for the UE-initiated/event-driven beam reporting as specified/defined herein in the present disclosure and one or more second CSI reporting settings not (dedicated) for the UE-initiated/event-driven beam reporting as specified/defined herein in the present disclosure:
In one example, the UE could follow fixed rule(s) in system specification(s) to determine or identify which of the first CSI reporting setting(s) and the second CSI reporting setting(s) to use or apply for the beam reporting. For instance, when/if the UE has sent or transmitted a PN message/trigger via/by/in the first PUCCH as in Step-1 according to or following those specified herein in the present disclosure, and/or the UE could determine or identify PUSCH resource(s)—as in Step-3 of Mode A and/or Mode C and/or as in Step-2 of Mode B-associated, linked, mapped or corresponding to the first PUCCH for transmitting the corresponding UEI beam report(s) according to or following those specified/defined herein in the present disclosure, (1) the UE could use or apply the first CSI reporting setting(s) associated, linked, mapped or corresponding to the indicated trigger state for transmitting the UEI beam report(s), or, (2) the UE could use or apply both the first CSI reporting setting(s) associated, linked, mapped or corresponding to the indicated trigger state for transmitting the UEI beam report(s) and the second CSI reporting setting(s) associated, linked, mapped or corresponding to the indicated trigger state for transmitting (legacy) aperiodic CSI/beam report(s)—i.e., other than the UEI beam report(s) as specified/defined herein in the present disclosure. When/if (i) the UE does not send or transmit any (valid) PN message(s)/trigger(s) via/by/in first PUCCH(s) as in Step-1 according to or following those specified herein in the present disclosure, and/or (ii) the UE has sent or transmitted a PN message/trigger via/by/in the first PUCCH as in Step-1 according to or following those specified herein in the present disclosure but the UE could not determine or identify PUSCH resource(s)—as in Step-3 of Mode A and/or Mode C and/or as in Step-2 of Mode B-linked, associated, mapped or corresponding to the first PUCCH for transmitting the corresponding UEI beam report(s) according to or following those specified/defined herein in the present disclosure, the UE could use or apply the second CSI reporting setting(s) associated, linked, mapped or corresponding to the indicated trigger state for transmitting (legacy) aperiodic CSI/beam report(s)—i.e., other than the UEI beam report(s) as specified/defined herein in the present disclosure.
In another example, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, an indicator to indicate to the UE which of the first CSI reporting setting(s) and the second CSI reporting setting(s) to use or apply for the beam reporting. For example, the UE could be provided or configured in higher layer parameter(s) e.g. CSI-ReportConfig that provides or configures necessary information/setting(s) for the UE-initiated/event-driven beam reporting as specified/defined herein in the present disclosure a higher layer parameter reportConfigType; in this case, when/if reportConfigType is set to ‘first’, the UE could use or apply the first CSI reporting setting(s) associated, linked, mapped or corresponding to the indicated trigger state for the beam reporting, when/if reportConfigType is set to ‘second’, the UE could use or apply the second CSI reporting setting(s) associated, linked, mapped or corresponding to the indicated trigger state for the beam reporting, and/or when/if reportConfig Type is set to ‘both’, the UE could use or apply both the first and second CSI reporting settings associated, linked, mapped or corresponding to the indicated trigger state for the beam reporting. For another example, the UE could receive in a DCI (via a DCI field) a one-bit indicator; when/if the one-bit indicator is set to ‘0’ (or ‘1’), the UE could use or apply the first CSI reporting setting(s) associated, linked, mapped or corresponding to the indicated trigger state for the beam reporting, and when/if the one-bit indicator is set to ‘1’ (or ‘0’), the UE could use or apply the second CSI reporting setting(s) associated, linked, mapped or corresponding to the indicated trigger state for the beam reporting; for this design example, the DCI could correspond to the (downlink/uplink) DCI in Step-2 of Mode A and/or Mode C that provides the UL grant for the beam reporting, and the DCI field could be a new/dedicated DCI field or an existing DCI field e.g, the CSI request field by/via repurposing one or more codepoints of the existing DCI field. For another example, the UE could receive in a DCI (via a DCI field) a two-bit indicator; when/if the two-bit indicator is set to ‘00’ (or ‘01’ or ‘10’ or ‘11’), the UE could use or apply the first CSI reporting setting(s) associated, linked, mapped or corresponding to the indicated trigger state for the beam reporting, when/if the two-bit indicator is set to ‘01’ (or ‘00’ or ‘10’ or ‘11’), the UE could use or apply the second CSI reporting setting(s) associated, linked, mapped or corresponding to the indicated trigger state for the beam reporting, and/or when/if the two-bit indicator is set to ‘10’ (or ‘00’ or ‘01’ or ‘11’), the UE could use or apply both the first and second CSI reporting settings associated, linked, mapped or corresponding to the indicated trigger state for the beam reporting; for this design example, the DCI could correspond to the (downlink/uplink) DCI in Step-2 of Mode A and/or Mode C that provides the UL grant for the beam reporting, and the DCI field could be a new/dedicated DCI field or an existing DCI field e.g, the CSI request field by/via repurposing one or more codepoints of the existing DCI field.
In another example, the PN message/trigger (or the first UEI report) sent or transmitted by the UE via/by/in the first PUCCH as in Step-1 could indicate to the network which of the first CSI reporting setting(s) and the second CSI reporting setting(s) the UE would/could use or apply for the beam reporting. For instance, the PN message/trigger (or the first UEI report) could be or could correspond to a one-bit indicator; when/if the one-bit indicator is set to ‘0’ (or ‘1’), the UE could indicate to the network that they would/could use or apply the first CSI reporting setting(s) associated, linked, mapped or corresponding to the indicated trigger state for the beam reporting, and when/if the one-bit indicator is set to ‘1’ (or ‘0’), the UE could indicate to the network that they would/could use or apply the second CSI reporting setting(s) associated, linked, mapped or corresponding to the indicated trigger state for the beam reporting. For another example, the PN message/trigger (or the first UEI report) could be or could correspond to a two-bit indicator; when/if the two-bit indicator is set to ‘00’ (or ‘01’ or ‘10’ or ‘11’), the UE could indicate to the network that they would/could use or apply the first CSI reporting setting(s) associated, linked, mapped or corresponding to the indicated trigger state for the beam reporting, when/if the two-bit indicator is set to ‘01’ (or ‘00’ or ‘10’ or ‘11’), the UE could indicate to the network that they would/could use or apply the second CSI reporting setting(s) associated, linked, mapped or corresponding to the indicated trigger state for the beam reporting, and/or when/if the two-bit indicator is set to ‘10’ (or ‘00’ or ‘01’ or ‘11’), the UE could indicate to the network that they would/could use or apply both the first and second CSI reporting settings associated, linked, mapped or corresponding to the indicated trigger state for the beam reporting.

The UE could follow those specified/defined herein in the present disclosure, e.g., the above described or specified design examples, to determine or identify which of the first CSI reporting setting(s) dedicated for the UE-initiated/event-driven beam reporting as specified/defined herein in the present disclosure and the second CSI reporting setting(s) not (dedicated) for the UE-initiated/event-driven beam reporting as specified/defined herein in the present disclosure associated, linked, mapped or corresponding to the first PUCCH and/or the indicated trigger state according to or following those specified/defined herein in the present disclosure to use or apply for beam reporting according to or based on one or more of:
when/if the UE has sent or transmitted a PN message/trigger via/by/in the first PUCCH as in Step-1 according to or following those specified herein in the present disclosure, and/or the UE could determine or identify PUSCH resource(s)—as in Step-3 of Mode A and/or Mode C and/or as in Step-2 of Mode B-associated, linked, mapped or corresponding to the first PUCCH for transmitting the corresponding UEI beam report(s) according to or following those specified/defined herein in the present disclosure,
when/if (i) the UE does not send or transmit any (valid) PN message(s)/trigger(s) via/by/in first PUCCH(s) as in Step-1 according to or following those specified herein in the present disclosure, and/or (ii) the UE has sent or transmitted a PN message/trigger via/by/in the first PUCCH as in Step-1 according to or following those specified herein in the present disclosure but the UE could not determine or identify PUSCH resource(s)—as in Step-3 of Mode A and/or Mode C and/or as in Step-2 of Mode B-linked, associated, mapped or corresponding to the first PUCCH for transmitting the corresponding UEI beam report(s) according to or following those specified/defined herein in the present disclosure.

For the design examples specified/described herein in the present disclosure, the UE could use or apply the first CSI reporting setting(s) associated, linked, mapped or corresponding to the first PUCCH and/or the indicated trigger state for transmitting the UEI beam report(s), and the UE could use or apply the second CSI reporting setting(s) associated, linked, mapped or corresponding to the first PUCCH and/or the indicated trigger state for transmitting (legacy) aperiodic CSI/beam report(s)—i.e., other than the UEI beam report(s) as specified/defined herein in the present disclosure.

According to or following those specified herein in the present disclosure, for Mode A, Mode B and/or Mode C, when/if the PUCCH resource or PUCCH transmission occasion of the first UL channel that carries or conveys the PN message/trigger (or equivalently, an UE-initiated beam report indication/indicator (UEIBRI), an UE-initiated channel state information indication/indicator (UEICI), or an UE-initiated report indication/indicator (UEIR)) is associated or linked or mapped to multiple (e.g., M>1) candidate CSI reporting settings each provided by a CSI-ReportConfig that provides or configures necessary information and/or setting(s) for the UE-initiated/event-driven beam operation(s) including beam measurement/reporting (according to or following those specified/defined herein in the present disclosure, for Mode A, the multiple candidate CSI reporting settings could correspond to those associated or linked or mapped or corresponding to the trigger state indicated by/in the CSI request field in the DCI received in Step-2 after the end of the transmission of the PUCCH resource/transmission occasion of the first UL channel as in Step-1), the UE could transmit or send or report in a single reporting instance a UEI (beam) report comprising nrofReportedRS-UEIBR-r19 CRIs or SSBRIs and their absolute L1-RSRPs or differential L1-RSRPs corresponding to reference signals provided by the new BeamResourceSet-r19 that comprise at least one reference signal that satisfies the event condition(s) and/or determines the event, and, when enabledCurrentBeamReport-r19 is configured, the differential L1-RSRP corresponding to reference signal in the indicated TCI state, or to the SSB which is QCLed with the reference signal in the indicated TCI state:
on a PUSCH indicated by the DCI format 0_1/0_2 in a PDCCH reception after the end of the PUCCH if reportTransmissionMode-r19 is configured as ‘ModeA’ and the CSI trigger state associated with the CSI-ReportConfig is indicated in the CSI request field in the DCI format 0_1/0_2, or
on a type 1 CG-PUSCH configured by configuredResourceForSecondChannelOfModeB-r19 in the same CC as the corresponding CSI-ReportConfig which is the first available transmission occasion numOfSymbols-ModeB-r19 symbols after the end of the PUCCH if reportTransmissionMode-r19 is configured as ‘ModeB’, where the periodicity of the PUCCH resource and type 1 CG-PUSCH resource is the same, and the CG-PUSCH does not carry UL-SCH,
   wherein the UEI (beam) report could be provided, configured, associated with or specific to a target CSI reporting setting determined or selected or identified from the multiple (e.g., M>1) candidate CSI reporting settings. In this case, the UE could determine or identify or select the target CSI reporting setting according to or following one or more of:
In one example, the target CSI reporting setting could correspond to the 1st (or first) or last (or M-th) CSI reporting setting among all the (e.g., M>1) candidate CSI reporting settings (e.g., in ordinal position(s)).
In another example, the target CSI reporting setting could correspond to the CSI reporting setting associated, configured or provided with the lowest (or highest) reportConfigId among all the (e.g., M>1) candidate CSI reporting settings.
In another example, the target CSI reporting setting could correspond to the m-th CSI reporting setting (e.g., in its ordinal position) or the CSI reporting setting associated, configured or provided with the m-th lowest (or m-th highest) reportConfigId among all the (e.g., M>1) candidate CSI reporting settings, wherein the UE could determine or identify the value of m according to or following or based on: (1) fixed value(s) in system specification(s) and/or per RRC configuration, (2) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (3) UE's autonomous determination or selection, which could be further sent to the network via/by/in various UL channels/signals including CSI/beam report and/or UE's capability signaling(s).
In another example, each of the (e.g., M>1) candidate CSI reporting settings could be associated, configured or provided with a priority index; for instance, the higher layer parameter CSI-ReportConfig that provides or configures a candidate CSI reporting setting could comprise, include, provide or contain a priority index (or a value of priority index). In this case, the target CSI reporting setting could correspond to the CSI reporting setting that is associated, configured or provided with the lowest (or highest) value of a priority index among all the (e.g., M>1) candidate CSI reporting settings, wherein the lowest (or highest) value of a priority index could indicate that the target CSI reporting setting has the highest priority among all the (e.g., M>1) candidate CSI reporting settings.
In another example, the target CSI reporting setting could correspond to the CSI reporting setting associated, configured or provided with an event that has the lowest (or highest) event index/ID among all the events associated, configured or provided with the (e.g., M>1) candidate CSI reporting settings. Or equivalently, the target CSI reporting setting could correspond to the CSI reporting setting having or configured or provided with eventType set to the lowest (or highest) value or an event with the lowest (or highest) event index/ID or the lowest (or highest) event index/ID among the corresponding/related values of the fields eventType's configured or indicated or provided in all the (e.g., M>1) candidate CSI reporting settings.
In another example, the target CSI reporting setting could correspond to the CSI reporting setting having or configured or provided with eventType set to ‘event-1’, ‘event-2’, . . . , or ‘event-x’ corresponding to the first event, second event, . . . , or x-th event according to or following those specified/defined herein in the present disclosure, wherein x∈{1, . . . , 7}. For instance, the UE could determine or identify a priority order (e.g., from the highest priority to the lowest priority or vice versa) for all the events (e.g., event-x corresponding to the x-th event as specified/defined herein in the present disclosure with x=1, 2, . . . , 7) according to or based on or following: (1) fixed rule(s) in system specification(s) and/or per RRC configuration—e.g., event-1> event-2> event-3> . . . , (2) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (3) UE's autonomous determination or selection, which could be further sent to the network via/by/in various UL channels/signals including CSI/beam report and/or UE's capability signaling(s). In this case, the target CSI reporting setting could correspond to the CSI reporting setting having or configured or provided with eventType set to ‘event-y’, wherein y∈Y with Y representing or denoting a set that comprises or contains or includes all the event(s) or index(es) for all the event(s) associated, mapped, linked or corresponding to all the (M>1) candidate CSI reporting settings; in this case, the y-th event corresponding to eventType set to ‘event-y’ could be the event that has the highest priority (e.g., with the lowest (or highest) priority order/index) among all the event(s) in the set Y.
In another example, the target CSI reporting setting could correspond to the CSI reporting setting associated, configured or provided with the CC or serving cell that has the lowest (or highest) CC or serving cell index/ID among all the (e.g., M>1) candidate CSI reporting settings. Or equivalently, the target CSI reporting setting could correspond to the CSI reporting setting having or configured or provided with carrier/ServCellIndex set to the lowest (or highest) value among the values of the fields carrier's/ServCellIndex's that are configured or indicated or provided in all the (e.g., M>1) candidate CSI reporting settings.
In another example, the target CSI reporting setting could correspond to the CSI reporting setting associated, configured or provided with the CC or serving cell that has the highest priority (e.g., a PCell or PScell) among all CCs or serving cells associated, configured or provided with all the (e.g., M) multiple candidate CSI reporting settings. For instance, the UE could determine or identify a priority order (e.g., from the highest priority to the lowest priority or vice versa) for all the CCs or serving cells according to or based on or following: (1) fixed rule(s) in system specification(s) and/or per RRC configuration—e.g., a PCell/PScell could have the highest priority, or the CC/serving cell with the lowest (or highest) CC or serving cell index/ID could have the highest priority and so on, (2) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (3) UE's autonomous determination or selection, which could be further sent to the network via/by/in various UL channels/signals including CSI/beam report and/or UE's capability signaling(s). In this case, the target CSI reporting setting could correspond to the CSI reporting setting having or configured or provided with carrier/ServCellIndex set to value y, wherein y∈Y with Y representing or denoting a set that comprises or contains or includes all the CC/serving cell indexes/IDs associated, mapped, linked or corresponding to all the (M>1) candidate CSI reporting settings; in this case, the CC/serving cell with the CC or serving cell ID/index value y could be the CC/serving cell that has the highest priority (e.g., with the lowest (or highest) priority order/index) among all the CCs/serving cells (and therefore their corresponding IDs/indexes) in the set Y.

The UE could determine or identify which one or more of the above described/specified design examples to follow to determine or identify the target CSI reporting setting according to or based on: (1) fixed rule(s)/rule(s) in system specification(s) and/or per RRC configuration, (2) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (3) UE's autonomous determination or selection, which could be further sent to the network via/by/in various UL channels/signals including CSI/beam report and/or UE's capability signaling(s). For instance, when/if the aforementioned multiple (e.g., M>1) candidate CSI reporting settings are associated, provided, configured with or specific to different priority indexes and different CCs/serving cells and different events according to or following those specified/defined herein in the present disclosure, the UE could determine or select or identify the target CSI reporting setting—e.g., among/from the aforementioned multiple (e.g., M>1) candidate CSI reporting settings-according to or based on the following priority order:
first to consider the priority index(es), if any/present/configured/provided, associated or mapped or linked or specific or corresponding to the CSI reporting setting(s)
second to consider the CC(s)/serving cell(s) e.g, the corresponding ID(s)/index(es) and/or the corresponding priority order(s) according to or following those specified/define herein in the present disclosure, if any/present/configured/provided, associated or mapped or linked or specific or corresponding to the CSI reporting setting(s)
third to consider the event(s) e.g, the corresponding ID(s)/index(es) and/or the corresponding priority order(s) according to or following those specified/defined herein in the present disclosure, if any/present/configured/provided, associated or mapped or linked or specific or corresponding to the CSI reporting setting(s);
   or according to or based on the following priority order:
first to consider the priority index(es), if any/present/configured/provided, associated or mapped or linked or specific or corresponding to the CSI reporting setting(s)
second to consider the event(s) e.g, the corresponding ID(s)/index(es) and/or the corresponding priority order(s) according to or following those specified/defined herein in the present disclosure, if any/present/configured/provided, associated or mapped or linked or specific or corresponding to the CSI reporting setting(s)
third to consider the CC(s)/serving cell(s) e.g, the corresponding ID(s)/index(es) and/or the corresponding priority order(s) according to or following those specified/define herein in the present disclosure, if any/present/configured/provided, associated or mapped or linked or specific or corresponding to the CSI reporting setting(s);
   or according to or based on the following priority order:
first to consider the event(s) e.g, the corresponding ID(s)/index(es) and/or the corresponding priority order(s) according to or following those specified/defined herein in the present disclosure, if any/present/configured/provided, associated or mapped or linked or specific or corresponding to the CSI reporting setting(s)
second to consider the priority index(es), if any/present/configured/provided, associated or mapped or linked or specific or corresponding to the CSI reporting setting(s)
third to consider the CC(s)/serving cell(s) e.g, the corresponding ID(s)/index(es) and/or the corresponding priority order(s) according to or following those specified/define herein in the present disclosure, if any/present/configured/provided, associated or mapped or linked or specific or corresponding to the CSI reporting setting(s);
   or according to or based on the following priority order:
first to consider the event(s) e.g, the corresponding ID(s)/index(es) and/or the corresponding priority order(s) according to or following those specified/defined herein in the present disclosure, if any/present/configured/provided, associated or mapped or linked or specific or corresponding to the CSI reporting setting(s)
second to consider the CC(s)/serving cell(s) e.g, the corresponding ID(s)/index(es) and/or the corresponding priority order(s) according to or following those specified/define herein in the present disclosure, if any/present/configured/provided, associated or mapped or linked or specific or corresponding to the CSI reporting setting(s)
second to consider the priority index(es), if any/present/configured/provided, associated or mapped or linked or specific or corresponding to the CSI reporting setting(s);
   or according to or based on the following priority order:
first to consider the CC(s)/serving cell(s) e.g, the corresponding ID(s)/index(es) and/or the corresponding priority order(s) according to or following those specified/define herein in the present disclosure, if any/present/configured/provided, associated or mapped or linked or specific or corresponding to the CSI reporting setting(s)
   second to consider the priority index(es), if any/present/configured/provided, associated or mapped or linked or specific or corresponding to the CSI reporting setting(s)
third to consider the event(s) e.g, the corresponding ID(s)/index(es) and/or the corresponding priority order(s) according to or following those specified/defined herein in the present disclosure, if any/present/configured/provided, associated or mapped or linked or specific or corresponding to the CSI reporting setting(s);
   or according to or based on the following priority order:
first to consider the CC(s)/serving cell(s) e.g, the corresponding ID(s)/index(es) and/or the corresponding priority order(s) according to or following those specified/define herein in the present disclosure, if any/present/configured/provided, associated or mapped or linked or specific or corresponding to the CSI reporting setting(s)
second to consider the event(s) e.g, the corresponding ID(s)/index(es) and/or the corresponding priority order(s) according to or following those specified/defined herein in the present disclosure, if any/present/configured/provided, associated or mapped or linked or specific or corresponding to the CSI reporting setting(s)
third to consider the priority index(es), if any/present/configured/provided, associated or mapped or linked or specific or corresponding to the CSI reporting setting(s).

The design examples/embodiments and the corresponding procedures/signalings/signaling flows and the corresponding UE's assumptions/operations/behaviors for determining, identifying or selecting a target CSI reporting setting—e.g., among/from the aforementioned multiple (e.g., M>1) candidate CSI reporting settings can be extended to or equally applied to a UE determining, identifying or selecting more than one target CSI reporting setting—e.g., among/from the aforementioned multiple (e.g., M>1) candidate CSI reporting settings.

Throughout the present disclosure, a priority index could be equivalent to a priority order, or vice versa.

For Mode A, Mode B and/or Mode C, when/if the first PUCCH that carries or conveys the PN message/trigger (or the first UEI report) is associated, linked, mapped or corresponding to multiple (e.g., M>1) CSI reporting settings, and/or an indicated trigger state is associated, linked, mapped or corresponding to multiple (e.g., M>1) CSI reporting settings according to or following those specified herein in the present disclosure, wherein the M>1 CSI reporting settings could comprise one or more first CSI reporting settings dedicated for the UE-initiated/event-driven beam reporting as specified/defined herein in the present disclosure and/or one or more second CSI reporting settings not (dedicated) for the UE-initiated/event-driven beam reporting as specified/defined herein in the present disclosure, the UE could determine or identify which of the M>1 CSI reporting settings—denoted by target CSI reporting setting(s) herein—to use or apply for the beam reporting according to or based on one or more of:
fixed rule(s) in system specification(s):
   for example, the target CSI reporting setting(s) could correspond to the first (or last), e.g. in ordinal position, CSI reporting setting among all the M>1 CSI reporting settings, the CSI reporting setting with the lowest (or highest) reportConfigId among all the M>1 CSI reporting settings, the first (or last), e.g. in ordinal position, CSI reporting setting among all the first CSI reporting setting(s) dedicated for the UE-initiated/event-driven beam reporting as specified/defined herein in the present disclosure, the CSI reporting setting with the lowest (or highest) reportConfigId among all the first CSI reporting setting(s) dedicated for the UE-initiated/event-driven beam reporting as specified/defined herein in the present disclosure, the first (or last), e.g. in ordinal position, CSI reporting setting among all the second CSI reporting setting(s) not (dedicated) for the UE-initiated/event-driven beam reporting as specified/defined herein in the present disclosure, and/or the CSI reporting setting with the lowest (or highest) reportConfigId among all the second CSI reporting setting(s) not (dedicated) for the UE-initiated/event-driven beam reporting as specified/defined herein in the present disclosure;
   for another example, the target CSI reporting setting(s) could correspond to the first (or last) P≥1, e.g. in ordinal position(s), CSI reporting setting(s) among all the M>1 CSI reporting settings, the CSI reporting setting(s) with the P≥1 lowest (or highest) reportConfigId(s) among all the M>1 CSI reporting settings, the first (or last) P≥1, e.g. in ordinal position(s), CSI reporting setting(s) among all the first CSI reporting setting(s) dedicated for the UE-initiated/event-driven beam reporting as specified/defined herein in the present disclosure, the CSI reporting setting(s) with the P≥1 lowest (or highest) reportConfigId(s) among all the first CSI reporting setting(s) dedicated for the UE-initiated/event-driven beam reporting as specified/defined herein in the present disclosure, the first (or last) P≥1, e.g. in ordinal position(s), CSI reporting setting(s) among all the second CSI reporting setting(s) not (dedicated) for the UE-initiated/event-driven beam reporting as specified/defined herein in the present disclosure, and/or the CSI reporting setting(s) with the P≥1 lowest (or highest) reportConfigId(s) among all the second CSI reporting setting(s) not (dedicated) for the UE-initiated/event-driven beam reporting as specified/defined herein in the present disclosure; in this case, the UE could determine or identity the value(s) of P according to or based on: (i) fixed value(s), e.g., 1 or 2 or 3 or 4, in system specification(s) and/or per RRC configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s).
   for another example, the target CSI reporting setting(s) could correspond to the even (or odd) indexed, e.g. in ordinal position(s), CSI reporting setting(s) among all the M>1 CSI reporting settings, the CSI reporting setting(s) with the even (or odd) valued reportConfigId among all the M>1 CSI reporting settings, the even (or odd) indexed, e.g. in ordinal position(s), CSI reporting setting(s) among all the first CSI reporting setting(s) dedicated for the UE-initiated/event-driven beam reporting as specified/defined herein in the present disclosure, the CSI reporting setting(s) with the even (or odd) valued reportConfigId among all the first CSI reporting setting(s) dedicated for the UE-initiated/event-driven beam reporting as specified/defined herein in the present disclosure, the even (or odd) indexed, e.g. in ordinal position(s), CSI reporting setting(s) among all the second CSI reporting setting(s) not (dedicated) for the UE-initiated/event-driven beam reporting as specified/defined herein in the present disclosure, and/or the CSI reporting setting(s) with the even (or odd) valued reportConfigId among all the second CSI reporting setting(s) not (dedicated) for the UE-initiated/event-driven beam reporting as specified/defined herein in the present disclosure;
   for another example, the target CSI reporting setting(s) could correspond to all the M>1 CSI reporting settings, all the first CSI reporting setting(s) dedicated for the UE-initiated/event-driven beam reporting as specified/defined herein in the present disclosure, and/or all the second CSI reporting setting(s) not (dedicated) for the UE-initiated/event-driven beam reporting as specified/defined herein in the present disclosure.
one or more indicators via network's configuration(s)/indication(s) e.g. via higher layer RRC signaling(s)/parameter(s) and/or MAC CE command(s) and/or dynamic DCI based LI signaling(s) based on or according/subject to a corresponding UE's capability or capability signaling:
   for example, the indicator(s) could correspond to an index value k (e.g., k∈{1, . . . , M}); for this design example, the target CSI reporting setting(s) could correspond to the k-th, e.g. in ordinal position, CSI reporting setting among all the M>1 CSI reporting settings, the CSI reporting setting with the k-th lowest (or highest) reportConfigId among all the M>1 CSI reporting settings, the k-th, e.g. in ordinal position, CSI reporting setting among all the first CSI reporting setting(s) dedicated for the UE-initiated/event-driven beam reporting as specified/defined herein in the present disclosure, the CSI reporting setting with the k-th lowest (or highest) reportConfigId among all the first CSI reporting setting(s) dedicated for the UE-initiated/event-driven beam reporting as specified/defined herein in the present disclosure, the k-th, e.g. in ordinal position, CSI reporting setting among all the second CSI reporting setting(s) not (dedicated) for the UE-initiated/event-driven beam reporting as specified/defined herein in the present disclosure, and/or the CSI reporting setting with the k-th lowest (or highest) reportConfigId among all the second CSI reporting setting(s) not (dedicated) for the UE-initiated/event-driven beam reporting as specified/defined herein in the present disclosure;
   for another example, the indicator(s) could correspond to a set of one or more (e.g., N≥1 and N≤M) index values denoted by k_0, . . . , k_N with k_0, . . . , k_N∈{1, . . . , M}; for this design example, the target CSI reporting setting(s) could correspond to the k_0-th, . . . , k_N-th, e.g., in ordinal position(s), CSI reporting setting(s) among all the M>1 CSI reporting settings, the CSI reporting setting with the k_0-th, . . . , k_N-th lowest (or highest) reportConfigId(s) among all the M>1 CSI reporting settings, the k_0-th, . . . , k_N-th, e.g. in ordinal position(s), CSI reporting setting(s) among all the first CSI reporting setting(s) dedicated for the UE-initiated/event-driven beam reporting as specified/defined herein in the present disclosure, the CSI reporting setting(s) with the k_0-th, . . . , k_N-th lowest (or highest) reportConfigId(s) among all the first CSI reporting setting(s) dedicated for the UE-initiated/event-driven beam reporting as specified/defined herein in the present disclosure, the k_0-th, . . . , k_N-th, e.g. in ordinal position(s), CSI reporting setting(s) among all the second CSI reporting setting(s) not (dedicated) for the UE-initiated/event-driven beam reporting as specified/defined herein in the present disclosure, and/or the CSI reporting setting(s) with the k_0-th, . . . , k_N-th lowest (or highest) reportConfigId(s) among all the second CSI reporting setting(s) not (dedicated) for the UE-initiated/event-driven beam reporting as specified/defined herein in the present disclosure;
   for another example, the indicator(s) could correspond to a one-bit indicator; in this case, when/if the one-bit indicator is set to ‘0’ (or ‘1’), the target CSI reporting setting(s) could correspond to a first set of one or more CSI reporting settings among all the corresponding CSI reporting setting(s)—e.g., among all the M>1 CSI reporting settings, all the first CSI reporting setting(s) dedicated for the UE-initiated/event-driven beam reporting as specified/defined herein in the present disclosure, and/or all the second CSI reporting setting(s) not (dedicated) for the UE-initiated/event-driven beam reporting as specified/defined herein in the present disclosure; when/if the one-bit indicator is set to ‘1’ (or ‘0’), the target CSI reporting setting(s) could correspond to a second set of one or more CSI reporting settings among all the corresponding CSI reporting setting(s)—e.g., among all the M>1 CSI reporting settings, all the first CSI reporting setting(s) dedicated for the UE-initiated/event-driven beam reporting as specified/defined herein in the present disclosure, and/or all the second CSI reporting setting(s) not (dedicated) for the UE-initiated/event-driven beam reporting as specified/defined herein in the present disclosure; in particular,
      in one example, the first set of CSI reporting setting(s) could correspond to the first half (e.g., 1 or 2 or 3 or 4, . . . , [M/2] or [M/2]), e.g. in ordinal position(s), of the corresponding CSI reporting setting(s), and the second set of CSI reporting setting(s) could correspond to the second half (e.g., [M/2]+1 or [M/2]+1, . . . , M), e.g. in ordinal position(s), of the corresponding CSI reporting setting(s)
      in another example, the first set of CSI reporting setting(s) could correspond to the CSI reporting setting(s) with the 1-st, . . . , [M/2]-th or [M/2]-th lowest (or highest) reportConfigId(s) among the corresponding CSI reporting setting(s), and the second set of CSI reporting setting(s) could correspond to the CSI reporting setting(s) with the ([M/2]+1)-th or ([M/2]+1)-th, . . . , M-th lowest (or highest) reportConfigId(s) among the corresponding CSI reporting setting(s)
      in another example, the first set of CSI reporting setting(s) could correspond to a first subset of the corresponding CSI reporting setting(s) comprising one or more of the corresponding CSI reporting setting(s), and the second set of CSI reporting setting(s) could correspond to a second subset of the corresponding CSI reporting setting(s) comprising one or more of the corresponding CSI reporting setting(s), wherein the first subset and the second subset could be associated, linked, mapped or corresponding to each other according to or based on: (i) fixed value(s)/rule(s) in system specification(s) and/or per RRC configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s)
      in another example, the first set of CSI reporting setting(s) could correspond to a first subset of the first CSI reporting setting(s) as specified/defined herein in the present disclosure comprising one or more of the first CSI reporting setting(s), and the second set of CSI reporting setting(s) could correspond to a second subset of the second CSI reporting setting(s) as specified/defined herein in the present disclosure comprising one or more of the first CSI reporting setting(s), wherein the first subset and the second subset could be associated, linked, mapped or corresponding to each other according to or based on: (i) fixed value(s)/rule(s) in system specification(s) and/or per RRC configuration, (ii) network's configuration(s) and/or indication(s), e.g., via higher layer RRC signaling(s)/parameter(s) and/or MAC CE command(s) and/or dynamic DCI based LI signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s)
      in another example, for M=2, the first set of CSI reporting setting(s) could correspond to the first (or second), e.g. in ordinal position, CSI reporting setting, and/or the CSI reporting setting with the lowest (or highest) reportConfigId among all the corresponding CSI reporting setting(s), and the second set of CSI reporting setting(s) could correspond to the second (or first), e.g. in ordinal position, CSI reporting setting, and/or the CSI reporting setting with the highest (or lowest) reportConfigId among all the corresponding CSI reporting setting(s)
      Optionally, the indicator(s) could correspond to a set of one or more aforementioned one-bit indicators;
   for another example, the indicator(s) could correspond to a one-bit indicator associated, linked, mapped and corresponding to a CSI reporting setting (e.g., among the corresponding CSI reporting setting(s) including the M>1 CSI reporting settings, the first CSI reporting setting(s), and/or the second CSI reporting setting(s) as specified/defined herein in the present disclosure); in this case, when/if the indicator(s), or equivalently, the one-bit indicator is set to ‘1’ (or ‘0’) or ‘enabled’ (or ‘disabled’), the target CSI reporting setting(s) could comprise the CSI reporting setting associated, linked, mapped and corresponding to the indicator(s), or equivalently, the one-bit (flag) indicator. Optionally, the indicator(s) could correspond to a set of one or more aforementioned one-bit indicators for another example, the indicator(s) could correspond to a k-bit indicator (e.g., k>1 and/or k=[log₂M]); in this case, the target CSI reporting setting(s) could correspond to or include or contain or comprise the 2^{k}-th (or min {M, 2^{k}}-th), e.g. in ordinal position, CSI reporting setting among all the M>1 CSI reporting settings, the CSI reporting setting with the 2^{k}-th (or min {M, 2^{k}}-th) lowest (or highest) reportConfigId among all the M>1 CSI reporting settings, the 2^{k}-th (or min {M_1, 2^{k}}-th), e.g. in ordinal position, CSI reporting setting among all the first CSI reporting setting(s) dedicated for the UE-initiated/event-driven beam reporting as specified/defined herein in the present disclosure, the CSI reporting setting with the 2^{k}-th (or min {M_1, 2^{k}}-th) lowest (or highest) reportConfigId among all the first CSI reporting setting(s) dedicated for the UE-initiated/event-driven beam reporting as specified/defined herein in the present disclosure, the 2^{k}-th (or min {M_2, 2^{k}}-th), e.g. in ordinal position, CSI reporting setting among all the second CSI reporting setting(s) not (dedicated) for the UE-initiated/event-driven beam reporting as specified/defined herein in the present disclosure, and/or the CSI reporting setting with the 2^{k}-th (or min {M_2, 2^{k}}-th) lowest (or highest) reportConfigId among all the second CSI reporting setting(s) not (dedicated) for the UE-initiated/event-driven beam reporting as specified/defined herein in the present disclosure; here, M_1 and M_2 could represent or denote or correspond to the number of the first CSI reporting setting(s) and the number of the second CSI reporting setting(s), respectively. Optionally, the indicator(s) could correspond to a set of one or more aforementioned k-bit indicators
   for another example, the indicator(s) could correspond to a k-bit indicator (e.g., k>1 and/or k=[log₂M]), and each codepoint of the k-bit indicator could correspond a CSI reporting setting (e.g., among the corresponding CSI reporting setting(s) including the M>1 CSI reporting settings, the first CSI reporting setting(s), and/or the second CSI reporting setting(s) as specified/defined herein in the present disclosure) or a reserved codepoint; in this case, when/if the indicator(s) indicates a (“unreserved”) codepoint of the k-bit indicator, the target CSI reporting setting(s) could correspond to or include or contain or comprise the CSI reporting setting associated, linked, corresponding or mapped to the codepoint. For instance, for M=4, when/if the indicator(s) indicates ‘00’ (or ‘01’ or ‘10’ or ‘11’), the target CSI reporting setting(s) could correspond to the 1st, e.g. in ordinal position, CSI reporting setting among all the M=4 CSI reporting settings, and/or the CSI reporting setting with the lowest (or highest) reportConfigId among all the M=4 CSI reporting settings, when/if the indicator(s) indicates ‘01’ (or ‘00’ or ‘10’ or ‘11’), the target CSI reporting setting(s) could correspond to the 2nd, e.g. in ordinal position, CSI reporting setting among all the M=4 CSI reporting settings, and/or the CSI reporting setting with the second lowest (or second highest) reportConfigId among all the M=4 CSI reporting settings, when/if the indicator(s) indicates ‘10’ (or ‘00’ or ‘01’ or ‘11’), the target CSI reporting setting(s) could correspond to the 3rd, e.g. in ordinal position, CSI reporting setting among all the M=4 CSI reporting settings, the CSI reporting setting with the third lowest (or third highest) reportConfigId among all the M=4 CSI reporting settings, and/or when/if the indicator(s) indicates ‘11’ (or ‘00’ or ‘01’ or ‘10’), the target CSI reporting setting(s) could correspond to the 4th, e.g. in ordinal position, CSI reporting setting among all the M=4 CSI reporting settings, and/or the CSI reporting setting with the highest (or lowest) reportConfigId among all the M=4 CSI reporting settings. Optionally, the indicator(s) could correspond to a set of one or more aforementioned k-bit indicators
   for another example, the indicator(s) could correspond to a bitmap with each entry/bit position of the bitmap corresponding to a CSI reporting setting (e.g., among the corresponding CSI reporting setting(s) including the M>1 CSI reporting settings, the first CSI reporting setting(s), and/or the second CSI reporting setting(s) as specified/defined herein in the present disclosure); in this case, when/if an entry/bit position of the bitmap/indicator(s) is set to ‘1’ (or ‘0’), the target CSI reporting setting(s) could correspond to or include or contain or comprise the CSI reporting setting associated, linked, corresponding or mapped to the entry/bit position of the bitmap/indicator(s). For instance, for M=2, the indicator(s) could correspond to a bitmap of [x y] wherein x, y could be set to ‘0’ or ‘1’; furthermore, the entry/bit position x could be associated, linked, mapped or corresponding to the 1st, e.g. in ordinal position, CSI reporting setting among all the M=2 CSI reporting settings, and/or the CSI reporting setting with the lowest (or highest) reportConfigId among all the M=2 CSI reporting settings, and the entry/bit position y could be associated, linked, mapped or corresponding to the 2nd, e.g. in ordinal position, CSI reporting setting among all the M=2 CSI reporting settings, and/or the CSI reporting setting with the highest (or lowest) reportConfigId among all the M=2 CSI reporting settings; in this case, when/if the entry/bit position x of the bitmap/indicator(s) is set to ‘1’ (or ‘0’), the target CSI reporting setting(s) correspond to or include or contain or comprise the 1st, e.g. in ordinal position, CSI reporting setting among all the M=2 CSI reporting settings, and/or the CSI reporting setting with the lowest (or highest) reportConfigId among all the M=2 CSI reporting settings, and/or when/if the entry/bit position y of the bitmap/indicator(s) is set to ‘1’ (or ‘0’), the target CSI reporting setting(s) correspond to or include or contain or comprise the 2nd, e.g. in ordinal position, CSI reporting setting among all the M=2 CSI reporting settings, and/or the CSI reporting setting with the highest (or lowest) reportConfigId among all the M=2 CSI reporting settings.

According to or following those specified/defined herein in the present disclosure, the UE could be provided or configured, e.g., via higher layer RRC signaling(s)/parameter(s), the aforementioned indicator(s); e.g., the higher layer RRC signaling(s)/parameter(s) could correspond to CSI-ReportConfig or UEI-ReportConfig that provides or configures necessary information/setting(s) for the UE-initiated/event-driven beam reporting as specified/defined herein in the present disclosure; furthermore, the aforementioned indicator(s) could be absent or may not be present, configured, provided or comprised in the corresponding higher layer RRC signaling(s)/parameter(s) as specified/defined herein in the present disclosure—in this case, the UE could follow the fixed rule(s) in system specification(s) as specified/defined herein in the present disclosure to determine or identify the target CSI reporting setting(s). Optionally or alternatively, the UE could be indicated by/in or could receive in, a (downlink/uplink) DCI (via one or more codepoints of one or more DCI fields), the indicator(s); e.g., the DCI could correspond to the (downlink/uplink) DCI in Step-2 of Mode A and/or Mode C that provides the UL grant for the beam reporting, the DCI field(s) could be new/dedicated DCI field(s) or existing DCI field(s) e.g, the CSI request field by/via repurposing one or more codepoints of the existing DCI field(s), and the codepoint(s) used to indicate the indicator(s) could correspond to one or more codepoints of new/dedicated DCI field(s) or existing DCI field(s) by/via repurposing the one or more codepoints of the existing DCI field(s); furthermore, the UE could be configured or provided by the network, a higher layer RRC signaling/parameter—e.g. in/via higher layer RRC signaling(s)/parameter(s) CSI-ReportConfig or UEI-ReportConfig that provides or configures necessary information/setting(s) for the UE-initiated/event-driven beam reporting as specified/defined herein in the present disclosure—denoted by indicatorPresentInDCI, to enable (or disable) presence (or absence) of the indication(s) in the DCI. For instance, when/if the higher layer RRC signaling/parameter indicatorPresentInDCI is set to ‘enabled’ (or ‘disabled’), the aforementioned indicator(s) could be present in the corresponding (downlink/uplink) DCI, and/or when/if the higher layer RRC signaling/parameter indicatorPresentInDCI is set to ‘disabled’, the aforementioned indicator(s) could be absent or may not be present or configured or provided or comprised or included or contained in the corresponding (downlink/uplink) DCI—in this case, the UE could follow the fixed rule(s) in system specification(s) as specified/defined herein in the present disclosure to determine or identify the target CSI reporting setting(s).
UE's autonomous selection(s)/determination(s), which could be indicated/sent/informed to the network e.g. in form/part of the PN message/trigger transmitted/sent over/in/by the first UL channel/PUCCH as in Step-1 of Mode A, Mode B and/or Mode C—in the following design examples, the PN message/trigger is represented or denoted by/as indicator(s) for illustrations:
   for example, the indicator(s) could correspond to an index value k (e.g., k∈{1, . . . , M}); for this design example, the target CSI reporting setting(s) could correspond to the k-th, e.g. in ordinal position, CSI reporting setting among all the M>1 CSI reporting settings, the CSI reporting setting with the k-th lowest (or highest) reportConfigId among all the M>1 CSI reporting settings, the k-th, e.g. in ordinal position, CSI reporting setting among all the first CSI reporting setting(s) dedicated for the UE-initiated/event-driven beam reporting as specified/defined herein in the present disclosure, the CSI reporting setting with the k-th lowest (or highest) reportConfigId among all the first CSI reporting setting(s) dedicated for the UE-initiated/event-driven beam reporting as specified/defined herein in the present disclosure, the k-th, e.g. in ordinal position, CSI reporting setting among all the second CSI reporting setting(s) not (dedicated) for the UE-initiated/event-driven beam reporting as specified/defined herein in the present disclosure, and/or the CSI reporting setting with the k-th lowest (or highest) reportConfigId among all the second CSI reporting setting(s) not (dedicated) for the UE-initiated/event-driven beam reporting as specified/defined herein in the present disclosure;
   for another example, the indicator(s) could correspond to a set of one or more (e.g., N≥1 and N≤M) index values denoted by k_0, . . . , k_N with k_0, . . . , k_N∈{1, . . . , M}; for this design example, the target CSI reporting setting(s) could correspond to the k_0-th, . . . , k_N-th, e.g., in ordinal position(s), CSI reporting setting(s) among all the M>1 CSI reporting settings, the CSI reporting setting with the k_0-th, . . . , k_N-th lowest (or highest) reportConfigId(s) among all the M>1 CSI reporting settings, the k_0-th, . . . , k_N-th, e.g. in ordinal position(s), CSI reporting setting(s) among all the first CSI reporting setting(s) dedicated for the UE-initiated/event-driven beam reporting as specified/defined herein in the present disclosure, the CSI reporting setting(s) with the k_0-th, . . . , k_N-th lowest (or highest) reportConfigId(s) among all the first CSI reporting setting(s) dedicated for the UE-initiated/event-driven beam reporting as specified/defined herein in the present disclosure, the k_0-th, . . . , k_N-th, e.g. in ordinal position(s), CSI reporting setting(s) among all the second CSI reporting setting(s) not (dedicated) for the UE-initiated/event-driven beam reporting as specified/defined herein in the present disclosure, and/or the CSI reporting setting(s) with the k_0-th, . . . , k_N-th lowest (or highest) reportConfigId(s) among all the second CSI reporting setting(s) not (dedicated) for the UE-initiated/event-driven beam reporting as specified/defined herein in the present disclosure;
   for another example, the indicator(s) could correspond to a one-bit indicator; in this case, when/if the one-bit indicator is set to ‘0’ (or ‘1’), the target CSI reporting setting(s) could correspond to a first set of one or more CSI reporting settings among all the corresponding CSI reporting setting(s)—e.g., among all the M>1 CSI reporting settings, all the first CSI reporting setting(s) dedicated for the UE-initiated/event-driven beam reporting as specified/defined herein in the present disclosure, and/or all the second CSI reporting setting(s) not (dedicated) for the UE-initiated/event-driven beam reporting as specified/defined herein in the present disclosure; when/if the one-bit indicator is set to ‘1’ (or ‘0’), the target CSI reporting setting(s) could correspond to a second set of one or more CSI reporting settings among all the corresponding CSI reporting setting(s)—e.g., among all the M>1 CSI reporting settings, all the first CSI reporting setting(s) dedicated for the UE-initiated/event-driven beam reporting as specified/defined herein in the present disclosure, and/or all the second CSI reporting setting(s) not (dedicated) for the UE-initiated/event-driven beam reporting as specified/defined herein in the present disclosure; in particular,
      in one example, the first set of CSI reporting setting(s) could correspond to the first half (e.g., 1 or 2 or 3 or 4, . . . , [M/2] or [M/2]), e.g. in ordinal position(s), of the corresponding CSI reporting setting(s), and the second set of CSI reporting setting(s) could correspond to the second half (e.g., [M/2]+1 or [M/2]+1, . . . , M), e.g. in ordinal position(s), of the corresponding CSI reporting setting(s)
      in another example, the first set of CSI reporting setting(s) could correspond to the CSI reporting setting(s) with the 1-st, . . . , [M/2]-th or [M/2]-th lowest (or highest) reportConfigId(s) among the corresponding CSI reporting setting(s), and the second set of CSI reporting setting(s) could correspond to the CSI reporting setting(s) with the ([M/2]+1)-th or ([M/2]+1)-th, . . . , M-th lowest (or highest) reportConfigId(s) among the corresponding CSI reporting setting(s)
      in another example, the first set of CSI reporting setting(s) could correspond to a first subset of the corresponding CSI reporting setting(s) comprising one or more of the corresponding CSI reporting setting(s), and the second set of CSI reporting setting(s) could correspond to a second subset of the corresponding CSI reporting setting(s) comprising one or more of the corresponding CSI reporting setting(s), wherein the first subset and the second subset could be associated, linked, mapped or corresponding to each other according to or based on: (i) fixed value(s)/rule(s) in system specification(s) and/or per RRC configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s)
      in another example, the first set of CSI reporting setting(s) could correspond to a first subset of the first CSI reporting setting(s) as specified/defined herein in the present disclosure comprising one or more of the first CSI reporting setting(s), and the second set of CSI reporting setting(s) could correspond to a second subset of the second CSI reporting setting(s) as specified/defined herein in the present disclosure comprising one or more of the first CSI reporting setting(s), wherein the first subset and the second subset could be associated, linked, mapped or corresponding to each other according to or based on: (i) fixed value(s)/rule(s) in system specification(s) and/or per RRC configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s)
      in another example, for M-2, the first set of CSI reporting setting(s) could correspond to the first (or second), e.g. in ordinal position, CSI reporting setting, and/or the CSI reporting setting with the lowest (or highest) reportConfigId among all the corresponding CSI reporting setting(s), and the second set of CSI reporting setting(s) could correspond to the second (or first), e.g. in ordinal position, CSI reporting setting, and/or the CSI reporting setting with the highest (or lowest) reportConfigId among all the corresponding CSI reporting setting(s)
Optionally, the indicator(s) could correspond to a set, group, bundle or series of one or more aforementioned one-bit indicators;
   for another example, the indicator(s) could correspond to a one-bit indicator associated, linked, mapped and corresponding to a CSI reporting setting (e.g., among the corresponding CSI reporting setting(s) including the M>1 CSI reporting settings, the first CSI reporting setting(s), and/or the second CSI reporting setting(s) as specified/defined herein in the present disclosure); in this case, when/if the indicator(s), or equivalently, the one-bit indicator is set to ‘1’ (or ‘0’) or ‘enabled’ (or ‘disabled’), the target CSI reporting setting(s) could comprise the CSI reporting setting associated, linked, mapped and corresponding to the indicator(s), or equivalently, the one-bit (flag) indicator. Optionally, the indicator(s) could correspond to a set, group, bundle or series of one or more aforementioned one-bit indicators
   for another example, the indicator(s) could correspond to a k-bit indicator (e.g., k>1 and/or k=[log₂M]); in this case, the target CSI reporting setting(s) could correspond to or include or contain or comprise the 2^{k}-th (or min {M, 2^{k}}-th), e.g. in ordinal position, CSI reporting setting among all the M>1 CSI reporting settings, the CSI reporting setting with the 2^{k}-th (or min {M, 2^{k}}-th) lowest (or highest) reportConfigId among all the M>1 CSI reporting settings, the 2^{k}-th (or min {M_1, 2^{k}}-th), e.g. in ordinal position, CSI reporting setting among all the first CSI reporting setting(s) dedicated for the UE-initiated/event-driven beam reporting as specified/defined herein in the present disclosure, the CSI reporting setting with the 2^{k}-th (or min {M_1, 2^{k}}-th) lowest (or highest) reportConfigId among all the first CSI reporting setting(s) dedicated for the UE-initiated/event-driven beam reporting as specified/defined herein in the present disclosure, the 2^{k}-th (or min {M_2, 2^{k}}-th), e.g. in ordinal position, CSI reporting setting among all the second CSI reporting setting(s) not (dedicated) for the UE-initiated/event-driven beam reporting as specified/defined herein in the present disclosure, and/or the CSI reporting setting with the 2^{k}-th (or min {M_2, 2^{k}}-th) lowest (or highest) reportConfigId among all the second CSI reporting setting(s) not (dedicated) for the UE-initiated/event-driven beam reporting as specified/defined herein in the present disclosure; here, M_1 and M_2 could represent or denote or correspond to the number of the first CSI reporting setting(s) and the number of the second CSI reporting setting(s), respectively. Optionally, the indicator(s) could correspond to a set, group, bundle or series of one or more aforementioned k-bit indicators
   for another example, the indicator(s) could correspond to a k-bit indicator (e.g., k>1 and/or k=[log₂M]), and each codepoint of the k-bit indicator could correspond a CSI reporting setting (e.g., among the corresponding CSI reporting setting(s) including the M>1 CSI reporting settings, the first CSI reporting setting(s), and/or the second CSI reporting setting(s) as specified/defined herein in the present disclosure) or a reserved codepoint; in this case, when/if the indicator(s) indicates a (“unreserved”) codepoint of the k-bit indicator, the target CSI reporting setting(s) could correspond to or include or contain or comprise the CSI reporting setting associated, linked, corresponding or mapped to the codepoint. For instance, for M=4, when/if the indicator(s) indicates ‘00’ (or ‘01’ or ‘10’ or ‘11’), the target CSI reporting setting(s) could correspond to the 1st, e.g. in ordinal position, CSI reporting setting among all the M=4 CSI reporting settings, and/or the CSI reporting setting with the lowest (or highest) reportConfigId among all the M=4 CSI reporting settings, when/if the indicator(s) indicates ‘01’ (or ‘00’ or ‘10’ or ‘11’), the target CSI reporting setting(s) could correspond to the 2nd, e.g. in ordinal position, CSI reporting setting among all the M=4 CSI reporting settings, and/or the CSI reporting setting with the second lowest (or second highest) reportConfigId among all the M=4 CSI reporting settings, when/if the indicator(s) indicates ‘10’ (or ‘00’ or ‘01’ or ‘11’), the target CSI reporting setting(s) could correspond to the 3rd, e.g. in ordinal position, CSI reporting setting among all the M=4 CSI reporting settings, the CSI reporting setting with the third lowest (or third highest) reportConfigId among all the M=4 CSI reporting settings, and/or when/if the indicator(s) indicates ‘11’ (or ‘00’ or ‘01’ or ‘10’), the target CSI reporting setting(s) could correspond to the 4th, e.g. in ordinal position, CSI reporting setting among all the M=4 CSI reporting settings, and/or the CSI reporting setting with the highest (or lowest) reportConfigId among all the M=4 CSI reporting settings. Optionally, the indicator(s) could correspond to a set, group, bundle or series of one or more aforementioned k-bit indicators
   for another example, the indicator(s) could correspond to a bitmap with each entry/bit position of the bitmap corresponding to a CSI reporting setting (e.g., among the corresponding CSI reporting setting(s) including the M>1 CSI reporting settings, the first CSI reporting setting(s), and/or the second CSI reporting setting(s) as specified/defined herein in the present disclosure); in this case, when/if an entry/bit position of the bitmap/indicator(s) is set to ‘1’ (or ‘0’), the target CSI reporting setting(s) could correspond to or include or contain or comprise the CSI reporting setting associated, linked, corresponding or mapped to the entry/bit position of the bitmap/indicator(s). For instance, for M=2, the indicator(s) could correspond to a bitmap of [x y] wherein x, y could be set to ‘0’ or ‘1’; furthermore, the entry/bit position x could be associated, linked, mapped or corresponding to the 1st, e.g. in ordinal position, CSI reporting setting among all the M=2 CSI reporting settings, and/or the CSI reporting setting with the lowest (or highest) reportConfigId among all the M=2 CSI reporting settings, and the entry/bit position y could be associated, linked, mapped or corresponding to the 2nd, e.g. in ordinal position, CSI reporting setting among all the M=2 CSI reporting settings, and/or the CSI reporting setting with the highest (or lowest) reportConfigId among all the M=2 CSI reporting settings; in this case, when/if the entry/bit position x of the bitmap/indicator(s) is set to ‘1’ (or ‘0’), the target CSI reporting setting(s) correspond to or include or contain or comprise the 1st, e.g. in ordinal position, CSI reporting setting among all the M=2 CSI reporting settings, and/or the CSI reporting setting with the lowest (or highest) reportConfigId among all the M=2 CSI reporting settings, and/or when/if the entry/bit position y of the bitmap/indicator(s) is set to ‘1’ (or ‘0’), the target CSI reporting setting(s) correspond to or include or contain or comprise the 2nd, e.g. in ordinal position, CSI reporting setting among all the M=2 CSI reporting settings, and/or the CSI reporting setting with the highest (or lowest) reportConfigId among all the M=2 CSI reporting settings.

According to or following those specified/defined herein in the present disclosure, the UE could be configured or provided by the network, a higher layer RRC signaling/parameter—e.g. in/via higher layer RRC signaling(s)/parameter(s) CSI-ReportConfig or UEI-ReportConfig that provides or configures necessary information/setting(s) for the UE-initiated/event-driven beam reporting as specified/defined herein in the present disclosure—denoted by pnAsIndicator, to enable (or disable) use or application of the indicator(s) as/in form/part of the PN message/trigger according to or following those specified herein in the present disclosure. For instance, when/if the higher layer RRC signaling/parameter pnAsIndicator is set to ‘enabled’ (or ‘disabled’), the UE could use or apply the aforementioned indicator(s) in form/part of the PN message/trigger sent/transmitted via/in/by the first PUCCH/UL channel as in Step-1 of Mode A, Mode B and/or Mode C to indicate or inform to the network their selected/determined target CSI reporting setting(s), and/or when/if the higher layer RRC signaling/parameter pnAsIndicator is set to ‘disabled’ (or ‘enabled’), the UE may not use or apply the aforementioned indicator(s) in form/part of the PN message/trigger sent/transmitted via/in/by the first PUCCH/UL channel as in Step-1 of Mode A, Mode B and/or Mode C to indicate or inform to the network their selected/determined target CSI reporting setting(s)—in this case, the UE could follow the fixed rule(s) in system specification(s) as specified/defined herein in the present disclosure to determine or identify the target CSI reporting setting(s).

According to or following those specified/defined herein in the present disclosure, when/if the UE is not provided or configured by the network the aforementioned indicator(s), and/or when/if the UE does not transmit the aforementioned indicator(s) in form/part of the PN message/trigger via/by/in the first UL channel/PUCCH as in Step-1 of Mode A, Mode B and/or Mode C, the UE could follow the fixed rule(s) in system specification(s) as specified/defined herein in the present disclosure to identify or determine the target CSI reporting setting(s).

According to or following those specified/defined herein in the present disclosure, for Mode A, Mode B and/or Mode C, the UE could determine or identify multiple (e.g., M>1) CSI reporting settings for sending or transmitting UEI beam report(s) according to or following those specified/defined herein in the present disclosure, and/or (legacy) aperiodic CSI/beam report(s)—i.e., other than the UEI beam report(s) as specified/defined herein in the present disclosure. In this case, the UE could determine or identify or generate or construct multiple (e.g., M>1) CSI/beam reports each corresponding, associated, linked or mapped to a CSI reporting setting (among the M>1 CSI reporting settings), and (the corresponding report quantity(s)) comprising or including or containing or providing at least one or more resource indicators such as SSBRI(s)/CRI(s) and/or one or more (corresponding) beam metrics including L1-RSRP(s)/L1-SINR(s)
In one example, the UE could report, in a single (CSI/beam) reporting instance—denoted by a joint CSI/beam report, one or more of the M>1 CSI/beam reports—for each reported CSI/beam report, one or more of the corresponding report quantities comprised, included, contained or provided therein could be reported in the single (CSI/beam) reporting instance—i.e., the joint CSI/beam report. For this design example, assume that the UE could report, in the single (CSI/beam) reporting instance—i.e., the joint CSI/beam report, L>1 CSI/beam reports wherein for each of the L>1 reported CSI/beam reports, one or more of the corresponding report quantities comprised, included, contained or provided therein could be reported; furthermore, the UE could determine or identify which of the M>1 CSI/beam reports (and therefore, the corresponding M>1 CSI reporting settings) could correspond to the L>1 CSI/beam reports (and therefore, the corresponding L>1 CSI reporting settings), and/or value(s) of L, according to or based on: (i) fixed value(s) in system specification(s) and/or per RRC configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s), following or according to those specified/defined herein in the present disclosure
   For example, the UE could determine or identify ordering(s) or position(s) of the L>1 CSI/beam reports (and therefore, the corresponding report quantities) in the joint beam/CSI report according to or based on fixed rule(s) in system specification(s)
      In one example, the UE could place or determine or identify or construct or put the L>1 CSI/beam reports (and therefore, the corresponding report quantities) in the joint CSI/beam report-starting from the CSI field(s) with the smallest/lowest (or largest/highest) ID(s)/index(es) to the CSI field(s) with the largest/highest (or smallest/lowest) ID(s)/index(es)—according to or based on the values of reportConfigIds of their respective L>1 CSI reporting settings from low to high (or high to low)
      In another example, the UE could place or determine or identify or construct or put the CSI/beam report(s) corresponding to the first CSI reporting setting(s) for UEI beam reporting as specified/defined herein in the present disclosure, if any, among the L>1 CSI/beam reports in first CSI field(s) with the smallest/lowest (or largest/highest) ID(s)/index(es) in the joint CSI/beam report, and/or the CSI/beam report(s) corresponding to the second CSI reporting setting(s) for (legacy) beam reporting other than the UEI beam reporting as specified/defined herein in the present disclosure, if any, among the L>1 CSI/beam reports in second CSI field(s) following the first CSI field(s)—e.g., the second CSI field(s) could be with smaller/lower (or larger/higher) ID(s)/index(es) than that/those of the first CSI field(s)—in the joint CSI/beam report. For this design example, for the first CSI reporting setting(s), if any, the UE could place or determine or identify or construct or put the respective CSI/beam report(s) (and therefore, the corresponding report quantity(s)) in the joint CSI/beam report—starting from the first CSI field(s) with the smallest/lowest (or largest/highest) ID(s)/index(es) to the first CSI field(s) with the largest/highest (or smallest/lowest) ID(s)/index(es)—according to or based on the values of reportConfigIds of their respective first CSI reporting setting(s) from low to high (or high to low); for the second CSI reporting setting(s), if any, the UE could place or determine or identify or construct or put the respective CSI/beam report(s) (and therefore, the corresponding report quantity(s)) in the joint CSI/beam report—starting from the second CSI field(s) with the smallest/lowest (or largest/highest) ID(s)/index(es) to the second CSI field(s) with the largest/highest (or smallest/lowest) ID(s)/index(es)—according to or based on the values of reportConfigIds of their respective second CSI reporting setting(s) from low to high (or high to low)
      In another example, the UE could place or determine or identify or construct or put the CSI/beam report(s) corresponding to the second CSI reporting setting(s) for (legacy) beam reporting other than UEI beam reporting as specified/defined herein in the present disclosure, if any, among the L>1 CSI/beam reports in second CSI field(s) with the smallest/lowest (or largest/highest) ID(s)/index(es) in the joint CSI/beam report, and/or the CSI/beam report(s) corresponding to the first CSI reporting setting(s) for the UEI beam reporting as specified/defined herein in the present disclosure, if any, among the L>1 CSI/beam reports in first CSI field(s) following the second CSI field(s)—e.g., the first CSI field(s) could be with smaller/lower (or larger/higher) ID(s)/index(es) than that/those of the second CSI field(s)—in the joint CSI/beam report. For this design example, for the first CSI reporting setting(s), if any, the UE could place or determine or identify or construct or put the respective CSI/beam report(s) (and therefore, the corresponding report quantity(s)) in the joint CSI/beam report—starting from the first CSI field(s) with the smallest/lowest (or largest/highest) ID(s)/index(es) to the first CSI field(s) with the largest/highest (or smallest/lowest) ID(s)/index(es)—according to or based on the values of reportConfigIds of their respective first CSI reporting setting(s) from low to high (or high to low); for the second CSI reporting setting(s), if any, the UE could place or determine or identify or construct or put the respective CSI/beam report(s) (and therefore, the corresponding report quantity(s)) in the joint CSI/beam report-starting from the second CSI field(s) with the smallest/lowest (or largest/highest) ID(s)/index(es) to the second CSI field(s) with the largest/highest (or smallest/lowest) ID(s)/index(es)—according to or based on the values of reportConfigIds of their respective second CSI reporting setting(s) from low to high (or high to low)
   For another example, the UE could determine or identify ordering(s) or position(s) of the L>1 CSI/beam reports (and therefore, the corresponding report quantities) in the joint beam/CSI report according to or based on network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling.
      In one example, the UE could be provided or configured by the network, e.g., via higher layer RRC signaling(s)/parameter(s) CSI-ReportConfig that provides or configures necessary information/setting(s) for the UE-initiated/event-driven beam reporting as specified/defined herein in the present disclosure, a list/set of values each corresponding, associated, mapped or linked to a CSI/beam report, and therefore, a corresponding/respective CSI reporting setting among the L>1 CSI reporting settings; in this case, the UE could place or determine or identify or construct or put the L>1 CSI/beam reports (and therefore, the corresponding report quantities) in the joint CSI/beam report—starting from the CSI field(s) with the smallest/lowest (or largest/highest) ID(s)/index(es) to the CSI field(s) with the largest/highest (or smallest/lowest) ID(s)/index(es)—according to or based on the provided or configured list/set of values corresponding, associated, mapped or linked to the L>1 CSI reporting settings from low to high (or high to low)
      In another example, the UE could be provided or configured by the network, e.g., via higher layer RRC signaling(s)/parameter(s) CSI-ReportConfig that provides or configures necessary information/setting(s) for the UE-initiated/event-driven beam reporting as specified/defined herein in the present disclosure, a list/set of values each corresponding, associated, mapped or linked to a CSI/beam report, and therefore, a corresponding/respective CSI reporting setting among the L>1 CSI reporting settings; the UE could place or determine or identify or construct or put the CSI/beam report(s) corresponding to the first CSI reporting setting(s) for UEI beam reporting as specified/defined herein in the present disclosure, if any, among the L>1 CSI/beam reports in first CSI field(s) with the smallest/lowest (or largest/highest) ID(s)/index(es) in the joint CSI/beam report, and/or the CSI/beam report(s) corresponding to the second CSI reporting setting(s) for (legacy) beam reporting other than the UEI beam reporting as specified/defined herein in the present disclosure, if any, among the L>1 CSI/beam reports in second CSI field(s) following the first CSI field(s)—e.g., the second CSI field(s) could be with smaller/lower (or larger/higher) ID(s)/index(es) than that/those of the first CSI field(s)—in the joint CSI/beam report; in this case, for the first CSI reporting setting(s), if any, the UE could place or determine or identify or construct or put the respective CSI/beam report(s) (and therefore, the corresponding report quantity(s)) in the joint CSI/beam report—starting from the first CSI field(s) with the smallest/lowest (or largest/highest) ID(s)/index(es) to the first CSI field(s) with the largest/highest (or smallest/lowest) ID(s)/index(es)—according to or based on the value(s) in the provided or configured list/set corresponding, associated, mapped or linked to the first CSI reporting setting(s) from low to high (or high to low); for the second CSI reporting setting(s), if any, the UE could place or determine or identify or construct or put the respective CSI/beam report(s) (and therefore, the corresponding report quantity(s)) in the joint CSI/beam report—starting from the second CSI field(s) with the smallest/lowest (or largest/highest) ID(s)/index(es) to the second CSI field(s) with the largest/highest (or smallest/lowest) ID(s)/index(es)—according to or based on the value(s) in the provided or configured list/set corresponding, associated, mapped or linked to the second CSI reporting setting(s)
      In another example, the UE could be provided or configured by the network, e.g., via higher layer RRC signaling(s)/parameter(s) CSI-ReportConfig that provides or configures necessary information/setting(s) for the UE-initiated/event-driven beam reporting as specified/defined herein in the present disclosure, a list/set of values each corresponding, associated, mapped or linked to a CSI/beam report, and therefore, a corresponding/respective CSI reporting setting among the L>1 CSI reporting settings; the UE could place or determine or identify or construct or put the CSI/beam report(s) corresponding to the second CSI reporting setting(s) for (legacy) beam reporting other than UEI beam reporting as specified/defined herein in the present disclosure, if any, among the L>1 CSI/beam reports in second CSI field(s) with the smallest/lowest (or largest/highest) ID(s)/index(es) in the joint CSI/beam report, and/or the CSI/beam report(s) corresponding to the first CSI reporting setting(s) for the UEI beam reporting as specified/defined herein in the present disclosure, if any, among the L>1 CSI/beam reports in first CSI field(s) following the second CSI field(s)—e.g., the first CSI field(s) could be with smaller/lower (or larger/higher) ID(s)/index(es) than that/those of the second CSI field(s)—in the joint CSI/beam report; in this case, for the first CSI reporting setting(s), if any, the UE could place or determine or identify or construct or put the respective CSI/beam report(s) (and therefore, the corresponding report quantity(s)) in the joint CSI/beam report—starting from the first CSI field(s) with the smallest/lowest (or largest/highest) ID(s)/index(es) to the first CSI field(s) with the largest/highest (or smallest/lowest) ID(s)/index(es)—according to or based on the value(s) in the provided or configured list/set corresponding, associated, mapped or linked to the first CSI reporting setting(s) from low to high (or high to low); for the second CSI reporting setting(s), if any, the UE could place or determine or identify or construct or put the respective CSI/beam report(s) (and therefore, the corresponding report quantity(s)) in the joint CSI/beam report—starting from the second CSI field(s) with the smallest/lowest (or largest/highest) ID(s)/index(es) to the second CSI field(s) with the largest/highest (or smallest/lowest) ID(s)/index(es)—according to or based on the value(s) in the provided or configured list/set corresponding, associated, mapped or linked to the second CSI reporting setting(s)
      In another example, the UE could be provided or configured by the network for a (or each) CSI reporting setting among the L>1 CSI reporting settings, e.g., in/by/via a corresponding higher layer RRC signaling/parameter CSI-ReportConfig or UEI-ReportConfig that provides or configures the CSI reporting setting, a value x; in this case, the UE could place or determine or identify or construct or put the L>1 CSI/beam reports (and therefore, the corresponding report quantities) in the joint CSI/beam report—starting from the CSI field(s) with the smallest/lowest (or largest/highest) ID(s)/index(es) to the CSI field(s) with the largest/highest (or smallest/lowest) ID(s)/index(es)—according to or based on the values x's corresponding, associated, mapped or linked to the L>1 CSI reporting settings from low to high (or high to low)
      In another example, the UE could be provided or configured by the network for a (or each) CSI reporting setting among the L>1 CSI reporting settings, e.g., in/by/via a corresponding higher layer RRC signaling/parameter CSI-ReportConfig or UEI-ReportConfig that provides or configures the CSI reporting setting, a value x; the UE could place or determine or identify or construct or put the CSI/beam report(s) corresponding to the first CSI reporting setting(s) for UEI beam reporting as specified/defined herein in the present disclosure, if any, among the L>1 CSI/beam reports in first CSI field(s) with the smallest/lowest (or largest/highest) ID(s)/index(es) in the joint CSI/beam report, and/or the CSI/beam report(s) corresponding to the second CSI reporting setting(s) for (legacy) beam reporting other than the UEI beam reporting as specified/defined herein in the present disclosure, if any, among the L>1 CSI/beam reports in second CSI field(s) following the first CSI field(s)—e.g., the second CSI field(s) could be with smaller/lower (or larger/higher) ID(s)/index(es) than that/those of the first CSI field(s)—in the joint CSI/beam report; in this case, for the first CSI reporting setting(s), if any, the UE could place or determine or identify or construct or put the respective CSI/beam report(s) (and therefore, the corresponding report quantity(s)) in the joint CSI/beam report—starting from the first CSI field(s) with the smallest/lowest (or largest/highest) ID(s)/index(es) to the first CSI field(s) with the largest/highest (or smallest/lowest) ID(s)/index(es)—according to or based on the values x's corresponding, associated, mapped or linked to the first CSI reporting setting(s) from low to high (or high to low); for the second CSI reporting setting(s), if any, the UE could place or determine or identify or construct or put the respective CSI/beam report(s) (and therefore, the corresponding report quantity(s)) in the joint CSI/beam report—starting from the second CSI field(s) with the smallest/lowest (or largest/highest) ID(s)/index(es) to the second CSI field(s) with the largest/highest (or smallest/lowest) ID(s)/index(es)—according to or based on the values x's corresponding, associated, mapped or linked to the second CSI reporting setting(s)
      In another example, the UE could be provided or configured by the network for a (or each) CSI reporting setting among the L>1 CSI reporting settings, e.g., in/by/via a corresponding higher layer RRC signaling/parameter CSI-ReportConfig or UEI-ReportConfig that provides or configures the CSI reporting setting, a value x; the UE could place or determine or identify or construct or put the CSI/beam report(s) corresponding to the second CSI reporting setting(s) for (legacy) beam reporting other than UEI beam reporting as specified/defined herein in the present disclosure, if any, among the L>1 CSI/beam reports in second CSI field(s) with the smallest/lowest (or largest/highest) ID(s)/index(es) in the joint CSI/beam report, and/or the CSI/beam report(s) corresponding to the first CSI reporting setting(s) for the UEI beam reporting as specified/defined herein in the present disclosure, if any, among the L>1 CSI/beam reports in first CSI field(s) following the second CSI field(s)—e.g., the first CSI field(s) could be with smaller/lower (or larger/higher) ID(s)/index(es) than that/those of the second CSI field(s)—in the joint CSI/beam report; in this case, for the first CSI reporting setting(s), if any, the UE could place or determine or identify or construct or put the respective CSI/beam report(s) (and therefore, the corresponding report quantity(s)) in the joint CSI/beam report—starting from the first CSI field(s) with the smallest/lowest (or largest/highest) ID(s)/index(es) to the first CSI field(s) with the largest/highest (or smallest/lowest) ID(s)/index(es)—according to or based on the values x's corresponding, associated, mapped or linked to the first CSI reporting setting(s) from low to high (or high to low); for the second CSI reporting setting(s), if any, the UE could place or determine or identify or construct or put the respective CSI/beam report(s) (and therefore, the corresponding report quantity(s)) in the joint CSI/beam report—starting from the second CSI field(s) with the smallest/lowest (or largest/highest) ID(s)/index(es) to the second CSI field(s) with the largest/highest (or smallest/lowest) ID(s)/index(es)—according to or based on the values x's corresponding, associated, mapped or linked to the second CSI reporting setting(s)
   For another example, the UE could autonomously determine or identify, and send, inform or transmit to the network, one or more indicators to indicate ordering(s) or position(s) of the L>1 CSI/beam reports (and therefore, the corresponding report quantities) in the joint beam/CSI report according to or based on network's configuration(s)/indication(s), e.g., via higher layer RRC signaling(s)/parameter(s) and/or MAC CE command(s) and/or dynamic DCI based LI signaling(s) based on or according to a corresponding UE's capability or capability signaling. In this case, the UE could send or transmit the one or more indicators in form/part of the PN message/trigger transmitted/sent over/in/by the first UL channel/PUCCH as in Step-1 of Mode A, Mode B and/or Mode C; alternatively, or optionally, the UE could send or transmit the one or more indicators in part of a UEI beam report—as report content(s)/quantity(s) in the UEI beam report-transmitted/sent over/in/by the second UL channel/PUSCH as in Step-2 of Mode B and/or Step-3 of Mode A and/or Mode C
      In one example, the one or more indicators could comprise or correspond to a list/set of values each corresponding, associated, mapped or linked to a CSI/beam report, and therefore, a corresponding/respective CSI reporting setting among the L>1 CSI reporting settings; in this case, the UE could place or determine or identify or construct or put the L>1 CSI/beam reports (and therefore, the corresponding report quantities) in the joint CSI/beam report—starting from the CSI field(s) with the smallest/lowest (or largest/highest) ID(s)/index(es) to the CSI field(s) with the largest/highest (or smallest/lowest) ID(s)/index(es)—according to or based on the indicator(s), and therefore the list/set of values corresponding, associated, mapped or linked to the L>1 CSI reporting settings from low to high (or high to low)
      In another example, the one or more indicators could comprise or correspond to a list/set of values each corresponding, associated, mapped or linked to a CSI/beam report, and therefore, a corresponding/respective CSI reporting setting among the L>1 CSI reporting settings; the UE could place or determine or identify or construct or put the CSI/beam report(s) corresponding to the first CSI reporting setting(s) for UEI beam reporting as specified/defined herein in the present disclosure, if any, among the L>1 CSI/beam reports in first CSI field(s) with the smallest/lowest (or largest/highest) ID(s)/index(es) in the joint CSI/beam report, and/or the CSI/beam report(s) corresponding to the second CSI reporting setting(s) for (legacy) beam reporting other than the UEI beam reporting as specified/defined herein in the present disclosure, if any, among the L>1 CSI/beam reports in second CSI field(s) following the first CSI field(s)—e.g., the second CSI field(s) could be with smaller/lower (or larger/higher) ID(s)/index(es) than that/those of the first CSI field(s)—in the joint CSI/beam report; in this case, for the first CSI reporting setting(s), if any, the UE could place or determine or identify or construct or put the respective CSI/beam report(s) (and therefore, the corresponding report quantity(s)) in the joint CSI/beam report-starting from the first CSI field(s) with the smallest/lowest (or largest/highest) ID(s)/index(es) to the first CSI field(s) with the largest/highest (or smallest/lowest) ID(s)/index(es)—according to or based on the indicator(s), and therefore the value(s) in the list/set corresponding, associated, mapped or linked to the first CSI reporting setting(s) from low to high (or high to low); for the second CSI reporting setting(s), if any, the UE could place or determine or identify or construct or put the respective CSI/beam report(s) (and therefore, the corresponding report quantity(s)) in the joint CSI/beam report—starting from the second CSI field(s) with the smallest/lowest (or largest/highest) ID(s)/index(es) to the second CSI field(s) with the largest/highest (or smallest/lowest) ID(s)/index(es)—according to or based on the indicator(s), and therefore the value(s) in the list/set corresponding, associated, mapped or linked to the second CSI reporting setting(s)
      In another example, the one or more indicators could comprise or correspond to a list/set of values each corresponding, associated, mapped or linked to a CSI/beam report, and therefore, a corresponding/respective CSI reporting setting among the L>1 CSI reporting settings; the UE could place or determine or identify or construct or put the CSI/beam report(s) corresponding to the second CSI reporting setting(s) for (legacy) beam reporting other than UEI beam reporting as specified/defined herein in the present disclosure, if any, among the L>1 CSI/beam reports in second CSI field(s) with the smallest/lowest (or largest/highest) ID(s)/index(es) in the joint CSI/beam report, and/or the CSI/beam report(s) corresponding to the first CSI reporting setting(s) for the UEI beam reporting as specified/defined herein in the present disclosure, if any, among the L>1 CSI/beam reports in first CSI field(s) following the second CSI field(s)—e.g., the first CSI field(s) could be with smaller/lower (or larger/higher) ID(s)/index(es) than that/those of the second CSI field(s)—in the joint CSI/beam report; in this case, for the first CSI reporting setting(s), if any, the UE could place or determine or identify or construct or put the respective CSI/beam report(s) (and therefore, the corresponding report quantity(s)) in the joint CSI/beam report-starting from the first CSI field(s) with the smallest/lowest (or largest/highest) ID(s)/index(es) to the first CSI field(s) with the largest/highest (or smallest/lowest) ID(s)/index(es)—according to or based on the indicator(s), and therefore the value(s) in the list/set corresponding, associated, mapped or linked to the first CSI reporting setting(s) from low to high (or high to low); for the second CSI reporting setting(s), if any, the UE could place or determine or identify or construct or put the respective CSI/beam report(s) (and therefore, the corresponding report quantity(s)) in the joint CSI/beam report—starting from the second CSI field(s) with the smallest/lowest (or largest/highest) ID(s)/index(es) to the second CSI field(s) with the largest/highest (or smallest/lowest) ID(s)/index(es)—according to or based on the indicator(s), and therefore the value(s) in the list/set corresponding, associated, mapped or linked to the second CSI reporting setting(s)
      In another example, the one or more indicators could comprise or correspond to a list/set of reportConfigId's each corresponding, associated, mapped or linked to a CSI/beam report, and therefore, a corresponding/respective CSI reporting setting among the L>1 CSI reporting settings; in this case, the UE could place or determine or identify or construct or put the L>1 CSI/beam reports (and therefore, the corresponding report quantities) in the joint CSI/beam report-starting from the CSI field(s) with the smallest/lowest (or largest/highest) ID(s)/index(es) to the CSI field(s) with the largest/highest (or smallest/lowest) ID(s)/index(es)—according to or based on the order(s)/ordering(s) of the list/set of reportConfigId's (hence the indicator(s))
      In another example, the one or more indicators could comprise or correspond to a list/set of reportConfigId's each corresponding, associated, mapped or linked to a CSI/beam report, and therefore, a corresponding/respective CSI reporting setting among the L>1 CSI reporting settings; the UE could place or determine or identify or construct or put the CSI/beam report(s) corresponding to the first CSI reporting setting(s) for UEI beam reporting as specified/defined herein in the present disclosure, if any, among the L>1 CSI/beam reports in first CSI field(s) with the smallest/lowest (or largest/highest) ID(s)/index(es) in the joint CSI/beam report, and/or the CSI/beam report(s) corresponding to the second CSI reporting setting(s) for (legacy) beam reporting other than the UEI beam reporting as specified/defined herein in the present disclosure, if any, among the L>1 CSI/beam reports in second CSI field(s) following the first CSI field(s)—e.g., the second CSI field(s) could be with smaller/lower (or larger/higher) ID(s)/index(es) than that/those of the first CSI field(s)—in the joint CSI/beam report; in this case, for the first CSI reporting setting(s), if any, the UE could place or determine or identify or construct or put the respective CSI/beam report(s) (and therefore, the corresponding report quantity(s)) in the joint CSI/beam report—starting from the first CSI field(s) with the smallest/lowest (or largest/highest) ID(s)/index(es) to the first CSI field(s) with the largest/highest (or smallest/lowest) ID(s)/index(es)—according to or based on the order(s)/ordering(s) of the reportConfigId's (hence the indicator(s)) corresponding, associated, mapped or linked to the first CSI reporting setting(s) in the list/set; for the second CSI reporting setting(s), if any, the UE could place or determine or identify or construct or put the respective CSI/beam report(s) (and therefore, the corresponding report quantity(s)) in the joint CSI/beam report—starting from the second CSI field(s) with the smallest/lowest (or largest/highest) ID(s)/index(es) to the second CSI field(s) with the largest/highest (or smallest/lowest) ID(s)/index(es)—according to or based on the order(s)/ordering(s) of the reportConfigId's (hence the indicator(s)) corresponding, associated, mapped or linked to the second CSI reporting setting(s) in the list/set
      In another example, the one or more indicators could comprise or correspond to a list/set of reportConfigId's each corresponding, associated, mapped or linked to a CSI/beam report, and therefore, a corresponding/respective CSI reporting setting among the L>1 CSI reporting settings; the UE could place or determine or identify or construct or put the CSI/beam report(s) corresponding to the second CSI reporting setting(s) for (legacy) beam reporting other than UEI beam reporting as specified/defined herein in the present disclosure, if any, among the L>1 CSI/beam reports in second CSI field(s) with the smallest/lowest (or largest/highest) ID(s)/index(es) in the joint CSI/beam report, and/or the CSI/beam report(s) corresponding to the first CSI reporting setting(s) for the UEI beam reporting as specified/defined herein in the present disclosure, if any, among the L>1 CSI/beam reports in first CSI field(s) following the second CSI field(s)—e.g., the first CSI field(s) could be with smaller/lower (or larger/higher) ID(s)/index(es) than that/those of the second CSI field(s)—in the joint CSI/beam report; in this case, for the first CSI reporting setting(s), if any, the UE could place or determine or identify or construct or put the respective CSI/beam report(s) (and therefore, the corresponding report quantity(s)) in the joint CSI/beam report—starting from the first CSI field(s) with the smallest/lowest (or largest/highest) ID(s)/index(es) to the first CSI field(s) with the largest/highest (or smallest/lowest) ID(s)/index(es)—according to or based on the order(s)/ordering(s) of the reportConfigId's (hence the indicator(s)) corresponding, associated, mapped or linked to the first CSI reporting setting(s) in the list/set; for the second CSI reporting setting(s), if any, the UE could place or determine or identify or construct or put the respective CSI/beam report(s) (and therefore, the corresponding report quantity(s)) in the joint CSI/beam report—starting from the second CSI field(s) with the smallest/lowest (or largest/highest) ID(s)/index(es) to the second CSI field(s) with the largest/highest (or smallest/lowest) ID(s)/index(es)—according to or based on the order(s)/ordering(s) of the reportConfigId's (hence the indicator(s)) corresponding, associated, mapped or linked to the second CSI reporting setting(s) in the list/set
      In another example, the one or more indicators could comprise or correspond to one or more reportConfig's each corresponding or linked or mapped or associated to a report quantity in the joint CSI/beam report; in this case, a report quantity associated, linked, mapped or corresponding to a reportConfigId in the joint CSI/beam report could belong to a CSI/beam report-among the L>1 CSI/beam reports-hence a corresponding CSI reporting setting associated, provided or configured with the (same) reportConfigId.
In another example, the UE could report, in a single (CSI/beam) reporting instance—denoted by a joint CSI/beam report, one or more of the M>1 CSI/beam reports—for each reported CSI/beam report, one or more of the corresponding report quantities comprised, included, contained or provided therein could be reported in the single (CSI/beam) reporting instance—i.e., the joint CSI/beam report. For this design example, assume that the UE could report, in the single (CSI/beam) reporting instance—i.e., the joint CSI/beam report, L>1 CSI/beam reports wherein for each of the L>1 reported CSI/beam reports, one or more of the corresponding report quantities comprised, included, contained or provided therein could be reported; furthermore, the UE could determine or identify which of the M>1 CSI/beam reports (and therefore, the corresponding M>1 CSI reporting settings) could correspond to the L>1 CSI/beam reports (and therefore, the corresponding L>1 CSI reporting settings), and/or value(s) of L, according to or based on: (i) fixed value(s) in system specification(s) and/or per RRC configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s), following or according to those specified/defined herein in the present disclosure. For this design example, the L>1 CSI/beam reports, hence their respective/corresponding report quantity(s), could be multiplexed in the joint CSI/beam report
   For example, the UE could determine or identify means of or how to—e.g., in terms/form of ordering(s) and/or position(s) of-multiplexing or multiplex the L>1 CSI/beam reports (and therefore, the corresponding report quantities) in the joint beam/CSI report, e.g., according to or based on (i) fixed rule(s) in system specification(s), (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s), following or according to those specified/defined herein in the present disclosure.
   For another example, a/each CSI reporting setting and/or a/each reportConfigId could be associated with a priority index/value; here, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, the aforementioned association(s); for instance, for a CSI reporting setting, the UE could be provided or configured in higher layer parameter(s) e.g. CSI-ReportConfig and/or UEI-ReportConfig that provides or configures necessary information/setting(s) for the CSI reporting setting as specified/defined herein in the present disclosure a priority index/value-hence the CSI reporting setting and the priority index/value are associated. A CSI reporting setting associated with a lower (or higher) priority index/value could be of a higher (or lower) priority than a CSI reporting setting associated with a higher (or lower) priority index/value in terms of multiplexing their respective/corresponding CSI/beam reports in a same (CSI/beam) report/reporting instance. In this case, the UE could multiplex the L>1 CSI/beam reports (and therefore, the corresponding report quantities) in the joint CSI/beam report—starting from the CSI field(s) with the smallest/lowest (or largest/highest) ID(s)/index(es) to the CSI field(s) with the largest/highest (or smallest/lowest) ID(s)/index(es)—according to or based on the priority indexes/values associated with the L>1 CSI reporting settings from low to high (or high to low)
   For another example, a/each CSI reporting setting and/or a/each reportConfigId could be associated with a priority index/value; here, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, the aforementioned association(s); for instance, for a CSI reporting setting, the UE could be provided or configured in higher layer parameter(s) e.g. CSI-ReportConfig and/or UEI-ReportConfig that provides or configures necessary information/setting(s) for the CSI reporting setting as specified/defined herein in the present disclosure a priority index/value-hence the CSI reporting setting and the priority index/value are associated. A CSI reporting setting associated with a lower (or higher) priority index/value could be of a higher (or lower) priority than a CSI reporting setting associated with a higher (or lower) priority index/value in terms of multiplexing their respective/corresponding CSI/beam reports in a same (CSI/beam) report/reporting instance. In this case, the UE could place or determine or identify or construct or put the CSI/beam report(s) corresponding to the first CSI reporting setting(s) for UEI beam reporting as specified/defined herein in the present disclosure, if any, among the L>1 CSI/beam reports in first CSI field(s) with the smallest/lowest (or largest/highest) ID(s)/index(es) in the joint CSI/beam report, and/or the CSI/beam report(s) corresponding to the second CSI reporting setting(s) for (legacy) beam reporting other than the UEI beam reporting as specified/defined herein in the present disclosure, if any, among the L>1 CSI/beam reports in second CSI field(s) following the first CSI field(s)—e.g., the second CSI field(s) could be with smaller/lower (or larger/higher) ID(s)/index(es) than that/those of the first CSI field(s)—in the joint CSI/beam report. Furthermore, for the first CSI reporting setting(s), if any, the UE could multiplex the respective CSI/beam report(s) (and therefore, the corresponding report quantity(s)) in the joint CSI/beam report—starting from the first CSI field(s) with the smallest/lowest (or largest/highest) ID(s)/index(es) to the first CSI field(s) with the largest/highest (or smallest/lowest) ID(s)/index(es)—according to or based on the priority index(es)/value(s) associated with the first CSI reporting setting(s) from low to high (or high to low); for the second CSI reporting setting(s), if any, the UE could multiplex the respective CSI/beam report(s) (and therefore, the corresponding report quantity(s)) in the joint CSI/beam report—starting from the second CSI field(s) with the smallest/lowest (or largest/highest) ID(s)/index(es) to the second CSI field(s) with the largest/highest (or smallest/lowest) ID(s)/index(es)—according to or based on the priority index(es)/value(s) associated with the second CSI reporting setting(s)
   For another example, a/each CSI reporting setting and/or a/each reportConfigId could be associated with a priority index/value; here, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, the aforementioned association(s); for instance, for a CSI reporting setting, the UE could be provided or configured in higher layer parameter(s) e.g. CSI-ReportConfig and/or UEI-ReportConfig that provides or configures necessary information/setting(s) for the CSI reporting setting as specified/defined herein in the present disclosure a priority index/value-hence the CSI reporting setting and the priority index/value are associated. A CSI reporting setting associated with a lower (or higher) priority index/value could be of a higher (or lower) priority than a CSI reporting setting associated with a higher (or lower) priority index/value in terms of multiplexing their respective/corresponding CSI/beam reports in a same (CSI/beam) report/reporting instance. In this case, the UE could place or determine or identify or construct or put the CSI/beam report(s) corresponding to the second CSI reporting setting(s) for (legacy) beam reporting other than UEI beam reporting as specified/defined herein in the present disclosure, if any, among the L>1 CSI/beam reports in second CSI field(s) with the smallest/lowest (or largest/highest) ID(s)/index(es) in the joint CSI/beam report, and/or the CSI/beam report(s) corresponding to the first CSI reporting setting(s) for the UEI beam reporting as specified/defined herein in the present disclosure, if any, among the L>1 CSI/beam reports in first CSI field(s) following the second CSI field(s)—e.g., the first CSI field(s) could be with smaller/lower (or larger/higher) ID(s)/index(es) than that/those of the second CSI field(s)—in the joint CSI/beam report. Furthermore, for the first CSI reporting setting(s), if any, the UE could multiplex the respective CSI/beam report(s) (and therefore, the corresponding report quantity(s)) in the joint CSI/beam report—starting from the first CSI field(s) with the smallest/lowest (or largest/highest) ID(s)/index(es) to the first CSI field(s) with the largest/highest (or smallest/lowest) ID(s)/index(es)—according to or based on the priority index(es)/value(s) associated with the first CSI reporting setting(s) from low to high (or high to low); for the second CSI reporting setting(s), if any, the UE could multiplex the respective CSI/beam report(s) (and therefore, the corresponding report quantity(s)) in the joint CSI/beam report—starting from the second CSI field(s) with the smallest/lowest (or largest/highest) ID(s)/index(es) to the second CSI field(s) with the largest/highest (or smallest/lowest) ID(s)/index(es)—according to or based on the priority index(es)/value(s) associated with the second CSI reporting setting(s)
   For another example, a/each CSI reporting setting and/or a/each reportConfigId could be associated with a priority index/value; here, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, the aforementioned association(s); for instance, for a CSI reporting setting, the UE could be provided or configured in higher layer parameter(s) e.g. CSI-ReportConfig and/or UEI-ReportConfig that provides or configures necessary information/setting(s) for the CSI reporting setting as specified/defined herein in the present disclosure a priority index/value-hence the CSI reporting setting and the priority index/value are associated. A CSI reporting setting associated with a lower (or higher) priority index/value could be of a higher (or lower) priority than a CSI reporting setting associated with a higher (or lower) priority index/value in terms of multiplexing their respective/corresponding CSI/beam reports in a same (CSI/beam) report/reporting instance. In this case, the UE could place or determine or identify or construct or put the CSI/beam report(s) corresponding to the first CSI reporting setting(s) for UEI beam reporting as specified/defined herein in the present disclosure, if any, among the L>1 CSI/beam reports in first CSI field(s) with the smallest/lowest (or largest/highest) ID(s)/index(es) in the joint CSI/beam report, and/or multiplex the CSI/beam report(s) corresponding to the second CSI reporting setting(s) for (legacy) beam reporting other than the UEI beam reporting as specified/defined herein in the present disclosure, if any, among the L>1 CSI/beam reports in second CSI field(s) following the first CSI field(s)—e.g., the second CSI field(s) could be with smaller/lower (or larger/higher) ID(s)/index(es) than that/those of the first CSI field(s)—in the joint CSI/beam report—starting from the second CSI field(s) with the smallest/lowest (or largest/highest) ID(s)/index(es) to the second CSI field(s) with the largest/highest (or smallest/lowest) ID(s)/index(es)—according to or based on the priority index(es)/value(s) associated with the second CSI reporting setting(s)
   For another example, a/each CSI reporting setting and/or a/each reportConfigId could be associated with a priority index/value; here, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, the aforementioned association(s); for instance, for a CSI reporting setting, the UE could be provided or configured in higher layer parameter(s) e.g. CSI-ReportConfig and/or UEI-ReportConfig that provides or configures necessary information/setting(s) for the CSI reporting setting as specified/defined herein in the present disclosure a priority index/value-hence the CSI reporting setting and the priority index/value are associated. A CSI reporting setting associated with a lower (or higher) priority index/value could be of a higher (or lower) priority than a CSI reporting setting associated with a higher (or lower) priority index/value in terms of multiplexing their respective/corresponding CSI/beam reports in a same (CSI/beam) report/reporting instance. In this case, the UE could place or determine or identify or construct or put the CSI/beam report(s) corresponding to the second CSI reporting setting(s) for (legacy) beam reporting other than UEI beam reporting as specified/defined herein in the present disclosure, if any, among the L>1 CSI/beam reports in second CSI field(s) with the smallest/lowest (or largest/highest) ID(s)/index(es) in the joint CSI/beam report, and/or multiplex the CSI/beam report(s) corresponding to the first CSI reporting setting(s) for the UEI beam reporting as specified/defined herein in the present disclosure, if any, among the L>1 CSI/beam reports in first CSI field(s) following the second CSI field(s)—e.g., the first CSI field(s) could be with smaller/lower (or larger/higher) ID(s)/index(es) than that/those of the second CSI field(s)—in the joint CSI/beam report—starting from the first CSI field(s) with the smallest/lowest (or largest/highest) ID(s)/index(es) to the first CSI field(s) with the largest/highest (or smallest/lowest) ID(s)/index(es)—according to or based on the priority index(es)/value(s) associated with the first CSI reporting setting(s)
In another example, the UE could report, in one or more (CSI/beam) reporting instances-denoted by separate CSI/beam report(s), one or more of the M>1 CSI/beam reports—for each reported CSI/beam report, one or more of the corresponding report quantities comprised, included, contained or provided therein could be reported in the corresponding/respective (CSI/beam) reporting instance. In particular, the UE could report, in L>1 (CSI/beam) reporting instances, L>1 CSI/beam reports respectively wherein for each of the L>1 reported CSI/beam reports, one or more of the corresponding report quantities comprised, included, contained or provided therein could be reported; for sending or transmitting each of the L>1 CSI/beam reports (hence, the corresponding L>1 CSI reporting settings), the UE could determine or identify the corresponding/respective (CSI/beam) reporting instance, accordingly; furthermore, the UE could determine or identify which of the M>1 CSI/beam reports (and therefore, the corresponding M>1 CSI reporting settings) could correspond to the L>1 CSI/beam reports (and therefore, the corresponding L>1 CSI reporting settings), and/or value(s) of L, according to or based on: (i) fixed value(s) in system specification(s) and/or per RRC configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s), following or according to those specified/defined herein in the present disclosure.

For the above described/specified design examples, L could be equal to M, i.e., L=M. Furthermore, according to or following those specified/defined herein in the present disclosure, for joint CSI/beam reporting in a single (CSI/beam) reporting instance, when/if the UE is not provided or configured by the network ordering(s) or position(s) of the L>1 CSI/beam reports (and therefore, the corresponding report quantities) in the joint beam/CSI report, and/or when/if the UE does not transmit the aforementioned indicator(s) in form/part of the PN message/trigger via/by/in the first UL channel/PUCCH as in Step-1 of Mode A, Mode B and/or Mode C or in part of a UEI beam report—as report content(s)/quantity(s) in the UEI beam report-transmitted/sent over/in/by the second UL channel/PUSCH as in Step-2 of Mode B and/or Step-3 of Mode A and/or Mode C, to indicate or inform the network ordering(s) or position(s) of the L>1 CSI/beam reports (and therefore, the corresponding report quantities) in the joint beam/CSI report, the UE could follow the fixed rule(s) in system specification(s) as specified/defined herein in the present disclosure to identify or determine ordering(s) or position(s) of the L>1 CSI/beam reports (and therefore, the corresponding report quantities) in the joint beam/CSI report. Optionally, or alternatively, the UE could transmit a joint CSI/beam report as specified/defined herein in the present disclosure in two parts (part 1 and part 2 of the joint CSI/beam report)—part 1 (or the first part) of the joint CSI/beam report could have a fixed payload size, and/or indicate information, e.g., payload size, related to part 2 (or the second part) of the joint/CSI beam report; and part 2 (or the second part) of the joint CSI/beam report could be of a variable payload size. In particular, part 1 of the joint CSI/beam report could provide, comprise, include, contain, comprise or indicate at least one or more of:
Component-1: value(s) of M, L and/or P as specified/defined above or herein in the present disclosure
Component-2: a/the number of CSI/beam report(s)—hence a/the corresponding number(s) of resource indicator(s) including SSBRI(s)/CRI(s) and/or beam metric(s) including L1-RSRP(s)/L1-SINR(s)—indicated in part 2 of the joint CSI/beam report
Component-3: a/the number of CSI/beam report(s) that is associated with the first CSI reporting setting(s) for UEI beam reporting as specified/defined herein in the present disclosure-hence a/the corresponding number(s) of resource indicator(s) including SSBRI(s)/CRI(s) and/or beam metric(s) including L1-RSRP(s)/L1-SINR(s)—indicated in part 2 of the joint CSI/beam report
Component-4: a/the number of CSI/beam report(s) that is associated with the second CSI reporting setting(s) for (legacy) beam reporting other than UEI beam reporting as specified/defined herein in the present disclosure
hence the corresponding number(s) of resource indicator(s) including SSBRI(s)/CRI(s) and/or beam metric(s) including L1-RSRP(s)/L1-SINR(s)—indicated in part 2 of the joint CSI/beam report
Component-5: one or more of the CSI/beam reports associated with the first CSI reporting setting(s) for UEI beam reporting as specified/defined herein in the present disclosure-hence the corresponding resource indicator(s) including SSBRI(s)/CRI(s) and/or beam metric(s) including L1-RSRP(s)/L1-SINR(s)
Component-6: one or more of the CSI/beam reports associated with the second CSI reporting setting(s) for (legacy) beam reporting other than the UEI beam reporting as specified/defined herein in the present disclosure—hence the corresponding resource indicator(s) including SSBRI(s)/CRI(s) and/or beam metric(s) including L1-RSRP(s)/L1-SINR(s)

Component-7: the aforementioned indicator(s) as defined/specified herein in the present disclosure; for example, the indicator(s) used to indicate the target CSI reporting setting, the indicator(s) used to indicate ordering(s) or position(s) of the corresponding/respective CSI/beam reports, and/or etc. as specified/defined herein in the present disclosure.

Part 2 of the joint CSI/beam report could provide, comprise, include, contain, comprise or indicate at least one or more of:
Component-i: one or more of the CSI/beam reports associated with the first CSI reporting setting(s) for UEI beam reporting as specified/defined herein in the present disclosure-hence the corresponding resource indicator(s) including SSBRI(s)/CRI(s) and/or beam metric(s) including L1-RSRP(s)/L1-SINR(s)
Component-ii: one or more of the CSI/beam reports associated with the second CSI reporting setting(s) for (legacy) beam reporting other than the UEI beam reporting as specified/defined herein in the present disclosure—hence the corresponding resource indicator(s) including SSBRI(s)/CRI(s) and/or beam metric(s) including L1-RSRP(s)/L1-SINR(s)

In addition, part 2 of the joint CSI/beam report could be absent (i.e., the joint CSI/beam report could contain, comprise, include or correspond to only part 1) based on or according to one or more of:
network's configuration(s) and/or indication(s), e.g., via higher layer RRC signaling(s)/parameter(s) and/or MAC CE command(s) and/or dynamic DCI based L1 signaling(s) based on or according to a corresponding UE's capability or capability signaling
one or more of the components—e.g., Component-1, Component-2, Component-3, Component-4 and/or Component-7 as specified/defined herein in the present disclosure—is/are absent in/from part 1 of the joint CSI/beam report
Component-5 in/from part 1 of the joint CSI/beam report could comprise all the CSI/beam reports associated with the first CSI reporting setting(s) for UEI beam reporting as specified/defined herein in the present disclosure-hence the corresponding resource indicator(s) including SSBRI(s)/CRI(s) and/or beam metric(s) including L1-RSRP(s)/L1-SINR(s)
Component-6 in/from part 1 of the joint CSI/beam report could comprise all the CSI/beam reports associated with the second CSI reporting setting(s) for (legacy) beam reporting other than the UEI beam reporting as specified/defined herein in the present disclosure-hence the corresponding resource indicator(s) including SSBRI(s)/CRI(s) and/or beam metric(s) including L1-RSRP(s)/L1-SINR(s)

According to or following those specified/defined herein in the present disclosure, a trigger state e.g. pointing to an index of an entry in the higher layer RRC parameter CSI-AperiodicTriggerStateList or an index of a codepoint in the aperiodic CSI trigger state sub selection MAC CE could correspond to or could be associated, linked or mapped to: (i) one or more first CSI reporting settings (dedicated) for the UEI beam reporting as specified/defined herein in the present disclosure, (ii) one or more second CSI reporting settings for (legacy) beam reporting i.e. other than the UEI beam reporting as specified/defined herein in the present disclosure, or (iii) a mixture of one or more first CSI reporting settings (dedicated) for the UEI beam reporting as specified/defined herein in the present disclosure, and one or more second CSI reporting settings for (legacy) beam reporting i.e. other than the UEI beam reporting as specified/defined herein in the present disclosure.
In one example, when/if the UE-initiated/event-driven beam reporting is enabled according to or based on one or more of:
   a higher layer parameter denoted by ueInitiatedBeamReporting is provided/configured by/in CSI report setting(s)/configuration(s) provided by higher layer parameter(s) CSI-ReportConfig and/or UEI-ReportConfig for the UE-initiated/event-driven beam reporting and/or set to ‘enabled’, and/or the higher layer parameter reportQuantity in the aforementioned CSI-ReportConfig and/or UEI-ReportConfig is set to a particular value, e.g., ‘none’, to enable the UE-initiated/event-driven beam reporting
   one or more events including their respective event configurations such as measurement RS resource(s), time window/timer for evaluating, assessing, declaring, detecting and/or determining the corresponding event(s), (maximum) number of event instance(s) count(s) for evaluating, assessing, declaring, detecting and/or determining the corresponding event(s) and etc. are provided, configured and/or enabled by/in CSI report setting(s)/configuration(s) provided by higher layer parameter(s) CSI-ReportConfig and/or UEI-ReportConfig for the UE-initiated/event-driven beam reporting
   one or more sets of measurement RS resources—including candidate/new beam RS resource set—for evaluating, assessing, declaring, detecting and/or determining the corresponding event(s) are provided, configured and/or enabled by/in CSI report setting(s)/configuration(s) provided by higher layer parameter(s) CSI-ReportConfig and/or UEI-ReportConfig for the UE-initiated/event-driven beam reporting
   Mode A, Mode B and/or Mode C as specified/defined herein in the present disclosure is/are enabled
   information related to UEI beam report quantity(s), content(s) and/or format(s) including (maximum) number of beam(s) to be reported in the corresponding UEI beam report is provided, configured and/or enabled by/in CSI report setting(s)/configuration(s) provided by higher layer parameter(s) CSI-ReportConfig and/or UEI-ReportConfig for the UE-initiated/event-driven beam reporting
   resource configuration(s) for the first UL channel/PUCCH is provided and/or configured by/in CSI report setting(s)/configuration(s) provided by higher layer parameter(s) CSI-ReportConfig and/or UEI-ReportConfig for the UE-initiated/event-driven beam reporting
   resource configuration(s) for the second UL channel/PUSCH is provided and/or configured by/in CSI report setting(s)/configuration(s) provided by higher layer parameter(s) CSI-ReportConfig and/or UEI-ReportConfig for the UE-initiated/event-driven beam reporting the UE could assume, determine or identify that each of the trigger state(s) provided, configured, included, contained or comprised in the higher layer RRC parameter CSI-AperiodicTriggerStateList could be (dedicated) for the UEI beam reporting as specified/defined herein in the present disclosure. Alternatively, or optionally, also in this case, when/if the UE has received from the network an aperiodic CSI trigger state subselection MAC CE, the trigger state(s) (sub) selected by the aperiodic CSI trigger state subselection MAC CE from the list of trigger state(s) provided or configured by the higher layer RRC parameter CSI-AperiodicTriggerStateList could be (dedicated) for the UEI beam reporting as specified/defined herein in the present disclosure. Otherwise, i.e., when/if the UE-initiated/event-driven beam reporting is not enabled is disabled, the UE could assume, determine or identify that each of the trigger state(s) provided, configured, included, contained or comprised in the higher layer RRC parameter CSI-AperiodicTriggerStateList could be (dedicated) for the (legacy) aperiodic CSI/beam reporting other than the UEI beam reporting as specified/defined herein in the present disclosure, and/or when/if the UE has received from the network an aperiodic CSI trigger state subselection MAC CE, the trigger state(s) (sub) selected by the aperiodic CSI trigger state subselection MAC CE from the list of trigger state(s) provided or configured by the higher layer RRC parameter CSI-AperiodicTriggerStateList could be (dedicated) for the (legacy) beam reporting other than the UEI beam reporting as specified/defined herein in the present disclosure
In another example, the UE could be provided or configured by the network, e.g., by/via/in a higher layer RRC parameter UEI-AperiodicTriggerStateList, a list of trigger state(s) comprising one or more trigger states (dedicated) for the UEI beam reporting as specified/defined herein in the present disclosure; in this case, each of the trigger state(s) provided, configured, included, contained or comprised in the higher layer RRC parameter UEI-AperiodicTriggerStateList could be (dedicated) for the UEI beam reporting as specified/defined herein in the present disclosure. Alternatively, or optionally, the UE could receive from the network a UEI trigger state subselection MAC CE-having a similar/same MAC CE format/structure as the aperiodic CSI trigger state subselection MAC CE (hence, similar/same codepoint(s) and functionalities in the MAC CEs); in this case, the trigger state(s) (sub) selected by the UEI trigger state subselection MAC CE from the list(s) of trigger state(s) provided or configured by the higher layer RRC parameter(s) UEI-AperiodicTriggerStateList and/or CSI-AperiodicTriggerStateList could be (dedicated) for the UEI beam reporting as specified/defined herein in the present disclosure. In addition, when/if the UE has received from the network an aperiodic CSI trigger state subselection MAC CE, the trigger state(s) (sub) selected by the aperiodic CSI trigger state subselection MAC CE from the list of trigger state(s) provided or configured by the higher layer RRC parameter UEI-AperiodicTriggerStateList could be (dedicated) for the UEI beam reporting as specified/defined herein in the present disclosure
In another example, the UE could be provided or configured by the network, e.g., via higher layer RRC signaling(s)/parameter(s) and/or MAC CE command(s) and/or dynamic DCI based L1 signaling(s) based on or according to a corresponding UE's capability or capability signaling, one or more indicators to indicate which of the trigger state(s) in the list of trigger state(s) provided or configured by the higher layer RRC parameter CSI-AperiodicTriggerStateList could be (i) (dedicated) for the UEI beam reporting as specified/defined herein in the present disclosure, (ii) (dedicated) for (legacy) beam reporting i.e. other than the UEI beam reporting as specified/defined herein in the present disclosure, and/or (iii) for both the UEI beam reporting as specified/defined herein in the present disclosure and the (legacy) beam reporting i.e. other than the UEI beam reporting as specified/defined herein in the present disclosure. For instance, the UE could be provided or configured in higher layer parameter(s) e.g. CSI-ReportConfig and/or UEI-ReportConfig that provides or configures necessary information/setting(s) for the UE-initiated/event-driven beam reporting as specified/defined herein in the present disclosure the one or more indicators.
   For example, the higher layer RRC parameter CSI-AperiodicTriggerStateList and/or higher layer RRC signaling(s)/parameter(s) that provides or configures the list of trigger state(s) of CSI-AperiodicTriggerStateList and/or higher layer RRC signaling(s)/parameter(s) e.g. CSI-ReportConfig and/or UEI-ReportConfig that provides or configures necessary information/setting for the UE-initiated/event-driven beam reporting as specified/defined herein in the present disclosure could include, comprise, contain, provide, configure or comprise a higher layer parameter ueiBeamReporting; in this case, when/if the higher layer parameter ueiBeamReporting is present, configured or provided in the corresponding RRC signaling(s)/parameter(s) and/or set to ‘enabled’, all of the trigger state(s) provided or configured in/by the list of trigger state(s) of CSI-AperiodicTriggerStateList could be (dedicated) for the UEI beam reporting as specified/defined herein in the present disclosure; otherwise, i.e., when/if the higher layer parameter ueiBeamReporting is present, configured or provided in the corresponding RRC signaling(s)/parameter(s) but set to ‘disabled’, and/or the higher layer parameter ueiBeamReporting is not present, configured or provided (or is absent) in the corresponding RRC signaling(s)/parameter(s), all of the trigger state(s) provided or configured in/by the list of trigger state(s) of CSI-AperiodicTriggerStateList could be (dedicated) for the (legacy) beam reporting other than the UEI beam reporting as specified/defined herein in the present disclosure
   For another example, the one or more indicators could correspond to one or more one-bit indicators each associated, linked, mapped or corresponding to a trigger state provided or configured in the list of trigger state(s) provided or configured by CSI-AperiodicTriggerStateList. For this design example, when/if an aforementioned one-bit indicator is set to ‘1’ (or ‘0’) or ‘uei’, the trigger state associated, mapped, linked or corresponding to the one-bit indicator could be (dedicated) for the UEI beam reporting as specified/defined herein in the present disclosure; otherwise, i.e., when/if an aforementioned one-bit indicator is set to ‘0’ (or ‘1’) or ‘apCsi’, the trigger state associated, mapped, linked or corresponding to the one-bit indicator could be (dedicated) for the (legacy) aperiodic CSI/beam reporting other than the UEI beam reporting as specified/defined herein in the present disclosure. Alternatively, when/if an aforementioned one-bit indicator is set to ‘1’ (or ‘0’) or ‘uei’, the trigger state associated, mapped, linked or corresponding to the one-bit indicator could be (dedicated) for the UEI beam reporting as specified/defined herein in the present disclosure; otherwise, i.e., when/if an aforementioned one-bit indicator is set to ‘0’ (or ‘1’) or ‘ueiAndapCsi’, the trigger state associated, mapped, linked or corresponding to the one-bit indicator could be for both the UEI beam reporting and the (legacy) aperiodic CSI/beam reporting other than the UEI beam reporting as specified/defined herein in the present disclosure. Optionally, when/if an aforementioned one-bit indicator is set to ‘1’ (or ‘0’) or ‘apCsi’, the trigger state associated, mapped, linked or corresponding to the one-bit indicator could be (dedicated) for the legacy (aperiodic) CSI/beam reporting other than the UEI beam reporting as specified/defined herein in the present disclosure; otherwise, i.e., when/if an aforementioned one-bit indicator is set to ‘0’ (or ‘1’) or ‘ueiAndapCsi’, the trigger state associated, mapped, linked or corresponding to the one-bit indicator could be for both the UEI beam reporting and the (legacy) aperiodic CSI/beam reporting other than the UEI beam reporting as specified/defined herein in the present disclosure
   For another example, the one or more indicators could correspond to one or more multi-bit (e.g., two-bit) indicators each associated, linked, mapped or corresponding to a trigger state provided or configured in the list of trigger state(s) provided or configured by CSI-AperiodicTriggerStateList. For this design example, when/if an aforementioned two-bit indicator is set to ‘00’ (or ‘01’ or ‘10’ or ‘11’) or ‘uei’, the trigger state associated, mapped, linked or corresponding to the two-bit indicator could be (dedicated) for the UEI beam reporting as specified/defined herein in the present disclosure, when/if the two-bit indicator is set to ‘01’ (or ‘00’ or ‘10’ or ‘11’) or ‘apCsi’, the trigger state associated, mapped, linked or corresponding to the two-bit indicator could be (dedicated) for the (legacy) aperiodic CSI/beam reporting other than the UEI beam reporting as specified/defined herein in the present disclosure, and when/if the two-bit indicator is set to ‘11’ (or ‘00’ or ‘01’ or ‘10’) or ‘ueiAndapCsi’, the trigger state associated, mapped, linked or corresponding to the two-bit indicator could be for both the UEI beam reporting and the (legacy) aperiodic CSI/beam reporting other than the UEI beam reporting as specified/defined herein in the present disclosure
   For another example, the one or more indicators could correspond to a bitmap with each entry/bit position of the bitmap associated, linked, mapped or corresponding to a trigger state provided or configured in the list of trigger state(s) provided or configured by CSI-AperiodicTriggerStateList. For this design example, when/if an entry/bit position of the bitmap is set to ‘1’ (or ‘0’) or ‘uei’, the trigger state associated, mapped, linked or corresponding to the entry/bit position could be (dedicated) for the UEI beam reporting as specified/defined herein in the present disclosure; otherwise, i.e., when/if an entry/bit position of the bitmap is set to ‘0’ (or ‘1’) or ‘apCsi’, the trigger state associated, mapped, linked or corresponding to the entry/bit position could be (dedicated) for the (legacy) aperiodic CSI/beam reporting other than the UEI beam reporting as specified/defined herein in the present disclosure. Alternatively, when/if an entry/bit position of the bitmap is set to ‘1’ (or ‘0’) or ‘uei’, the trigger state associated, mapped, linked or corresponding to the entry/bit position could be (dedicated) for the UEI beam reporting as specified/defined herein in the present disclosure; otherwise, i.e., when/if an entry/bit position of the bitmap is set to ‘0’ (or ‘1’) or ‘ueiAndapCsi’, the trigger state associated, mapped, linked or corresponding to the entry/bit position could be for both the UEI beam reporting and the (legacy) aperiodic CSI/beam reporting other than the UEI beam reporting as specified/defined herein in the present disclosure. Optionally, when/if an entry/bit position of the bitmap is set to ‘1’ (or ‘0’) or ‘apCsi’, the trigger state associated, mapped, linked or corresponding to the entry/bit position could be (dedicated) for the legacy (aperiodic) CSI/beam reporting other than the UEI beam reporting as specified/defined herein in the present disclosure; otherwise, i.e., when/if an entry/bit position of the bitmap is set to ‘0’ (or ‘1’) or ‘ueiAndapCsi’, the trigger state associated, mapped, linked or corresponding to the entry/bit position could be for both the UEI beam reporting and the (legacy) aperiodic CSI/beam reporting other than the UEI beam reporting as specified/defined herein in the present disclosure
In another example, the UE could be provided or configured by the network, e.g., via higher layer RRC signaling(s)/parameter(s) and/or MAC CE command(s) and/or dynamic DCI based L1 signaling(s) based on or according to a corresponding UE's capability or capability signaling, one or more indicators to indicate which of the trigger state(s) (sub) selected by an aperiodic CSI trigger state subselection MAC CE from the list of trigger state(s) provided or configured by the higher layer RRC parameter CSI-AperiodicTriggerStateList could be (i) (dedicated) for the UEI beam reporting as specified/defined herein in the present disclosure, (ii) (dedicated) for (legacy) beam reporting i.e. other than the UEI beam reporting as specified/defined herein in the present disclosure, and/or (iii) for both the UEI beam reporting as specified/defined herein in the present disclosure and the (legacy) beam reporting i.e. other than the UEI beam reporting as specified/defined herein in the present disclosure. For instance, the UE could be provided or configured in a/the aperiodic CSI trigger state subselection MAC CE the one or more indicators as one or more fields and/or codepoints in/of the MAC CE.
   For example, the higher layer RRC parameter CSI-AperiodicTriggerStateList and/or higher layer RRC signaling(s)/parameter(s) that provides or configures the list of trigger state(s) of CSI-AperiodicTriggerStateList and/or higher layer RRC signaling(s)/parameter(s) e.g. CSI-ReportConfig and/or UEI-ReportConfig that provides or configures necessary information/setting for the UE-initiated/event-driven beam reporting as specified/defined herein in the present disclosure could include, comprise, contain, provide, configure or comprise a higher layer parameter ueiBeamReporting; in this case, when/if the higher layer parameter ueiBeamReporting is present, configured or provided in the corresponding RRC signaling(s)/parameter(s) and/or set to ‘enabled’, all of the trigger state(s) (sub) selected by the aperiodic CSI trigger state subselection MAC CE from/in the list of trigger state(s) of CSI-AperiodicTriggerStateList could be (dedicated) for the UEI beam reporting as specified/defined herein in the present disclosure; otherwise, i.e., when/if the higher layer parameter ueiBeamReporting is present, configured or provided in the corresponding RRC signaling(s)/parameter(s) but set to ‘disabled’, and/or the higher layer parameter ueiBeamReporting is not present, configured or provided (or is absent) in the corresponding RRC signaling(s)/parameter(s), all of the trigger state(s) (sub) selected by the aperiodic CSI trigger state subselection MAC CE in/by the list of trigger state(s) of CSI-AperiodicTriggerStateList could be (dedicated) for the (legacy) beam reporting other than the UEI beam reporting as specified/defined herein in the present disclosure
   For another example, the one or more indicators could correspond to one or more one-bit indicators each associated, linked, mapped or corresponding to a trigger state (sub) selected by an aperiodic CSI trigger state subselection MAC CE in/from the list of trigger state(s) provided or configured by CSI-AperiodicTriggerStateList. For this design example, when/if an aforementioned one-bit indicator is set to ‘1’ (or ‘0’) or ‘uei’, the trigger state associated, mapped, linked or corresponding to the one-bit indicator could be (dedicated) for the UEI beam reporting as specified/defined herein in the present disclosure; otherwise, i.e., when/if an aforementioned one-bit indicator is set to ‘0’ (or ‘1’) or ‘apCsi’, the trigger state associated, mapped, linked or corresponding to the one-bit indicator could be (dedicated) for the (legacy) aperiodic CSI/beam reporting other than the UEI beam reporting as specified/defined herein in the present disclosure. Alternatively, when/if an aforementioned one-bit indicator is set to ‘1’ (or ‘0’) or ‘uei’, the trigger state associated, mapped, linked or corresponding to the one-bit indicator could be (dedicated) for the UEI beam reporting as specified/defined herein in the present disclosure; otherwise, i.e., when/if an aforementioned one-bit indicator is set to ‘0’ (or ‘1’) or ‘ueiAndapCsi’, the trigger state associated, mapped, linked or corresponding to the one-bit indicator could be for both the UEI beam reporting and the (legacy) aperiodic CSI/beam reporting other than the UEI beam reporting as specified/defined herein in the present disclosure. Optionally, when/if an aforementioned one-bit indicator is set to ‘1’ (or ‘0’) or ‘apCsi’, the trigger state associated, mapped, linked or corresponding to the one-bit indicator could be (dedicated) for the legacy (aperiodic) CSI/beam reporting other than the UEI beam reporting as specified/defined herein in the present disclosure; otherwise, i.e., when/if an aforementioned one-bit indicator is set to ‘0’ (or ‘1’) or ‘ueiAndapCsi’, the trigger state associated, mapped, linked or corresponding to the one-bit indicator could be for both the UEI beam reporting and the (legacy) aperiodic CSI/beam reporting other than the UEI beam reporting as specified/defined herein in the present disclosure
   For another example, the one or more indicators could correspond to one or more multi-bit (e.g., two-bit) indicators each associated, linked, mapped or corresponding to a trigger state (sub) selected by an aperiodic CSI trigger state subselection MAC CE in/from the list of trigger state(s) provided or configured by CSI-AperiodicTriggerStateList. For this design example, when/if an aforementioned two-bit indicator is set to ‘00’ (or ‘01’ or ‘10’ or ‘11’) or ‘uei’, the trigger state associated, mapped, linked or corresponding to the two-bit indicator could be (dedicated) for the UEI beam reporting as specified/defined herein in the present disclosure, when/if the two-bit indicator is set to ‘01’ (or ‘00’ or ‘10’ or ‘11’) or ‘apCsi’, the trigger state associated, mapped, linked or corresponding to the two-bit indicator could be (dedicated) for the (legacy) aperiodic CSI/beam reporting other than the UEI beam reporting as specified/defined herein in the present disclosure, and when/if the two-bit indicator is set to ‘11’ (or ‘00’ or ‘01’ or ‘10’) or ‘ueiAndapCsi’, the trigger state associated, mapped, linked or corresponding to the two-bit indicator could be for both the UEI beam reporting and the (legacy) aperiodic CSI/beam reporting other than the UEI beam reporting as specified/defined herein in the present disclosure
   For another example, the one or more indicators could correspond to a bitmap with each entry/bit position of the bitmap associated, linked, mapped or corresponding to a trigger state (sub) selected by an aperiodic CSI trigger state subselection MAC CE in/from the list of trigger state(s) provided or configured by CSI-AperiodicTriggerStateList. For this design example, when/if an entry/bit position of the bitmap is set to ‘1’ (or ‘0’) or ‘uei’, the trigger state associated, mapped, linked or corresponding to the entry/bit position could be (dedicated) for the UEI beam reporting as specified/defined herein in the present disclosure; otherwise, i.e., when/if an entry/bit position of the bitmap is set to ‘0’ (or ‘1’) or ‘apCsi’, the trigger state associated, mapped, linked or corresponding to the entry/bit position could be (dedicated) for the (legacy) aperiodic CSI/beam reporting other than the UEI beam reporting as specified/defined herein in the present disclosure. Alternatively, when/if an entry/bit position of the bitmap is set to ‘1’ (or ‘0’) or ‘uei’, the trigger state associated, mapped, linked or corresponding to the entry/bit position could be (dedicated) for the UEI beam reporting as specified/defined herein in the present disclosure; otherwise, i.e., when/if an entry/bit position of the bitmap is set to ‘0’ (or ‘1’) or ‘ueiAndapCsi’, the trigger state associated, mapped, linked or corresponding to the entry/bit position could be for both the UEI beam reporting and the (legacy) aperiodic CSI/beam reporting other than the UEI beam reporting as specified/defined herein in the present disclosure. Optionally, when/if an entry/bit position of the bitmap is set to ‘1’ (or ‘0’) or ‘apCsi’, the trigger state associated, mapped, linked or corresponding to the entry/bit position could be (dedicated) for the legacy (aperiodic) CSI/beam reporting other than the UEI beam reporting as specified/defined herein in the present disclosure; otherwise, i.e., when/if an entry/bit position of the bitmap is set to ‘0’ (or ‘1’) or ‘ueiAndapCsi’, the trigger state associated, mapped, linked or corresponding to the entry/bit position could be for both the UEI beam reporting and the (legacy) aperiodic CSI/beam reporting other than the UEI beam reporting as specified/defined herein in the present disclosure

The UE could follow one or more of the above described/specified design examples, e.g., to determine or identify that a trigger state e.g. pointing to an index of an entry in the higher layer RRC parameter CSI-AperiodicTriggerStateList or an index of a codepoint in the aperiodic CSI trigger state subselection MAC CE could be: (i) (dedicated) for the UEI beam reporting as specified/defined herein in the present disclosure, or equivalently associated, linked, corresponding or mapped to one or more first CSI reporting settings (dedicated) for the UEI beam reporting as specified/defined herein in the present disclosure, (ii) (dedicated) for the (legacy) aperiodic CSI/beam reporting other than the UEI beam reporting as specified/defined herein in the present disclosure, or equivalently associated, linked, corresponding or mapped to one or more second CSI reporting settings for (legacy) beam reporting i.e. other than the UEI beam reporting as specified/defined herein in the present disclosure, or (iii) for both the UEI beam reporting as specified/defined herein in the present disclosure and the (legacy) beam reporting i.e. other than the UEI beam reporting as specified/defined herein in the present disclosure, or equivalently associated, linked, corresponding or mapped to a mixture of one or more first CSI reporting settings (dedicated) for the UEI beam reporting as specified/defined herein in the present disclosure, and one or more second CSI reporting settings for (legacy) beam reporting i.e. other than the UEI beam reporting as specified/defined herein in the present disclosure, or alternatively, the UE may not expect or assume a trigger state e.g. pointing to an index of an entry in the higher layer RRC parameter CSI-AperiodicTriggerStateList or an index of a codepoint in the aperiodic CSI trigger state subselection MAC CE to be: (i) (dedicated) for the UEI beam reporting as specified/defined herein in the present disclosure, or equivalently associated, linked, corresponding or mapped to one or more first CSI reporting settings (dedicated) for the UEI beam reporting as specified/defined herein in the present disclosure, (ii) (dedicated) for the (legacy) aperiodic CSI/beam reporting other than the UEI beam reporting as specified/defined herein in the present disclosure, or equivalently associated, linked, corresponding or mapped to one or more second CSI reporting settings for (legacy) beam reporting i.e. other than the UEI beam reporting as specified/defined herein in the present disclosure, or (iii) for both the UEI beam reporting as specified/defined herein in the present disclosure and the (legacy) beam reporting i.e. other than the UEI beam reporting as specified/defined herein in the present disclosure, or equivalently associated, linked, corresponding or mapped to a mixture of one or more first CSI reporting settings (dedicated) for the UEI beam reporting as specified/defined herein in the present disclosure, and one or more second CSI reporting settings for (legacy) beam reporting i.e. other than the UEI beam reporting as specified/defined herein in the present disclosure, when/if (a) the UE-initiated/event-driven beam reporting is enabled according to or based on one or more of:
a higher layer parameter denoted by ueInitiatedBeamReporting is provided/configured by/in CSI report setting(s)/configuration(s) provided by higher layer parameter(s) CSI-ReportConfig and/or UEI-ReportConfig for the UE-initiated/event-driven beam reporting and/or set to ‘enabled’, and/or the higher layer parameter reportQuantity in the aforementioned CSI-ReportConfig and/or UEI-ReportConfig is set to a particular value, e.g., ‘none’, to enable the UE-initiated/event-driven beam reporting
one or more events including their respective event configurations such as measurement RS resource(s), time window/timer for evaluating, assessing, declaring, detecting and/or determining the corresponding event(s), (maximum) number of event instance(s) count(s) for evaluating, assessing, declaring, detecting and/or determining the corresponding event(s) and etc. are provided, configured and/or enabled by/in CSI report setting(s)/configuration(s) provided by higher layer parameter(s) CSI-ReportConfig and/or UEI-ReportConfig for the UE-initiated/event-driven beam reporting
one or more sets of measurement RS resources—including candidate/new beam RS resource set—for evaluating, assessing, declaring, detecting and/or determining the corresponding event(s) are provided, configured and/or enabled by/in CSI report setting(s)/configuration(s) provided by higher layer parameter(s) CSI-ReportConfig and/or UEI-ReportConfig for the UE-initiated/event-driven beam reporting
Mode A, Mode B and/or Mode C as specified/defined herein in the present disclosure is/are enabled
information related to UEI beam report quantity(s), content(s) and/or format(s) including (maximum) number of beam(s) to be reported in the corresponding UEI beam report is provided, configured and/or enabled by/in CSI report setting(s)/configuration(s) provided by higher layer parameter(s) CSI-ReportConfig and/or UEI-ReportConfig for the UE-initiated/event-driven beam reporting
resource configuration(s) for the first UL channel/PUCCH is provided and/or configured by/in CSI report setting(s)/configuration(s) provided by higher layer parameter(s) CSI-ReportConfig and/or UEI-ReportConfig for the UE-initiated/event-driven beam reporting
resource configuration(s) for the second UL channel/PUSCH is provided and/or configured by/in CSI report setting(s)/configuration(s) provided by higher layer parameter(s) CSI-ReportConfig and/or UEI-ReportConfig for the UE-initiated/event-driven beam reporting,
   and/or (b) the UE-initiated/event-driven beam reporting is not enabled or is disabled according to or based on one or more of:
the higher layer parameter denoted by ueInitiatedBeamReporting is not provided/configured by/in CSI report setting(s)/configuration(s) provided by higher layer parameter(s) CSI-ReportConfig and/or UEI-ReportConfig for the UE-initiated/event-driven beam reporting, and/or the higher layer parameter denoted by ueInitiatedBeamReporting is provided/configured by/in CSI report setting(s)/configuration(s) provided by higher layer parameter(s) CSI-ReportConfig and/or UEI-ReportConfig for the UE-initiated/event-driven beam reporting but is set to ‘disabled’, and/or the higher layer parameter reportQuantity in the aforementioned CSI-ReportConfig and/or UEI-ReportConfig is not set to a particular value, e.g., ‘none’, used to enable the UE-initiated/event-driven beam reporting
the one or more events including their respective event configurations such as measurement RS resource(s), time window/timer for evaluating, assessing, declaring, detecting and/or determining the corresponding event(s), (maximum) number of event instance(s) count(s) for evaluating, assessing, declaring, detecting and/or determining the corresponding event(s) and etc. are not provided, configured and/or enabled by/in CSI report setting(s)/configuration(s) provided by higher layer parameter(s) CSI-ReportConfig and/or UEI-ReportConfig for the UE-initiated/event-driven beam reporting
the one or more sets of measurement RS resources—including candidate/new beam RS resource set—for evaluating, assessing, declaring, detecting and/or determining the corresponding event(s) are not provided, configured and/or enabled by/in CSI report setting(s)/configuration(s) provided by higher layer parameter(s) CSI-ReportConfig and/or UEI-ReportConfig for the UE-initiated/event-driven beam reporting
Mode A, Mode B and/or Mode C as specified/defined herein in the present disclosure is/are not enabled or is/are disabled
The information related to UEI beam report quantity(s), content(s) and/or format(s) including (maximum) number of beam(s) to be reported in the corresponding UEI beam report is not provided, configured and/or enabled by/in CSI report setting(s)/configuration(s) provided by higher layer parameter(s) CSI-ReportConfig and/or UEI-ReportConfig for the UE-initiated/event-driven beam reporting
the resource configuration(s) for the first UL channel/PUCCH is not provided and/or configured by/in CSI report setting(s)/configuration(s) provided by higher layer parameter(s) CSI-ReportConfig and/or UEI-ReportConfig for the UE-initiated/event-driven beam reporting the resource configuration(s) for the second UL channel/PUSCH is not provided and/or configured by/in CSI report setting(s)/configuration(s) provided by higher layer parameter(s) CSI-ReportConfig and/or UEI-ReportConfig for the UE-initiated/event-driven beam reporting.

According to or following those specified herein in the present disclosure, a UE could be configured or provided or enabled or indicated by the network, e.g., via/by/in higher layer RRC signaling(s)/parameter(s) e.g. CSI-ReportConfig and/or UEI-ReportConfig that provides or configures necessary information and/or setting(s) for the UE-initiated/event-driven beam reporting and/or MAC CE command(s) and/or dynamic DCI based L1 signaling(s) based on or according to corresponding UE's capability(s) or capability signaling(s), one or more indicators to indicate or enable whether a PUCCH or a PUCCH resource or a PUCCH transmission occasion that carries or conveys a/the PN message/trigger or a/the PN message/trigger (also denoted by an UEI transmission indication (UEITI) in the present disclosure) transmission occasion of a/the PUCCH/PUCCH resource of the first UL channel could be associated or linked to one CSI reporting setting or multiple (>1) CSI reporting settings each provided by CSI-ReportConfig and/or UEI-ReportConfig that provides or configures necessary information and/or setting(s) for the UE-initiated/event-driven beam reporting as specified/defined herein in the present disclosure.
In one example, the one or more indicators could correspond to or could be in form of a higher layer parameter onePUCCHtoM provided or configured in CSI-ReportConfig and/or UEI-ReportConfig that provides or configures necessary information and/or setting(s) for the UE-initiated/event-driven beam reporting. In this case, when/if the higher layer parameter onePUCCHtoM is configured or provided and/or set to ‘enabled’, a PUCCH or a PUCCH resource or a PUCCH transmission occasion that carries or conveys a/the PN message/trigger or a/the PN message/trigger (or equivalently a/the UEITI) transmission occasion of a/the PUCCH/PUCCH resource of the first UL channel could be associated or linked to multiple (>1) CSI reporting settings each provided by CSI-ReportConfig and/or UEI-ReportConfig that provides or configures necessary information and/or setting(s) for the UE-initiated/event-driven beam reporting as specified/defined herein in the present disclosure; otherwise, e.g., when/if the higher layer parameter onePUCCHtoM (i) is not configured or provided or present or is absent, and/or (ii) is configured or provided or present but is set to ‘disabled’, a PUCCH or a PUCCH resource or a PUCCH transmission occasion that carries or conveys a/the PN message/trigger or a/the PN message/trigger (or equivalently a/the UEITI) transmission occasion of a/the PUCCH/PUCCH resource of the first UL channel could be associated or linked to only one CSI reporting setting provided by CSI-ReportConfig and/or UEI-ReportConfig that provides or configures necessary information and/or setting(s) for the UE-initiated/event-driven beam reporting as specified/defined herein in the present disclosure.
In another example, the one or more indicators could correspond to or could be in form of a higher layer parameter nrOfUEIReportConfig, provided or configured in CSI-ReportConfig and/or UEI-ReportConfig that provides or configures necessary information and/or setting(s) for the UE-initiated/event-driven beam reporting, indicating the number of CSI reporting setting(s) that can be associated or linked to a PUCCH or a PUCCH resource or a PUCCH transmission occasion that carries or conveys a/the PN message/trigger or a/the PN message/trigger (or equivalently a/the UEITI) transmission occasion of a/the PUCCH/PUCCH resource of the first UL channel. In this case, when/if the higher layer parameter nrOfUEIReportConfig is configured or provided and/or set to value M>1, a PUCCH or a PUCCH resource or a PUCCH transmission occasion that carries or conveys a/the PN message/trigger or a/the PN message/trigger (or equivalently a/the UEITI) transmission occasion of a/the PUCCH/PUCCH resource of the first UL channel could be associated or linked to M>1 CSI reporting settings each provided by CSI-ReportConfig and/or UEI-ReportConfig that provides or configures necessary information and/or setting(s) for the UE-initiated/event-driven beam reporting as specified/defined herein in the present disclosure; otherwise, e.g., when/if the higher layer parameter nrOfUEIReportConfig (i) is not configured or provided or present or is absent, and/or (ii) is configured or provided or present but is set to value M=1, a PUCCH or a PUCCH resource or a PUCCH transmission occasion that carries or conveys a/the PN message/trigger or a/the PN message/trigger (or equivalently a/the UEITI) transmission occasion of a/the PUCCH/PUCCH resource of the first UL channel could be associated or linked to only one CSI reporting setting provided by CSI-ReportConfig and/or UEI-ReportConfig that provides or configures necessary information and/or setting(s) for the UE-initiated/event-driven beam reporting as specified/defined herein in the present disclosure.
In another example, the one or more indicators could correspond to or could be in form of a one-bit indicator, provided or configured or indicated in CSI-ReportConfig and/or UEI-ReportConfig that provides or configures necessary information and/or setting(s) for the UE-initiated/event-driven beam reporting and/or MAC CE command(s) and/or DCI format(s)—e.g., by/via/in a new/dedicated DCI field and/or repurposing one or more codepoints of one or more existing DCI fields (e.g., the TCI and/or TPMI field(s)). In this case, when/if the one-bit indicator is set to ‘1’ (or ‘0’), a PUCCH or a PUCCH resource or a PUCCH transmission occasion that carries or conveys a/the PN message/trigger or a/the PN message/trigger (or equivalently a/the UEITI) transmission occasion of a/the PUCCH/PUCCH resource of the first UL channel could be associated or linked to M>1 CSI reporting settings each provided by CSI-ReportConfig and/or UEI-ReportConfig that provides or configures necessary information and/or setting(s) for the UE-initiated/event-driven beam reporting as specified/defined herein in the present disclosure; otherwise, e.g., when/if the one-bit indicator (i) is not configured or provided or present or is absent, and/or (ii) is configured or provided or present but is set to ‘0’ (or ‘1’), a PUCCH or a PUCCH resource or a PUCCH transmission occasion that carries or conveys a/the PN message/trigger or a/the PN message/trigger (or equivalently a/the UEITI) transmission occasion of a/the PUCCH/PUCCH resource of the first UL channel could be associated or linked to only one CSI reporting setting provided by CSI-ReportConfig and/or UEI-ReportConfig that provides or configures necessary information and/or setting(s) for the UE-initiated/event-driven beam reporting as specified/defined herein in the present disclosure. For this design example, presence/absence of the one-bit indicator in the corresponding signaling medium(s)—e.g., DCI format(s)—could be configured or enabled by the network via higher layer RRC signaling(s)/parameter(s) subject to or according to or based on a corresponding UE's capability or capability signaling.
In another example, higher layer RRC signaling(s)/parameter(s), e.g., PUCCH-Resource, PUCCH-ResourceSet, PUCCH-Config and/or etc., that provides or configures necessary information and/or setting(s) for PUCCH(s)/PUCCH resource(s) used or applied or configured or provided for carrying or conveying a/the PN message/trigger (or equivalently, a/the UEITI) of the first UL channel as in Step-1 of Mode A, Mode B and/or Mode C could comprise, indicate, provide, configure, include or contain information, e.g., in terms/form of reporting setting/configuration ID(s)/index(es), related to one or more CSI reporting settings for the UE-initiated/event-driven beam reporting as specified/defined herein in the present disclosure.

Furthermore, when/if (it is configured or provided or indicated or enabled that) a PUCCH or a PUCCH resource or a PUCCH transmission occasion that carries or conveys a/the PN message/trigger or a/the PN message/trigger (or equivalently a/the UEITI) transmission occasion of a/the PUCCH/PUCCH resource of the first UL channel can be associated or linked to M>1 CSI reporting settings each provided by CSI-ReportConfig and/or UEI-ReportConfig that provides or configures necessary information and/or setting(s) for the UE-initiated/event-driven beam reporting according to or following those specified/defined herein in the present disclosure, M≤Mmax, wherein the UE could determine or identify value(s) of Mmax according to or based on: (i) fixed value(s) in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). The value Mmax could be subject to or according to or based on a corresponding UE's capability or capability signaling, or a component of a corresponding UE's capability or capability signaling, to indicate the maximum number of CSI reporting setting(s) for or specific to the UE-initiated/event-driven beam reporting that the UE could support to be associated or linked to a PUCCH or a PUCCH resource or a PUCCH transmission occasion that carries or conveys a/the PN message/trigger or a/the PN message/trigger (or equivalently a/the UEITI) transmission occasion of a/the PUCCH/PUCCH resource of the first UL channel as in Step-1 of Mode A, Mode B and/or Mode C. Furthermore,
In one example, when/if (it is configured or provided or indicated or enabled that) a PUCCH or a PUCCH resource or a PUCCH transmission occasion used, applied, configured or provided for carrying or conveying a/the PN message/trigger or a/the PN message/trigger (or equivalently a/the UEITI) transmission occasion of a/the PUCCH/PUCCH resource of the first UL channel shall be associated or linked to one (i.e., M=1) CSI reporting setting provided by CSI-ReportConfig and/or UEI-ReportConfig that provides or configures necessary information and/or setting(s) for the UE-initiated/event-driven beam reporting according to or following those specified/defined herein in the present disclosure, the UE could transmit or send to the network, a/the PN message/trigger (or equivalently, a/the UEITI), via/by/in/on/over only the PUCCH(s)/PUCCH resource(s) of the first UL channel as in Step-1 of Mode A, Mode B and/or Mode C associated, linked, mapped, specific or corresponding to one CSI reporting setting according to or following those specified herein in the present disclosure—e.g., the higher layer RRC signaling(s)/parameter(s), e.g., PUCCH-Resource, PUCCH-ResourceSet, PUCCH-Config and/or etc., that provides or configures necessary information and/or setting(s) for the PUCCH(s)/PUCCH resource(s) of the first UL channel as in Step-1 of Mode A, Mode B and/or Mode C could comprise, indicate, provide, configure, include or contain information, e.g., in terms/form of the reporting setting/configuration ID/index, related only to the CSI reporting setting. For this design example, the UE could be provided or configured or indicated by the network, e.g., via higher layer RRC signaling(s)/parameter(s) based on or according to a corresponding UE's capability or capability signaling, multiple (>1) PUCCH resources or PUCCH resource configurations used, applied, configured or provided for carrying or conveying a/the PN message(s)/trigger(s)—or equivalently, the UEITI(s)—of the first UL channel as in Step-1 of Mode A, Mode B and/or Mode C each associated or linked to one (i.e., M=1) CSI reporting setting provided by CSI-ReportConfig and/or UEI-ReportConfig that provides or configures necessary information and/or setting(s) for the UE-initiated/event-driven beam reporting according to or following those specified/defined herein in the present disclosure.
In another example, when/if (it is configured or provided or indicated or enabled that) a PUCCH or a PUCCH resource or a PUCCH transmission occasion used, applied, configured or provided for carrying or conveying a/the PN message/trigger or a/the PN message/trigger (or equivalently a/the UEITI) transmission occasion of a/the PUCCH/PUCCH resource of the first UL channel shall be associated or linked to multiple (i.e., M>1) CSI reporting settings each provided by CSI-ReportConfig and/or UEI-ReportConfig that provides or configures necessary information and/or setting(s) for the UE-initiated/event-driven beam reporting according to or following those specified/defined herein in the present disclosure, the UE could transmit or send to the network, a/the PN message/trigger (or equivalently, a/the UEITI), via/by/in/on/over only the PUCCH(s)/PUCCH resource(s) of the first UL channel as in Step-1 of Mode A, Mode B and/or Mode C associated, linked, mapped, specific or corresponding to multiple (i.e., M>1) CSI reporting settings according to or following those specified herein in the present disclosure—e.g., the higher layer RRC signaling(s)/parameter(s), e.g., PUCCH-Resource, PUCCH-ResourceSet, PUCCH-Config and/or etc., that provides or configures necessary information and/or setting(s) for the PUCCH(s)/PUCCH resource(s) of the first UL channel as in Step-1 of Mode A, Mode B and/or Mode C could comprise, indicate, provide, configure, include or contain information, e.g., in terms/form of the reporting setting/configuration IDs/indexes, related to the M>1 CSI reporting settings.
In another example, when/if (it is configured or provided or indicated or enabled that) a PUCCH or a PUCCH resource or a PUCCH transmission occasion used, applied, configured or provided for carrying or conveying a/the PN message/trigger or a/the PN message/trigger (or equivalently a/the UEITI) transmission occasion of a/the PUCCH/PUCCH resource of the first UL channel could be associated or linked to one CSI reporting setting or multiple (i.e., M>1) CSI reporting settings each provided by CSI-ReportConfig and/or UEI-ReportConfig that provides or configures necessary information and/or setting(s) for the UE-initiated/event-driven beam reporting according to or following those specified/defined herein in the present disclosure, the UE could transmit or send to the network, a/the PN message/trigger (or equivalently, a/the UEITI), via/by/in/on/over the PUCCH(s)/PUCCH resource(s) of the first UL channel as in Step-1 of Mode A, Mode B and/or Mode C associated, linked, mapped, specific or corresponding to one CSI reporting setting or multiple (i.e., M>1) CSI reporting settings according to or following those specified herein in the present disclosure—e.g., the higher layer RRC signaling(s)/parameter(s), e.g., PUCCH-Resource, PUCCH-ResourceSet, PUCCH-Config and/or etc., that provides or configures necessary information and/or setting(s) for the PUCCH(s)/PUCCH resource(s) of the first UL channel as in Step-1 of Mode A, Mode B and/or Mode C could comprise, indicate, provide, configure, include or contain information, e.g., in terms/form of the reporting setting/configuration ID(s)/index(es), related to the one CSI reporting setting or the M>1 CSI reporting settings.

In one embodiment, a cyclic shift index associated, corresponding or specific to or for a PUCCH or a PUCCH resource or a PUCCH transmission occasion that carries or conveys a/the PN message/trigger or a/the PN message/trigger (or equivalently a/the UEITI) transmission occasion of a/the PUCCH/PUCCH resource of the first UL channel as in Step-1 of Mode A, Mode B and/or Mode C could be associated, linked, corresponding or mapped to one or more CSI reporting settings each provided by CSI-ReportConfig and/or UEI-ReportConfig that provides or configures necessary information and/or setting(s) for the UE-initiated/event-driven beam reporting as specified/defined herein in the present disclosure. The UE could determine or identify the association(s), linkage(s), correspondence(s) or mapping(s) according to or following one or more of: (i) fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on corresponding UE's capability(s) or capability signaling(s), and/or (iii) UE's autonomous determination/selection, which could be further sent to the network via various UL channels/signals and/or in part of a CSI/beam report and/or UE's capability signaling. More specifically, for one or more cyclic shift indexes (hence the corresponding cyclic shift(s)) associated, corresponding or specific to or for a PUCCH or a PUCCH resource or a PUCCH transmission occasion that carries or conveys a/the PN message/trigger or a/the PN message/trigger (or equivalently a/the UEITI) transmission occasion of a/the PUCCH/PUCCH resource of the first UL channel as in Step-1 of Mode A, Mode B and/or Mode C
In one example, higher layer parameter(s)/signaling(s) that provides or configures a cyclic shift and/or cyclic shift index could also be associated, corresponding or specific to or could provide, configure, comprise reporting setting ID(s)/index(es) of one or more CSI reporting settings each provided by CSI-ReportConfig and/or UEI-ReportConfig that provides or configures necessary information and/or setting(s) for the UE-initiated/event-driven beam reporting as specified/defined herein in the present disclosure. In this case, the cyclic shift/cyclic shift index could be associated, linked, corresponding or mapped to the one or more CSI reporting settings.
In another example, the higher layer parameter(s)/signaling(s) CSI-ReportConfig and/or UEI-ReportConfig that provides or configures a CSI reporting setting for the UE-initiated/event-driven beam reporting could also provide, configure, comprise a cyclic shift and/or cyclic shift index. In this case, the CSI reporting setting could be associated, linked, corresponding or mapped to the cyclic shift/cyclic shift index.
In another example, the aforementioned PUCCH or PUCCH resource or PUCCH transmission occasion that carries or conveys a/the PN message/trigger or a/the PN message/trigger (or equivalently a/the UEITI) transmission occasion of a/the PUCCH/PUCCH resource of the first UL channel as in Step-1 of Mode A, Mode B and/or Mode C could be associated, corresponding, linked or mapped to one or more first CSI reporting settings each provided by CSI-ReportConfig and/or UEI-ReportConfig that provides or configures necessary information and/or setting(s) for the UE-initiated/event-driven beam reporting as specified/defined herein in the present disclosure. In this case,
   For example, the UE could first determine or identify that the one or more first CSI reporting settings could be in or divided/partitioned into G≥1 group(s) each having a group ID/index and comprising one or more of the first CSI reporting setting(s) according to or based on: (i) fixed rule(s) in system specification(s) and/or per RRC (re-)configuration, (ii) network's configuration(s)/indication(s) via higher layer RRC signaling(s)/parameter(s) and/or MAC CE command(s) and/or dynamic DCI based L1 signaling(s) according to or based on corresponding UE's capability(s) or capability signaling(s), and/or (iii) UE's autonomous determination/selection, which could be further sent to the network via various UL channels/signals and/or in part of a CSI/beam report and/or UE's capability signaling. For example, the UE could be configured or provided by the network, e.g., via/in/by the higher layer parameter(s)/signaling(s) CSI-ReportConfig and/or UEI-ReportConfig that provides or configures necessary information and/or setting(s) for the UE-initiated/event-driven beam reporting, the G≥1 group(s) of first CSI reporting setting(s) with each group having a group ID/index and comprising one or more first CSI reporting settings. For another example, the first CSI reporting setting(s) in a given group could be ordered according to the corresponding or respective reporting setting ID(s)/index(es) in an ascending (or descending) order, and the first CSI reporting setting(s) across all of the G group(s) could be ordered according to the corresponding or respective reporting setting ID(s)/index(es) in an ascending (or descending) order. In this case, a/the first (or last) cyclic shift index and/or a/the cyclic shift index with the lowest (or highest) value could be associated, corresponding, mapped or linked to the first group of first CSI reporting setting(s) or the group of first CSI reporting setting(s) with or having the lowest group ID/index, and so on, and a/the last (or first) cyclic shift index and/or a/the cyclic shift index with the highest (or lowest) value could be associated, corresponding, mapped or linked to the last (or G-th) group of first CSI reporting setting(s) or the group of first CSI reporting setting(s) with or having the highest group ID/index.
   For another example, the UE could be configured or provided by the network, e.g., via/in/by the higher layer parameter(s)/signaling(s) PUCCH-Resource that provides or configures the aforementioned PUCCH or PUCCH resource or PUCCH transmission occasion that carries or conveys a/the PN message/trigger or a/the PN message/trigger (or equivalently a/the UEITI) transmission occasion of a/the PUCCH/PUCCH resource of the first UL channel as in Step-1 of Mode A, Mode B and/or Mode C, one or more bitmaps each associated, specific or corresponding to a cyclic shift index (hence the corresponding cyclic shift value). For this design example, each entry/bit position of a bitmap could be associated, specific or corresponding to a first CSI reporting setting. In this case, when/if an entry/bit position of a bitmap associated, specific or corresponding to a/the k-th cyclic shift index and/or a/the cyclic shift index with the k-th lowest (or k-th highest) value is set to ‘1’ (or ‘0’), the first CSI reporting setting associated, specific or corresponding to the entry/bit position could be associated, corresponding, linked or mapped to the k-th cyclic shift index and/or the cyclic shift index with the k-th lowest (or k-th highest) value, wherein k∈{1, . . . , G} with G representing the total number of cyclic shift index(es) associated, corresponding, linked or mapped to the aformentioned PUCCH or PUCCH resource or PUCCH transmission occasion that carries or conveys a/the PN message/trigger or a/the PN message/trigger (or equivalently a/the UEITI) transmission occasion of a/the PUCCH/PUCCH resource of the first UL channel as in Step-1 of Mode A, Mode B and/or Mode C.
   For another example, the UE could be configured or provided by the network, e.g., via/in/by the higher layer parameter(s)/signaling(s) PUCCH-Resource that provides or configures the aforementioned PUCCH or PUCCH resource or PUCCH transmission occasion that carries or conveys a/the PN message/trigger or a/the PN message/trigger (or equivalently a/the UEITI) transmission occasion of a/the PUCCH/PUCCH resource of the first UL channel as in Step-1 of Mode A, Mode B and/or Mode C, a set of one or more cyclic shift indexes with the first entry of the set (hence the corresponding cyclic shift index) corresponding or specific to the 1-st (or last) first CSI reporting setting or the first CSI reporting setting with the lowest (or highest) reporting setting ID/index, and so on, and the last entry of the set (hence the corresponding cyclic shift index) corresponding or specific to the last (or 1-st) first CSI reporting setting or the first CSI reporting setting with the highest (or lowest) reporting setting ID/index.
   For another example, the UE could be configured or provided by the network, e.g., via/in/by the higher layer parameter(s)/signaling(s) PUCCH-Resource that provides or configures the aforementioned PUCCH or PUCCH resource or PUCCH transmission occasion that carries or conveys a/the PN message/trigger or a/the PN message/trigger (or equivalently a/the UEITI) transmission occasion of a/the PUCCH/PUCCH resource of the first UL channel as in Step-1 of Mode A, Mode B and/or Mode C, a first set of one or more reporting setting IDs/indexes each associated or specific to or for a first CSI reporting setting, and a second set of one or more cyclic shift indexes, wherein the first and second sets could have the same number of entries in the set(s); in this case, the first CSI reporting setting that is indicated by/in the first entry of the first set could be corresponding or specific or associated or linked or mapped to the cyclic shift index/cyclic shift that is indicated by/in the first (or last) entry of the second set, and so on, and the first CSI reporting setting that is indicated by/in the last entry of the first set could be corresponding or specific or associated or linked or mapped to the cyclic shift index/cyclic shift that is indicated by/in the last (or first) entry of the second set.

Throughout the present disclosure, when/if a cyclic shift index/cyclic shift of a PUCCH or a PUCCH resource or a PUCCH transmission occasion that carries or conveys a/the PN message/trigger or a/the PN message/trigger (or equivalently a/the UEITI) transmission occasion of a/the PUCCH/PUCCH resource of the first UL channel as in Step-1 of Mode A, Mode B and/or Mode C is associated, corresponding, linked or mapped to one or more CSI reporting settings each provided by CSI-ReportConfig and/or UEI-ReportConfig that provides or configures necessary information and/or setting(s) for the UE-initiated/event-driven beam reporting as specified/defined herein in the present disclosure, the PUCCH or PUCCH resource or PUCCH transmission occasion that carries or conveys a/the PN message/trigger or a/the PN message/trigger (or equivalently a/the UEITI) transmission occasion of a/the PUCCH/PUCCH resource of the first UL channel as in Step-1 of Mode A, Mode B and/or Mode C could also be associated, corresponding, linked or mapped to the one or more CSI reporting settings each provided by CSI-ReportConfig and/or UEI-ReportConfig that provides or configures necessary information and/or setting(s) for the UE-initiated/event-driven beam reporting as specified/defined herein in the present disclosure.

According to or following those specified or defined herein in the present disclosure, a PUCCH or a PUCCH resource or a PUCCH transmission occasion that carries or conveys a/the PN message/trigger or a/the PN message/trigger (also denoted by an UEI transmission indication (UEITI) in the present disclosure) transmission occasion of a/the PUCCH/PUCCH resource of the first UL channel as in Step-1 of Mode A, Mode B and/or Mode C could be associated or linked to one or more CSI reporting settings each provided by CSI-ReportConfig and/or UEI-ReportConfig that provides or configures necessary information and/or setting(s) for the UE-initiated/event-driven beam reporting as specified/defined herein in the present disclosure, wherein each of the one or more CSI reporting settings could be
configured or provided or enabled for one or more events; for instance, higher layer parameter(s) triggeringEvent and/or eventType could be provided or configured or enabled in the higher layer parameter(s) CSI-ReportConfig and/or UEI-ReportConfig that provides or configures a CSI reporting setting, and/or set to value(s) indicating that the one or more events could be enabled for the UE-initiated/event-driven beam reporting for the CSI reporting setting; for example, the higher layer parameter eventType could be provided or configured in the higher layer parameter(s) CSI-ReportConfig and/or UEI-ReportConfig that provides or configures a CSI reporting setting—in this case, when/if eventType is set to ‘Event-2’, the second event (or Event-2) as specified/defined herein in the present disclosure could be enabled for or specific to the CSI reporting setting; and/or
configured or provided or enabled for one or more carriers or component carriers (CCs); for instance, higher layer parameter(s) carrier and/or cellIndex and/or carrierIndex and/or servingCellIndex could be provided or configured or enabled in the higher layer parameter(s) CSI-ReportConfig and/or UEI-ReportConfig that provides or configures a CSI reporting setting, and/or set to value(s) indicating that the one or more carriers/CCs could be enabled for the UE-initiated/event-driven beam reporting for the corresponding CSI reporting setting.

In one embodiment, when/if a UE has sent or transmitted a PN message/trigger (or a UEITI) via/by/in/on/over the PUCCH(s)/PUCCH resource(s) of the first UL channel as in Step-1 of Mode A, Mode B and/or Mode C, and the PN message/trigger or the UEITI or the PUCCH(s)/PUCCH resource(s) of the first UL channel that carries or conveys the PN message/trigger (or UEITI) transmission occasion is associated or linked to one or more CSI reporting settings each associated or linked to one or more events and/or one or more carriers/CCs according to or following those specified herein in the present disclosure, one or more of the following UE's behaviors, assumptions and/or operations can be assumed or expected by the network:
In one example, (higher layer(s) of) the UE has declared or determined the event(s) specific to or for or associated or linked to each of the one or more CSI reporting settings (and/or the associated/linked carrier(s)/CC(s)) according to or following those specified herein in the present disclosure. For instance, when/if a UE has sent or transmitted a PN message/trigger (or a UEITI) via/by/in/on/over the PUCCH(s)/PUCCH resource(s) of the first UL channel as in Step-1 of Mode A, Mode B and/or Mode C, and the PN message/trigger or the UEITI or the PUCCH(s)/PUCCH resource(s) of the first UL channel that carries or conveys the PN message/trigger (or UEITI) transmission occasion is associated or linked to a first CSI reporting setting associated or linked to the first event (or Event-1) for carrier/CC #1, and a second CSI reporting setting associated or linked to the second event (or Event-2) for carrier/CC #2, when receiving or detecting the PN message/trigger (or equivalently the UEITI) carried or conveyed via/by/in/on/over the PUCCH(s)/PUCCH resource(s) of the first UL channel, the network would know or could determine/identify that (higher layer(s) of) the UE has declared or determined the first event (or Event-1) specific to or for or associated or linked to the first CSI reporting setting for the carrier/CC #1, and the second event (or Event-2) specific to or for or associated or linked to the second CSI reporting setting for the carrier/CC #2, according to or following those specified herein in the present disclosure.
In another example, (higher layer(s) of) the UE has declared or determined the event(s) specific to or for or associated or linked to one or more or a subset of the one or more CSI reporting settings—denoted by one or more first CSI reporting settings (and/or the associated/linked carrier(s)/CC(s))—according to or following those specified herein in the present disclosure, wherein as aforementioned the first CSI reporting setting(s) could be from/among the one or more CSI reporting settings, and/or the first CSI reporting setting(s) could correspond to one or more of or a subset of the one or more CSI reporting settings, and/or (higher layer(s) of) the UE may not declare or determine any of the event(s) specific to or for or associated or linked to the rest of the one or more CSI reporting settings (i.e., the one or more CSI reporting settings excluding the first CSI reporting setting(s)—denoted by one or more second CSI reporting settings (and/or the associated/linked carrier(s)/CC(s))—according to or following those specified herein in the present disclosure, wherein as aforementioned the second CSI reporting setting(s) could be from/among the one or more CSI reporting settings, and/or the second CSI reporting setting(s) could correspond to one or more of or a subset of the one or more CSI reporting settings, and/or the second CSI reporting setting(s) could be different or separate from the first CSI reporting setting(s). In this case,
   For example, for Mode A and/or Mode C as specified/defined herein in the present disclosure, the UE could expect to receive from or be indicated by the network, via/by/in the ‘CSI request’ field in the DCI in Step-2 in response to the transmission(s) of the PN message/trigger (or the UEITI) via/by/in/on/over the PUCCH(s)/PUCCH resource(s) of the first UL channel, a trigger state associated or linked or mapped to all of the one or more CSI reporting settings.
   For another example, for Mode B as specified/defined herein in the present disclosure, the UE could expect the network to monitor or detect or receive all the (pre-configured or CG Type1) PUSCH(s)/PUSCH resource(s) of the second UL channel associated or linked or specific or corresponding or mapped to all of the one or more CSI reporting settings.
   For another example, for Mode A and/or Mode C as specified/defined herein in the present disclosure, the UE could expect to receive from or be indicated the network, via/by/in the ‘CSI request’ field in the DCI in Step-2 in response to the transmission(s) of the PN message/trigger (or the UEITI) via/by/in/on/over the PUCCH(s)/PUCCH resource(s) of the first UL channel, a trigger state associated or linked or mapped to one or more of the one or more CSI reporting settings—denoted by or referred to as reference CSI reporting setting(s) here. The UE could determine or identify the reference CSI reporting setting(s) according or following: (i) fixed rule(s)/value(s) in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s), following or according to those specified/defined herein in the present disclosure.
      In one example, the reference CSI reporting setting(s) could correspond to one or more of the one or more CSI reporting settings corresponding or associated or specific to the P≥1 earlies (or latest) reporting instance(s)/CSI report(s) in time, among the reporting instance(s)/CSI report(s) associated, linked, mapped, corresponding or specific to the one or more CSI reporting settings.
      In another example, the UEI report(s) and/or the corresponding UEI report content(s)/quantity(s) carried or conveyed by/in/over/on the (DG or CG Type1) PUSCH(s) or PUSCH resource(s) of the second UL channel as in Step-3 of Mode A and/or Mode C and/or Step-2 of Mode B transmitted or sent in reporting instance(s)/CSI report(s) associated, corresponding, specific, mapped or linked to the reference CSI reporting setting(s) could comprise or indicate or contain or include a one-bit (flag) indicators set to ‘1’ (or ‘0’).
      In another example, the reference CSI reporting setting(s) could correspond to one or more of the one or more CSI reporting settings with the P>1 highest priority(s) and/or highest (or lowest) priority order(s)/value(s) among all the one or more CSI reporting settings, wherein a priority order/value could be provided or configured in the higher layer parameter(s)/signaling(s) CSI-ReportConfig and/or UEI-ReportConfig that provides or configures a corresponding CSI reporting setting. For this design example, the UE could determine or identify the value(s) of P according to or based on: (i) fixed value(s), e.g., 1 or 2 or 3 or 4, in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s).
      In another example, the reference CSI reporting setting(s) could correspond to the first (or last) P≥1 CSI reporting setting(s) and/or the CSI reporting setting(s) with or having the P≥1 highest (or lowest) report setting or configuration ID(s)/index(es) among all the one or more CSI reporting settings, wherein the UE could determine or identify the value(s) of P according to or based on: (i) fixed value(s), e.g., 1 or 2 or 3 or 4, in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s).
      In another example, the reference CSI reporting setting(s) could correspond to the CSI reporting setting(s) with or having the P≥1 highest (or lowest) payload size(s) or payload size information for CSI/beam reporting among all the one or more CSI reporting settings, wherein the UE could determine or identify the value(s) of P according to or based on: (i) fixed value(s), e.g., 1 or 2 or 3 or 4, in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s).
      In another example, the reference CSI reporting setting(s) could correspond to the odd (or even) indexed/ordered CSI reporting setting(s) and/or the CSI reporting setting(s) with or having odd (or even) report setting or configuration ID(s)/index(es) among all the one or more CSI reporting settings.
      In another example, the UE could receive from the network, e.g., via/by/in higher layer RRC signaling(s)/parameter(s) e.g. CSI-ReportConfig and/or UEI-ReportConfig that provides or configures necessary information and/or setting(s) for the UE-initiated/event-driven beam reporting and/or MAC CE command(s) and/or dynamic DCI based L1 signaling(s) based on or according to corresponding UE's capability(s) or capability signaling(s), one or more indicators to indicate which of the one or more CSI reporting settings could correspond to the reference CSI reporting setting(s). For example, the one or more indicators could correspond to or could be in form of a one-bit indicator; in this case, when/if the one-bit indicator is set to ‘1’ (or ‘0’), all of the one or more CSI reporting settings could correspond to the reference CSI reporting setting(s). For another example, the one or more indicators could correspond or could be in form of a bitmap with each entry/bit position of the bitmap corresponding or associated to one or more of the one or more CSI reporting settings; in this case, when/if an entry/bit position of the bitmap is set to ‘1’ (or ‘0’), the CSI reporting setting(s) corresponding to the entry/bit position could correspond to the reference CSI reporting setting(s).
      In another example, the UE could transmit or send to the network, in (part of) the UEI report(s) e.g. via/by/in (part or form of) a/the PN message/trigger (or equivalently, a/the UEITI) transmitted or sent in/by/via/on/over the PUCCH(s)/PUCCH resource(s) of the first UL channel as in Step-1 of Mode A, Mode B and/or Mode C, one or more indicators to indicate which one or more of the one or more CSI reporting settings could correspond to the reference CSI reporting setting(s).
         For example, according to or following those specified or defined herein in the present disclosure, a cyclic shift index/cyclic shift associated, corresponding or specific to or for a PUCCH or a PUCCH resource or a PUCCH transmission occasion that carries or conveys a/the PN message/trigger or a/the PN message/trigger (or equivalently a/the UEITI) transmission occasion of a/the PUCCH/PUCCH resource of the first UL channel as in Step-1 of Mode A, Mode B and/or Mode C could be associated, linked, corresponding or mapped to one or more CSI reporting settings each provided by CSI-ReportConfig and/or UEI-ReportConfig that provides or configures necessary information and/or setting(s) for the UE-initiated/event-driven beam reporting as specified/defined herein in the present disclosure. For this design example, to indicate which one or more of the one or more CSI reporting settings correspond to the reference CSI reporting setting(s), the UE could send or transmit or indicate to the network, the PN message/trigger (or equivalently the UEITI), via/by/in/on/over PUCCH(s) or PUCCH resource(s) or PUCCH transmission occasion(s) of the first UL channel as in Step-1 of Mode A, Mode B and/or Mode C that is having/using/applying, associated, mapped, corresponding, linked or specific to the cyclic shift/cyclic shift index associated, linked, corresponding or mapped to the one or more reference CSI reporting settings. In this case, the one or more indicators could correspond to or could be in form of the cyclic shift/cyclic shift index.
         For another example, the one or more indicators could correspond to or could be in form of a one-bit indicator; in this case, when/if the one-bit indicator is set to ‘1’ (or ‘0’), all of the one or more CSI reporting settings could correspond to the reference CSI reporting setting(s).
         For another example, the one or more indicators could correspond or could be in form of a bitmap with each entry/bit position of the bitmap corresponding or associated to one or more of the one or more CSI reporting settings; in this case, when/if an entry/bit position of the bitmap is set to ‘1’ (or ‘0’), the CSI reporting setting(s) corresponding to the entry/bit position could correspond to the reference CSI reporting setting(s).
      For this design example, presence or absence of the one or more indicators in (part of) the UEI report(s) could be enabled (or disabled) or configured/provided/indicated by the network e.g. via/by/in corresponding higher layer RRC signaling(s)/parameter(s).

According to or following those specified herein in the present disclosure, the UE could transmit or send to the network, in (part of) the UEI report(s) e.g. via/by/in (part or form of) a/the PN message/trigger (or equivalently, a/the UEITI) transmitted or sent in/by/via/on/over the PUCCH(s)/PUCCH resource(s) of the first UL channel as in Step-1 of Mode A, Mode B and/or Mode C, one or more indicators to indicate the value(s) of P, and/or the number of the reference CSI reporting setting(s)—denoted by P′—as specified/defined herein in the present disclosure. For instance, the one or more indicators could correspond to or could be in form of the exact value(s) of P and/or P′; optionally or alternatively, the UE could be first provided or configured by the network, e.g., via higher layer RRC signaling(s)/parameter(s) and/or MAC CE command(s) and/or dynamic DCI based L1 signaling(s) based on or according to corresponding UE's capability(s) or capability signaling(s), R≥1 candidate value(s)/range(s)/configuration(s) for the value(s) of P and/or P′. In this case,
In one example, the one or more indicators could correspond to or could be in form of a [log₂R]-bit indicator with each codepoint of the [log₂R]-bit indicator corresponding, associated or specific to a candidate value/range/configuration for the value(s) of P and/or P′. For this design example, when/if the [log₂ R]-bit indicator is set to a codepoint, the candidate value/range/configuration for the value(s) of P and/or P′ associated, corresponding or specific to the codepoint could be indicated or notified to the network.
In another example, the one or more indicators could correspond to or could be in form of a bitmap with each entry/bit position of the bitmap corresponding, associated or specific to a candidate value/range/configuration for the value(s) of P and/or P′. For this design example, when/if an entry/bit position of the bitmap is set to ‘1’ (or ‘0’), the candidate value/range/configuration for the value(s) of P and/or P′ associated, corresponding or specific to the entry/bit position could be indicated or notified to the network.
In another example, a cyclic shift index/cyclic shift associated, corresponding or specific to or for a PUCCH or a PUCCH resource or a PUCCH transmission occasion that carries or conveys a/the PN message/trigger or a/the PN message/trigger (or equivalently a/the UEITI) transmission occasion of a/the PUCCH/PUCCH resource of the first UL channel as in Step-1 of Mode A, Mode B and/or Mode C could be associated, linked, corresponding or mapped to one or more candidate values/ranges/configurations for the value(s) of P and/or P′. For this design example, to indicate a candidate value/range/configuration for the value(s) of P and/or P′, the UE could send or transmit or indicate to the network, the PN message/trigger (or equivalently the UEITI), via/by/in/on/over PUCCH(s) or PUCCH resource(s) or PUCCH transmission occasion(s) of the first UL channel as in Step-1 of Mode A, Mode B and/or Mode C that is having/using/applying, associated, mapped, corresponding, linked or specific to the cyclic shift/cyclic shift index associated, linked, corresponding or mapped to the candidate value/range/configuration for the value(s) of P and/or P′. In this case, the one or more indicators could correspond to or could be in form of the cyclic shift/cyclic shift index.

The presence or absence of the one or more indicators in (part of) the UEI report(s) could be enabled (or disabled) or configured/provided/indicated by the network e.g. via/by/in corresponding higher layer RRC signaling(s)/parameter(s).
For another example, for Mode B as specified/defined herein in the present disclosure, the UE could expect the network to monitor or detect or receive all the (pre-configured or CG Type1) PUSCH(s)/PUSCH resource(s) of the second UL channel associated or linked or specific or corresponding or mapped to (one or more of) the reference CSI reporting setting(s). In this case, the UE (and/or the network) could determine or identify the reference CSI reporting setting(s) according to or based on: (i) fixed rule(s) in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based LI signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s), following or according to those specified/defined herein in the present disclosure, e.g., the above described design examples for Mode A and/or Mode C.
For another example, for Mode A and/or Mode C as specified/defined herein in the present disclosure, the UE could expect to receive from or be indicated by the network, via/by/in the ‘CSI request’ field in the DCI in Step-2 in response to the transmission(s) of the PN message/trigger (or the UEITI) via/by/in/on/over the PUCCH(s)/PUCCH resource(s) of the first UL channel, a trigger state associated or linked or mapped to one or more of the first CSI reporting setting(s). In this case, the UE (and/or the network) could determine or identify the first CSI reporting setting(s) according to or based on: (i) fixed rule(s) in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s), following or according to those specified/defined herein in the present disclosure.
   In one example, the first CSI reporting setting(s) could correspond to one or more of the one or more CSI reporting settings corresponding or associated or specific to the Q≥1 earlies (or latest) reporting instance(s)/CSI report(s) in time, among the reporting instance(s)/CSI report(s) associated, linked, mapped, corresponding or specific to the one or more CSI reporting settings.
   In another example, the UEI report(s) and/or the corresponding UEI report content(s)/quantity(s) carried or conveyed by/in/over/on the (DG or CG Type1) PUSCH(s) or PUSCH resource(s) of the second UL channel as in Step-3 of Mode A and/or Mode C and/or Step-2 of Mode B transmitted or sent in reporting instance(s)/CSI report(s) associated, corresponding, specific, mapped or linked to the first CSI reporting setting(s) could comprise or indicate or contain or include a one-bit (flag) indicators set to ‘1’ (or ‘0’).
   In another example, the first CSI reporting setting(s) could correspond to one or more of the one or more CSI reporting settings with the Q≥1 highest priority(s) and/or highest (or lowest) priority order(s)/value(s) among all the one or more CSI reporting settings, wherein a priority order/value could be provided or configured in the higher layer parameter(s)/signaling(s) CSI-ReportConfig and/or UEI-ReportConfig that provides or configures a corresponding CSI reporting setting. For this design example, the UE could determine or identify the value(s) of Q according to or based on: (i) fixed value(s), e.g., 1 or 2 or 3 or 4, in system specification(s) and/or per RRC (re-)configuration, (ii) network's s configuration(s) and/or indication(s), e.g., via higher layer RRC signaling(s)/parameter(s) and/or MAC CE command(s) and/or dynamic DCI based LI signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s).
   In another example, the first CSI reporting setting(s) could correspond to the first (or last) Q≥1 CSI reporting setting(s) and/or the CSI reporting setting(s) with or having the Q≥1 highest (or lowest) report setting or configuration ID(s)/index(es) among all the one or more CSI reporting settings, wherein the UE could determine or identify the value(s) of Q according to or based on: (i) fixed value(s), e.g., 1 or 2 or 3 or 4, in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s).
   In another example, the first CSI reporting setting(s) could correspond to the CSI reporting setting(s) with or having the Q≥1 highest (or lowest) payload size(s) or payload size information for CSI/beam reporting among all the one or more CSI reporting settings, wherein the UE could determine or identify the value(s) of Q according to or based on: (i) fixed value(s), e.g., 1 or 2 or 3 or 4, in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s).
   In another example, the first CSI reporting setting(s) could correspond to the odd (or even) indexed/ordered CSI reporting setting(s) and/or the CSI reporting setting(s) with or having odd (or even) report setting or configuration ID(s)/index(es) among all the one or more CSI reporting settings.
   In another example, the UE could receive from the network, e.g., via/by/in higher layer RRC signaling(s)/parameter(s) e.g. CSI-ReportConfig and/or UEI-ReportConfig that provides or configures necessary information and/or setting(s) for the UE-initiated/event-driven beam reporting and/or MAC CE command(s) and/or dynamic DCI based L1 signaling(s) based on or according to corresponding UE's capability(s) or capability signaling(s), one or more indicators to indicate which of the one or more CSI reporting settings could correspond to the first CSI reporting setting(s). For example, the one or more indicators could correspond to or could be in form of a one-bit indicator; in this case, when/if the one-bit indicator is set to ‘1’ (or ‘0’), all of the one or more CSI reporting settings could correspond to the first CSI reporting setting(s). For another example, the one or more indicators could correspond or could be in form of a bitmap with each entry/bit position of the bitmap corresponding or associated to one or more of the one or more CSI reporting settings; in this case, when/if an entry/bit position of the bitmap is set to ‘1’ (or ‘0’), the CSI reporting setting(s) corresponding to the entry/bit position could correspond to the first CSI reporting setting(s).
   In another example, the UE could transmit or send to the network, in (part of) the UEI report(s) e.g. via/by/in (part or form of) a/the PN message/trigger (or equivalently, a/the UEITI) transmitted or sent in/by/via/on/over the PUCCH(s)/PUCCH resource(s) of the first UL channel as in Step-1 of Mode A, Mode B and/or Mode C, one or more indicators to indicate which one or more of the one or more CSI reporting settings could correspond to the first CSI reporting setting(s).
      For example, according to or following those specified or defined herein in the present disclosure, a cyclic shift index/cyclic shift associated, corresponding or specific to or for a PUCCH or a PUCCH resource or a PUCCH transmission occasion that carries or conveys a/the PN message/trigger or a/the PN message/trigger (or equivalently a/the UEITI) transmission occasion of a/the PUCCH/PUCCH resource of the first UL channel as in Step-1 of Mode A, Mode B and/or Mode C could be associated, linked, corresponding or mapped to one or more CSI reporting settings each provided by CSI-ReportConfig and/or UEI-ReportConfig that provides or configures necessary information and/or setting(s) for the UE-initiated/event-driven beam reporting as specified/defined herein in the present disclosure. For this design example, to indicate which one or more of the one or more CSI reporting settings correspond to the first CSI reporting setting(s), the UE could send or transmit or indicate to the network, the PN message/trigger (or equivalently the UEITI), via/by/in/on/over PUCCH(s) or PUCCH resource(s) or PUCCH transmission occasion(s) of the first UL channel as in Step-1 of Mode A, Mode B and/or Mode C that is having/using/applying, associated, mapped, corresponding, linked or specific to the cyclic shift/cyclic shift index associated, linked, corresponding or mapped to the one or more first CSI reporting settings. In this case, the one or more indicators could correspond to or could be in form of the cyclic shift/cyclic shift index.
      For another example, the one or more indicators could correspond to or could be in form of a one-bit indicator; in this case, when/if the one-bit indicator is set to ‘1’ (or ‘0’), all of the one or more CSI reporting settings could correspond to the first CSI reporting setting(s).
      For another example, the one or more indicators could correspond or could be in form of a bitmap with each entry/bit position of the bitmap corresponding or associated to one or more of the one or more CSI reporting settings; in this case, when/if an entry/bit position of the bitmap is set to ‘1’ (or ‘0’), the CSI reporting setting(s) corresponding to the entry/bit position could correspond to the first CSI reporting setting(s).
      For this design example, presence or absence of the one or more indicators in (part of) the UEI report(s) could be enabled (or disabled) or configured/provided/indicated by the network e.g. via/by/in corresponding higher layer RRC signaling(s)/parameter(s).

According to or following those specified herein in the present disclosure, the UE could transmit or send to the network, in (part of) the UEI report(s) e.g. via/by/in (part or form of) a/the PN message/trigger (or equivalently, a/the UEITI) transmitted or sent in/by/via/on/over the PUCCH(s)/PUCCH resource(s) of the first UL channel as in Step-1 of Mode A, Mode B and/or Mode C, one or more indicators to indicate the value(s) of Q, and/or the number of the first CSI reporting setting(s)—denoted by Q′—as specified/defined herein in the present disclosure. For instance, the one or more indicators could correspond or could be in form of the exact value(s) of Q and/or Q′; optionally or alternatively, the UE could be first provided or configured by the network, e.g., via higher layer RRC signaling(s)/parameter(s) and/or MAC CE command(s) and/or dynamic DCI based L1 signaling(s) based on or according to corresponding UE's capability(s) or capability signaling(s), S≥1 candidate value(s)/range(s)/configuration(s) for the value(s) of Q and/or Q′. In this case,
In one example, the one or more indicators could correspond to or could be in form of a [log₂S]-bit indicator with each codepoint of the [log₂S]-bit indicator corresponding, associated or specific to a candidate value/range/configuration for the value(s) of Q and/or Q′. For this design example, when/if the [log₂S]-bit indicator is set to a codepoint, the candidate value/range/configuration for the value(s) of Q and/or Q′ associated, corresponding or specific to the codepoint could be indicated or notified to the network.
In another example, the one or more indicators could correspond to or could be in form of a bitmap with each entry/bit position of the bitmap corresponding, associated or specific to a candidate value/range/configuration for the value(s) of Q and/or Q′. For this design example, when/if an entry/bit position of the bitmap is set to ‘1’ (or ‘0’), the candidate value/range/configuration for the value(s) of Q and/or Q′ associated, corresponding or specific to the entry/bit position could be indicated or notified to the network.
In another example, a cyclic shift index/cyclic shift associated, corresponding or specific to or for a PUCCH or a PUCCH resource or a PUCCH transmission occasion that carries or conveys a/the PN message/trigger or a/the PN message/trigger (or equivalently a/the UEITI) transmission occasion of a/the PUCCH/PUCCH resource of the first UL channel as in Step-1 of Mode A, Mode B and/or Mode C could be associated, linked, corresponding or mapped to one or more candidate values/ranges/configurations for the value(s) of Q and/or Q′. For this design example, to indicate a candidate value/range/configuration for the value(s) of Q and/or Q′, the UE could send or transmit or indicate to the network, the PN message/trigger (or equivalently the UEITI), via/by/in/on/over PUCCH(s) or PUCCH resource(s) or PUCCH transmission occasion(s) of the first UL channel as in Step-1 of Mode A, Mode B and/or Mode C that is having/using/applying, associated, mapped, corresponding, linked or specific to the cyclic shift/cyclic shift index associated, linked, corresponding or mapped to the candidate value/range/configuration for the value(s) of Q and/or Q′. In this case, the one or more indicators could correspond to or could be in form of the cyclic shift/cyclic shift index.

The presence or absence of the one or more indicators in (part of) the UEI report(s) could be enabled (or disabled) or configured/provided/indicated by the network e.g. via/by/in corresponding higher layer RRC signaling(s)/parameter(s).
For another example, for Mode B as specified/defined herein in the present disclosure, the UE could expect the network to monitor or detect or receive all the (pre-configured or CG Type1) PUSCH(s)/PUSCH resource(s) of the second UL channel associated or linked or specific or corresponding or mapped to (one or more of) the first CSI reporting setting(s). In this case, the UE (and/or the network) could determine or identify the first CSI reporting setting(s) according to or based on: (i) fixed rule(s) in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s), following or according to those specified/defined herein in the present disclosure, e.g., the above described design examples for Mode A and/or Mode C.

In one embodiment, a UE could send or transmit a PN message/trigger (or a UEITI) via/by/in/on/over the PUCCH(s)/PUCCH resource(s) of the first UL channel as in Step-1 of Mode A, Mode B and/or Mode C, wherein the PN message/trigger or the UEITI or the PUCCH(s)/PUCCH resource(s) of the first UL channel that carries or conveys the PN message/trigger (or UEITI) transmission occasion could be associated or linked to one or more CSI reporting settings each associated or linked to one or more events and/or one or more carriers/CCs according to or following those specified herein in the present disclosure, when/if one or more of the following conditions are achieved, held or satisfied:
Condition-1: (higher layer(s) of) the UE has declared or determined the event(s) specific to or for or associated or linked to each of the one or more CSI reporting settings (and/or the associated/linked carrier(s)/CC(s)) according to or following those specified herein in the present disclosure. In this case, when/if a UE has sent or transmitted a PN message/trigger (or a UEITI) via/by/in/on/over the PUCCH(s)/PUCCH resource(s) of the first UL channel as in Step-1 of Mode A, Mode B and/or Mode C, and the PN message/trigger or the UEITI or the PUCCH(s)/PUCCH resource(s) of the first UL channel that carries or conveys the PN message/trigger (or UEITI) transmission occasion is associated or linked to a first CSI reporting setting associated or linked to the first event (or Event-1) for carrier/CC #1, and a second CSI reporting setting associated or linked to the second event (or Event-2) for carrier/CC #2, when receiving or detecting the PN message/trigger (or equivalently the UEITI) carried or conveyed via/by/in/on/over the PUCCH(s)/PUCCH resource(s) of the first UL channel, the network would know or could determine/identify that (higher layer(s) of) the UE has declared or determined the first event (or Event-1) specific to or for or associated or linked to the first CSI reporting setting for the carrier/CC #1, and the second event (or Event-2) specific to or for or associated or linked to the second CSI reporting setting for the carrier/CC #2, according to or following those specified herein in the present disclosure.
Condition-2: (higher layer(s) of) the UE has declared or determined the event(s) specific to or for or associated or linked to one or more or a subset of the one or more CSI reporting settings—denoted by one or more first CSI reporting settings (and/or the associated/linked carrier(s)/CC(s))—according to or following those specified herein in the present disclosure, wherein as aforementioned the first CSI reporting setting(s) could be from/among the one or more CSI reporting settings, and/or the first CSI reporting setting(s) could correspond to one or more of or a subset of the one or more CSI reporting settings; in this case, (higher layer(s) of) the UE may not declare or determine any of the event(s) specific to or for or associated or linked to the rest of the one or more CSI reporting settings (i.e., the one or more CSI reporting settings excluding the first CSI reporting setting(s)—denoted by one or more second CSI reporting (and/or the associated/linked carrier(s)/CC(s))—according to or following those specified herein in the present disclosure, wherein as aforementioned the second CSI reporting setting(s) could be from/among the one or more CSI reporting settings, and/or the second CSI reporting setting(s) could correspond to one or more of or a subset of the one or more CSI reporting settings, and/or the second CSI reporting setting(s) could be different or separate from the first CSI reporting setting(s). In this case, the UE (and/or the network) could determine or identify the first CSI reporting setting(s) according to or based on: (i) fixed rule(s) in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s), following or according to those specified/defined herein in the present disclosure.
   In one example, the first CSI reporting setting(s) could correspond to one or more of the one or more CSI reporting settings corresponding or associated or specific to the Q≥1 earlies (or latest) reporting instance(s)/CSI report(s) in time, among the reporting instance(s)/CSI report(s) associated, linked, mapped, corresponding or specific to the one or more CSI reporting settings.
   In another example, the UEI report(s) and/or the corresponding UEI report content(s)/quantity(s) carried or conveyed by/in/over/on the (DG or CG Type1) PUSCH(s) or PUSCH resource(s) of the second UL channel as in Step-3 of Mode A and/or Mode C and/or Step-2 of Mode B transmitted or sent in reporting instance(s)/CSI report(s) associated, corresponding, specific, mapped or linked to the first CSI reporting setting(s) could comprise or indicate or contain or include a one-bit (flag) indicators set to ‘1’ (or ‘0’).
   In another example, the first CSI reporting setting(s) could correspond to one or more of the one or more CSI reporting settings with the Q≥1 highest priority(s) and/or highest (or lowest) priority order(s)/value(s) among all the one or more CSI reporting settings, wherein a priority order/value could be provided or configured in the higher layer parameter(s)/signaling(s) CSI-ReportConfig and/or UEI-ReportConfig that provides or configures a corresponding CSI reporting setting. For this design example, the UE could determine or identify the value(s) of Q according to or based on: (i) fixed value(s), e.g., 1 or 2 or 3 or 4, in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s).
   In another example, the first CSI reporting setting(s) could correspond to the first (or last) Q≥1 CSI reporting setting(s) and/or the CSI reporting setting(s) with or having the Q≥1 highest (or lowest) report setting or configuration ID(s)/index(es) among all the one or more CSI reporting settings, wherein the UE could determine or identify the value(s) of Q according to or based on: (i) fixed value(s), e.g., 1 or 2 or 3 or 4, in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s).
   In another example, the first CSI reporting setting(s) could correspond to the CSI reporting setting(s) with or having the Q≥1 highest (or lowest) payload size(s) or payload size information for CSI/beam reporting among all the one or more CSI reporting settings, wherein the UE could determine or identify the value(s) of Q according to or based on: (i) fixed value(s), e.g., 1 or 2 or 3 or 4, in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s).
   In another example, the first CSI reporting setting(s) could correspond to the odd (or even) indexed/ordered CSI reporting setting(s) and/or the CSI reporting setting(s) with or having odd (or even) report setting or configuration ID(s)/index(es) among all the one or more CSI reporting settings.
   In another example, the UE could receive from the network, e.g., via/by/in higher layer RRC signaling(s)/parameter(s) e.g. CSI-ReportConfig and/or UEI-ReportConfig that provides or configures necessary information and/or setting(s) for the UE-initiated/event-driven beam reporting and/or MAC CE command(s) and/or dynamic DCI based L1 signaling(s) based on or according to corresponding UE's capability(s) or capability signaling(s), one or more indicators to indicate which of the one or more CSI reporting settings could correspond to the first CSI reporting setting(s). For example, the one or more indicators could correspond to or could be in form of a one-bit indicator; in this case, when/if the one-bit indicator is set to ‘1’ (or ‘0’), all of the one or more CSI reporting settings could correspond to the first CSI reporting setting(s). For another example, the one or more indicators could correspond or could be in form of a bitmap with each entry/bit position of the bitmap corresponding or associated to one or more of the one or more CSI reporting settings; in this case, when/if an entry/bit position of the bitmap is set to ‘1’ (or ‘0’), the CSI reporting setting(s) corresponding to the entry/bit position could correspond to the first CSI reporting setting(s).
   In another example, the UE could transmit or send to the network, in (part of) the UEI report(s) e.g. via/by/in (part or form of) a/the PN message/trigger (or equivalently, a/the UEITI) transmitted or sent in/by/via/on/over the PUCCH(s)/PUCCH resource(s) of the first UL channel as in Step-1 of Mode A, Mode B and/or Mode C, one or more indicators to indicate which one or more of the one or more CSI reporting settings could correspond to the first CSI reporting setting(s).
      For example, according to or following those specified or defined herein in the present disclosure, a cyclic shift index/cyclic shift associated, corresponding or specific to or for a PUCCH or a PUCCH resource or a PUCCH transmission occasion that carries or conveys a/the PN message/trigger or a/the PN message/trigger (or equivalently a/the UEITI) transmission occasion of a/the PUCCH/PUCCH resource of the first UL channel as in Step-1 of Mode A, Mode B and/or Mode C could be associated, linked, corresponding or mapped to one or more CSI reporting settings each provided by CSI-ReportConfig and/or UEI-ReportConfig that provides or configures necessary information and/or setting(s) for the UE-initiated/event-driven beam reporting as specified/defined herein in the present disclosure. For this design example, to indicate which one or more of the one or more CSI reporting settings correspond to the first CSI reporting setting(s), the UE could send or transmit or indicate to the network, the PN message/trigger (or equivalently the UEITI), via/by/in/on/over PUCCH(s) or PUCCH resource(s) or PUCCH transmission occasion(s) of the first UL channel as in Step-1 of Mode A, Mode B and/or Mode C that is having/using/applying, associated, mapped, corresponding, linked or specific to the cyclic shift/cyclic shift index associated, linked, corresponding or mapped to the one or more first CSI reporting settings. In this case, the one or more indicators could correspond to or could be in form of the cyclic shift/cyclic shift index.
      For another example, the one or more indicators could correspond to or could be in form of a one-bit indicator; in this case, when/if the one-bit indicator is set to ‘1’ (or ‘0’), all of the one or more CSI reporting settings could correspond to the first CSI reporting setting(s).
      For another example, the one or more indicators could correspond or could be in form of a bitmap with each entry/bit position of the bitmap corresponding or associated to one or more of the one or more CSI reporting settings; in this case, when/if an entry/bit position of the bitmap is set to ‘1’ (or ‘0’), the CSI reporting setting(s) corresponding to the entry/bit position could correspond to the first CSI reporting setting(s).
      For this design example, presence or absence of the one or more indicators in (part of) the UEI report(s) could be enabled (or disabled) or configured/provided/indicated by the network e.g. via/by/in corresponding higher layer RRC signaling(s)/parameter(s).

According to or following those specified herein in the present disclosure, the UE could transmit or send to the network, in (part of) the UEI report(s) e.g. via/by/in (part or form of) a/the PN message/trigger (or equivalently, a/the UEITI) transmitted or sent in/by/via/on/over the PUCCH(s)/PUCCH resource(s) of the first UL channel as in Step-1 of Mode A, Mode B and/or Mode C, one or more indicators to indicate the value(s) of Q, and/or the number of the first CSI reporting setting(s)—denoted by Q′—as specified/defined herein in the present disclosure. For instance, the one or more indicators could correspond to or could be in form of the exact value(s) of Q and/or Q′; optionally or alternatively, the UE could be first provided or configured by the network, e.g., via higher layer RRC signaling(s)/parameter(s) and/or MAC CE command(s) and/or dynamic DCI based L1 signaling(s) based on or according to corresponding UE's capability(s) or capability signaling(s), S≥1 candidate value(s)/range(s)/configuration(s) for the value(s) of Q and/or Q′. In this case,
In one example, the one or more indicators could correspond to or could be in form of a [log₂S]-bit indicator with each codepoint of the [log₂S]-bit indicator corresponding, associated or specific to a candidate value/range/configuration for the value(s) of Q and/or Q′. For this design example, when/if the [log₂S]-bit indicator is set to a codepoint, the candidate value/range/configuration for the value(s) of Q and/or Q′ associated, corresponding or specific to the codepoint could be indicated or notified to the network.
In another example, the one or more indicators could correspond to or could be in form of a bitmap with each entry/bit position of the bitmap corresponding, associated or specific to a candidate value/range/configuration for the value(s) of Q and/or Q′. For this design example, when/if an entry/bit position of the bitmap is set to ‘1’ (or ‘0’), the candidate value/range/configuration for the value(s) of Q and/or Q′ associated, corresponding or specific to the entry/bit position could be indicated or notified to the network.
In another example, a cyclic shift index/cyclic shift associated, corresponding or specific to or for a PUCCH or a PUCCH resource or a PUCCH transmission occasion that carries or conveys a/the PN message/trigger or a/the PN message/trigger (or equivalently a/the UEITI) transmission occasion of a/the PUCCH/PUCCH resource of the first UL channel as in Step-1 of Mode A, Mode B and/or Mode C could be associated, linked, corresponding or mapped to one or more candidate values/ranges/configurations for the value(s) of Q and/or Q′. For this design example, to indicate a candidate value/range/configuration for the value(s) of Q and/or Q′, the UE could send or transmit or indicate to the network, the PN message/trigger (or equivalently the UEITI), via/by/in/on/over PUCCH(s) or PUCCH resource(s) or PUCCH transmission occasion(s) of the first UL channel as in Step-1 of Mode A, Mode B and/or Mode C that is having/using/applying, associated, mapped, corresponding, linked or specific to the cyclic shift/cyclic shift index associated, linked, corresponding or mapped to the candidate value/range/configuration for the value(s) of Q and/or Q′. In this case, the one or more indicators could correspond to or could be in form of the cyclic shift/cyclic shift index.

The presence or absence of the one or more indicators in (part of) the UEI report(s) could be enabled (or disabled) or configured/provided/indicated by the network e.g. via/by/in corresponding higher layer RRC signaling(s)/parameter(s). Furthermore,
For example, for Mode A and/or Mode C as specified/defined herein in the present disclosure, the UE could expect to receive from or be indicated by the network, via/by/in the ‘CSI request’ field in the DCI in Step-2 in response to the transmission(s) of the PN message/trigger (or the UEITI) via/by/in/on/over the PUCCH(s)/PUCCH resource(s) of the first UL channel, a trigger state associated or linked or mapped to all of the one or more CSI reporting settings.
For another example, for Mode B as specified/defined herein in the present disclosure, the UE could expect the network to monitor or detect or receive all the (pre-configured or CG Type1) PUSCH(s)/PUSCH resource(s) of the second UL channel associated or linked or specific or corresponding or mapped to all of the one or more CSI reporting settings.
For another example, for Mode A and/or Mode C as specified/defined herein in the present disclosure, the UE could expect to receive from or be indicated the network, via/by/in the ‘CSI request’ field in the DCI in Step-2 in response to the transmission(s) of the PN message/trigger (or the UEITI) via/by/in/on/over the PUCCH(s)/PUCCH resource(s) of the first UL channel, a trigger state associated or linked or mapped to one or more of the one or more CSI reporting settings—denoted by or referred to as reference CSI reporting setting(s) here. The UE could determine or identify the reference CSI reporting setting(s) according or following: (i) fixed rule(s)/value(s) in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s), following or according to those specified/defined herein in the present disclosure.
   In one example, the reference CSI reporting setting(s) could correspond to one or more of the one or more CSI reporting settings corresponding or associated or specific to the P≥1 earlies (or latest) reporting instance(s)/CSI report(s) in time, among the reporting instance(s)/CSI report(s) associated, linked, mapped, corresponding or specific to the one or more CSI reporting settings.
   In another example, the UEI report(s) and/or the corresponding UEI report content(s)/quantity(s) carried or conveyed by/in/over/on the (DG or CG Type1) PUSCH(s) or PUSCH resource(s) of the second UL channel as in Step-3 of Mode A and/or Mode C and/or Step-2 of Mode B transmitted or sent in reporting instance(s)/CSI report(s) associated, corresponding, specific, mapped or linked to the reference CSI reporting setting(s) could comprise or indicate or contain or include a one-bit (flag) indicators set to ‘1’ (or ‘0’).
   In another example, the reference CSI reporting setting(s) could correspond to one or more of the one or more CSI reporting settings with the P≥1 highest priority(s) and/or highest (or lowest) priority order(s)/value(s) among all the one or more CSI reporting settings, wherein a priority order/value could be provided or configured in the higher layer parameter(s)/signaling(s) CSI-ReportConfig and/or UEI-ReportConfig that provides or configures a corresponding CSI reporting setting. For this design example, the UE could determine or identify the value(s) of P according to or based on: (i) fixed value(s), e.g., 1 or 2 or 3 or 4, in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based LI signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s).
   In another example, the reference CSI reporting setting(s) could correspond to the first (or last) P≥1 CSI reporting setting(s) and/or the CSI reporting setting(s) with or having the P≥1 highest (or lowest) report setting or configuration ID(s)/index(es) among all the one or more CSI reporting settings, wherein the UE could determine or identify the value(s) of P according to or based on: (i) fixed value(s), e.g., 1 or 2 or 3 or 4, in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s).
   In another example, the reference CSI reporting setting(s) could correspond to the CSI reporting setting(s) with or having the P≥1 highest (or lowest) payload size(s) or payload size information for CSI/beam reporting among all the one or more CSI reporting settings, wherein the UE could determine or identify the value(s) of P according to or based on: (i) fixed value(s), e.g., 1 or 2 or 3 or 4, in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s).
   In another example, the reference CSI reporting setting(s) could correspond to the odd (or even) indexed/ordered CSI reporting setting(s) and/or the CSI reporting setting(s) with or having odd (or even) report setting or configuration ID(s)/index(es) among all the one or more CSI reporting settings.
   In another example, the UE could receive from the network, e.g., via/by/in higher layer RRC signaling(s)/parameter(s) e.g. CSI-ReportConfig and/or UEI-ReportConfig that provides or configures necessary information and/or setting(s) for the UE-initiated/event-driven beam reporting and/or MAC CE command(s) and/or dynamic DCI based L1 signaling(s) based on or according to corresponding UE's capability(s) or capability signaling(s), one or more indicators to indicate which of the one or more CSI reporting settings could correspond to the reference CSI reporting setting(s). For example, the one or more indicators could correspond to or could be in form of a one-bit indicator; in this case, when/if the one-bit indicator is set to ‘1’ (or ‘0’), all of the one or more CSI reporting settings could correspond to the reference CSI reporting setting(s). For another example, the one or more indicators could correspond or could be in form of a bitmap with each entry/bit position of the bitmap corresponding or associated to one or more of the one or more CSI reporting settings; in this case, when/if an entry/bit position of the bitmap is set to ‘1’ (or ‘0’), the CSI reporting setting(s) corresponding to the entry/bit position could correspond to the reference CSI reporting setting(s).
   In another example, the UE could transmit or send to the network, in (part of) the UEI report(s) e.g. via/by/in (part or form of) a/the PN message/trigger (or equivalently, a/the UEITI) transmitted or sent in/by/via/on/over the PUCCH(s)/PUCCH resource(s) of the first UL channel as in Step-1 of Mode A, Mode B and/or Mode C, one or more indicators to indicate which one or more of the one or more CSI reporting settings could correspond to the reference CSI reporting setting(s).
      For example, according to or following those specified or defined herein in the present disclosure, a cyclic shift index/cyclic shift associated, corresponding or specific to or for a PUCCH or a PUCCH resource or a PUCCH transmission occasion that carries or conveys a/the PN message/trigger or a/the PN message/trigger (or equivalently a/the UEITI) transmission occasion of a/the PUCCH/PUCCH resource of the first UL channel as in Step-1 of Mode A, Mode B and/or Mode C could be associated, linked, corresponding or mapped to one or more CSI reporting settings each provided by CSI-ReportConfig and/or UEI-ReportConfig that provides or configures necessary information and/or setting(s) for the UE-initiated/event-driven beam reporting as specified/defined herein in the present disclosure. For this design example, to indicate which one or more of the one or more CSI reporting settings correspond to the reference CSI reporting setting(s), the UE could send or transmit or indicate to the network, the PN message/trigger (or equivalently the UEITI), via/by/in/on/over PUCCH(s) or PUCCH resource(s) or PUCCH transmission occasion(s) of the first UL channel as in Step-1 of Mode A, Mode B and/or Mode C that is having/using/applying, associated, mapped, corresponding, linked or specific to the cyclic shift/cyclic shift index associated, linked, corresponding or mapped to the one or more reference CSI reporting settings. In this case, the one or more indicators could correspond to or could be in form of the cyclic shift/cyclic shift index.
      For another example, the one or more indicators could correspond to or could be in form of a one-bit indicator; in this case, when/if the one-bit indicator is set to ‘1’ (or ‘0’), all of the one or more CSI reporting settings could correspond to the reference CSI reporting setting(s).
      For another example, the one or more indicators could correspond or could be in form of a bitmap with each entry/bit position of the bitmap corresponding or associated to one or more of the one or more CSI reporting settings; in this case, when/if an entry/bit position of the bitmap is set to ‘1’ (or ‘0’), the CSI reporting setting(s) corresponding to the entry/bit position could correspond to the reference CSI reporting setting(s).
      For this design example, presence or absence of the one or more indicators in (part of) the UEI report(s) could be enabled (or disabled) or configured/provided/indicated by the network e.g. via/by/in corresponding higher layer RRC signaling(s)/parameter(s).

According to or following those specified herein in the present disclosure, the UE could transmit or send to the network, in (part of) the UEI report(s) e.g. via/by/in (part or form of) a/the PN message/trigger (or equivalently, a/the UEITI) transmitted or sent in/by/via/on/over the PUCCH(s)/PUCCH resource(s) of the first UL channel as in Step-1 of Mode A, Mode B and/or Mode C, one or more indicators to indicate the value(s) of P, and/or the number of the reference CSI reporting setting(s)—denoted by P′—as specified/defined herein in the present disclosure. For instance, the one or more indicators could correspond to or could be in form of the exact value(s) of P and/or P′; alternatively or optionally, the UE could be first provided or configured by the network, e.g., via higher layer RRC signaling(s)/parameter(s) and/or MAC CE command(s) and/or dynamic DCI based L1 signaling(s) based on or according to corresponding UE's capability(s) or capability signaling(s), R≥1 candidate value(s)/range(s)/configuration(s) for the value(s) of P and/or P′. In this case,
In one example, the one or more indicators could correspond to or could be in form of a [log₂R]-bit indicator with each codepoint of the [log₂R]-bit indicator corresponding, associated or specific to a candidate value/range/configuration for the value(s) of P and/or P′. For this design example, when/if the [log₂ R]-bit indicator is set to a codepoint, the candidate value/range/configuration for the value(s) of P and/or P′ associated, corresponding or specific to the codepoint could be indicated or notified to the network.
In another example, the one or more indicators could correspond to or could be in form of a bitmap with each entry/bit position of the bitmap corresponding, associated or specific to a candidate value/range/configuration for the value(s) of P and/or P′. For this design example, when/if an entry/bit position of the bitmap is set to ‘1’ (or ‘0’), the candidate value/range/configuration for the value(s) of P and/or P′ associated, corresponding or specific to the entry/bit position could be indicated or notified to the network.
In another example, a cyclic shift index/cyclic shift associated, corresponding or specific to or for a PUCCH or a PUCCH resource or a PUCCH transmission occasion that carries or conveys a/the PN message/trigger or a/the PN message/trigger (or equivalently a/the UEITI) transmission occasion of a/the PUCCH/PUCCH resource of the first UL channel as in Step-1 of Mode A, Mode B and/or Mode C could be associated, linked, corresponding or mapped to one or more candidate values/ranges/configurations for the value(s) of P and/or P′. For this design example, to indicate a candidate value/range/configuration for the value(s) of P and/or P′, the UE could send or transmit or indicate to the network, the PN message/trigger (or equivalently the UEITI), via/by/in/on/over PUCCH(s) or PUCCH resource(s) or PUCCH transmission occasion(s) of the first UL channel as in Step-1 of Mode A, Mode B and/or Mode C that is having/using/applying, associated, mapped, corresponding, linked or specific to the cyclic shift/cyclic shift index associated, linked, corresponding or mapped to the candidate value/range/configuration for the value(s) of P and/or P′. In this case, the one or more indicators could correspond to or could be in form of the cyclic shift/cyclic shift index.

The presence or absence of the one or more indicators in (part of) the UEI report(s) could be enabled (or disabled) or configured/provided/indicated by the network e.g. via/by/in corresponding higher layer RRC signaling(s)/parameter(s).
For another example, for Mode B as specified/defined herein in the present disclosure, the UE could expect the network to monitor or detect or receive all the (pre-configured or CG Type1) PUSCH(s)/PUSCH resource(s) of the second UL channel associated or linked or specific or corresponding or mapped to (one or more of) the reference CSI reporting setting(s). In this case, the UE (and/or the network) could determine or identify the reference CSI reporting setting(s) according to or based on: (i) fixed rule(s) in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based LI signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s), following or according to those specified/defined herein in the present disclosure, e.g., the above described design examples for Mode A and/or Mode C.
For another example, for Mode A and/or Mode C as specified/defined herein in the present disclosure, the UE could expect to receive from or be indicated by the network, via/by/in the ‘CSI request’ field in the DCI in Step-2 in response to the transmission(s) of the PN message/trigger (or the UEITI) via/by/in/on/over the PUCCH(s)/PUCCH resource(s) of the first UL channel, a trigger state associated or linked or mapped to one or more of the first CSI reporting setting(s).
For another example, for Mode B as specified/defined herein in the present disclosure, the UE could expect the network to monitor or detect or receive all the (pre-configured or CG Type1) PUSCH(s)/PUSCH resource(s) of the second UL channel associated or linked or specific or corresponding or mapped to (one or more of) the first CSI reporting setting(s). In this case, the UE (and/or the network) could determine or identify the first CSI reporting setting(s) according to or based on: (i) fixed rule(s) in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s), following or according to those specified/defined herein in the present disclosure, e.g., the above described design examples for Mode A and/or Mode C.

According to or following those specified herein in the present disclosure, when/if (it is configured or provided or indicated or enabled that) a PUCCH or a PUCCH resource or a PUCCH transmission occasion that carries or conveys a/the PN message/trigger or a/the PN message/trigger (or equivalently a/the UEITI) transmission occasion of a/the PUCCH/PUCCH resource of the first UL channel could be associated or linked to M>1 CSI reporting settings each provided by CSI-ReportConfig and/or UEI-ReportConfig that provides or configures necessary information and/or setting(s) for the UE-initiated/event-driven beam reporting according to or following those specified/defined herein in the present disclosure, the UEI report(s) and/or the corresponding UEI report content(s)/quantity(s) carried or conveyed by/in/over/on the (DG or CG Type1) PUSCH(s) or PUSCH resource(s) of the second UL channel as in Step-3 of Mode A and/or Mode C and/or Step-2 of Mode B, transmitted or sent in a reporting instance/CSI report, could comprise or contain or include or indicate one or more IDs/indexes to indicate or in form of one or more of:
reporting setting ID(s)/index(es) for/of one or more CSI reporting settings; in this case, the report quantity(s) in (part of) the UEI report(s) and/or the corresponding UEI report content(s)/quantity(s) could be specific to or for the one or more CSI reporting settings;
ID(s)/index(es) for/of one or more events associated, specific or corresponding to the one or more CSI reporting settings; in this case, the report quantity(s) in (part of) the UEI report(s) and/or the corresponding UEI report content(s)/quantity(s) could be specific to or for the one or more CSI reporting settings (and therefore, declaration(s) or determination(s) or detection(s) of the one or more events); and
ID(s)/index(es) for/of one or more carriers/CCs associated, specific or corresponding to the one or more CSI reporting settings; in this case, the report quantity(s) in (part of) the UEI report(s) and/or the corresponding UEI report content(s)/quantity(s) could be specific to or for the one or more CSI reporting settings (and therefore, declaration(s) or determination(s) or detection(s) of one or more events in/for/on the one or more carriers/CCs).

Optionally, presence or absence of the one or more IDs/indexes as specified/defined herein in the present disclosure in (part of) the UEI report(s) and/or the corresponding UEI report content(s)/quantity(s) could be enabled (or disabled) and/or configured or provided or indicated by the network, e.g., via/by/in corresponding higher layer RRC signaling(s)/parameter(s). In addition, the UEI report(s) and/or the corresponding UEI report content(s)/quantity(s) carried or conveyed by/in/over/on the (DG or CG Type1) PUSCH(s) or PUSCH resource(s) of the second UL channel as in Step-3 of Mode A and/or Mode C and/or Step-2 of Mode B, transmitted or sent in a reporting instance/CSI report, could comprise or contain or include or indicate one or more indicators to indicate which one or more of the M>1 CSI reporting settings could correspond to the first CSI reporting setting(s) defined/specified herein in the present disclosure.
For another example, the one or more indicators could correspond to or could be in form of a one-bit indicator; in this case, when/if the one-bit indicator is set to ‘1’ (or ‘0’), all of the M>1 CSI reporting settings could correspond to the first CSI reporting setting(s).
For another example, the one or more indicators could correspond or could be in form of a bitmap with each entry/bit position of the bitmap corresponding or associated to one or more of the M>1 CSI reporting settings; in this case, when/if an entry/bit position of the bitmap is set to ‘1’ (or ‘0’), the CSI reporting setting(s) corresponding to the entry/bit position could correspond to the first CSI reporting setting(s).

The presence or absence of the one or more indicators in (part of) the UEI report(s) and/or the corresponding UEI report content(s)/quantity(s) could be enabled (or disabled) or configured/provided/indicated by the network e.g. via/by/in corresponding higher layer RRC signaling(s)/parameter(s). According to or following those specified herein in the present disclosure, the UEI report(s) and/or the corresponding UEI report content(s)/quantity(s) carried or conveyed by/in/over/on the (DG or CG Type1) PUSCH(s) or PUSCH resource(s) of the second UL channel as in Step-3 of Mode A and/or Mode C and/or Step-2 of Mode B, transmitted or sent in a reporting instance/CSI report, could comprise or contain or include or indicate one or more indicators to indicate the value(s) of Q (defined/specified herein in the present disclosure) and/or the number of the first CSI reporting setting(s)—denoted by Q′—as specified/defined herein in the present disclosure. For instance, the one or more indicators could correspond to or could be in form of the exact value(s) of Q and/or Q′; optionally or alternatively, the UE could be first provided or configured by the network, e.g., via higher layer RRC signaling(s)/parameter(s) and/or MAC CE command(s) and/or dynamic DCI based L1 signaling(s) based on or according to corresponding UE's capability(s) or capability signaling(s), S≥1 candidate value(s)/range(s)/configuration(s) for the value(s) of Q and/or Q′. In this case,
In one example, the one or more indicators could correspond to or could be in form of a [log₂S]-bit indicator with each codepoint of the [log₂S]-bit indicator corresponding, associated or specific to a candidate value/range/configuration for the value(s) of Q and/or Q′. For this design example, when/if the [log₂S]-bit indicator is set to a codepoint, the candidate value/range/configuration for the value(s) of Q and/or Q′ associated, corresponding or specific to the codepoint could be indicated or notified to the network.
In another example, the one or more indicators could correspond to or could be in form of a bitmap with each entry/bit position of the bitmap corresponding, associated or specific to a candidate value/range/configuration for the value(s) of Q and/or Q′. For this design example, when/if an entry/bit position of the bitmap is set to ‘1’ (or ‘0’), the candidate value/range/configuration for the value(s) of Q and/or Q′ associated, corresponding or specific to the entry/bit position could be indicated or notified to the network.

The presence or absence of the one or more indicators in (part of) the UEI report(s) and/or the corresponding UEI report content(s)/quantity(s) could be enabled (or disabled) or configured/provided/indicated by the network e.g. via/by/in corresponding higher layer RRC signaling(s)/parameter(s). Additionally, the UEI report(s) and/or the corresponding UEI report content(s)/quantity(s) carried or conveyed by/in/over/on the (DG or CG Type1) PUSCH(s) or PUSCH resource(s) of the second UL channel as in Step-3 of Mode A and/or Mode C and/or Step-2 of Mode B, transmitted or sent in a reporting instance/CSI report, could comprise or contain or include or indicate one or more indicators to indicate which one or more of the M>1 CSI reporting settings could correspond to the reference CSI reporting setting(s) defined/specified herein in the present disclosure.
For another example, the one or more indicators could correspond to or could be in form of a one-bit indicator; in this case, when/if the one-bit indicator is set to ‘1’ (or ‘0’), all of the M>1 CSI reporting settings could correspond to the reference CSI reporting setting(s).
For another example, the one or more indicators could correspond or could be in form of a bitmap with each entry/bit position of the bitmap corresponding or associated to one or more of the M>1 CSI reporting settings; in this case, when/if an entry/bit position of the bitmap is set to ‘1’ (or ‘0’), the CSI reporting setting(s) corresponding to the entry/bit position could correspond to the reference CSI reporting setting(s).

The presence or absence of the one or more indicators in (part of) the UEI report(s) and/or the corresponding UEI report content(s)/quantity(s) could be enabled (or disabled) or configured/provided/indicated by the network e.g. via/by/in corresponding higher layer RRC signaling(s)/parameter(s). According to or following those specified herein in the present disclosure, the UEI report(s) and/or the corresponding UEI report content(s)/quantity(s) carried or conveyed by/in/over/on the (DG or CG Type1) PUSCH(s) or PUSCH resource(s) of the second UL channel as in Step-3 of Mode A and/or Mode C and/or Step-2 of Mode B, transmitted or sent in a reporting instance/CSI report, could comprise or contain or include or indicate one or more indicators to indicate the value(s) of P (defined/specified herein in the present disclosure) and/or the number of the reference CSI reporting setting(s)—denoted by P′—as specified/defined herein in the present disclosure. For instance, the one or more indicators could correspond to or could be in form of the exact value(s) of P and/or P′; optionally or alternatively, the UE could be first provided or configured by the network, e.g., via higher layer RRC signaling(s)/parameter(s) and/or MAC CE command(s) and/or dynamic DCI based L1 signaling(s) based on or according to corresponding UE's capability(s) or capability signaling(s), R≥1 candidate value(s)/range(s)/configuration(s) for the value(s) of P and/or P′. In this case,
In one example, the one or more indicators could correspond to or could be in form of a [log₂R]-bit indicator with each codepoint of the [log₂R]-bit indicator corresponding, associated or specific to a candidate value/range/configuration for the value(s) of P and/or P′. For this design example, when/if the [log₂R]-bit indicator is set to a codepoint, the candidate value/range/configuration for the value(s) of P and/or P′ associated, corresponding or specific to the codepoint could be indicated or notified to the network.
In another example, the one or more indicators could correspond to or could be in form of a bitmap with each entry/bit position of the bitmap corresponding, associated or specific to a candidate value/range/configuration for the value(s) of P and/or P′. For this design example, when/if an entry/bit position of the bitmap is set to ‘1’ (or ‘0’), the candidate value/range/configuration for the value(s) of P and/or P′ associated, corresponding or specific to the entry/bit position could be indicated or notified to the network.

The presence or absence of the one or more indicators in (part of) the UEI report(s) and/or the corresponding UEI report content(s)/quantity(s) could be enabled (or disabled) or configured/provided/indicated by the network e.g. via/by/in corresponding higher layer RRC signaling(s)/parameter(s). The UE could transmit or send the aforementioned one or more indicators, e.g., for indicating
which one or more of the M>1 CSI reporting settings could correspond to the first CSI reporting setting(s), and/or
which one or more of the M>1 CSI reporting settings could correspond to the reference CSI reporting setting(s), and/or
the value(s) of P and/or P′, and/or
the value(s) of Q and/or Q′, and/or etc.
   according to or following those specified or defined herein in the present disclosure, in (part of) the UEI report(s) and/or the corresponding UEI report content(s)/quantity(s) carried or conveyed by/in/over/on the (DG or CG Type1) PUSCH(s) or PUSCH resource(s) of the second UL channel as in Step-3 of Mode A and/or Mode C and/or Step-2 of Mode B transmitted or sent in reporting instance(s)/CSI report(s) associated, corresponding, specific, mapped or linked to one or more of the M>1 CSI reporting settings—denoted by or referred to as one or more target CSI reporting settings. In this case, the UE (and/or the network) could determine or identify the reporting instance(s)/CSI report(s) and/or the target CSI reporting setting(s) according to or based on: (i) fixed rule(s) in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s), following or according to those specified/defined herein in the present disclosure.
In one example, the target CSI reporting setting(s) could correspond to one or more of the M>1 CSI reporting settings and/or the first/reference CSI reporting setting(s) as specified/defined herein in the present disclosure corresponding or associated or specific to the T≥1 earlies (or latest) reporting instance(s)/CSI report(s) in time, among the reporting instance(s)/CSI report(s) associated, linked, mapped, corresponding or specific to the M>1 CSI reporting settings and/or the first/reference CSI reporting setting(s) as specified/defined herein in the present disclosure.
In another example, the UEI report(s) and/or the corresponding UEI report content(s)/quantity(s) carried or conveyed by/in/over/on the (DG or CG Type1) PUSCH(s) or PUSCH resource(s) of the second UL channel as in Step-3 of Mode A and/or Mode C and/or Step-2 of Mode B transmitted or sent in reporting instance(s)/CSI report(s) associated, corresponding, specific, mapped or linked to the target CSI reporting setting(s) could comprise or indicate or contain or include a one-bit (flag) indicators set to ‘1’ (or ‘0’).
In another example, the target CSI reporting setting(s) could correspond to one or more of the M>1 CSI reporting settings and/or the first/reference CSI reporting setting(s) as specified/defined herein in the present disclosure with the T≥1 highest priority(s) and/or highest (or lowest) priority order(s)/value(s) among all the M>1 CSI reporting settings and/or the first/reference CSI reporting setting(s) as specified/defined herein in the present disclosure, wherein a priority order/value could be provided or configured in the higher layer parameter(s)/signaling(s) CSI-ReportConfig and/or UEI-ReportConfig that provides or configures a corresponding CSI reporting setting. For this design example, the UE could determine or identify the value(s) of T according to or based on: (i) fixed value(s), e.g., 1 or 2 or 3 or 4, in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s).
In another example, the target CSI reporting setting(s) could correspond to the first (or last) T≥1 CSI reporting setting(s) and/or the CSI reporting setting(s) with or having the T≥1 highest (or lowest) report setting or configuration ID(s)/index(es) among all the M>1 CSI reporting settings and/or the first/reference CSI reporting setting(s) as specified/defined herein in the present disclosure, wherein the UE could determine or identify the value(s) of T according to or based on: (i) fixed value(s), e.g., 1 or 2 or 3 or 4, in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s).
In another example, the target CSI reporting setting(s) could correspond to the CSI reporting setting(s) with or having the T≥1 highest (or lowest) payload size(s) or payload size information for CSI/beam reporting among all the M>1 CSI reporting settings and/or the first/reference CSI reporting setting(s) as specified/defined herein in the present disclosure, wherein the UE could determine or identify the value(s) of T according to or based on: (i) fixed value(s), e.g., 1 or 2 or 3 or 4, in system specification(s) and/or per RRC (re-)configuration, (ii) network's configuration(s) and/or indication(s), e.g., via higher layer RRC signaling(s)/parameter(s) and/or MAC CE command(s) and/or dynamic DCI based LI signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s).
In another example, the target CSI reporting setting(s) could correspond to the odd (or even) indexed/ordered CSI reporting setting(s) and/or the CSI reporting setting(s) with or having odd (or even) report setting or configuration ID(s)/index(es) among all the M>1 CSI reporting settings and/or the first/reference CSI reporting setting(s) as specified/defined herein in the present disclosure.
In another example, the UE could receive from the network, e.g., via/by/in higher layer RRC signaling(s)/parameter(s) e.g. CSI-ReportConfig and/or UEI-ReportConfig that provides or configures necessary information and/or setting(s) for the UE-initiated/event-driven beam reporting and/or MAC CE command(s) and/or dynamic DCI based L1 signaling(s) based on or according to corresponding UE's capability(s) or capability signaling(s), one or more indicators to indicate which of the M>1 CSI reporting settings and/or the first/reference CSI reporting setting(s) as specified/defined herein in the present disclosure could correspond to the target CSI reporting setting(s). For example, the one or more indicators could correspond to or could be in form of a one-bit indicator; in this case, when/if the one-bit indicator is set to ‘1’ (or ‘0’), all of the M>1 CSI reporting settings and/or the first/reference CSI reporting setting(s) as specified/defined herein in the present disclosure could correspond to the target CSI reporting setting(s). For another example, the one or more indicators could correspond or could be in form of a bitmap with each entry/bit position of the bitmap corresponding or associated to one or more of the M>1 CSI reporting settings and/or the first/reference CSI reporting setting(s) as specified/defined herein in the present disclosure; in this case, when/if an entry/bit position of the bitmap is set to ‘1’ (or ‘0’), the (first or reference) CSI reporting setting(s) corresponding to the entry/bit position could correspond to the target CSI reporting setting(s).
In another example, the UE could transmit or send to the network, in (part of) the UEI report(s) e.g. via/by/in (part or form of) a/the PN message/trigger (or equivalently, a/the UEITI) transmitted or sent in/by/via/on/over the PUCCH(s)/PUCCH resource(s) of the first UL channel as in Step-1 of Mode A, Mode B and/or Mode C, one or more indicators to indicate which one or more of the M>1 CSI reporting settings and/or the first/reference CSI reporting setting(s) as specified/defined herein in the present disclosure could correspond to the target CSI reporting setting(s).
   For example, according to or following those specified or defined herein in the present disclosure, a cyclic shift index/cyclic shift associated, corresponding or specific to or for a PUCCH or a PUCCH resource or a PUCCH transmission occasion that carries or conveys a/the PN message/trigger or a/the PN message/trigger (or equivalently a/the UEITI) transmission occasion of a/the PUCCH/PUCCH resource of the first UL channel as in Step-1 of Mode A, Mode B and/or Mode C could be associated, linked, corresponding or mapped to one or more CSI reporting settings each provided by CSI-ReportConfig and/or UEI-ReportConfig that provides or configures necessary information and/or setting(s) for the UE-initiated/event-driven beam reporting as specified/defined herein in the present disclosure. For this design example, to indicate which one or more of the M>1 CSI reporting settings and/or the first/reference CSI reporting setting(s) as specified/defined herein in the present disclosure correspond to the target CSI reporting setting(s), the UE could send or transmit or indicate to the network, the PN message/trigger (or equivalently the UEITI), via/by/in/on/over PUCCH(s) or PUCCH resource(s) or PUCCH transmission occasion(s) of the first UL channel as in Step-1 of Mode A, Mode B and/or Mode C that is having/using/applying, associated, mapped, corresponding, linked or specific to the cyclic shift/cyclic shift index associated, linked, corresponding or mapped to the one or more target CSI reporting settings. In this case, the one or more indicators could correspond to or could be in form of the cyclic shift/cyclic shift index.
   For another example, the one or more indicators could correspond to or could be in form of a one-bit indicator; in this case, when/if the one-bit indicator is set to ‘1’ (or ‘0’), all of the M>1 CSI reporting settings and/or the first/reference CSI reporting setting(s) as specified/defined herein in the present disclosure could correspond to the target CSI reporting setting(s).
   For another example, the one or more indicators could correspond or could be in form of a bitmap with each entry/bit position of the bitmap corresponding or associated to one or more of the M>1 CSI reporting settings and/or the first/reference CSI reporting setting(s) as specified/defined herein in the present disclosure; in this case, when/if an entry/bit position of the bitmap is set to ‘1’ (or ‘0’), the (first or reference) CSI reporting setting(s) corresponding to the entry/bit position could correspond to the target CSI reporting setting(s).
   For this design example, presence or absence of the one or more indicators in (part of) the UEI report(s) could be enabled (or disabled) or configured/provided/indicated by the network e.g. via/by/in corresponding higher layer RRC signaling(s)/parameter(s).

According to or following those specified herein in the present disclosure, the UE could transmit or send to the network, in (part of) the UEI report(s) e.g. via/by/in (part or form of) a/the PN message/trigger (or equivalently, a/the UEITI) transmitted or sent in/by/via/on/over the PUCCH(s)/PUCCH resource(s) of the first UL channel as in Step-1 of Mode A, Mode B and/or Mode C, one or more indicators to indicate the value(s) of T, and/or the number of the target CSI reporting setting(s)—denoted by T′—as specified/defined herein in the present disclosure. For instance, the one or more indicators could correspond to or could be in form of the exact value(s) of T and/or T′; optionally or alternatively, the UE could be first provided or configured by the network, e.g., via higher layer RRC signaling(s)/parameter(s) and/or MAC CE command(s) and/or dynamic DCI based L1 signaling(s) based on or according to corresponding UE's capability(s) or capability signaling(s) V≥1 candidate value(s)/range(s)/configuration(s) for the value(s) of T and/or T′. In this case,
In one example, the one or more indicators could correspond to or could be in form of a [log 2V]-bit indicator with each codepoint of the [log 2V]-bit indicator corresponding, associated or specific to a candidate value/range/configuration for the value(s) of T and/or T′. For this design example, when/if the [log 2V]-bit indicator is set to a codepoint, the candidate value/range/configuration for the value(s) of T and/or T′ associated, corresponding or specific to the codepoint could be indicated or notified to the network.
In another example, the one or more indicators could correspond to or could be in form of a bitmap with each entry/bit position of the bitmap corresponding, associated or specific to a candidate value/range/configuration for the value(s) of T and/or T′. For this design example, when/if an entry/bit position of the bitmap is set to ‘1’ (or ‘0’), the candidate value/range/configuration for the value(s) of T and/or T′ associated, corresponding or specific to the entry/bit position could be indicated or notified to the network.
In another example, a cyclic shift index/cyclic shift associated, corresponding or specific to or for a PUCCH or a PUCCH resource or a PUCCH transmission occasion that carries or conveys a/the PN message/trigger or a/the PN message/trigger (or equivalently a/the UEITI) transmission occasion of a/the PUCCH/PUCCH resource of the first UL channel as in Step-1 of Mode A, Mode B and/or Mode C could be associated, linked, corresponding or mapped to one or more candidate values/ranges/configurations for the value(s) of T and/or T′. For this design example, to indicate a candidate value/range/configuration for the value(s) of T and/or T′, the UE could send or transmit or indicate to the network, the PN message/trigger (or equivalently the UEITI), via/by/in/on/over PUCCH(s) or PUCCH resource(s) or PUCCH transmission occasion(s) of the first UL channel as in Step-1 of Mode A, Mode B and/or Mode C that is having/using/applying, associated, mapped, corresponding, linked or specific to the cyclic shift/cyclic shift index associated, linked, corresponding or mapped to the candidate value/range/configuration for the value(s) of T and/or T′. In this case, the one or more indicators could correspond to or could be in form of the cyclic shift/cyclic shift index.

The presence or absence of the one or more indicators in (part of) the UEI report(s) could be enabled (or disabled) or configured/provided/indicated by the network e.g. via/by/in corresponding higher layer RRC signaling(s)/parameter(s).

According to or following those specified/defined herein in the present disclosure, the UEI report(s) and/or the corresponding UEI report content(s)/quantity(s) carried or conveyed by/in/over/on the (DG or CG Type1) PUSCH(s) or PUSCH resource(s) of the second UL channel as in Step-3 of Mode A and/or Mode C and/or Step-2 of Mode B transmitted or sent in reporting instance(s)/CSI report(s) associated, corresponding, specific, mapped or linked to one or more of the one or more CSI reporting settings—e.g., the first CSI reporting setting(s), the reference CSI reporting setting(s) and/or the target CSI reporting setting(s)—associated, linked, mapped, corresponding or specific to the PUCCH or the PUCCH resource or the PUCCH transmission occasion that carries or conveys a/the PN message/trigger or a/the PN message/trigger (or equivalently a/the UEITI) transmission occasion of the PUCCH/PUCCH resource of the first UL channel as in Step-1 of Mode A, Mode B and/or Mode C could comprise, indicate, contain, include or provide a one-bit indicator. In this case, when/if the one-bit indicator is set to ‘1’ (or ‘0’), the one or more indicators as specified/defined herein in the present disclosure (e.g., the one or more indicators described, defined or specified in the aforementioned design examples) could be present in the UEI report(s) and/or the corresponding UEI report content(s)/quantity(s). Otherwise, i.e., when/if the one-bit indicator is set to ‘0’ (or ‘1’), the one or more indicators as specified/defined herein in the present disclosure could be absent in the corresponding UEI report(s) and/or UEI report content(s)/quantity(s).

According to or following those specified/defined herein in the present disclosure, the UE could determine or identify the value(s) of P′—i.e., the number of the reference CSI reporting setting(s) as specified/defined herein in the present disclosure, the value(s) of Q′—i.e, the number of the first CSI reporting setting(s) as specified/defined herein in the present disclosure, and/or the value(s) of T′—i.e., the number of the target CSI reporting setting(s) as specified/defined herein in the present disclosure, according to or based on: (i) fixed value(s), e.g., 1 or 2 or 3 or 4, in system specification(s) and/or per RRC configuration, (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s).

Furthermore, separate UEI reports (and therefore the corresponding UEI report contents/quantities) carried or conveyed by/in/over/on the (DG or CG Type1) PUSCHs/PUSCH resources of the second UL channel as in Step-3 of Mode A and/or Mode C and/or Step-2 of Mode B, transmitted or sent in their corresponding or respective different/separate reporting instances/CSI reports could comprise or contain or include or indicate a/the same or identical ID(s)/index(es)—e.g., a/the same or identical reporting setting ID(s)/index(es) and/or event ID(s)/index(es) and/or carrier/CC ID(s)/index(es)—according to or following those specified or defined herein in the present disclosure; in this case, the report quantity(s) in (part of) a first UEI report (and therefore the corresponding UEI report content(s)/quantity(s)) and the report quantity(s) in (part of) a second UEI report (and therefore the corresponding UEI report content(s)/quantity(s)) separate from the first UEI report could be the same or identical or repetitions as/to each other(s). Optionally, a reporting instance/CSI report that carries or conveys the UEI report(s) and/or the corresponding UEI report content(s)/quantity(s) could be in form of a two-part UCI/CSI depending on or according to network's configuration(s)/indication(s) subject to or based on corresponding UE's capability(s) or capability signaling(s); in this case, part 1 of the two-part UCI/CSI could comprise, indicate, contain, include or provide the one or more IDs/indexes and/or the one or more indicators, e.g., for indicating
which one or more of the M>1 CSI reporting settings could correspond to the first CSI reporting setting(s), and/or
which one or more of the M>1 CSI reporting settings could correspond to the reference CSI reporting setting(s), and/or
which one or more of the M>1 CSI reporting settings could correspond to the target CSI reporting setting(s), and/or
the value(s) of P and/or P′, and/or
the value(s) of Q and/or Q′, and/or
the value(s) of T and/or T′, and/or etc.
   as specified/defined herein in the present disclosure.

According to or following those specified or defined herein in the present disclosure, a UE could transmit or send a PN message/trigger (or a UEITI) via/by/in/on/over one or more PUCCHs/PUCCH resources of the first UL channel as in Step-1 of Mode A, Mode B and/or Mode C, wherein the PN message/trigger or the UEITI or the one or more PUCCHs/PUCCH resources of the first UL channel that carry or convey the PN message/trigger (or equivalently, the UEITI) transmission occasion(s) could be associated or linked to one or more CSI reporting settings each associated or linked to one or more events and/or one or more carriers/CCs according to or following those specified herein in the present disclosure. Furthermore, the UE could be configured or indicated or provided by the network, e.g., by/via/in a higher layer RRC parameter UEI-AperiodicTriggerStateList, a list of trigger state(s) comprising one or more trigger states (dedicated) for the UEI beam reporting as specified/defined herein in the present disclosure; in this case, each of the trigger state(s) provided, configured, included, contained or comprised in the list of trigger state(s) e.g. provided by the higher layer RRC parameter UEI-AperiodicTriggerStateList could be associated, linked, mapped, specific or corresponding to one or more CSI reporting settings (dedicated) for the UEI beam reporting as specified/defined herein in the present disclosure each associated or linked to one or more events and/or one or more carriers/CCs according to or following those specified herein in the present disclosure. In this case, the one or more CSI reporting settings associated or linked to the PN message/trigger or the UEITI or the one or more PUCCHs/PUCCH resources of the first UL channel that carry or convey the PN message/trigger (or equivalently, the UEITI) transmission occasion(s) could correspond to one or more (or a subset) of one or more CSI reporting settings associated, linked, mapped, specific or corresponding to at least one trigger state as defined/specified herein in the present disclosure.

Throughout the present disclosure, a candidate beam is equivalent to a candidate new beam or a new beam, and a beam/“beam” reported in a UEI (beam) report or a CSI report or a beam report in general can also be referred to as or equivalent to a report content/quantity—including SSBRI/CRI, L1-RSRP/L1-SINR and/or etc.-corresponding/associated/specific to a beam reported in a UEI (beam) report or a CSI report or a beam report in general, and/or one or more report contents/quantities—including SSBRI(s)/CRI(s), L1-RSRP(s)/L1-SINR(s) and/or etc.-corresponding/associated/specific to a beam reported in a UEI (beam) report or a CSI report or a beam report in general, and/or a resource indicator such as a SSBRI or a CRI reported in a UEI (beam) report or a CSI report or a beam report in general, and/or a beam metric such as a L1-RSRP or a L1-SINR reported in a UEI (beam) report or a CSI report or a beam report in general. In addition, throughout the present disclosure, a reference signal(S) could be equivalent to a RS resource, a RS resource index, a RS resource configuration index, a RS index and/or etc. A/the higher layer parameter CSI-ReportConfig and/or UEI-ReportConfig could correspond to or could be equivalent to or referred to a/the higher layer parameter CSI-AssociatedReportConfigInfo, and vice versa, such that they could be used or applied in an exchangeable or in similar/same manner(s) throughout the present disclosure. Additionally, a CSI reporting setting not (dedicated) for the UE-initiated/event-driven beam reporting as specified/defined herein in the present disclosure could correspond to or could be equivalent to or could be referred to a CSI reporting setting for (legacy) aperiodic CSI/beam reporting or a CSI reporting setting for L1/L2 triggered mobility (LTM), and vice versa. In addition, a CSI reporting setting corresponding to another CSI reporting setting could be equivalent to the CSI reporting setting comprising, containing, including and/or providing the another CSI reporting setting.

According to those specified/defined herein in the present disclosure, a UE could be provided or indicated or configured by the network via/by/in higher layer RRC signaling(s)/parameter(s) and/or MAC CE command(s) and/or dynamic DCI based L1 signaling(s) based on or according to a corresponding UE's capability or capability signaling, a set/list of one or more first CSI reporting settings each provided by e.g. CSI-ReportConfig and/or UEI-ReportConfig that provides or includes or comprises necessary information and/or setting(s) for the UE-initiated/event-driven beam reporting according to those specified/defined herein in the present disclosure, wherein the one or more first CSI reporting settings could be ordered in the set/list according to their corresponding CSI report configuration IDs/indexes in an ascending/descending order.
In one example, the higher layer parameter(s)/signaling(s) CSI-ReportConfig and/or UEI-ReportConfig that provides or configures each of the first CSI reporting setting(s) could provide or configure one or more PUCCH resources e.g. in terms/form of the corresponding PUCCH resource ID(s)/index(es). In this case, a PUCCH resource of the first UL channel as in Step-1 of Mode A, Mode B and/or Mode C could be associated, linked, mapped or corresponding to one or more first CSI reporting settings ordered according to the corresponding CSI report configuration ID(s)/index(es) in an ascending or descending order.
In another example, the set/list of one or more first CSI reporting settings provided by e.g. ReportConfigInfoList having a corresponding set/list ID/index could be provided or configured or comprised in a second CSI reporting setting provided by e.g. CSI-ReportConfig and/or UEI-ReportConfig that provides or includes or comprises necessary information and/or setting(s) for the UE-initiated/event-driven beam reporting according to those specified/defined herein in the present disclosure, wherein the second CSI reporting setting could provide or configure one or more PUCCH resources e.g. in terms/form of the corresponding PUCCH resource ID(s)/index(es). In this case, a PUCCH resource of the first UL channel as in Step-1 of Mode A, Mode B and/or Mode C could be associated, linked, mapped or corresponding to one or more second CSI reporting settings each providing or configuring or comprising a/the same set/list, hence, the PUCCH resource of the first UL channel as in Step-1 of Mode A, Mode B and/or Mode C could be associated, linked, mapped or corresponding to the first CSI reporting setting(s) in a/the same set/list.
In another example, the set/list of one or more first CSI reporting settings provided by e.g. ReportConfigInfoList could be associated, linked, mapped or corresponding to a trigger state pointing to an entry of a list of higher layer configured list of trigger states provided by CSI-TriggerStates-List. The trigger state could be provided or configured or comprised in a second CSI reporting setting provided by e.g. CSI-ReportConfig and/or UEI-ReportConfig that provides or includes or comprises necessary information and/or setting(s) for the UE-initiated/event-driven beam reporting according to those specified/defined herein in the present disclosure, wherein the second CSI reporting setting could provide or configure one or more PUCCH resources e.g. in terms/form of the corresponding PUCCH resource ID(s)/index(es). In this case, a PUCCH resource of the first UL channel as in Step-1 of Mode A, Mode B and/or Mode C could be associated, linked, mapped or corresponding to one or more second CSI reporting settings each providing or configuring or comprising a/the same trigger state, hence, the PUCCH resource of the first UL channel as in Step-1 of Mode A, Mode B and/or Mode C could be associated, linked, mapped or corresponding to the first CSI reporting setting(s) associated or linked or mapped or corresponding to a/the same trigger state.

For the above described design examples, the UE could transmit or send a PN message/trigger over/in/on a PUCCH resource or PUCCH transmission occasion (TO) of the first UL channel as in Step-1 of Mode A, Mode B and/or Mode C. The UE could determine or identify one or more first CSI reporting settings associated, linked, mapped or corresponding the PUCCH resource or PUCCH TO according to or following those specified/defined herein in the present disclosure. The UE could transmit or send a beam/CSI report over/in/on one or more PUSCH resources of the second UL channel as in Step-3 of Mode A and/or Mode C and/or Step-2 of Mode B, wherein the one or more PUSCH resources of the second UL channel could be associated, linked, mapped or corresponding to the PUCCH resource or PUCCH TO of the first UL channel. In this case, the beam/CSI report could comprise or include or provide or indicate an indicator to indicate one or more of the first CSI reporting setting(s). Furthermore, to indicate one of the first CSI reporting setting(s),
In one example, the indicator could be in form/terms of a/the CSI report configuration ID/index of the first CSI reporting setting.
In another example, the indicator could be a [log₂K]-bit indicator with K corresponding to the number of the first CSI reporting setting(s) associated, linked or mapped or corresponding to the PUCCH resource or PUCCH TO. In this case, the indicator could be set to a codepoint of the [log₂K]-bit indicator to indicate the first CSI reporting setting.

According to those specified or defined herein in the present disclosure, a UEI CSI/beam report sent or carried or conveyed in PUSCH resource(s) or transmission occasion(s) of the second UL channel as in Step-3 of Mode A/C and/or Step-2 of Mode B could comprise one or more indicators denoted by event condition met indicators each associated or corresponding or specific to a reported beam (e.g., in form of a resource indicator such as a CRI or a SSBRI and/or a corresponding quality metric such as a (differential) RSRP) in the UEI CSI/beam report to indicate whether the reported beam satisfies or meets the triggering event condition(s) and/or determines a/the event(s), wherein according to those specified herein in the present disclosure, the reported beam could correspond to a candidate/new beam RS or RS resource selected or determined or identified from a set or list or pool of candidate/new beam RSs or RS resources or RS resource IDs/indexes higher layer configured or provided by the network. Furthermore, an event condition met indicator can be set to a value of ‘1’ as shown in Table 6. Regarding the CSI report configuration indicator in Table 6, when/if

$${K}_{S}^{CSI\_config} = 1 ,$$

i.e., the PUCCH indicating the UEI CSI/beam report or carrying/conveying the PN message/trigger (or denoted by a UEI beam report indication (UEIBRI) or a beam report indicator (BRI)) is associated with only one CSI report configuration (i.e., one-to-one mapping), the CSI report configuration indicator can be of value 0.

TABLE 6

| Field | Bitwidth |
|---|---|
| CRI | $⌈ {log}_{2} ( {K}_{s}^{CSI - RS} ) ⌉$ |
| SSBRI | $⌈ {log}_{2} ( {K}_{s}^{SSB} ) ⌉$ |
| RSRP | 7 |
| Differential RSRP | 4 |
| CSI report configuration indicator | $⌈ {log}_{2} ( {K}_{s}^{CSI \_ config} ) ⌉$ |
| Event condition met indicator | 1 |

NOTE:
${K}_{s}^{CSI - RS} is the number of CSI - RS resources in the corresponding$ $resource set , {K}_{s}^{SSB} is the configured number of SS / PBCH blocks in$ the corresponding resource set for reporting ‘ssb-Index-RSRP’ or ‘ssb-Index-
$RSRP - {Index}^{′} , {K}_{s}^{CSI \_ config} is the number of CSI report configurations$ associated with the PUCCH indicating the UEI CSI/beam report or
carrying/conveying the PN message/trigger (or denoted by a UEI beam
report indication (UEIBRI) or a beam report indicator (BRI)).

According to those specified/defined herein in the present disclosure, the UEI report content(s)/quantity(s) of a UEI CSI/beam report could comprise those provided in Table 7a or Table 7b or Table 7c.

TABLE 7a
An example of mapping order of CSI fields
of one UE-initiated (UEI) CSI/beam report

| CSI | |
|---|---|
| report | |
| number | CSI fields |
| CSI | CSI report configuration indicator as in Table 6 |
| report | CRI or SSBRI #1 as in Table 6, if reported or if Event condition |
| #n | met indicator #1 is reported |
| | CRI or SSBRI #2 as in Table 6, if reported or if Event condition |
| | met indicator #2 is reported |
| | CRI or SSBRI #3 as in Table 6, if reported or if Event condition |
| | met indicator #3 is reported |
| | CRI or SSBRI #4 as in Table 6, if reported or if Event condition |
| | met indicator #4 is reported |
| | RSRP #1 as in Table 6, if reported or if Event condition met |
| | indicator #1 is reported |
| | Differential RSRP #2 as in Table 6, if reported or if Event |
| | condition met indicator #2 is reported |
| | Differential RSRP #3 as in Table 6, if reported or if Event |
| | condition met indicator #3 is reported |
| | Differential RSRP #4 as in Table 6, if reported or if Event |
| | condition met indicator #4 is reported |
| | Event condition met indicator #1 in Table 6, if reported |
| | Event condition met indicator #2 in Table 6, if reported |
| | Event condition met indicator #3 in Table 6, if reported |
| | Event condition met indicator #4 in Table 6, if reported |
| | Differential RSRP for the current beam RS as specified/defined |
| | herein in the present disclosure, if reported |

NOTE:
The CSI report configuration indicator with value i indicates the (i + 1)-th CSI report configuration among the CSI report configurations associated with the PUCCH indicating the UEI CSI/beam report or carrying/conveying the PN message/trigger or UEIBRI or BRI which are ordered in ascending order of CSI-ReportConfigId. Here, the CSI report configuration indicated by the CSI report configuration indicator could be configured with a higher layer parameter eventType-r19 set to ‘event-1’, ‘event-2’, ‘event-3’ and etc. respectively corresponding to the first event, second event, third event and etc. specified/defined herein in the present disclosure. The event condition met indicators are reported only when the UE is configured with higher layer parameter PresenceOfEventConditionMetIndicator. Differential RSRP for the current beam RS as specified/defined herein in the present disclosure is reported only when the UE is configured with higher layer parameter enabledCurrentBeamReport-r19.

TABLE 7b
An example of mapping order of CSI fields
of one UE-initiated (UEI) CSI/beam report

| CSI | |
|---|---|
| report | |
| number | CSI fields |
| CSI | CSI report configuration indicator as in Table 6 |
| report | CRI or SSBRI #1 as in Table 6 |
| #n | CRI or SSBRI #2 as in Table 6, if reported |
| | CRI or SSBRI #3 as in Table 6, if reported |
| | CRI or SSBRI #4 as in Table 6, if reported |
| | RSRP #1 as in Table 6 |
| | Differential RSRP #2 as in Table 6, if reported |
| | Differential RSRP #3 as in Table 6, if reported |
| | Differential RSRP #4 as in Table 6, if reported |
| | Event condition met indicator #1 in Table 6, if reported |
| | Event condition met indicator #2 in Table 6, if reported |
| | Event condition met indicator #3 in Table 6, if reported |
| | Event condition met indicator #4 in Table 6, if reported |
| | Differential RSRP for the current beam RS as specified/defined |
| | herein in the present disclosure, if reported |

NOTE:
The CSI report configuration indicator with value i indicates the (i + 1)-th CSI report configuration among the CSI report configurations associated with the PUCCH indicating the UEI CSI/beam report or carrying/conveying the PN message/trigger or UEIBRI or BRI which are ordered in ascending order of CSI-ReportConfigId. Here, the CSI report configuration indicated by the CSI report configuration indicator could be configured with a higher layer parameter eventType-r19 set to ‘event-1’, ‘event-2’, ‘event-3’ and etc. respectively corresponding to the first event, second event, third event and etc. specified/defined herein in the present disclosure. The event condition met indicators are reported only when the UE is configured with higher layer parameter PresenceOfEventConditionMetIndicator. Differential RSRP for the current beam RS as specified/defined herein in the present disclosure is reported only when the UE is configured with higher layer parameter enabledCurrentBeamReport-r19.

TABLE 7c
An example of mapping order of CSI fields
of one UE-initiated (UEI) CSI/beam report

| CSI | |
|---|---|
| report | |
| number | CSI fields |
| CSI | CSI report configuration indicator as in Table 6 |
| report | CRI or SSBRI #1 as in Table 6 |
| #n | CRI or SSBRI #2 as in Table 6, if reported |
| | CRI or SSBRI #3 as in Table 6, if reported |
| | CRI or SSBRI #4 as in Table 6, if reported |
| | RSRP #1 as in Table 6 |
| | Differential RSRP #2 as in Table 6, if reported |
| | Differential RSRP #3 as in Table 6, if reported |
| | Differential RSRP #4 as in Table 6, if reported |
| | Event condition met indicator #1 in Table 6 or 0, if reported |
| | Event condition met indicator #2 in Table 6 or 0, if reported |
| | Event condition met indicator #3 in Table 6 or 0, if reported |
| | Event condition met indicator #4 in Table 6 or 0, if reported |
| | Differential RSRP for the current beam RS as specified/defined |
| | herein in the present disclosure, if reported |

NOTE:
The CSI report configuration indicator with value i indicates the (i + 1)-th CSI report configuration among the CSI report configurations associated with the PUCCH indicating the UEI CSI/beam report or carrying/conveying the PN message/trigger or UEIBRI or BRI which are ordered in ascending order of CSI-ReportConfigId. Here, the CSI report configuration indicated by the CSI report configuration indicator could be configured with a higher layer parameter eventType-r19 set to ‘event-1’, ‘event-2’, ‘event-3’ and etc. respectively corresponding to the first event, second event, third event and etc. specified/defined herein in the present disclosure. The event condition met indicators are reported only when the UE is configured with higher layer parameter PresenceOfEventConditionMetIndicator. Differential RSRP for the current beam RS as specified/defined herein in the present disclosure is reported only when the UE is configured with higher layer parameter enabledCurrentBeamReport-r19.

TABLE 7d
An example of mapping order of CSI fields
of one UE-initiated (UEI) CSI/beam report

| CSI report | |
|---|---|
| number | CSI fields |
| CSI report | CSI report configuration indicator as in Table 6 |
| #n | CRI or SSBRI #1 as in Table 6 |
| | CRI or SSBRI #2 as in Table 6, if reported |
| | CRI or SSBRI #3 as in Table 6, if reported |
| | CRI or SSBRI #4 as in Table 6, if reported |
| | RSRP #1 as in Table 6 |
| | Differential RSRP #2 as in Table 6, if reported |
| | Differential RSRP #3 as in Table 6, if reported |
| | Differential RSRP #4 as in Table 6, if reported |
| | Event condition met indicator #1 in Table 6, if reported |
| | Event condition met indicator #2 in Table 6, if reported |
| | Event condition met indicator #3 in Table 6, if reported |
| | Event condition met indicator #4 in Table 6, if reported |
| | Differential RSRP for the current beam, if reported |
| | Zero padding bits O_{P}, if needed |

NOTE:
The CSI report configuration indicator with value i indicates the (i + 1)-th CSI report configuration among the CSI report configurations associated with the PUCCH carrying the PN message/trigger or UEIBRI or BRI which are ordered in ascending order of CSI-ReportConfigID. The event condition met indicators are reported only when the UE is configured with higher layer parameter PresenceOfEventConditionMetIndicator. Differential RSRP for the current beam is reported only when the UE is configured with higher layer parameter enabledCurrentBeamReport-r19. Current beam is the reference signal in the indicated TCI state or the SS/PBCH block which is QCLed with the reference signal in the indicated TCI state. When nrofReportedRS-UEIBR-r19 = 1, the Event condition indicator #1 may not be present even though/when the UE is configured with higher layer parameter PresenceOfEventConditionIndicator.

The number of zero padding bits Op in Table 7d is 0 if there is only one CSI report configuration associated with the PUCCH carrying the PN message/trigger or UEIBRI or BRI; otherwise Oₚ=Nₘₐₓ-N_{reported}, where:

$${N}_{max} = {max}_{i ∈ S} ( {N}_{i} ) ,$$

where S is the set of CSI report configurations associated with the PUCCH carrying the PN message/trigger or UEIBRI or BRI, and Nᵢ is the payload size of the report for the i-th CSI report configuration, obtained according to Table 7d prior to padding; regarding determination of Nᵢ
   For N=1, where Nis provided by nrofReportedRS-UEIBR-r19 in the i-th CSI report configuration, the report for the i-th CSI report configuration could then comprise one or more of:
      The CSI report configuration indicator
      CRI or SSBRI #1
      RSRP #1
      Event condition met indicator #1 when the UE is configured with higher layer parameter PresenceOfEventConditionIndicator
      Differential RSRP for the current beam when the UE is configured with higher layer parameter enabledCurrentBeamReport-r19,
      which could determine the corresponding payload size of Nᵢ.
   For N>1, where Nis provided by nrofReportedRS-UEIBR-r19 in the i-th CSI report configuration, the report for the i-th CSI report configuration could then comprise one or more of:
      The CSI report configuration indicator
      CRI or SSBRI #k, where k=1, . . . , N−1
      (Differential) RSRP #k, where k=1, . . . , N−1
      Event condition met indicator #p, when the UE is configured with higher layer parameter PresenceOfEventConditionMetIndicator, where p∈P, and P is the set comprising one or more values of {1, . . . , N−1} or P is a subset of {1, . . . , N−1}; the reference signal corresponding to CRI or SSBRI #p and/or (differential) RSRP #p could satisfy the event condition(s) and/or determine the corresponding event(s), and/or the reference signal corresponding to CRI or SSBRI #q and/or (differential) RSRP #q may not satisfy the event condition(s) and/or determine the corresponding event(s), where q∈{1, . . . , N−1} and q∉P
      Differential RSRP for the current beam when the UE is configured with higher layer parameter enabledCurrentBeamReport-r19,
   which could determine the corresponding payload size of Nᵢ.
N_{reported} is the payload size of the current report, obtained according to Table 7d prior to padding.

For N=1, where N is provided by nrofReportedRS-UEIBR-r19 in the current CSI report configuration that provides or configures necessary information and/or setting(s) for the current report, the current report for the current CSI report configuration could then comprise one or more of:

The CSI report configuration indicator
CRI or SSBRI #1
RSRP #1
Event condition met indicator #1 when the UE is configured with higher layer parameter PresenceOfEventConditionIndicator
Differential RSRP for the current beam when the UE is configured with higher layer parameter enabledCurrentBeamReport-r19,
which could determine the corresponding payload size of N_{reported}.

For N>1, where N is provided by nrofReportedRS-UEIBR-r19 in the current CSI report configuration that provides or configures necessary information and/or setting(s) for the current report, the current report for the current CSI report configuration could then comprise one or more of:
The CSI report configuration indicator
CRI or SSBRI #k, where k=1, . . . , N−1
(Differential) RSRP #k, where k=1, . . . , N−1
Event condition met indicator #p, when the UE is configured with higher layer parameter PresenceOfEventConditionMetIndicator, where p∈P, and P is the set comprising one or more values of {1, . . . , N−1} or P is a subset of {1, . . . , N−1}; the reference signal corresponding to CRI or SSBRI #p and/or (differential) RSRP #p could satisfy the event condition(s) and/or determine the corresponding event(s), and/or the reference signal corresponding to CRI or SSBRI #q and/or (differential) RSRP #q may not satisfy the event condition(s) and/or determine the corresponding event(s), where q∈{1, . . . , N−1} and q∉P
Differential RSRP for the current beam when the UE is configured with higher layer parameter enabledCurrentBeamReport-r19,
which could determine the corresponding payload size of N_{reported}.

TABLE 7e
An example of mapping order of CSI fields
of one UE-initiated (UEI) CSI/beam report

| CSI | |
|---|---|
| report | |
| number | CSI fields |
| CSI | CSI report configuration indicator as in Table 6 |
| report | CRI or SSBRI #1 as in Table 6 |
| #n | CRI or SSBRI #2 as in Table 6, if reported |
| | CRI or SSBRI #3 as in Table 6, if reported |
| | CRI or SSBRI #4 as in Table 6, if reported |
| | RSRP #1 as in Table 6 |
| | Differential RSRP #2 as in Table 6, if reported |
| | Differential RSRP #3 as in Table 6, if reported |
| | Differential RSRP #4 as in Table 6, if reported |
| | Event condition met indicator #1 in Table 6 or 0, if reported |
| | Event condition met indicator #2 in Table 6 or 0, if reported |
| | Event condition met indicator #3 in Table 6 or 0, if reported |
| | Event condition met indicator #4 in Table 6 or 0, if reported |
| | Differential RSRP for the current beam, if reported |
| | Zero padding bits O_{P}, if needed |

NOTE:
The CSI report configuration indicator with value i indicates the (i + 1)-th CSI report configuration among the CSI report configurations associated with the PUCCH carrying the PN message/trigger or UEIBRI or BRI which are ordered in ascending order of CSI-ReportConfigID. The event condition met indicators are reported only when the UE is configured with higher layer parameter PresenceOfEventConditionMetIndicator. Differential RSRP for the current beam is reported only when the UE is configured with higher layer parameter enabledCurrentBeamReport-r19. Current beam is the reference signal in the indicated TCI state or the SS/PBCH block which is QCLed with the reference signal in the indicated TCI state. When an Event condition met indicator is not present in the corresponding CSI field even though/when the UE is configured with higher layer parameter PresenceOfEventConditionIndicator, the corresponding CSI field could comprise, contain, include, provide or indicate a zero. When nrofReportedRS-UEIBR-r19 = 1, the Event condition indicator #1 may not be present even though/when the UE is configured with higher layer parameter PresenceOfEventConditionIndicator.

The number of zero padding bits Oₚ in Table 7e is 0 if there is only one CSI report configuration associated with the PUCCH carrying the PN message/trigger or UEIBRI or BRI; otherwise Oₚ=Nₘₐₓ−N_{reported}, where:

$${N}_{max} = {max}_{i ∈ S} ( {N}_{i} ) ,$$

where S is the set of CSI report configurations associated with the PUCCH carrying the PN message/trigger or UEIBRI or BRI, and Nᵢ is the payload size of the report for the i-th CSI report configuration, obtained according to Table 7e prior to padding; regarding determination of Nᵢ
   For N=1, where Nis provided by nrofReportedRS-UEIBR-r19 in the i-th CSI report configuration, the report for the i-th CSI report configuration could then comprise one or more of:
      The CSI report configuration indicator
      CRI or SSBRI #1
      RSRP #1
      Event condition met indicator #1 when the UE is configured with higher layer parameter PresenceOfEventConditionIndicator
      Differential RSRP for the current beam when the UE is configured with higher layer parameter enabledCurrentBeamReport-r19,
      which could determine the corresponding payload size of Nᵢ.
   For N>1, where Nis provided by nrofReportedRS-UEIBR-r19 in the i-th CSI report configuration, the report for the i-th CSI report configuration could then comprise one or more of:
      The CSI report configuration indicator
      CRI or SSBRI #k, where k=1, . . . , N−1
      (Differential) RSRP #k, where k=1, . . . , N−1
      Event condition met indicator #p, when the UE is configured with higher layer parameter PresenceOfEventConditionMetIndicator, where p∈P, and P is the set comprising one or more values of {1, . . . , N−1}; the reference signal corresponding to CRI or SSBRI #p and/or (differential) RSRP #p could satisfy the event condition(s) and/or determine the corresponding event(s), and/or the reference signal corresponding to CRI or SSBRI #q and/or (differential) RSRP #q may not satisfy the event condition(s) and/or determine the corresponding event(s), where q∈{1, . . . , N−1} and q∉P
      (N−|P|) zero(s) carried, conveyed or comprised by/in the (N−|P|) CSI field(s) that can be (or is supposed/expected to be) used to carry or convey or comprise or indicate Event condition met indicator(s) when the UE is configured with higher layer parameter PresenceOfEventConditionMetIndicator, where |P| represents or denotes size of the set P or the number of the one or more values comprised in the set P
      Differential RSRP for the current beam when the UE is configured with higher layer parameter enabledCurrentBeamReport-r19, which could determine the corresponding payload size of Nᵢ.
N_{reported} is the payload size of the current report, obtained according to Table 7e prior to padding.
   For N=1, where N is provided by nrofReportedRS-UEIBR-r19 in the current CSI report configuration that provides or configures necessary information and/or setting(s) for the current report, the current report for the current CSI report configuration could then comprise one or more of:
      The CSI report configuration indicator
      CRI or SSBRI #1
      RSRP #1
      Event condition met indicator #1 when the UE is configured with higher layer parameter PresenceOfEventConditionIndicator
      Differential RSRP for the current beam when the UE is configured with higher layer parameter enabledCurrentBeamReport-r19,
      which could determine the corresponding payload size of N_{reported}.
   For N>1, where N is provided by nrofReportedRS-UEIBR-r19 in the current CSI report configuration that provides or configures necessary information and/or setting(s) for the current report, the current report for the current CSI report configuration could then comprise one or more of:
      The CSI report configuration indicator
      CRI or SSBRI #k, where k=1, . . . , N−1
      (Differential) RSRP #k, where k=1, . . . , N−1
      Event condition met indicator #p, when the UE is configured with higher layer parameter PresenceOfEventConditionMetIndicator, where p∈P, and P is the set comprising one or more values of {1, . . . , N−1}; the reference signal corresponding to CRI or SSBRI #p and/or (differential) RSRP #p could satisfy the event condition(s) and/or determine the corresponding event(s), and/or the reference signal corresponding to CRI or SSBRI #q and/or (differential) RSRP #q may not satisfy the event condition(s) and/or determine the corresponding event(s), where q∈{1, . . . , N−1} and q∉P
      (N−[P]) zero(s) carried, conveyed or comprised by/in the (N−[P]) CSI field(s) that can be (or is supposed/expected to be) used to carry or convey or comprise or indicate Event condition met indicator(s) when the UE is configured with higher layer parameter PresenceOfEventConditionMetIndicator, where |P| represents or denotes size of the set P or the number of the one or more values comprised in the set P
      Differential RSRP for the current beam when the UE is configured with higher layer parameter enabledCurrentBeamReport-r19,
   which could determine the corresponding payload size of N_{reported}.

TABLE 7f
An example of mapping order of CSI fields
of one UE-initiated (UEI) CSI/beam report

| CSI report number | CSI fields |
|---|---|
| CSI report #n | CSI report configuration indicator as in Table 6 |
| | CRI or SSBRI #1 as in Table 6 |
| | CRI or SSBRI #2 as in Table 6, if reported |
| | CRI or SSBRI #3 as in Table 6, if reported |
| | CRI or SSBRI #4 as in Table 6, if reported |
| | RSRP #1 as in Table 6 |
| | Differential RSRP #2 as in Table 6, if reported |
| | Differential RSRP #3 as in Table 6, if reported |
| | Differential RSRP #4 as in Table 6, if reported |
| | Event condition indicator #1, if reported |
| | Event condition indicator #2, if reported |
| | Event condition indicator #3, if reported |
| | Event condition indicator #4, if reported |
| | Differential RSRP for the current beam, if reported |
| | Zero padding bits O_{P}, if needed |

NOTE:
The CSI report configuration indicator with value i indicates the (i + 1)-th CSI report configuration among the CSI report configurations associated with the PUCCH carrying the PN message/trigger or UEIBRI or BRI which are ordered in ascending order of CSI-ReportConfigID. The event condition indicators are reported only when the UE is configured with higher layer parameter PresenceOfEventConditionIndicator. Differential RSRP for the current beam is reported only when the UE is configured with higher layer parameter enabledCurrentBeamReport-r19. Current beam is the reference signal in the indicated TCI state or the SS/PBCH block which is QCLed with the reference signal in the indicated TCI state. When nrofReportedRS-UEIBR-r19 = 1, the Event condition indicator #1 may not be present even though/when the UE is configured with higher layer parameter PresenceOfEventConditionIndicator; in this case, if the Event condition indicator #1 is present, it is set to value 1.

An event condition indicator in Table 7d could be in form of a one-bit indicator with ‘1’ indicating that the reference signal corresponding to the reported beam (e.g., in terms/form of the corresponding CRI or SSBRI and/or (absolute/differential) RSRP as in Table 7d) associated, mapped, linked or specific to the event condition indicator satisfies the corresponding event condition(s) and/or determines the corresponding event, and ‘0’ indicating that the reference signal corresponding to the reported beam (e.g., in terms/form of the corresponding CRI or SSBRI and/or (absolute/differential) RSRP as in Table 7d) associated, mapped, linked or specific to the event condition indicator may not satisfy the corresponding event condition(s) and/or determine the corresponding event—for instance, when the UE is configured with higher layer parameter enabledCurrentBeamReport, and a corresponding CSI-ReportConfig (e.g., with which the CSI report configuration indicator is associated) is with the higher layer parameter eventType set to ‘event1’, ‘event2’ or ‘event3’ or ‘event7’, if the L1-RSRP of the reference signal associated with CRI or SSBRI #j is eventThreshold greater than (or equal to) the L1-RSRP of the reference signal in the indicated TCI state or the SS/PBCH block which is QCLed with the reference signal in the indicated TCI state by (1) at least eventInstanceCount (e.g., eventInstanceCount is provided and/or eventInstanceCount>1 or eventInstanceCount>1) times within a/the corresponding time window (e.g., provided by eventDetectionTime Window Length-r19 and/or eventDetectionTimeWindowLength-r19>0 or eventDetectionTimeWindowLength-r19>1) specific to the reference signal associated with CRI or SSBRI #j or (2) 1 or one or one time or once (e.g., if eventInstanceCount is not provided or if eventInstanceCount is provided but set to 1 or one, and/or if eventDetectionTime Window Length-r19 is not provided or if eventDetectionTimeWindowLength-r19 is provided but set to 0 or zero)—the above condition/procedure can also be referred to as that the reference signal associated with CRI or SSBRI #j initiates the UE to transmit a UEIRI in the PUCCH resource configured by firstPUCCHResourceConfig-UEIBR-r19 as in Step-1 of Mode-A, Mode-B and/or Mode-C as specified/defined herein in the present disclosure, the value of the condition met indicator #j is set to 1; otherwise set to 0.

The number of zero padding bits Op in Table 7f is 0 if there is only one CSI report configuration associated with the PUCCH carrying the PN message/trigger or UEIBRI or BRI; otherwise Oₚ=Nₘₐₓ−N_{reported}, where:

$${N}_{max} = {max}_{i ∈ S} ( {N}_{i} ) ,$$

where S is the set of CSI report configurations associated with the PUCCH carrying the PN message/trigger or UEIBRI or BRI, and Nᵢ is the payload size of the report for the i-th CSI report configuration, obtained according to Table 7f prior to padding; regarding determination of Nᵢ
   For N=1, where Nis provided by nrofReportedRS-UEIBR-r19 in the i-th CSI report configuration, the report for the i-th CSI report configuration could then comprise one or more of:
      The CSI report configuration indicator
      Event condition indicator #1 when the UE is configured with higher layer parameter PresenceOfEventConditionIndicator
      CRI or SSBRI #1
      RSRP #1
      Differential RSRP for the current beam when the UE is configured with higher layer parameter enabledCurrentBeamReport-r19,
      which could determine the corresponding payload size of Nᵢ.
For N>1, where Nis provided by nrofReportedRS-UEIBR-r19 in the i-th CSI report configuration, the report for the i-th CSI report configuration could then comprise one or more of:
   The CSI report configuration indicator
   CRI or SSBRI #k, where k=1, . . . , N−1
   (Differential) RSRP #k, where k=1, . . . , N−1
   Event condition indicator #k, where k=1, . . . , N−1, when the UE is configured with higher layer parameter PresenceOfEventConditionIndicator
   Differential RSRP for the current beam when the UE is configured with higher layer parameter enabledCurrentBeamReport-r19,
   which could determine the corresponding payload size of Nᵢ.
N_{reported} is the payload size of the current report, obtained according to Table 7f prior to padding.
   For N=1, where N is provided by nrofReportedRS-UEIBR-r19 in the current CSI report configuration that provides or configures necessary information and/or setting(s) for the current report, the current report for the current CSI report configuration could then comprise one or more of:
      The CSI report configuration indicator
      CRI or SSBRI #1
      RSRP #1
      Differential RSRP for the current beam when the UE is configured with higher layer parameter enabledCurrentBeamReport-r19,
      which could determine the corresponding payload size of N_{reported}.
   For N>1, where N is provided by nrofReportedRS-UEIBR-r19 in the current CSI report configuration that provides or configures necessary information and/or setting(s) for the current report, the current report for the current CSI report configuration could then comprise one or more of:
      The CSI report configuration indicator
      CRI or SSBRI #k, where k=1, . . . , N−1
      (Differential) RSRP #k, where k=1, . . . , N−1
      Event condition indicator #k, where k=1, . . . , N−1, when the UE is configured with higher layer parameter PresenceOfEventConditionIndicator
      Differential RSRP for the current beam when the UE is configured with higher layer parameter enabledCurrentBeamReport-r19,
      which could determine the corresponding payload size of N_{reported}.

Throughout the present disclosure, a UEIBRI can also be referred to as or equivalent to or represented/denoted by/as a UEI-CSI indicator/indication (UEICI) or a UEI report indicator/indication (UEIRI)—i.e., a UEIBRI used in the examples specified throughout the present disclosure can be replaced by/with a UEICI or a UEIRI. In addition, a UEIBR can also be referred to as or equivalent to or represented/denoted by/as a UEI CSI report (UEICR) or a UEI report (UEIR) such that a UEIBR used in the examples throughout the present disclosure can be replaced by/with a UEICR or a UEIR.

Throughout the present disclosure, a payload size of a report could correspond to or could be referred to as or could be represented or determined by/as a/the total number of bits or a/the total bit widths that can be indicated or carried or conveyed by all the CSI field(s) in the report.
If a CSI field does not indicate or carry or convey any report quantity(s) or 0, the number of bit(s) or bit width(s) that is indicated or carried or conveyed by this CSI field could be 0 (zero).
If a CSI field indicates or carries or conveys a zero (i.e., value 0), the number of bit(s) or bit width(s) that is indicated or carried or conveyed by this CSI field could be 1.
If a CSI field indicates or carries or conveys a one (i.e., value 1), the number of bit(s) or bit width(s) that is indicated or carried or conveyed by this CSI field could be 1.
If a CSI field indicates or carries or conveys a report quantity, the number of bit(s) or bit width(s) that is indicated or carried or conveyed by this CSI field could be the number of bit(s) or bit width(s) of or corresponding to the report quantity as illustrated in Table 6.

For the UEI report content(s)/quantity(s) in a UEI CSI/beam report shown in Table 7a, Table 7b and Table 7c,
When/if the UEI CSI/beam report comprises only one reported beam corresponding to CRI or SSBRI #1 and RSRP #1 in Table 7a/7b/7c, the UEI CSI/beam report may not comprise any event condition met indicator(s).
When/if the UEI CSI/beam report comprises one reported beam corresponding to CRI or SSBRI #1 and RSRP #1 in Table 7a/7b/7c, and the UEI CSI/beam report does not comprise the corresponding Event condition met indicator #1, the UEI CSI/beam report could comprise additional reported beam(s) corresponding to CRI(s) or SSBRI(s) #2, #3 and/or #4 and differential RSRP #2, #3 and/or #4 as shown in Table 7a/7b/7c and at least one Event condition met indicator of #2, #3 and/or #4.
When/if the UEI CSI/beam report comprises more than one or multiple reported beams each corresponding to a CRI or SSBRI #x and a corresponding (absolute or differential) RSRP #x (x∈{1, 2, 3, 4}), the UEI CSI/beam report could comprise at least one Event condition met indicator (e.g., denoted by Event condition met indicator #y with y∈{1, 2, 3, 4}).
When/if the UEI CSI/beam report comprises an Event condition met indicator y, the UEI CSI/beam report could also comprise a corresponding reported beam corresponding to a CRI or SSBRI #y and a corresponding (absolute or differential) RSRP #y, wherein y={1, 2, 3, 4}.

According to or following those specified herein in the present disclosure, the UE could report, in a single reporting instance or CSI/beam report associated with a CSI report configuration provided by CSI-ReportConfig configured with a higher layer parameter eventType-r19 set to ‘event-1’, ‘event-2’, ‘event-3’ and etc. respectively corresponding to the first event, second event, third event and etc. specified/defined herein in the present disclosure, N (e.g., N is provided by nrofReportedRS-UEIBR-r19 and greater than or equal to value 1—i.e., at least one) CRI(s) or SSBRI(s) and the corresponding L1-RSRP(s) corresponding to reference signal(s) determined or selected from reference signals provided by the newBeamResourceSet-r17 that comprise at least one reference signal that satisfies the triggering event condition(s) and/or determines a/the event(s), and when enableCurrentBeamReport-r19 is configured, the differential LI-RSRP of the reference signal indicated by the TCI state, or the SS/PBCH block which is QCLed with this reference signal, and M (e.g., M is greater than or equal to 0, and/or is less than or equal to N) Event condition met indicator(s) as specified/defined herein in the present disclosure.
When/if N=1, M=0, i.e., the UEI CSI/beam report may not comprise any Event condition met indicator. In this case,
   in one example, the UEI CSI/beam report may not comprise any CSI field(s) that could or could be used to carry or convey Event condition met indicator(s), and/or the CSI field(s) that could or could be used to carry or convey Event condition met indicator(s) could be absent from/in the UEI CSI/beam report;
   in another example, the UEI CSI/beam report may still comprise N=1 CSI field that could or could be used to carry or convey an Event condition met indicator, and/or the N=1 CSI field that could or could be used to carry or convey an Event condition met indicator could still be present in the UEI CSI/beam report; in this case, the aforementioned or above N=1 CSI field that could or could be used to carry or convey an Event condition met indicator could now carry or convey or could be padded with a zero as illustrated in the example provided in Table 7c, or a value/number other than or different from value 1 (i.e., value of an Event condition met indicator)
When/if N>1 (or N≥2), M≥1, i.e., the UEI CSI/beam report could comprise at least one Event condition met indicator.
When/if N>M (e.g., N>1 or N≥2 i.e. except for N=1, and/or M≥1), as shown in Table 7a/7b/7c, the UEI CSI/beam report could comprise N first CSI fields that could or could be used to carry or convey up to N Event condition met indicator(s) such that N=1, 2, 3, 4
   in this case, M CSI field(s) out of the N first CSI fields—denoted by M second CSI field(s)—could carry or convey the M Event condition met indicator(s)
   in addition, (N-M) CSI field(s) out of the N first CSI field(s)—denoted by (N-M) third CSI field(s)—other than the M second CSI field(s) could carry or convey or could be padded with zero(s) as illustrated in the example provided in Table 7c, or value(s)/number(s) other than or different from value 1 (i.e., value of an Event condition met indicator).

Throughout the present disclosure, a CSI/beam report can also be referred to as or equivalent to a UE-initiated (UEI) report of (report-)type (A), (report-)type (B) and/or (report-)type (C) as specified herein in the present disclosure, and the report content(s)/report quantity(s)/indicator(s) in a CSI/beam report can also be referred to as or equivalent to report content(s)/report quantity(s)/indicator(s) in a UEI report. As specified herein in the present disclosure, transmission of a UEI report (or equivalently, a CSI/beam report) could be preceded by transmission of a corresponding PN message, e.g., as UCI(s) via DG or Type1/Type2 CG PUSCH(s) and/or (periodic) PUCCH resource(s). Furthermore, transmission of a UEI report (or UEI report content(s)/quantity(s)) and transmission of a corresponding PN message can be in the same CSI report or reporting instance, or optionally, transmission of a UEI report (or UEI report content(s)/quantity(s)) and transmission of a corresponding PN message can be in separate CSI reports or reporting instances.

Throughout the present disclosure, unless otherwise specified, the UE could transmit/send the PN message(s)/trigger(s), e.g., in one or more or in a single or separate (UEI) report(s), of one or more or a single or separate PN configuration(s), according to those specified/defined herein in the present disclosure—e.g., configured/provided/indicated by the network (e.g., via RRC and/or MAC CE and/or DCI) subject to a UE's capability or capability signaling. In addition, a PN configuration (e.g., provided by PN-Config) as specified or defined herein in the present disclosure could also be referred to as a UEI configuration (e.g., provided by UEI-Config), and the transmission/indication of/by a PN message/trigger could also be referred to as transmission/indication of/by UEI report content(s)/UEI report(s).

Throughout the present disclosure, a radio link or beam quality could correspond to one or more absolute or differential RSRP and/or SINR values, wherein the RSRP/SINR value(s) could correspond to L1-RSRP/L1-SINR value(s) and/or filtered (e.g., L2/L3) RSRP and/or filtered (e.g., L2/L3) SINR value(s). Throughout the present disclosure, a UE could be provided or indicated or configured or informed or instructed by the network, e.g., via higher layer RRC signaling(s)/parameter(s) and/or MAC CE command(s) and/or dynamic DCI based L1 signaling(s) based on or according to a corresponding UE's capability or capability signaling, to apply or use a two-part UCI structure/format or a one-part UCI structure/format to transmit or send a UEI report.

Throughout the present disclosure, an indicated (joint/DL/UL) TCI state could correspond to or could be referred to as a (joint/DL/UL) TCI state provided/indicated in/by/via a cell switch command (CSC) for a PCI or a candidate cell via MAC CE signaling(s). Furthermore, a CSI report setting/CSI report configuration is equivalent to a CSI reporting setting/CSI reporting configuration and vice versa.

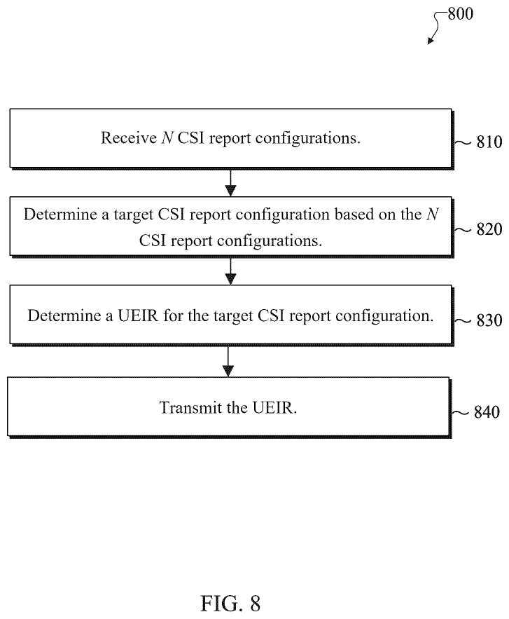

FIG. 8 illustrates an example method 800 performed by a UE in a wireless communication system according to embodiments of the present disclosure. The method 800 of FIG. 8 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 800 is for illustration only and other embodiments can be used without departing from the scope of the present disclosure.

The method 800 begins with the UE receiving N CSI report configurations (810). For example, in 810, each of the N CSI report configurations include a higher layer parameter ‘eventType’ and the N CSI report configurations include a common configuration of one or more PUCCH resources.

The UE then determines a target CSI report configuration based on the N CSI report configurations (820). In various embodiments, the target CSI report configuration has a lowest priority index value among the N CSI report configurations. In various embodiments, when the target CSI report configuration includes a higher layer parameter nrofReportedRS-UEIR set to a value greater than 1 and a higher layer parameter PresenceOfConditionMetIndicator, the UEIR includes at least one condition met indicator associated with a reported resource indicator. When the at least one condition met indicator is set to ‘1’, the reported resource indicator satisfies an event for the “eventType”. When the at least one condition met indicator is set to ‘0’, the reported resource indicator does not satisfy the event for the “eventType”. In various embodiments, when the target CSI report configuration is with a higher layer parameter nrofReportedRS-UEIR set to 1, the UEIR does not include a condition met indicator.

The UE then determines a UEIR for the target CSI report configuration (830). In various embodiments, the UEIR comprises a number of zeros, O, where O=Lmax−L; Lmax is a maximum payload size among the N CSI report configurations and L is a payload size for the target CSI report configuration.

The UE then transmits the UEIR (840). In various embodiments, the UE also transmits a UEIRI in one of the one or more PUCCH resources. The UEIR includes information related to the target CSI report configuration. For example, the information includes one an index of the target CSI report configuration or an ID of the target CSI report configuration.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to receive N channel state information (CSI) report configurations, where Nis greater than 1, wherein:
each of the N CSI report configurations includes a higher layer parameter ‘eventType’, and
the N CSI report configurations include a common configuration of one or more physical uplink control channel (PUCCH) resources; and
a processor operably coupled with the transceiver, the processor configured to:
determine a target CSI report configuration based on the N CSI report configurations; and
determine a UE-initiated report (UEIR) for the target CSI report configuration,
wherein the transceiver is further configured to transmit the UEIR.

2. The UE of claim 1, wherein:
the transceiver is further configured to transmit a UE-initiated report indicator (UEIRI) in one of the one or more PUCCH resources; and
the UEIR includes information related to the target CSI report configuration.

3. The UE of claim 2, wherein the information includes one of:
an index of the target CSI report configuration; or
an identity (ID) of the target CSI report configuration.

4. The UE of claim 1, wherein the target CSI report configuration has a lowest priority index value among the N CSI report configurations.

5. The UE of claim 1, wherein:
when the target CSI report configuration includes (i) a higher layer parameter nrofReportedRS-UEIR set to a value greater than 1 and (ii) a higher layer parameter PresenceOfConditionMetIndicator, the UEIR includes at least one condition met indicator associated with a reported resource indicator;
when the at least one condition met indicator is set to ‘1’, the reported resource indicator satisfies an event for the “eventType”; and
when the at least one condition met indicator is set to ‘0’, the reported resource indicator does not satisfy the event for the “eventType”.

6. The UE of claim 1, wherein, when the target CSI report configuration is with a higher layer parameter nrofReportedRS-UEIR set to 1, the UEIR does not include a condition met indicator.

7. The UE of claim 1, wherein:
the UEIR comprises a number of zeros, O, where O=Lmax−L;
Lmax is a maximum payload size among the N CSI report configurations; and
L is a payload size for the target CSI report configuration.

8. A base station (BS), comprising:
a processor; and
a transceiver operably coupled with the processor, the transceiver configured to:
transmit N channel state information (CSI) report configurations, where N is greater than 1, wherein:
each of the N CSI report configurations includes a higher layer parameter ‘eventType’, and
the N CSI report configurations include a common configuration of one or more physical uplink control channel (PUCCH) resources; and
receive a UE-initiated report (UEIR) associated with a target CSI report configuration, the target CSI report configuration based on the N CSI report configurations.

9. The BS of claim 8, wherein:
the transceiver is further configured to receive a UE-initiated report indicator (UEIRI) in one of the one or more PUCCH resources; and
the UEIR includes information related to the target CSI report configuration.

10. The BS of claim 9, wherein the information includes one of:
an index of the target CSI report configuration; or
an identity (ID) of the target CSI report configuration.

11. The BS of claim 8, wherein the target CSI report configuration has a lowest priority index value among the N CSI report configurations.

12. The BS of claim 8, wherein:
when the target CSI report configuration includes (i) a higher layer parameter nrofReportedRS-UEIR set to a value greater than 1 and (ii) a higher layer parameter PresenceOfConditionMetIndicator, the UEIR includes at least one condition met indicator associated with a reported resource indicator;
when the at least one condition met indicator is set to ‘1’, the reported resource indicator satisfies an event for the “eventType”; and
when the at least one condition met indicator is set to ‘0’, the reported resource indicator does not satisfy the event for the “eventType”.

13. The BS of claim 8, wherein, when the target CSI report configuration is with a higher layer parameter nrofReportedRS-UEIR set to 1, the UEIR does not include a condition met indicator.

14. The BS of claim 8, wherein:
the UEIR comprises a number of zeros, O, where O=Lmax−L;
Lmax is a maximum payload size among the N CSI report configurations; and
L is a payload size for the target CSI report configuration.

15. A method performed by a user equipment (UE), the method comprising:
receiving N channel state information (CSI) report configurations, where N is greater than 1, wherein:
each of the N CSI report configurations includes a higher layer parameter ‘eventType’, and
the N CSI report configurations include a common configuration of one or more physical uplink control channel (PUCCH) resources;
determining a target CSI report configuration based on the N CSI report configurations;
determining a UE-initiated report (UEIR) for the target CSI report configuration; and
transmitting the UEIR.

16. The method of claim 15, further comprising:
transmitting a UE-initiated report indicator (UEIRI) in one of the one or more PUCCH resources,
wherein the UEIR includes information related to the target CSI report configuration.

17. The method of claim 16, wherein the information includes one of:
an index of the target CSI report configuration; or
an identity (ID) of the target CSI report configuration.

18. The method of claim 15, wherein the target CSI report configuration has a lowest priority index value among the N CSI report configurations.

19. The method of claim 15, wherein:
when the target CSI report configuration includes (i) a higher layer parameter nrofReportedRS-UEIR set to a value greater than 1 and (ii) a higher layer parameter PresenceOfConditionMetIndicator, the UEIR includes at least one condition met indicator associated with a reported resource indicator;
when the at least one condition met indicator is set to ‘1’, the reported resource indicator satisfies an event for the “eventType”; and
when the at least one condition met indicator is set to ‘0’, the reported resource indicator does not satisfy the event for the “eventType”.

20. The method of claim 15, wherein, when the target CSI report configuration is with a higher layer parameter nrofReportedRS-UEIR set to 1, the UEIR does not include a condition met indicator.
